(19) United States
(12) Patent Application Publication
(10) Pub. No.: US 2025/0346304 A1
(43) Pub. Date: Nov. 13, 2025

(54) AUTONOMOUS MOBILE ROBOT

(71) Applicant: Oshkosh Corporation, Oshkosh, WI (US)

(72) Inventors: Devin Rosencrance, Oshkosh, WI (US); Taylor Adkins, Oshkosh, WI (US); Louis Bafile, Oshkosh, WI (US); Matt Becker, Oshkosh, WI (US); Patrick Dingman, Oshkosh, WI (US); Luke Dugan, Oshkosh, WI (US); Milan Klimes, Oshkosh, WI (US); Samuel Nessibu, Oshkosh, WI (US); Guido Ritelli, Oshkosh, WI (US); Kurtis Thrush, Oshkosh, WI (US); Tyler Walsh, Oshkosh, WI (US)

(73) Assignee: Oshkosh Corporation, Oshkosh, WI (US)

(21) Appl. No.: 19/086,543

(22) Filed: Mar. 21, 2025

Related U.S. Application Data
(60) Provisional application No. 63/643,528, filed on May 7, 2024.
(60) Provisional application No. 63/643,617, filed on May 7, 2024.
(60) Provisional application No. 63/643,788, filed on May 7, 2024.
(60) Provisional application No. 63/643,608, filed on May 7, 2024.
(60) Provisional application No. 63/643,631, filed on May 7, 2024.
(60) Provisional application No. 63/643,653, filed on May 7, 2024.
(60) Provisional application No. 63/643,541, filed on May 7, 2024.
(60) Provisional application No. 63/643,627, filed on May 7, 2024.
(60) Provisional application No. 63/643,723, filed on May 7, 2024.
(60) Provisional application No. 63/713,023, filed on Oct. 28, 2024.
(60) Provisional application No. 63/712,662, filed on Oct. 28, 2024.
(60) Provisional application No. 63/712,647, filed on Oct. 28, 2024.
(60) Provisional application No. 63/712,602, filed on Oct. 28, 2024.
(60) Provisional application No. 63/712,621, filed on Oct. 28, 2024.
(60) Provisional application No. 63/741,710, filed on Jan. 3, 2025.
(60) Provisional application No. 63/741,768, filed on Jan. 3, 2025.
(60) Provisional application No. 63/775,273, filed on Mar. 20, 2025.

(51) Int. Cl. B62D 33/08; G05D 1/693

(52) U.S. Cl. CPC B62D 33/08; G05D 1/693

(57) ABSTRACT

A system for transporting products throughout a manufacturing environment, includes a mobile robot including a frame, a tractive element coupled to the frame, a motor coupled to the frame and configured to drive the tractive element to propel the vehicle, at least one sensor configured to collect sensor data regarding a surrounding environment of the vehicle, an interface configured to engage a product, a lift assembly coupling the interface to the frame and configured to raise the interface relative to the frame, and a controller operatively coupled to the motor, the at least one sensor, and the lift assembly. The controller is configured to control the motor and the lift assembly based on information from the at least one sensor to autonomously transport the product.

### CROSS-REFERENCE TO RELATED PATENT APPLICATIONS

This application claims the benefit of and priority to (a) U.S. Provisional Patent Application 63/643,653, filed on May 7, 2024, (b) U.S. Provisional Patent Application 63/643,631, filed on May 7, 2024, (c) U.S. Provisional Patent Application 63/643,541, filed on May 7, 2024, (d) U.S. Provisional Patent Application 63/643,627, filed on May 7, 2024, (e) U.S. Provisional Patent Application 63/643,723, filed on May 7, 2024, (f) U.S. Provisional Patent Application 63/643,528, filed on May 7, 2024, (g) U.S. Provisional Patent Application 63/643,788, filed on May 7, 2024, (h) U.S. Provisional Patent Application 63/643,617, filed on May 7, 2024, (i) U.S. Provisional Patent Application 63/643,608, filed on May 7, 2024, (j) U.S. Provisional Patent Application 63/712,602, filed on Oct. 28, 2024, (k) U.S. Provisional Patent Application 63/712,621, filed on Oct. 28, 2024, (l) U.S. Provisional Patent Application 63/713,023, filed on Oct. 28, 2024, (m) U.S. Provisional Patent Application 63/712,662, filed on Oct. 28, 2024, (n) U.S. Provisional Patent Application 63/712,647, filed on Oct. 28, 2024, (o) U.S. Provisional Patent Application 63/741,768, filed on Jan. 3, 2025, (p) U.S. Provisional Patent Application 63/741,710, filed on Jan. 3, 2025, and (q) U.S. Provisional Patent Application 63/775,273, filed on Mar. 20, 2025, each of which is incorporated herein by reference in its entirety.

### BACKGROUND

The present disclosure relates generally to vehicles. More specifically, the present disclosure relates to vehicles utilized to transport material.

In a manufacturing environment, products are moved along a manufacturing line as various assembly processes are performed. In some such embodiments, the products are supported and/or propelled by vehicles. These vehicles may have varying ways of supporting the products and may incorporate varying levels of autonomy.

### SUMMARY

In some embodiments, a system for transporting products throughout a manufacturing environment, includes a mobile robot including: a frame: a tractive element coupled to the frame: a motor coupled to the frame and configured to drive the tractive element to propel the mobile robot: at least one sensor configured to collect sensor data regarding a surrounding environment of the mobile robot: an interface configured to engage a product: a lift assembly coupling the interface to the frame and configured to raise the interface relative to the frame; and a controller operatively coupled to the motor, the at least one sensor, and the lift assembly and configured to control the motor and the lift assembly based on information from the at least one sensor to transport the product.

In some embodiments, a system for transporting products throughout a manufacturing environment, includes: (1) a mobile robot including: a frame: a tractive element coupled to the frame: a motor coupled to the frame and configured to drive the tractive element to propel the mobile robot: at least one sensor configured to collect sensor data regarding a surrounding environment of the mobile robot: an interface configured to engage a product: a lift assembly coupling the interface to the frame and configured to raise the interface relative to the frame; and a controller operatively coupled to the motor, the at least one sensor, and the lift assembly and configured to control the motor and the lift assembly based on information from the at least one sensor to transport the product, (2) the mobile robot further including: a subframe pivotably coupled to the frame: a second tractive element coupled to the subframe, wherein the motor and the tractive element are coupled to the frame via the subframe, and wherein the subframe pivots relative to the frame to maintain contact of the tractive element and the second tractive element with a ground surface; and (3) wherein the lift assembly is a scissor assembly and includes a lift actuator coupled between the frame and the scissor assembly so that the lift actuator is configured to selectively raise the interface relative to the frame, wherein the lift actuator is a multi-stage telescoping actuator that includes a base stage, an intermediate stage, and an outer stage, and wherein the base stage is coupled to the frame, the outer stage is coupled to the scissor assembly, and the intermediate stage is arranged between the base stage and the outer stage; and (4) wherein the lift assembly further includes: a platform: the scissor assembly coupled between the frame and the platform and including a prop pin: the lift actuator coupled between the frame and the scissor assembly, wherein the lift actuator is configured to selectively raise the platform relative to the frame; and a support prop including a plurality of notches, wherein the support prop is pivotably coupled to a side of the scissor assembly so that when the lift actuator raises the platform, the support prop is pivotably biased to bring one of the plurality of notches into engagement with the prop pin and prevent the platform from being lowered; and (5) the mobile robot further including: a first channel and a second channel coupled to the frame, the first channel extending along a longitudinal axis and the second channel extending along a lateral axis, the first channel and the second channel each including: a first guide and a second guide offset from one another and each including a first portion and a second portion, wherein the first portions extend substantially parallel to one another, and wherein the second portions extend away from one another as the second portions extend away from the first portions; and (6) the mobile robot further including: a cart interface for coupling a cart to the mobile robot, the cart interface including: a mounting bracket configured to be coupled to the frame: a cam plate pivotably coupled to the mounting bracket: a cart interface actuator coupled to the mounting bracket and the cam plate and configured to rotate the cam plate relative to the mounting bracket; and a first pin coupled to the cam plate: wherein rotation of the cam plate causes the first pin to move upward to engage the cart; and (7) wherein the cart includes a plurality of tractive elements and a platform configured to support the product, and the mobile robot further includes: the first pin movably coupled to the frame and configured to engage the cart to couple the cart to the frame: an actuator assembly including at least one actuator, wherein the actuator assembly is configured to raise the first pin relative to the frame; and wherein the controller is further configured to: control the motor to propel the mobile robot to a position in which the pin is positioned beneath the cart; and control the actuator assembly to raise the first pin until the first pin engages the cart to couple the cart to the frame; and (8) the mobile robot further including: a cart interface coupled to the frame and configured to couple the mobile robot to a cart extending above the cart interface, the cart interface including: a second pin repositionable relative to the frame from a first lowered position to a first raised position to engage the cart: a third pin repositionable from a second lowered position to a second raised position to engage the cart; and a second cart interface actuator coupled to the second pin and configured to move the second pin from the first lowered position to the first raised position, wherein the second pin is repositionable without requiring movement of the third pin; and (9) wherein the frame includes a front surface, a rear surface opposite the front surface, and side surfaces extending between the front surface and the rear surface, and wherein the at least one sensor includes a first sensor oriented parallel with at least one of the front surface, the rear surface, or the side surfaces and a second sensor oriented non-parallel with the front surface, the rear surface, and the side surfaces; and (10) the mobile robot further includes: a first implement including: a first implement interface configured to be coupled to a first type of product; and a first base frame configured to be removably coupled to a mounting interface of the frame; and a second implement including: a second implement interface configured to be coupled to a second type of product; and a second base frame configured to be removably coupled to the mounting interface of the frame; and (11) a tow bar coupled to the mobile robot at a first end of the tow bar and coupled to a second mobile robot at a second end of the tow bar opposite the first end, wherein, responsive to the motor propelling the mobile robot, the tow bar exerts a force on the second mobile robot to maintain a space between the second mobile robot and the first mobile robot; and (12) wherein the interface includes a platform defining a platform aperture and a cradle configured to support an end of the product for movement, the cradle rotatably coupled to the frame, the mobile robot further including: a bracket coupled with the cradle and defining a bracket aperture; and a pin configured to be received in a platform aperture and the bracket aperture to inhibit rotation of the cradle relative to the platform, wherein the controller is further configured to: monitor a position of the pin; and control the motor of at least one of the mobile robot or the second mobile robot based on the position of the pin: wherein the mobile robot and the second mobile robot are configured to transition between a first configuration and a second configuration by moving the pin out of the platform aperture and the bracket aperture of one of the mobile robot and the second mobile robot and into the platform aperture and the bracket aperture of the other of the mobile robot and the second mobile robot; and (13) wherein the at least one sensor is moveable coupled to the frame, the mobile robot further including: a sensor actuator configured to move the at least one sensor to reposition the at least one sensor relative to the frame, wherein the controller is further configured to detect an obstruction of the at least one sensor and operate the sensor actuator to reposition the at least one sensor; and (14) wherein the controller is further configured to: obtain a floorplan of a production system and a current position of the mobile robot: receive one or more inputs including a plurality of locations and an order of the plurality of locations: generate, based on the floorplan of the production system and a footprint of the mobile robot, a route for the vehicle from the current position of the vehicle to the plurality of locations in the order; and (15) the second mobile robot coupled with the mobile robot, the mobile robot and the second mobile robot configured to support the product: wherein at least one of the controller is configured to, or one or more memory devices storing instructions thereon, that, when executed by one or more processors, cause the one or more processors to: obtain one or more locations in a floorplan of a production system: obtain a route for the first vehicle and the second vehicle, from a first current position of the first vehicle and a second current position of the second vehicle to the one or more locations; and generate a series of coordinated motions between the first vehicle and the second vehicle based on the route; and (16) the mobile robot further including: at least one of an audio output device or a visual output device, wherein the controller is further configured to: determine a condition of the mobile robot; and provide an alert, via the at least one audio output device or visual output device based on the determined condition, wherein the determined condition is at least one of a plurality of conditions, and wherein each condition of the plurality of conditions is associated with a unique alert, the unique alert including at least one unique aspect specific to the condition relative to the other conditions of the plurality of conditions; and (17) the mobile robot further including: a sensor coupled to the interface and configured to provide sensor data indicating a measured force on the interface, wherein the controller is further configured to: receive an indication of a current stage of assembly of the product: determine an expected force on the interface based on the current stage of assembly of the product: compare the measured force with the expected force; and in response to a determination that the measured force differs from the expected force, provide a notification to a user; and (18) wherein the controller is further configured to: operate the mobile robot in a first mode of a plurality of modes, wherein the plurality of modes includes a manual mode, a guided mobile robot mode, and an autonomous mode: determine a match value between the sensor data and at least one operational criteria of a plurality of operational criteria; and operate the mobile robot in a second mode of the plurality of modes based on the match value, wherein the second mode is different than the first mode; and (19) wherein the controller is further configured to: operate the mobile robot along a first path: sense, via the at least one sensor, at least one indicator in the environment: determine, based on the at least one indicator, a boundary of a first predefined zone: determine the first path extends into the first predefined zone in the environment surrounding the mobile robot: generate a second path based on the sensor data that avoids the first predefined zone; and operate the mobile robot along the second path.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a vehicle, according to an exemplary embodiment.

FIG. 2 is a top view of the vehicle of FIG. 1.

FIG. 3 is a perspective view of the vehicle of FIG. 1 equipped with a lifting implement, according to an exemplary embodiment.

FIG. 4 is a perspective view of the vehicle of FIG. 3 and another vehicle cooperating to support a telehandler, according to an exemplary embodiment.

FIG. 5 is a perspective view of the vehicle of FIG. 1 equipped with a cart implement, according to an exemplary embodiment.

FIG. 6 is a perspective view of the vehicle of FIG. 3 interfacing with a cart supporting a boom assembly, according to an exemplary embodiment.

FIG. 7 is a block diagram of a control system for the vehicle of FIG. 1.

FIG. 8 is a top view of a production system including the vehicle of FIG. 1, according to an exemplary embodiment.

FIG. 9 is a perspective view of a drive arrangement, according to an exemplary embodiment.

FIG. 10 is a perspective view of the drive arrangement of FIG. 9.

FIG. 11 is a perspective view of a subframe of a drive arrangement, according to an exemplary embodiment.

FIG. 12 is a perspective view of the subframe of FIG. 11.

FIG. 13 is a diagram of a drive arrangement on a flat surface, according to an exemplary embodiment.

FIG. 14 is a diagram of a drive arrangement on an uneven surface, according to an exemplary embodiment.

FIG. 15 is a diagram of a drive arrangement on an uneven surface, according to an exemplary embodiment.

FIG. 16 is a perspective view of a subframe of a drive arrangement, according to an exemplary embodiment.

FIG. 17 is a bottom perspective view of a portion of the drive arrangement of FIG. 16, according to an exemplary embodiment.

FIG. 18 is a perspective view of the lifting implement of FIG. 3, according to an exemplary embodiment.

FIG. 19 is a perspective view of the lifting implement of FIG. 18.

FIG. 20 is a bottom perspective view of the lifting implement of FIG. 18.

FIG. 21 is a perspective view of the lifting implement of FIG. 18 with a scissor assembly in a lowered position.

FIG. 22 is a perspective view of the lifting implement of FIG. 18 with a scissor assembly in a raised position and a support prop in an unlocked position.

FIG. 23 is a perspective view of the lifting implement of FIG. 18 with a scissor assembly in a raised position and a support prop in an unlocked position.

FIG. 24 is a perspective view of a scissor assembly of the lifting implement of FIG. 18.

FIG. 25 is a top perspective view of the lifting implement of FIG. 18.

FIG. 26 is a perspective view of a product received within a cradle of the lifting implement of FIG. 18, according to an exemplary embodiment.

FIG. 27 is a top perspective view of the lifting implement with a cradle rotated, according to an exemplary embodiment.

FIG. 28 is a bottom perspective view of a cradle of the lifting implement of FIG. 18.

FIG. 29 is a bottom perspective view of a cradle of the lifting implement of FIG. 18.

FIG. 30 is a perspective view of the lifting implement with a support prop in a locked position.

FIG. 31 is a perspective view of the lifting implement with a support prop in a locked position.

FIG. 32 is a perspective view of the lifting implement with a support prop in a locked position.

FIG. 33 is a perspective view of the lifting implement with a support prop in a locked position.

FIG. 34 is a perspective view of the lifting implement with a support prop in an unlocked position.

FIG. 35 is a cross-sectional view of the lifting implement with a lift actuator in an extended position.

FIG. 36 is a cross-sectional view of the lifting implement with a lift actuator in an extended position.

FIG. 37 is a cross-sectional view of the lifting implement with a lift actuator in a retracted position.

FIG. 38 is a cross-sectional view of the lifting implement with a lift actuator in a retracted position.

FIG. 39 is a cross-sectional view of the lifting implement with a lift actuator in a retracted position.

FIG. 40 is a cross-sectional view of the lifting implement with a lift actuator in a retracted position.

FIG. 41 is a cross-sectional view of the lifting implement with a lift actuator in an extended position.

FIG. 42 is a perspective view of a vehicle with a lifting implement in a retracted position, according to an exemplary embodiment.

FIG. 43 is a perspective view of the vehicle of FIG. 42 with a lifting implement in an extended position, according to an exemplary embodiment.

FIG. 44 is a top view of the vehicle of FIG. 42, according to an exemplary embodiment.

FIG. 45 is a top perspective view of a cradle of the vehicle of FIG. 42, according to an exemplary embodiment.

FIG. 46 is a bottom perspective view of the cradle of FIG. 45.

FIG. 47 is a perspective view of a scissor assembly of the vehicle of FIG. 42, according to an exemplary embodiment.

FIG. 48 is a perspective view of a scissor assembly of the vehicle of FIG. 42, according to an exemplary embodiment.

FIG. 49 is a perspective view of a scissor assembly of the vehicle of FIG. 42, according to an exemplary embodiment.

FIG. 50 is an enlarged side perspective view of a position arm of the vehicle of FIG. 42, according to an exemplary embodiment.

FIG. 51 is an enlarged rear perspective view of a position arm of the vehicle of FIG. 42, according to an exemplary embodiment.

FIG. 52 is a perspective view of the vehicle of FIG. 42 including a pump, according to an exemplary embodiment.

FIG. 53 is a perspective view of a cart, according to an exemplary embodiment.

FIG. 54 is a perspective view of the cart of the FIG. 53, according to an exemplary embodiment.

FIG. 55 is a perspective view of a guide of the cart of FIG. 53, according to an exemplary embodiment.

FIG. 56 is a perspective view of a positioning mechanism of the cart of FIG. 53, according to an exemplary embodiment.

FIG. 57 is a perspective view of a cart arrangement of the cart of FIG. 53, according to an exemplary embodiment.

FIG. 58 is a perspective view of a vehicle, a cart including casters, and booms, according to an exemplary embodiment.

FIG. 59 is a top perspective view of the cart of FIG. 58, according to an exemplary embodiment.

FIG. 60 is a perspective view of the vehicle and cart of FIG. 58, according to an exemplary embodiment.

FIG. 61 is a perspective view of the vehicle and cart of FIG. 58, according to an exemplary embodiment.

FIG. 62 is a bottom perspective view of the vehicle and cart of FIG. 58, according to an exemplary embodiment.

FIG. 63 is a top perspective view of the cart and cradle of FIG. 58, according to an exemplary embodiment.

FIG. 64 is a top perspective view of one of the casters of FIG. 58, according to an exemplary embodiment.

FIG. 65 is a top perspective view of the cart of FIG. 58, according to an exemplary embodiment.

FIG. 66 is a top view of the cart of FIG. 58, according to an exemplary embodiment.

FIG. 67 is a perspective view of a cart interface, according to an exemplary embodiment.

FIG. 68 is a cross-sectional view taken along a right side of the cart interface of FIG. 67, according to an exemplary embodiment.

FIG. 69 is a perspective view of the vehicle of FIG. 1 equipped with a cart interface engaging the cart of FIG. 58, according to an exemplary embodiment.

FIG. 70 is a perspective view of the vehicle of FIG. 1 with the cart interface of FIG. 69, according to an exemplary embodiment.

FIG. 71 is a perspective view of the vehicle of FIG. 1 with the cart interface of FIG. 69 with a pair of covers removed, according to an exemplary embodiment.

FIG. 72 is a side section view of the cart interface of FIG. 69, according to an exemplary embodiment.

FIG. 73 is a side section view of a first pin assembly of the cart interface of FIG. 69, according to an exemplary embodiment.

FIG. 74 is a side view of an actuator assembly of the cart interface of FIG. 69, according to an exemplary embodiment.

FIG. 75 is a section view of the first pin assembly of FIG. 73, according to an exemplary embodiment.

FIG. 76 is a section view of the first pin assembly of FIG. 73, according to another exemplary embodiment.

FIG. 77 is a side section view the cart interface of FIG. 69 and the cart of FIG. 58 in a first configuration, according to an exemplary embodiment.

FIG. 78 is a side section view the cart interface of FIG. 69 and the cart of FIG. 58 in a second configuration, according to an exemplary embodiment.

FIG. 79 is a side section view the cart interface of FIG. 69 and the cart of FIG. 58 in a third configuration, according to an exemplary embodiment.

FIG. 80 is a side section view the cart interface of FIG. 69 and the cart of FIG. 58 in a fourth configuration, according to an exemplary embodiment.

FIG. 81 is a side section view the cart interface of FIG. 69 and the cart of FIG. 58 in a fifth configuration, according to an exemplary embodiment.

FIG. 82 is a side section view the cart interface of FIG. 69 and the cart of FIG. 58 in a sixth configuration, according to an exemplary embodiment.

FIG. 83 is a top view of the vehicle of FIG. 1 including a sensing system, according to an exemplary embodiment.

FIG. 84 is a detail view of sensors of the sensing system of FIG. 83, according to an exemplary embodiment.

FIG. 85 is a top view of a sensing field of the sensing system of FIG. 83, according to an exemplary embodiment.

FIG. 86 is a perspective view of the sensing field of FIG. 85, according to an exemplary embodiment.

FIG. 87 is a top view of a sensing system of the vehicle of FIG. 1, according to an exemplary embodiment.

FIG. 88 is a side perspective view of the vehicle of FIG. 1, including a skate assembly, according to an exemplary embodiment.

FIG. 89 is a side perspective view of the vehicle of FIG. 1, including a skate assembly, according to an exemplary embodiment.

FIG. 90 is a top view of a vehicle according to an exemplary embodiment.

FIG. 91 is a detail view of the vehicle of FIG. 90, according to an exemplary embodiment.

FIG. 92 is a front perspective view of the vehicle of FIG. 90, according to an exemplary embodiment.

FIG. 93 is a detail view of the vehicle of FIG. 90, according to an exemplary embodiment.

FIG. 94 is a bottom perspective view of the vehicle of FIG. 90, according to an exemplary embodiment.

FIG. 95 is a bottom view of the vehicle of FIG. 1.

FIG. 96 is a top view of a frame of the vehicle of FIG. 1.

FIGS. 97-99 are perspective views of the lifting implement of FIG. 3.

FIGS. 100 and 101 are perspective views of the cart implement of FIG. 5.

FIG. 102 is a perspective view of a turning implement for the vehicle of FIG. 1, according to an exemplary embodiment.

FIG. 103 is a top view of the vehicle of FIG. 1 in a configuration having a first width.

FIG. 104 is a top view of the vehicle of FIG. 1 in a configuration having a second width.

FIG. 105 is a perspective view of the vehicle of FIG. 3 and a skate cooperating to support the telehandler, and a tow bar coupling the vehicle of FIG. 3 with the skate, according to an exemplary embodiment.

FIG. 106 is a top view of the vehicle of FIG. 3 and the skate of FIG. 105 cooperating to support the telehandler, and the tow bar of FIG. 105, according to an exemplary embodiment.

FIG. 107 is a bottom perspective view of the skate of FIG. 105, according to an exemplary embodiment.

FIG. 108 is a rear perspective view of the skate of FIG. 105, according to an exemplary embodiment.

FIG. 109 is a section view of the tow bar of FIG. 105, according to an exemplary embodiment.

FIG. 110 includes various side views of a conduit management system supporting a conduit coupling the vehicle of FIG. 3 with the skate of FIG. 105, according to an exemplary embodiment.

FIG. 111 is a perspective view of a conduit management system supporting a conduit coupling the vehicle of FIG. 3 with the skate of FIG. 105, according to an exemplary embodiment.

FIG. 112 is a side view of a conduit management system including a pulley system for routing a conduit within the skate of FIG. 105, according to an exemplary embodiment.

FIG. 113 is a perspective view of the pulley system of FIG. 112, according to an exemplary embodiment.

FIG. 114 is a block diagram of a control system for the skate of FIG. 105.

FIG. 115 is a perspective view of the vehicle of FIG. 3 and another vehicle cooperating to support a telehandler, according to an exemplary embodiment.

FIG. 116 is a side view of the vehicle of FIG. 3 and another vehicle cooperating to support a telehandler, according to an exemplary embodiment.

FIG. 117 is a perspective view of the vehicle of FIG. 3 including a rotation locking assembly in a first position, according to an exemplary embodiment.

FIG. 118 is a top view of the vehicle of FIG. 3 including the rotation locking assembly of FIG. 117 in the first position, according to an exemplary embodiment.

FIG. 119 is a bottom perspective view of the vehicle of FIG. 3 including a sensor monitoring a position of a pin of the rotation locking assembly of FIG. 117, according to an exemplary embodiment.

FIG. 120 is a block diagram of a control system for the vehicle of FIG. 7, with a pathing generation system, according to an exemplary embodiment:

FIG. 121 is a top down view of a production system including a vehicle with the pathing generation system of FIG. 120, according to an exemplary embodiment:

FIG. 121 is a top down view of a production system including a vehicle with the pathing generation system of FIG. 120, according to an exemplary embodiment:

FIG. 123 is a top down view of a production system including a vehicle with the pathing generation system of FIG. 120, according to an exemplary embodiment:

FIG. 124 is a top down view of a production system including a vehicle with the pathing generation system of FIG. 120, according to an exemplary embodiment:

FIG. 125 is a top down view of a production system including a vehicle with the pathing generation system of FIG. 120, according to an exemplary embodiment:

FIG. 126 is a flow diagram of a process of the pathing generation system of FIGS. 120-125, according to an embodiment: FIG. 127 is a block diagram of a coordinated motion system for a vehicle, according to an exemplary embodiment:

FIG. 128 is a block diagram of a control system for the vehicle of FIG. 7, with a coordinated motion system, according to an exemplary embodiment:

FIG. 129 is top down view of a production system including a vehicle with the coordinated motion system of FIG. 128, according to an exemplary embodiment;

FIG. 130 is a top down view of a production system including a vehicle with the coordinated motion system of FIG. 128, according to an exemplary embodiment:

FIG. 131 is a top down view of a production system including a vehicle with the coordinated motion system of FIG. 128, according to an exemplary embodiment; and

FIG. 132 is a flow diagram of a process of the coordinated motion system of FIGS. 127-131, according to an exemplary embodiment.

FIG. 133 is a block diagram of a control system for the vehicle of FIG. 7, with a pathing generation system, according to an exemplary embodiment; and

FIG. 134 is a top down view of a production system including a vehicle with the pathing generation system of FIG. 128, according to an exemplary embodiment.

FIG. 135 is a block diagram of the vehicle of FIG. 1 supporting a product and equipped with sensors, according to an exemplary embodiment.

FIG. 136 is a block diagram of the vehicle of FIG. 1 and another vehicle equipped with sensors and cooperating to support a product, according to an exemplary embodiment.

FIG. 137 is a block diagram of a manufacturing method implemented in the production system of FIG. 8, according to an exemplary embodiment.

FIG. 138 is a flow chart of a method for adjusting the operation of a vehicle, according to an exemplary embodiment.

FIG. 139 is a top view of a production system with a plurality of zones including the vehicle of FIG. 1, according to an exemplary embodiment.

FIG. 140 is a flow chart of a method for operating a vehicle, according to an exemplary embodiment.

FIG. 141 is a flow chart of a method for operating a vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

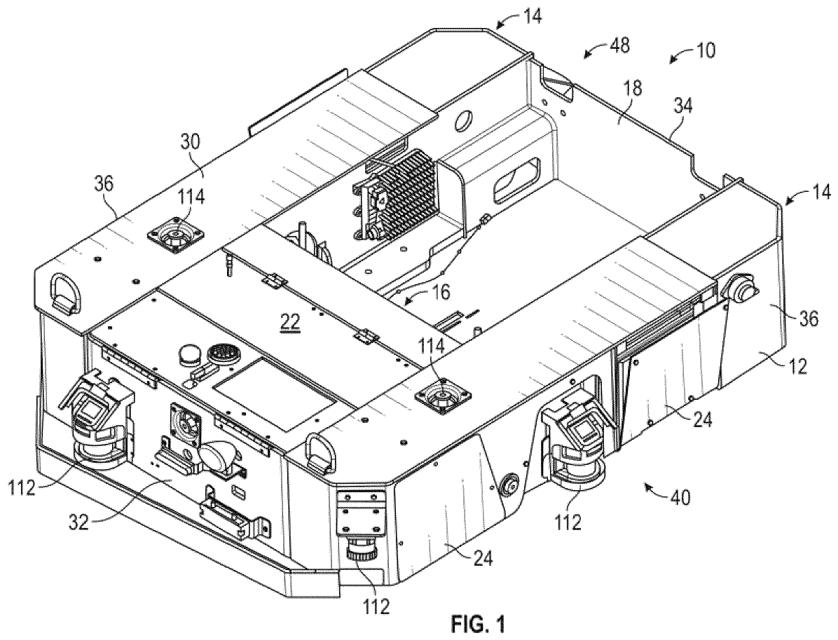

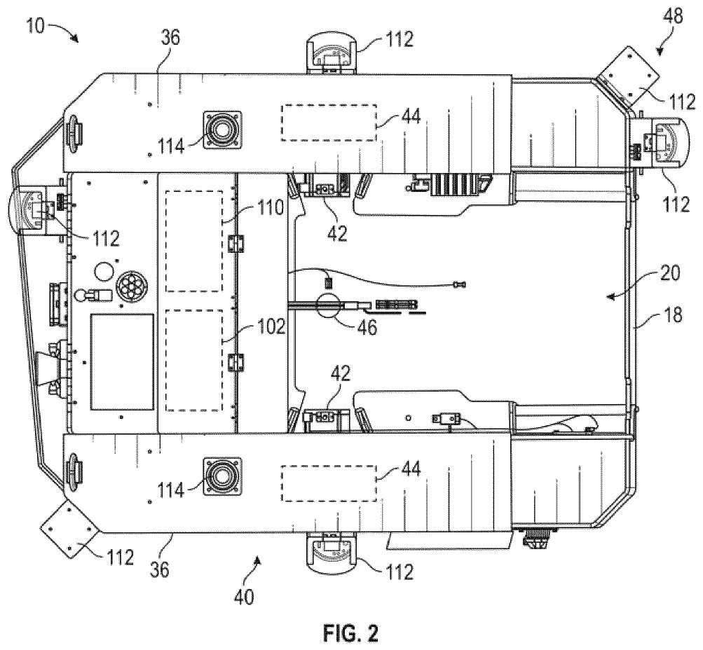

Referring to FIGS. 1 and 2, a machine, vehicle, trolley, transport, hauler, mule, or tug, is shown as vehicle 10 according to an exemplary embodiment. The vehicle 10 may be configured to support, push, pull, turn, or otherwise facilitate movement of a product or components of a product throughout a manufacturing environment. By way of example, the vehicle 10 may move a product (e.g., another vehicle or machine) along a manufacturing line as the product is assembled. The vehicle 10 may move the product between stations where different assembly operations are performed. Additionally or alternatively, the vehicle 10 may be used to move parts or subassemblies (e.g., booms, engines, tires, etc.) throughout the manufacturing environment (e.g., to the product, to a storage area, etc.).

The vehicle 10 may be manually controlled, partially autonomous, or fully autonomous. In some embodiments, the vehicle 10 is configured as a semi-automated guided vehicle (SGV). When configured as an SGV, the vehicle 10 may be manually operated by an operator (e.g., through a wireless or tethered user interface). By way of example, the operator may manually control the steering of the vehicle 10. In some embodiments, the vehicle 10 is configured as an automated guided vehicle (AGV). When configured as an AGV, the vehicle 10 may navigate along a predefined route (e.g., using a magnetic strip or other fixed navigation element). If the vehicle 10 configured as an AGV encounters an obstacle, the vehicle 10 may rely on manual intervention from an operator (e.g., through a user interface) to correct course and navigate around the obstacle. In some embodiments, the vehicle 10 is configured as an autonomous mobile robot (AMR). When configured as an AMR, the vehicle 10 may autonomously navigate through an area without requiring a predefined path. The vehicle 10 configured as an AMR may avoid obstacles without manual intervention by an operator.

The vehicle 10 includes a chassis, shown as frame 12, that supports the other components of the vehicle 10. In some embodiments, the frame 12 defines an enclosure that contains one or more components of the vehicle 10. The frame 12 includes a pair of side portions, shown as drive modules 14, a central portion, shown as controls enclosure 16, and a lateral member, shown as back plate 18. The drive modules 14 each extend longitudinally along the vehicle 10 and are laterally offset from one another. The controls enclosure 16 and the back plate 18 each extend laterally between the drive modules 14, fixedly coupling the drive modules 14 to one another. The controls enclosure 16 and the back plate 18 are longitudinally offset from one another, such that a recess or passage, shown as implement recess 20, is defined between the controls enclosure 16, the back plate 18, and the drive modules 14.

The drive modules 14 may contain components that facilitate propulsion of the vehicle (e.g., the drivetrain 40). The drive modules 14 may include one or more removable or repositionable panels, shown as drive module doors 24, that facilitate access to components within the drive modules 14 from outside of the vehicle 10. The controls enclosure 16 may contain components that facilitate powering or control over the vehicle (e.g., the controller 102, the batteries 110). The controls enclosure 16 includes a removable or repositionable panel, shown as controls enclosure door 22, that facilitates access to components within the controls enclosure 16 from outside of the vehicle 10. In other embodiments, the vehicle 10 includes a separate housing, body, or enclosure that is coupled to the frame 12 and contains one or more components of the vehicle.

The frame 12 defines a top surface 30, a front surface 32, a rear surface 34, and a pair of side surfaces 36 of the vehicle 10. The top surface 30 extends substantially horizontally across the drive modules 14 and the controls enclosure 16. A distance from the top surface 30 to the ground beneath the vehicle 10 may define a height of the vehicle 10. The front surface 32 is positioned at a front end portion of the frame 12 and extends substantially vertically and laterally across the drive modules 14 and the controls enclosure 16. The rear surface 34 is positioned at a rear end portion of the frame 12 and extends substantially vertically and laterally across the drive modules 14 and the back plate 18. The side surfaces 36 each extend longitudinally along one of the drive modules 14, between the front surface 32 and the rear surface 34.

The vehicle 10 includes a drive system or driveline, shown as drivetrain 40, that is configured to propel and steer the vehicle 10. The driveline includes a pair of actuators or motors (e.g., hydraulic motors, pneumatic motors, electric motors, etc.), shown as drive motors 42. In some embodiments, the drive motors 42 are electric motors powered by an electrical energy source (e.g., the batteries 110, energy from a power grid external to the vehicle 10, etc.). The drive motors 42 are each configured to provide rotational mechanical energy to drive rotation of one or more tractive elements 44 (e.g., wheel and tire assemblies as shown in FIG. 2). In some embodiments, the drive motors 42 drive the left and right sides of the drivetrain 40 independently, facilitating skid steer operation of the vehicle 10. By way of example, the tractive elements 44 may be driven at the same speed and in the same direction to travel straight. By way of another example, the tractive elements 44 may be driven at different directions and/or at different speeds to turn the vehicle 10. By driving the tractive elements 44 at the same speed and in opposite directions, the drivetrain 40 may rotate the vehicle 10 about a substantially vertical axis, shown as central axis 46, that is substantially centered relative to the frame 12. Rotation of the vehicle 10 about the central axis 46 may facilitate reorienting the vehicle 10 without changing position (i.e., turning in place).

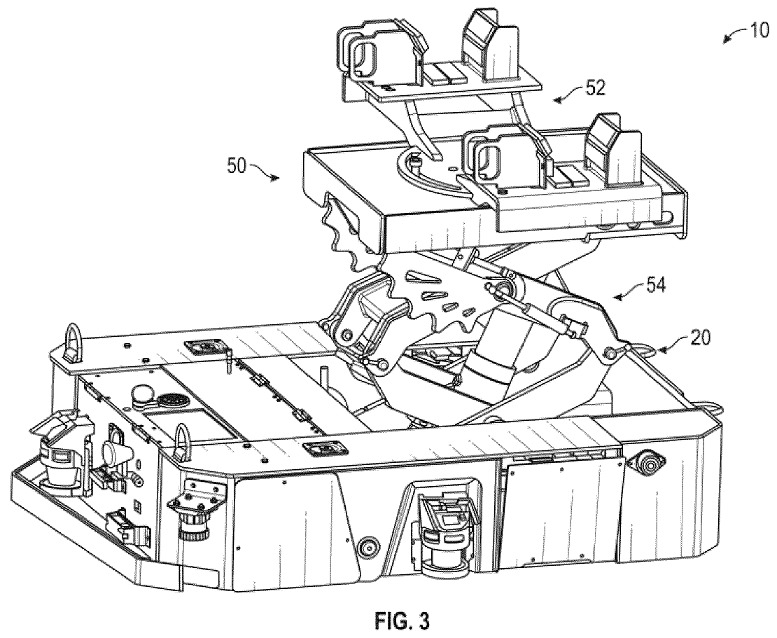

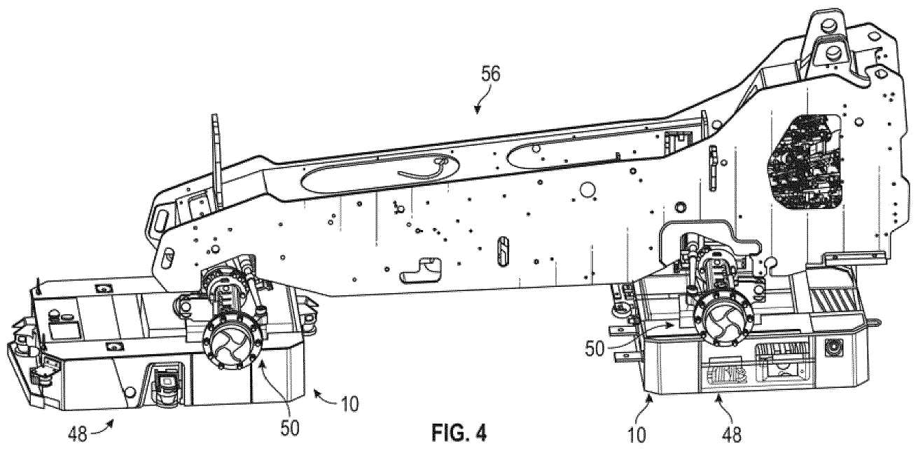

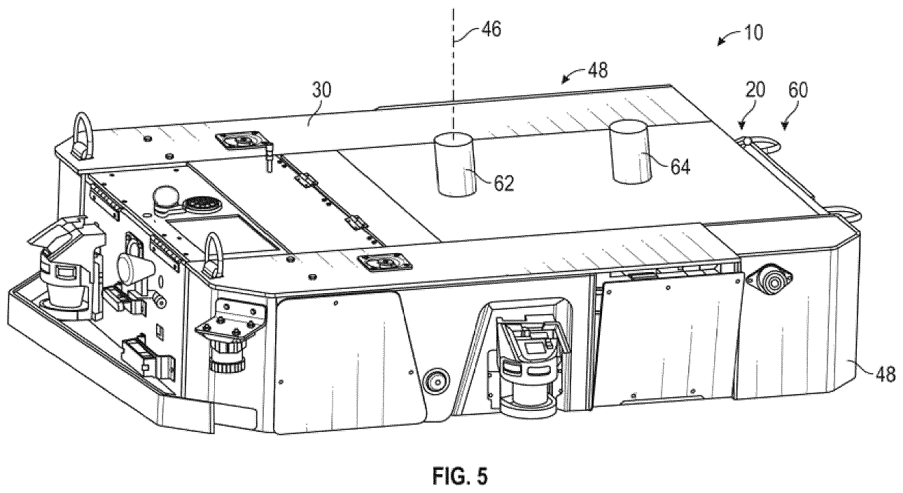

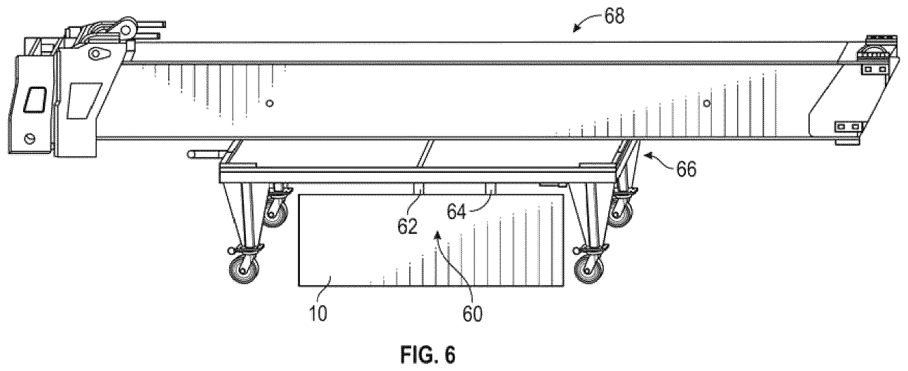

The frame 12, the drivetrain 40, and various other components coupled to the frame 12 form a base portion of the vehicle 10, shown as base assembly 48. To facilitate moving a product, the vehicle 10 may include an implement that that selectively couples the base assembly 48 to a product. FIGS. 3 and 4 illustrate a first implement, shown as lifting implement 50, and FIGS. 5 and 6 illustrate a second implement, shown as cart implement 60. Each implement may be received within the implement recess 20 and fixedly coupled to the frame 12. In some embodiments, the implement is removable from the implement recess 20 to facilitate interchanging with another type of implement. By way of example, the lifting implement 50 may be removed and replaced with the cart implement 60. In other embodiments, the implement is permanently installed on the vehicle.

Referring to FIGS. 3 and 4, the lifting implement 50 includes a product interface, shown as cradle 52, and a lift device or lifting assembly, shown as lift assembly 54. The cradle 52 is configured to receive and directly support a product, shown as telehandler 56. By way of example, the cradle 52 may receive an axle assembly of the telehandler 56. The lift assembly 54 couples the cradle 52 to the frame 12. The lift assembly 54 may be extended to raise the cradle 52 or retracted to lower the cradle 52. Accordingly, the lift assembly 54 may be used to raise or lower the telehandler 56.

Certain large products, such as the telehandler 56, may be difficult to support with only a single vehicle 10. To facilitate steering the product and spreading out the weight of the product, multiple vehicles 10 may be utilized. In the example shown in FIG. 4, a front axle of the telehandler 56 is supported by one vehicle 10, and a rear axle of the telehandler 56 is supported by another vehicle 10. In some embodiments, the vehicles 10 are independently operable. In other embodiments, operation of one vehicle 10 is dependent upon the other vehicle 10. By way of example, a first vehicle 10 may supply electrical energy to, propel, and/or control operation of the other vehicle 10.

Referring to FIGS. 5 and 6, the cart implement 60 includes a pair of protruding interface elements (e.g., pins), extending above the top surface 30. Specifically, the cart implement 60 includes a central pin, shown as driving pin 62, and an offset pin, shown as turning pin 64, that can each be selectively raised and lowered by an actuator of the cart implement 60. The driving pin 62 is centered about the central axis 46, and the turning pin 64 is offset from the central axis 46. The driving pin 62 and the turning pin 64 are positioned to a mobile platform, shown as cart 66, that supports a product subassembly, shown as boom assembly 68.

When extended, the driving pin 62 and the turning pin 64 each engage the cart 66 to limit movement of the cart 66 relative to the base assembly 48. When both the driving pin 62 and the turning pin 64 engage the cart 66, the cart 66 may be rotatably fixed to the base assembly 48. When only the driving pin 62 engages the cart 66, the base assembly 48 may rotate freely about the central axis 46 relative to the cart 66, but movement of the vehicle 10 in a particular direction may cause movement of the cart 66 in that same direction. When the driving pin 62 and the turning pin 64 are both retracted away from the cart 66, the vehicle 10 may move freely relative to the cart 66.

The cart 66 may be equipped with casters or slides to facilitate free movement of the cart 66 along the ground. In some embodiments, the cart 66 supports some or all of the weight of the boom assembly 68. The driving pin 62 and the turning pin 64 may generally push horizontally on the cart 66, such that there may be little or no transmission of vertical forces between the cart implement 60 and the cart 66. Accordingly, the vertical load on the vehicle 10 may be minimized while still permitting the vehicle 10 move the cart 66 and the boom assembly 68 throughout the environment as desired. This reduction in load may reduce the overall cost of the vehicle 10.

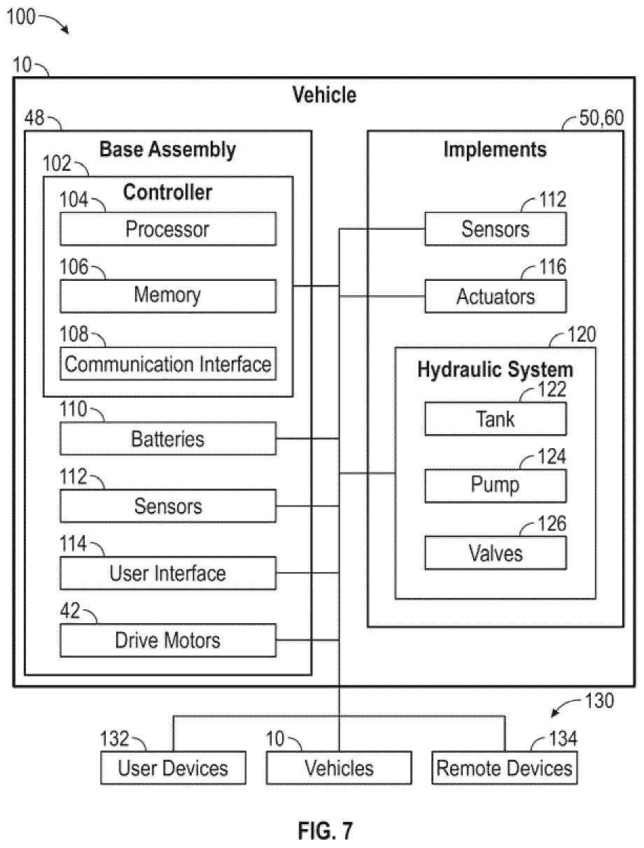

Referring to FIG. 7, the vehicle 10 and a control system 100 for the vehicle 10 are shown according to an exemplary embodiment. The control system 100 may facilitate operation of the vehicle 10 and/or other devices of a production environment. Although certain components are shown as being included in the base assembly 48 and/or the implements 50 and 60, it should be understood that any component may be positioned in the base assembly 48, the lifting implement 50, or the cart implement 60 or duplicated across multiple thereof.

The vehicle 10 includes a controller 102 that controls operation of the vehicle 10. The controller 102 includes a processing circuit, shown as processor 104, and a memory device, shown as memory 106. The memory 106 may contain one or more instruction that, when executed by the processor 104, cause the processor to perform the various functions described herein.

The controller 102 further includes a communication interface 108 (e.g., a communication circuit, a network interface, etc.) that facilitates communication with (e.g., to and from) other components of the vehicle 10 and/or the control system 100. The communication interface 108 may facilitate wired communication (e.g., through CAN, Ethernet, communication of power, etc.). Additionally or alternatively, the communication interface 108 may facilitate wireless communication (e.g., through Bluetooth, Wi-Fi, radio transmission, inductive transmission of energy, etc.).

The base assembly 48 includes one or more energy storage devices, shown as batteries 110. The batteries 110 store energy (e.g., as chemical energy). The batteries 110 may deliver electrical energy to other components of the vehicle 10 to power the vehicle 10. The batteries 110 may be charged by an outside source of energy (e.g., an electrical grid, a wireless charging interface, etc.). In other embodiments, the base assembly 48 includes a different type of energy storage device (e.g., a fuel tank for an internal combustion engine of a generator, a fuel cell, etc.).

The base assembly 48, the lifting implement 50, and the cart implement 60 may each include one or more sensors 112 operatively coupled to the controller 102. The sensors 112 may provide sensor data describing the current status of the vehicle 10 and/or the surrounding environment. By way of example, the sensors 112 may include mapping or imaging sensors (e.g., LIDAR sensors, light curtains, cameras, ultrasonic sensors, etc.). By way of example, the sensors 112 may include position sensors (e.g., GPS, potentiometers, encoders, etc.). By way of example, the sensors 112 may include orientation or acceleration sensors (e.g., accelerometers, gyroscopic sensors, inertial measurement units, compasses, etc.). By way of example, the sensors 112 may include pressure sensors, flowmeters, buttons, or other types of sensors.

The base assembly 48 may include one or more operator interface elements (e.g., input devices, output devices, etc.), shown as user interface 114. The user interface 114 may include output devices that provide information to one or more users. By way of example, the user interface 114 may include displays, speakers, lights, haptic feedback (e.g., vibrators, etc.), or other output devices. The user interface 114 may include input devices that receive information (e.g., commands) from one or more users. By way of example, the user interface 114 may include buttons, switches, knobs, touchscreens, microphones, or other input devices.

The lifting implement 50 and/or the cart implement 60 may include one or more actuators 116 that facilitate controlled movement (e.g., movement of the lifting implement 50 or the cart implement 60). The actuators 116 may include linear actuators (e.g., electric linear actuators, hydraulic cylinders, etc.), motors (e.g., electric motors, hydraulic motors, etc.), or other types of actuators. The actuators 116 may be electrically-powered, hydraulically-powered, or otherwise powered.

The lifting implement 50 and/or the cart implement 60 may include a hydraulic system 120. The hydraulic system 120 may supply pressurized hydraulic fluid (e.g., hydraulic oil) to facilitate operation of other components of the vehicle 10. By way of example, the hydraulic system 120 may supply pressurized hydraulic fluid to an actuator 116. In some embodiments, the hydraulic system 120 forms a self-contained hydraulic loop with one or more actuators 116.

The hydraulic system 120 includes a low-pressure reservoir, shown as tank 122, that stores a volume of hydraulic fluid at a low pressure. A pump 124 receives electrical energy from the batteries 110, draws hydraulic fluid from the tank 122, and supplies a flow of pressurized hydraulic fluid. One or more valves 126 (e.g., solenoid valves, directional control valves, etc.) control the flow of the hydraulic fluid from the pump 124. By way of example, the valves 126 may control the flow rate, direction, and destination of hydraulic fluid flowing throughout the hydraulic system 120. The controller 102 may control operation of the actuators 116 by controlling the valves 126.

The control system 100 further includes additional devices in communication with the vehicle 10. The devices may communicate with the vehicle 10 directly or through a network 130 (e.g., a local area network, a wide area network, the Internet, etc.). The network 130 may utilize wireless and/or wired communication. In some embodiments, the network 130 is a mesh network formed between multiple devices of the control system 100 (e.g., permitting indirect communication between two devices through a third device).

The control system 100 may include multiple vehicles 10. A vehicle 10 may communicate with other vehicles 10 to share information and facilitate operation. By way of example, a vehicle 10 may provide commands to another vehicle 10 to coordinate transportation of a large item that is carried by both of the vehicles 10. By way of another example, a vehicle 10 may provide its location to another vehicle 10 to facilitate path generation and avoid collisions.

The control system 100 may include one or more user devices 132 (e.g., smartphones, tablets, laptops, desktop computers, etc.). The user devices 132 may facilitate a user monitoring and/or controlling operation of the vehicles 10. By way of example, the user devices 132 may indicate statuses of the vehicles 10 (e.g., positions, whether maintenance is needed, if any errors are occurring, what task a vehicle 10 is assigned, etc.). By way of example, the user devices 132 may permit a user to command a vehicle 10 to travel to a different place or to assign a vehicle 10 to a particular production line.

The control system 100 may include one or more remote devices 134 (e.g., servers). In some embodiments, a remote device 134 functions as a production manager that controls various operations throughout a manufacturing environment. The production manager may receive requests for production of certain equipment (e.g., fifteen telehandlers are requested for production by Apr. 12, 2025, etc.). The production manager may monitor the statuses of vehicles 10, personnel, equipment, and raw materials. By way of example, the vehicles 10 may provide sensor data from the sensors 112 to a remote device 134 for storage and/or analysis. Based on the available data, the production manager may generate assignments for vehicles 10, personnel, equipment, and raw materials to meet the production requests. The production manager may adapt to changes in availability (e.g., by reassigning a vehicle 10 to a different task or area in response to a failure of one of the vehicles 10). The assignments for a vehicle 10 may include a path along which the vehicle 10 should travel, a desired configuration of the vehicle 10 (e.g., the type of implement available to the vehicle 10), an amount of time that the vehicle 10 should wait at a given station, etc.

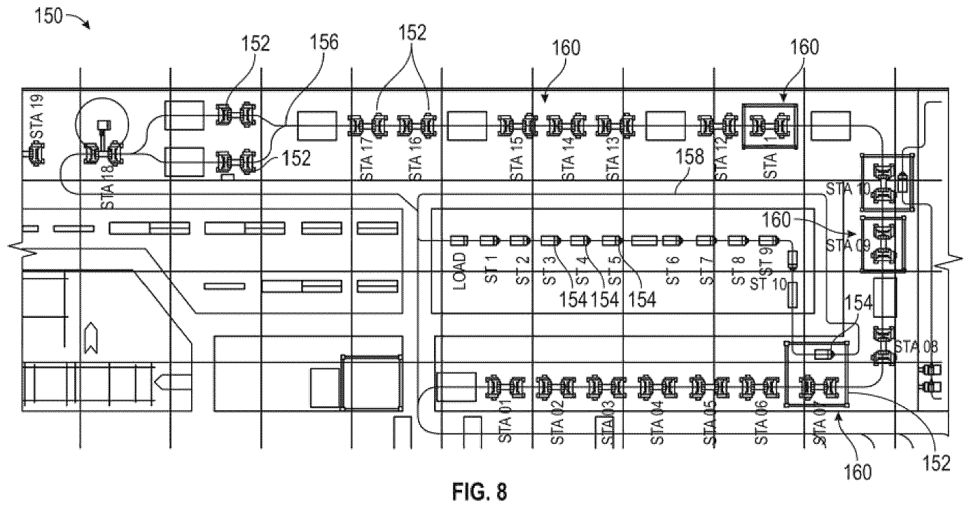

Referring to FIG. 8, a manufacturing environment or production system 150 is shown according to an exemplary embodiment. The production system 150 may include a series of vehicles 10 that move a product 152 and a subassembly 154 through various stages of assembly (e.g., as controlled by a remote device 134). The vehicles 10 move the product 152 along a first path, shown as manufacturing line 156, and the vehicles 10 move the subassembly 154 along a second path, shown as manufacturing line 158. A series of manufacturing or assembly stations, shown as stations 160, are spaced at regular intervals along the manufacturing lines 156 and 158. Each station 160 may be associated with a different manufacturing or assembly process that is performed there. By way of example, there may be stations 160 for attaching components to a product 152, coupling components with hoses or wires, confirming that certain functions are operating properly, etc.

Initially the product 152 and the subassembly 154 move along separate manufacturing lines 156 and 158. After the last station 160 needed to prepare the subassembly 154, the manufacturing line 158 intersects the manufacturing line 156, and the subassembly 154 is attached to the product 152. The product 152 and the subassembly 154 then move together along the manufacturing line 156. This proceeds until the product 152 is fully assembled and removed from the vehicles 10. The vehicles 10 may then return to collect another product that requires assembly, and the manufacturing process is repeated.

In some embodiments, the product 152 assembled by the production system is a vehicle or work machine. By way of example, the product 152 may be a lift device, such as a telehandler, a scissor lift, a boom lift, a vertical lift, an aerial work platform, or another type of lift device. By way of another example, the product 152 may be a fire truck, an aircraft rescue and firefighting apparatus (ARFF) truck, a refuse vehicle, a concrete mixing truck, a tow truck, a broadcast van, a military vehicle, a robot, a truck, a van, a passenger vehicle, or another type of vehicle. In other embodiments, the product 152 is not a vehicle (e.g., is a stationary piece of equipment).

### Drive Arrangement

Referring generally to the figures, a vehicle may include a drive arrangement to maneuver the vehicle about a ground surface and maintain engagement of the vehicle with the ground surface. More specifically, the drive arrangement may include one or more subframes coupled to a frame of the vehicle. The one or more subframes each include a drive wheel driven by a motor and a caster wheel. The one or more subframes may pivot to maintain engagement of the drive wheel and the caster wheel with the ground surface. The drive arrangement may include one or more caster wheels, which also maintain contact with the ground surface, to distribute the weight of the vehicle and facilitate steering of the vehicle as the vehicle maneuvers the ground surface.

Referring generally to the figures, a vehicle that is utilized in a manufacturing line or process is shown. The vehicle includes a frame and a base assembly coupled to the frame. The base assembly is configured to couple various implements to the frame, and the implements facilitate positioning, supporting, and/or lifting of a component of a product (e.g., a telehandler or an axle assembly of a telehandler). In some embodiments, the implement includes a lift implement with a cradle that receives and supports the component of the product and a lift assembly coupled between the cradle and the base assembly. The lift assembly includes a plurality of lift arms that are pivotably coupled to one another (e.g., a scissor stack or a scissor assembly). A lift actuator is coupled between the base assembly and the lift arms and is configured to selectively raise the cradle relative to the base assembly. In some embodiments, the lift actuator is in the form of a multi-stage telescoping actuator that includes a base stage, an Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a vehicle may include a drive arrangement to maneuver the vehicle about a ground surface and maintain engagement of the vehicle with the ground surface. More specifically, the drive arrangement may include one or more subframes coupled to a frame of the vehicle. The one or more subframes each include a drive wheel driven by a motor and a caster wheel. The one or more subframes may pivot to maintain engagement of the drive wheel and the caster wheel with the ground surface. The drive arrangement may include one or more caster wheels, which also maintain contact with the ground surface, to distribute the weight of the vehicle and facilitate steering of the vehicle as the vehicle maneuvers the ground surface.

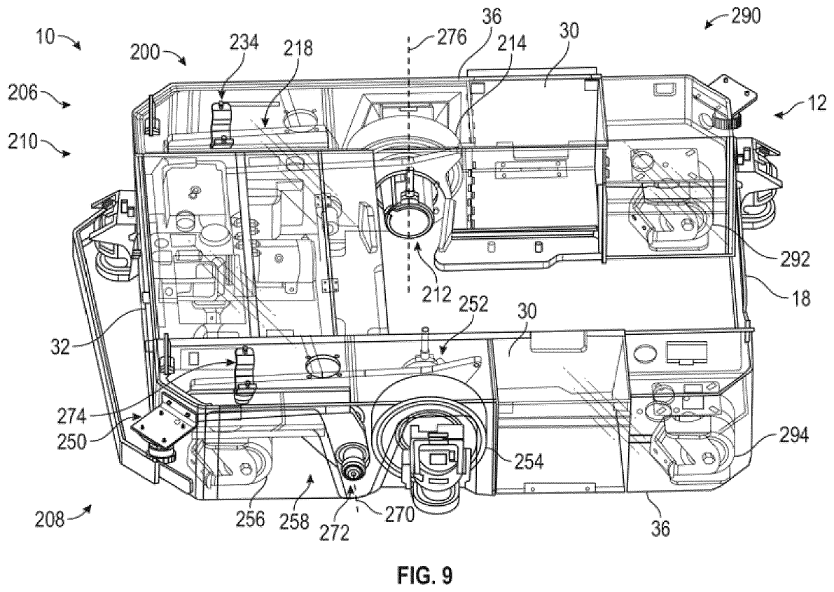

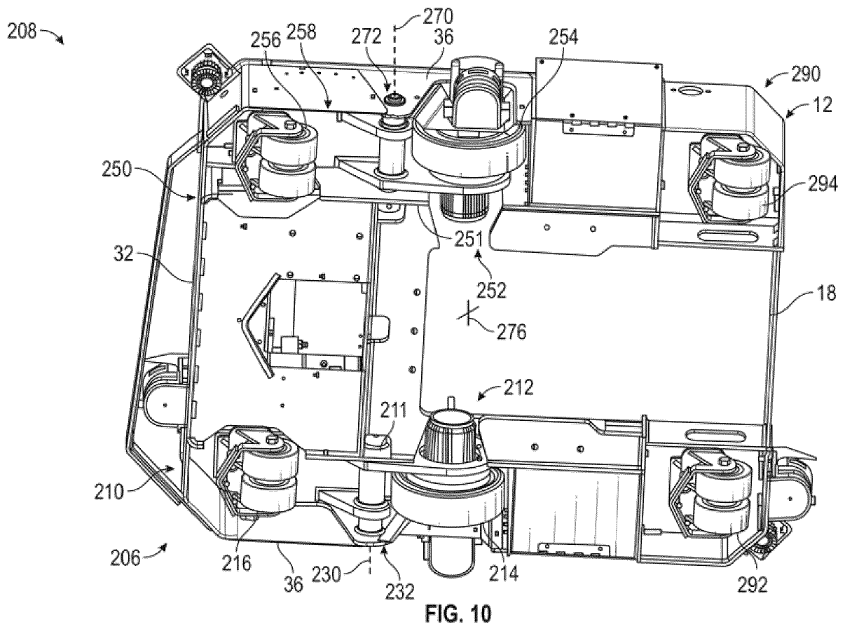

Referring to FIGS. 9 and 10, the drivetrain 40 of the vehicle 10 includes a drive assembly or arrangement 200 configured to maintain traction and engagement of the tractive elements 44 with a ground surface, propelling and steering the vehicle 10. The drive arrangement 200 includes a first drive assembly, shown as first drive module 210, a second drive assembly, shown as second drive module 250, and one or more independent, undriven, or caster wheels, shown as wheels 290, arranged toward the back plate 18 of the frame 12. The first drive module 210 and the second drive module 250 are positioned forward of the wheels 290. It should be noted that the first drive module 210 and the second drive module 210 are substantially similar (e.g., containing similar or identical components) with similar terms and using different reference numerals, unless otherwise described herein.

The first drive module 210 and one of the wheels 290 (e.g., a third caster wheel 292) are positioned along a first lateral or left side 206 of the vehicle 10 and located within the drive module 14 on the left side 206 of the vehicle 10. The first drive module 210 is coupled to the side surface 36 (e.g., on the right side of the vehicle 10) and a first interior wall 211 of the frame 12 (e.g., see FIG. 10). The third caster wheel 292 is configured to rotate, swivel, and/or pivot about a substantially vertical axis. The second drive module 250 and one of the wheels 290 (e.g., a fourth caster wheel 294) are positioned on a right or second lateral side 208 and located within the drive module 14 on the right side 208 of the vehicle 10. The second drive module 250 is coupled to the side surface 36 (e.g., on the left side of the vehicle 10) and a second interior wall 251 of the frame 12 (e.g., see FIG. 10). The fourth caster wheel 294 is configured to rotate, swivel, and/or pivot about a substantially vertical axis.

Referring to FIGS. 9-12, the first drive module 210 includes a first drive motor 212 (e.g., one of the drive motors 42) coupled to a first driven or drive wheel, shown as first drive wheel 214 (e.g., one of the one or more tractive elements 44), a first, undriven, or caster wheel 216, and a first subframe 218. The first drive wheel 214 and the first caster wheel 216 are coupled to the first subframe 218 on opposing ends of the first subframe 218. The first drive motor 212 is configured to drive the first drive wheel 214 to propel the vehicle 10. The first caster wheel 216 is configured to rotate, swivel, and/or pivot about a first substantially vertical axis as the first drive motor 212 drives the first drive wheel 214.

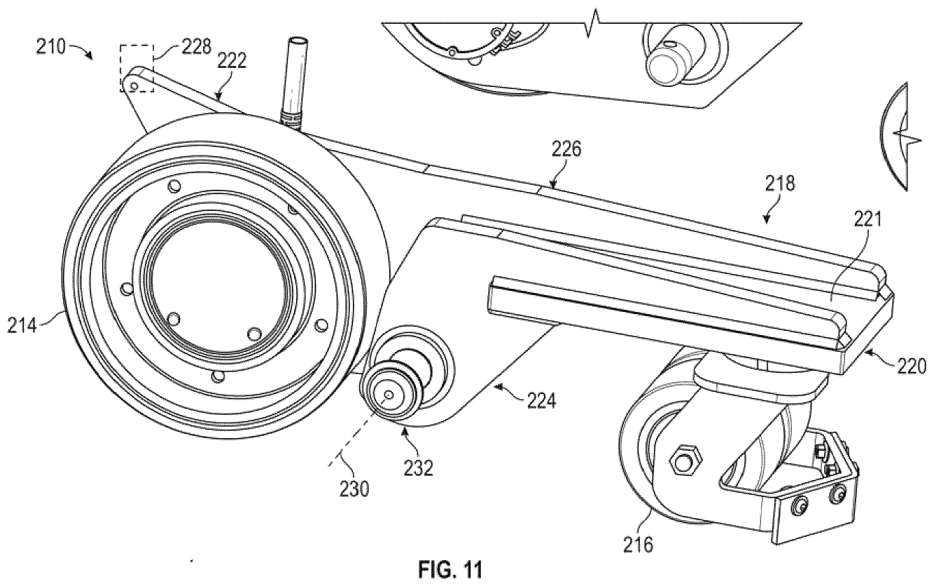

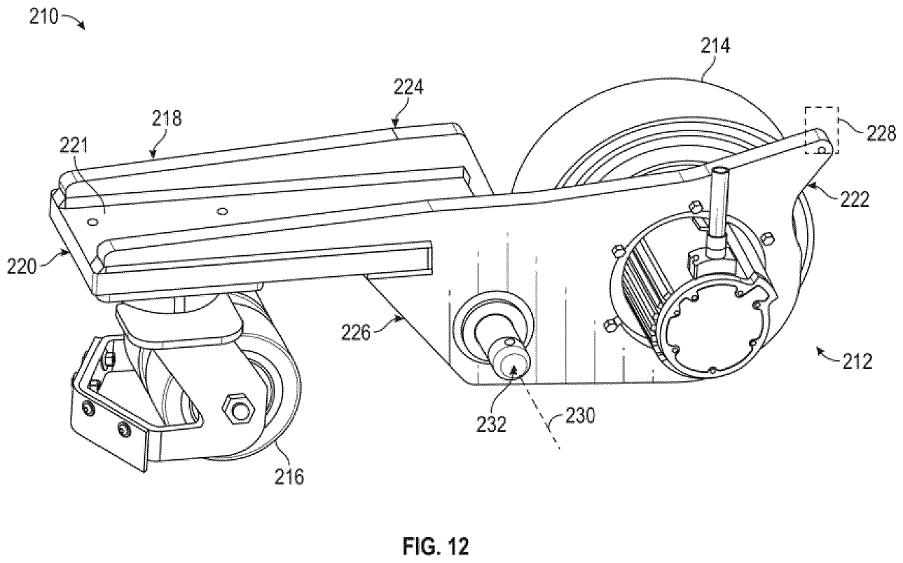

Referring to FIGS. 11 and 12, the first subframe 218 includes a first or front portion 220 disposed toward the front surface 32 of the frame 12, an opposing, second, or rear portion 222, an outer or first lateral portion 224 (e.g., a vertical plate) disposed toward the side surface 36, and an opposing, inner, or second lateral portion 226 (e.g. a vertical plate) from the front portion 220 to the rear portion 222. The front portion 220 includes a middle, extending, or horizontal portion (e.g., a horizontal plate), shown as central wall 221, extending between the outer portion 224 and a portion of the inner portion 226. The central wall 221, the first lateral portion 224, and the second lateral portion 226 may be fixedly coupled to one another (e.g., by welding). The first caster wheel 216 is coupled to the central wall 221 of the front portion 220 of the first subframe 218 by a bracket (e.g., caster wheel bracket or mount), and the first drive wheel 214 is coupled to the outer portion 224 towards the rear portion 222 of the first subframe 218. Specifically, the first drive motor 212 is fixedly coupled to the outer portion 224, and the drive motor 212 rotatably couples the first drive wheel 214 to the outer portion 224.

The first subframe 218 further includes a pivot assembly or link, shown as pivot pin 232 that extends through the outer portion 224 and the inner portion 226 (e.g., through apertures defined by bushings of the outer portion 224 and the inner portion 226) and is positioned between the front portion 220 and the rear portion 222 of the first subframe 218. The pivot pin 232 pivotably couples the first subframe 218 to the side surface 36 and the inner wall 211 of the frame 12. In some embodiments, the pivot pin 232 extends below the central wall 221 of the front portion 220. The pivot pin 232 defines a first lateral axis 230 that extends through the center of the pivot pin 232. The pivot pin 232 is configured to allow the first subframe 218 to pivot relative to the frame 12 about the first lateral axis 230.

In some embodiments, the first subframe 218 further includes a biasing element (e.g., a coil spring, a gas spring, a hydraulic actuator, etc.), shown as a first biasing element 228. The first biasing element 228 is coupled to the rear portion 222 of the first subframe 218 (e.g., see FIGS. 11 and 12). In some embodiments, the first biasing element 228 is configured to bias the first subframe 218 to rotate about the first lateral axis 230. By way of example, the first biasing element 228 may bias the first subframe 218 to direct the first drive wheel 214 downward towards a ground surface (e.g., in a direction away from the top surface 30 of the frame 12, counter-clockwise as shown in FIG. 11, etc.). In some embodiments, a top surface the first subframe 218 engages a bumper 234 coupled to the drive module 14 on the left side 206 of the vehicle 10 (e.g., see FIG. 9) to limit upward travel of the front portion 220. More specifically, the bumper 234 is coupled to the top surface 30 and is configured to engage the central wall 221 of the first subframe 218. By way of example, the bumper 234 defines a distance from the top surface 30 of the frame 12 to limit movement of the first subframe 218 within the distance defined by the bumper 234 as the first subframe 218 pivots relative to the frame 12 and the bumper 234 engages the central wall 221. For example, the bumper 234 may limit rotation of the first drive module 210 when the vehicle 10 is lifted off of the ground (e.g., for maintenance or transport).

Referring to FIGS. 9 and 10, the drive arrangement 200 includes the second drive module 250, which has a substantially similar configuration to the first drive module 210. The second drive module 250 includes a second drive motor 252 (e.g., one of the drive motors 42) coupled to a second driven or drive wheel, shown as second drive wheel 254 (e.g., one of the one or more tractive elements 44), a second, undriven, or caster wheel 256, and a second subframe 258. The second drive wheel 254 and the second caster wheel 256 are coupled to the second subframe 258 on opposing ends of the second subframe 258. The second drive motor 252 is configured to drive the second drive wheel 254 to propel the vehicle 10. The second caster wheel 256 is configured to rotate, swivel, and/or pivot about a second substantially vertical axis as the second drive motor 252 drives the second drive wheel 254.

Similar to the first subframe 218, the second subframe 258 includes a first or front portion disposed toward the front surface 32 of the frame 12, an opposing, second, or rear portion, an outer or first lateral portion disposed toward the side surface 36, and an opposing, inner, or second lateral portion from the front portion to the rear portion. The front portion includes a middle or extending portion, shown as central wall, extending between the outer portion and a portion of the inner portion. The second caster wheel 256 is coupled to the central wall of the front portion of the second subframe 258 by a bracket (e.g., caster wheel bracket or mount), and the second drive wheel 254 is coupled to the outer portion towards the rear portion of the second subframe 258.

The second subframe 258 further includes a pivot assembly or link, shown as pivot pin 272 that extends through the outer portion and the inner portion and is positioned between the front portion and the rear portion of the second subframe 258. The pivot pin 272 pivotably couples the second subframe 258 to the side surface 36 and the inner wall 251 of the frame 12. In some embodiments, the pivot pin 272 extends below the central wall of the front portion of the second subframe 258. The pivot pin 272 defines a second lateral axis 270 that extends through the center of the pivot pin 272. The pivot pin 272 is configured to allow the second subframe 258 to pivot relative to the frame 12 about the second lateral axis 270. In some embodiments, the second subframe 258 further includes a coil spring, a gas spring, a hydraulic actuator, or other biasing element substantially similar or identical to the first biasing element 228 of the first subframe 218. In some embodiments, the second subframe 258 will engage a bumper 274 coupled to the top surface 30 of the frame 12 that is substantially similar or identical to the bumper 234.

The first drive module 210 and the second drive module 250 are configured to operate or function independently from each other to maneuver and/or propel the vehicle 10 over a ground surface (e.g., the first subframe 218 and the second subframe 258 pivot different amounts or degrees, the first drive motor 212 and the second drive motor 252 operate at different speeds and/or directions, one or more of the first caster wheel 216, the second caster wheel 256, the third caster wheel 292, or the fourth caster wheel 294 move in different directions or speeds, etc.). Independent motion of the drive modules 210 and 250 may facilitate operation on inconsistent ground surfaces (e.g., ground surfaces that are not flat).

In some embodiments, the vehicle 10 may traverse the ground surface, which may be uneven, sloped, curved, or include thresholds, bumps, divots, cracks, etc. By way of example, the first drive motor 212 drives the first drive wheel 214, and the first subframe 218 pivots about the first lateral axis 230 to maintain engagement of the first drive wheel 214, the first caster wheel 216, and the third caster wheel 292 with the ground surface. Similarly, the second drive motor 252 drives the second drive wheel 254, and the second subframe 258 pivots the second lateral axis 270 to maintain engagement of the second drive wheel 254, the second caster wheel 256, and the fourth caster wheel 294 with the ground surface. In some embodiments, the first lateral axis 230 and the second lateral axis 270 align or coincide as the first subframe 218 and the second subframe 258 each independently pivot relative to the frame 12 to main engagement of the first drive wheel 214, the first caster wheel 216, the second caster wheel 256, the second drive wheel 254, the third caster wheel 292, or the fourth caster wheel 294 with the ground surface. In other embodiments, as on a sloped ground surface, the first lateral axis 230 and the second lateral axis 270 are unaligned as the first subframe 218 and the second subframe 258 each independently pivot relative to the frame 12 to main engagement of the first drive wheel 214, the first caster wheel 216, the second caster wheel 256, the second drive wheel 254, the third caster wheel 292, or the fourth caster wheel 294 with the ground surface.

In some embodiments, the first drive motor 212 and the second drive motor 252 operate independently from one another to facilitate skid steer operation of the vehicle 10. By way of example, the first drive motor 212 and the second drive motor 252 may drive the first drive wheel 214 and the second drive wheel 254, respectively, at the same speed to drive the vehicle 10 straight. By way of another example, the first drive motor 212 and the second drive motor 252 may drive the first drive wheel 214 and the second drive wheel 254, respectively, at different speeds and/or in different directions (e.g., one drive wheel rotates forward while the other drive rotates backwards) to turn the vehicle 10 about a central or substantially vertical axis 276. In some embodiments, the front surface 32, the rear surface 34, and the pair of side surfaces 36 of the frame 12 define an outer perimeter of the frame 12, within which the central vertical axis 276 extends. In such embodiments, the central vertical axis 276 may shift based on the relative speeds and directions of the first drive motor 212 and the second drive motor 252.

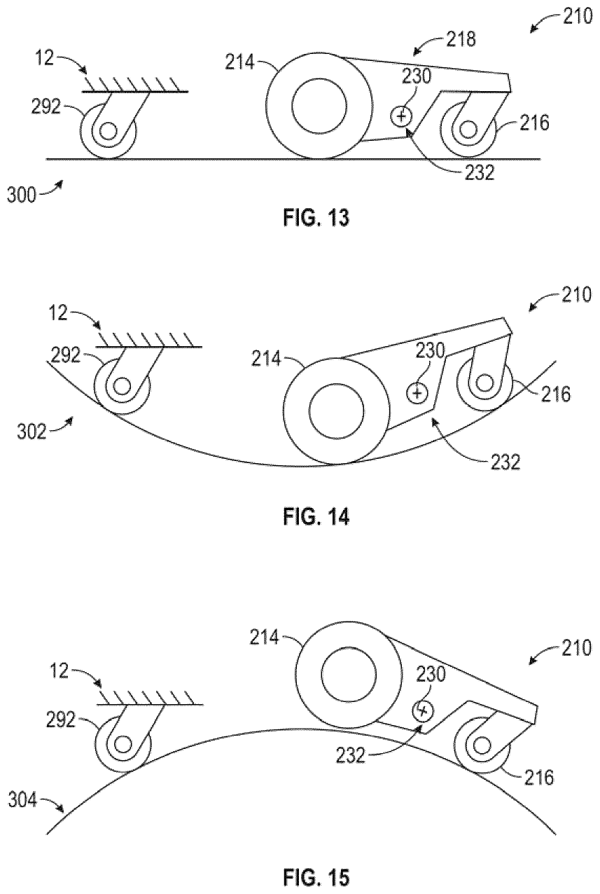

Referring to FIGS. 13-15, the drive arrangement 200 is shown navigating ground surfaces of varying shapes and curvatures, maintaining engagement of the wheels with the ground surface regardless of the shape of the ground surface. The ground surface may be a flat ground surface 300 (e.g., see FIG. 13), a curved or concave surface 302 (e.g., see FIG. 14), a curved or convex surface 304 (e.g., see FIG. 15), or a combination of one or more of the flat surface 300, the curved surface 302, or the curved surface 304. Although FIGS. 13-15 illustrate the first drive module 210 and the caster wheel 292, the second drive module 250 and the caster wheel 294 may perform similarly (e.g., based on the shape of the ground surface contacted by the drive module 250 and the caster wheel 294). As shown in FIGS. 13-15, the caster wheel 292 and the caster wheel 294 each have a fixed vertical distance from the frame 12 that remains substantially consistent as the vehicle 10 maneuvers the flat surface 300, the curved surface 302, and/or the curved surface 304.

Referring to FIG. 13, the drive arrangement 200 (e.g., the first drive module 210 and the third caster wheel 292) engage the flat surface 300. In the exemplary embodiment, the first drive wheel 214, the first caster wheel 216, and the third caster wheel 292 each engage the flat surface 300 at a corresponding contact point (e.g., the bottom portion of the wheels). The contact point of the first drive wheel 214, the contact point of the first caster wheel 216, and the contact point of the third caster wheel 292 are substantially aligned along a horizontal plane defined by the flat surface 300. The first drive module 210 has a first orientation about the first lateral axis 230 defined by the pivot pin 232 in FIG. 13.

Referring to FIG. 14, the drive arrangement 200 (e.g., the first drive module 210 and the third caster wheel 292) engage the curved surface 302. In the exemplary embodiment, the first drive wheel 214, the first caster wheel 216, and the third caster wheel 292 each engage the curved surface 302 at a corresponding contact point (e.g., the bottom portion of the wheels). The contact point of the first drive wheel 214, the contact point of the first caster wheel 216, and the contact point of the third caster wheel 292 are staggered or offset from one another as the respective contact points engage the curved surface 302. The first drive module 210 is positioned such that the first subframe 218 pivots upward (e.g., relative to the front of the vehicle 10) about the first lateral axis 230 defined by the pivot pin 232 in response to contacting the curved surface 302. By way of example, the caster wheel 216 may contact the curved surface 302 before the drive wheel 214. Due to the offset of the caster wheel 216 from the lateral axis 230, the normal force on the caster wheel 216 applies a torque onto the drive module 210 (e.g., counterclockwise as shown in FIG. 14), causing the drive module 210 to rotate until the drive wheel 214 contacts the curved surface 302. In this position, the contact point of the first drive wheel 214 is lower than the contact point of the first caster wheel 216 and the contact point of the third caster wheel 292. Accordingly, the pivot pin 232 permits the first subframe 218 to pivot and maintain engagement of the first drive wheel 214, the first caster wheel 216, and the third caster wheel 292 with the curved surface 302, improving traction of the first drive wheel 214 and spreading the weight of the vehicle 10 across all of the wheels.

Referring to FIG. 15, the drive arrangement 200 (e.g., the first drive module 210 and the third caster wheel 292) engage the curved surface 304 at the respective contact points (e.g., the bottom portion of the wheels). The contact point of the first drive wheel 214, the contact point of the first caster wheel 216, and the contact point of the third caster wheel 292 are staggered or offset from one another as the respective contact points engage the curved surface 304. The first drive module 210 is positioned such that the first subframe 218 pivots downward (e.g., relative to the front of the vehicle 10) about the first lateral axis 230 defined by the pivot pin 232 in response to contacting the curved surface 304. By way of example, the caster wheel 216 may contact the curved surface 304 before the drive wheel 214. Due to the offset of the caster wheel 216 from the lateral axis 230, the normal force on the caster wheel 216 applies a torque onto the drive module 210 (e.g., clockwise as shown in FIG. 15), causing the drive module 210 to rotate until the drive wheel 214 contacts the curved surface 304. In this position, the contact point of the first drive wheel 214 is higher than the contact point of the first caster wheel 216 and the contact point of the third caster wheel 292. Accordingly, the pivot pin 232 permits the first subframe 218 to pivot to maintain engagement of the first drive wheel 214, the first caster wheel 216, and the third caster wheel 292 with the curved surface 304, improving traction of the first drive wheel 214 and spreading the weight of the vehicle 10 across all of the wheels.

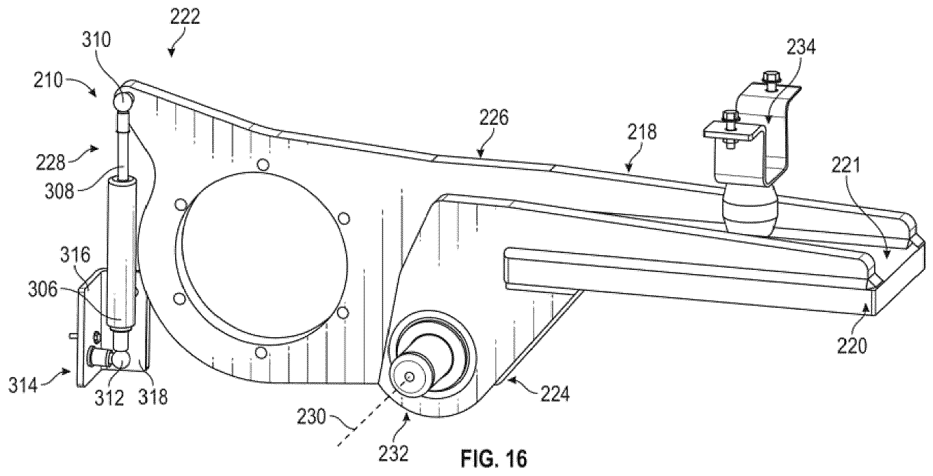

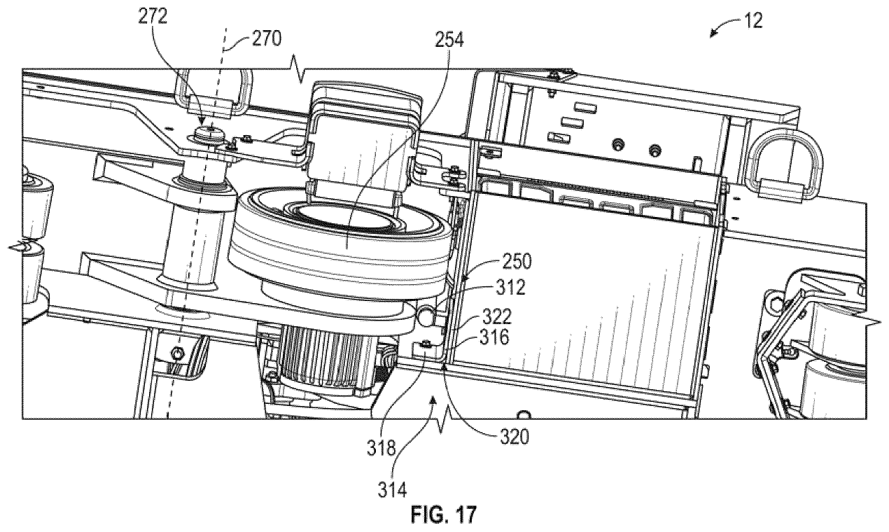

Referring to FIGS. 16 and 17, the first drive module 210 according to another embodiment. The first drive module 210 may be similar to the first drive module 210 of FIGS. 11 and 12 other than otherwise specified. The first biasing element 228 is a gas spring. The first biasing element 228 includes a body 306, a rod 308, a first swivel coupling 310, and a second swivel coupling 312. The rod 308 is received within the body 306, and configured to move in with respect to the body 306, in and out of an end of the body 306. The rod 308 includes compressed gas sealed inside of the rod 308. The first swivel coupling 310 is coupled to a first end of the body 306, and the second swivel coupling 312 is coupled to a second end of the body 306, the second end opposite the first end. Each of the first swivel coupling 310 and the second swivel coupling 312 enable the first biasing element 228 to rotate relative to the frame 12. In the illustrated embodiment, the first swivel coupling 310 and the second swivel coupling 312 are ball studs. The first swivel coupling 310 is coupled to the rear portion 222 of the first subframe 218, and enables the first biasing element 228 it rotate relative to the first subframe 218.

The first drive module 210 includes a bracket 314. The bracket 314 includes a first portion 316 and a second portion 318. The first portion 316 extends substantially perpendicular to the second portion 318. The first portion 316 and the second portion 318 are each configured to couple to a mounting location 320 on the frame 12 (as shown in FIG. 17). The mounting location 320 is located at the first interior wall 211 and a third interior wall 322 adjacent to the first interior wall 211. The second swivel coupling 312 is coupled to the first portion 316 of the bracket 314, and enables the first biasing element 228 to rotate relative to the frame 12.

### Lifting Implement

Referring generally to the figures, a vehicle that is utilized in a manufacturing line or process is shown. The vehicle includes a frame and a base assembly coupled to the frame. The base assembly is configured to couple various implements to the frame, and the implements facilitate positioning, supporting, and/or lifting of a component of a product (e.g., a telehandler or an axle assembly of a telehandler). In some embodiments, the implement includes a lift implement with a cradle that receives and supports the component of the product and a lift assembly coupled between the cradle and the base assembly. The lift assembly includes a plurality of lift arms that are pivotably coupled to one another (e.g., a scissor stack or a scissor assembly). A lift actuator is coupled between the base assembly and the lift arms and is configured to selectively raise the cradle relative to the base assembly. In some embodiments, the lift actuator is in the form of a multi-stage telescoping actuator that includes a base stage, an intermediate or middle stage, and an end or distal stage. The inclusion of a multi-stage actuator facilitates a compact arrangement of the lift assembly, for example, when fully retracted (e.g., greater extension range or stroke but smaller size when fully retracted). In some embodiments, the lift actuator is hydraulically controlled and operated by a lift valve that selectively supplies hydraulic fluid (e.g., oil) to the lift actuator to extend one or more stages of the lift actuator. In some embodiments, the stages of the lift actuator are retracted by gravity and the weight acting on the cradle.

In some embodiments, the lift assembly includes a support prop or prop wing arranged to both lateral sides of the scissor assembly that is configured to permit extension of the lift actuator but that acts in compression to resist retraction of the scissor assembly. In general, the prop wings acts to hold the cradle in one of various raised positions, for example, in the event of a power or pressure failure, to prevent the cradle from involuntarily retracting toward the base assembly. In some embodiments, the prop wings are pivotably coupled to the scissor assembly and each include a plurality of recesses or notches that are configured to engage a pin of the scissor assembly. The prop wings are biased, for example via gravity and/or a gas spring, in a direction that urges one of the notches into engagement with the pin of the scissor assembly. When one of the notches engages and receives the pin, the scissor assembly is prevented from retracting and held in its raised position. With the prop wings each including a plurality of notches, the prop wings are configured to operate and hold the cradle in a plurality of raised positions. In some embodiments, the prop wings are each coupled to a prop actuator that are configured to selectively pivot the prop wings out of engagement with the pin to enable the cradle to be lowered.

In some embodiments, the cradle is supported on and rotatably coupled to a top platform. For example, the cradle is rotatable about a vertical axis, which allows the cradle to rotate relative to the frame/base assembly and enables steering operation of the vehicle, for example, when the product is supported by and spans between two of the vehicles. In some embodiments, the cradle includes an arcuate slot within which a pin (e.g., a shoulder bolt) is received, and the ends of the arcuate slot limit the rotational movement of the cradle relative to the top platform and the frame/base assembly.

In some embodiments, the cradle includes a pair of laterally separated bracket assemblies that define a channel or slot within which the component (e.g., an axle assembly of a telehandler is received). The bracket assemblies each include a fixed bracket and a movable bracket. The movable bracket is configured to be selective moved relative to the fixed bracket to adjust (e.g., increase or decrease) a distance between the movable bracket and the fixed bracket, which allows the cradle to receive different sized components (e.g., an axle of a telehandler).

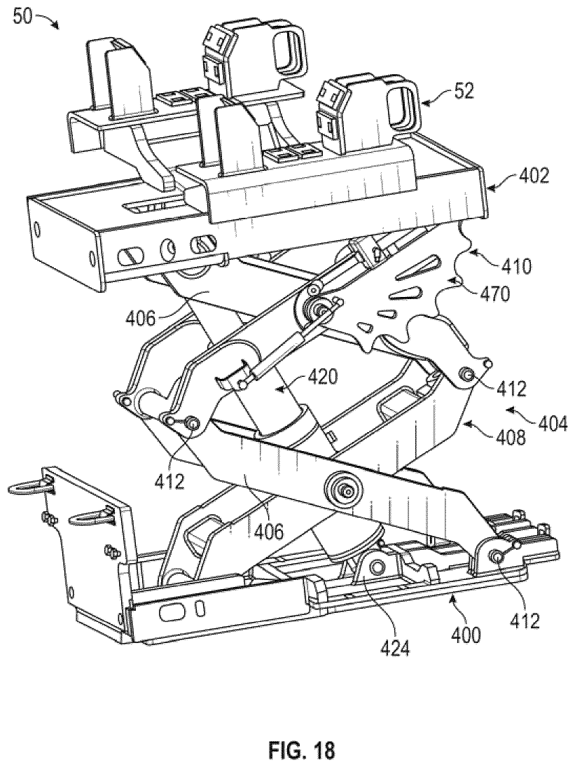

As described herein, the base assembly 48 of the vehicle 10 may be selectively coupled to an implement that facilitates supporting and/or moving of the component or product. In some embodiments, the base assembly 48 is coupled to the lifting implement 50 that both supports the product and selectively raises and lowers the product relative to the base assembly 48. FIGS. 18-26 illustrated the lifting implement 50 according to an exemplary embodiment. The lifting implement 50 includes the cradle 52, the lift assembly 54, a bottom plate or platform 400, and an upper plate or platform 402. The bottom platform 400 may be selectively coupled to or form part of the base assembly 48. In this way, for example, the bottom platform 400 may couple the lifting implement 50 to the frame 12 of the vehicle 10. The cradle 52 is rotatably coupled to and supported on the top platform 402.

In some embodiments, the lift assembly 54 includes a scissor assembly 404 formed by a plurality of lift arms 406 that are pivotably coupled to one another in a crisscross or X-shaped arrangement. The scissor assembly 404 is coupled between the bottom platform 400 (e.g., the base assembly 48) and the top platform 402. In some embodiments, each of the lift arms 406 is in the form of a lift plate. The lift arms 406 may include a lower section 408 and an upper section 410. The lower section 408 includes a plurality of the lift arms 406, with each of the lift arms 406 in the lower section 408 being pivotably coupled to the bottom platform 400 at one end and to a respective one of the lift arms 406 in the upper section 410 at an opposing end. The upper section 410 includes a plurality of the lift arm 406, with each of the lift arms 406 in the upper section 410 being pivotably coupled to a respective one of the lift arms 406 in the lower section 408 at one end and to the top platform 402 at an opposing end.

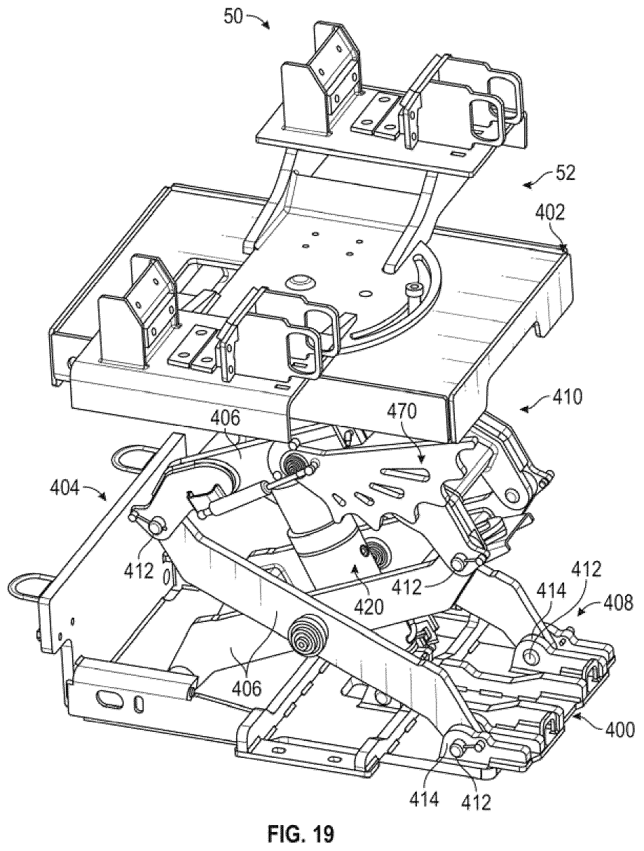

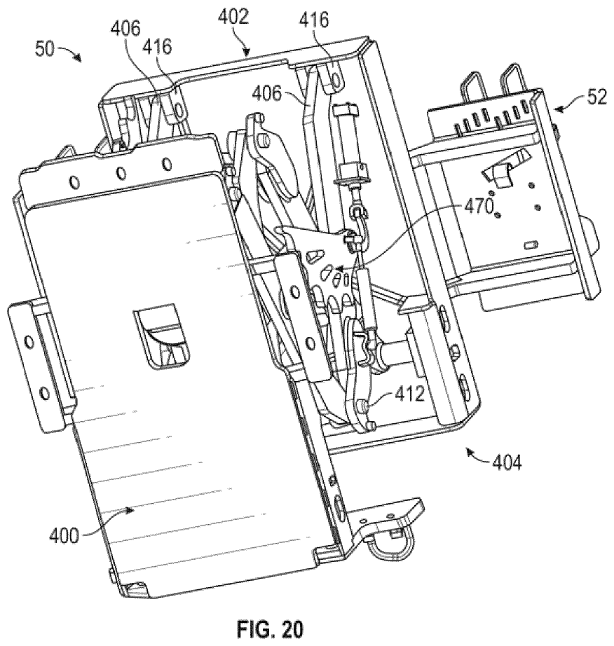

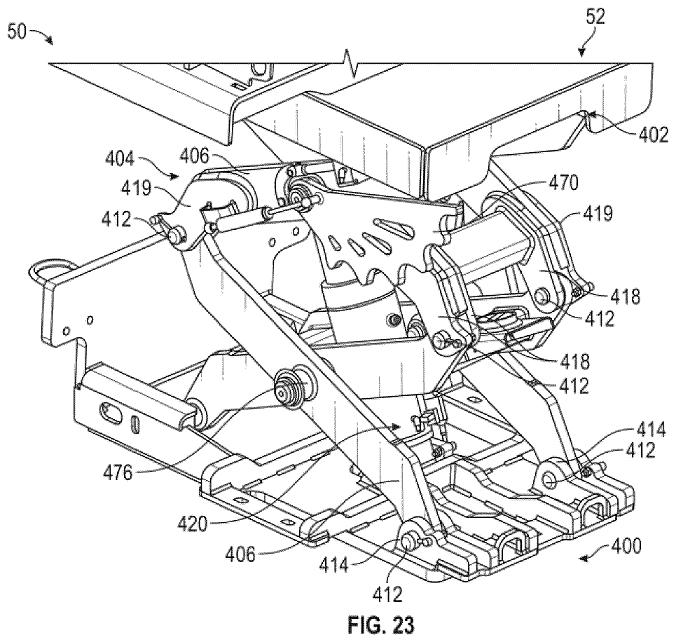

The ends of each of the lift arms 406 are pivotably coupled to the bottom platform 400, the top platform 402, or another end of one of the lift arms 406 by a pivot pin 412. For example, at least two of the lift arms 406 in the lower section 408 are pivotably coupled at one end to the bottom platform 400 by one of the pivot pins 412 that extends through a base bracket 414 (see, e.g., FIGS. 19 and 23). The base bracket 414 is rigidly coupled to the bottom platform 400 so that the ends of the lift arms 406 that are coupled to the bottom platform 400 are fixed (e.g., do not move relative to) to the bottom platform 400. At least two of the lift arms 406 in the upper section 410 are pivotably coupled at one end to the top platform 402 by one of the pivot pins 412 that extends through a top bracket 416 (see, e.g., FIG. 20). The top brackets 416 are rigidly coupled to a lower or bottom side of the top platform 402 so that the ends of the lift arms 406 that are coupled to the top platform 402 are fixed (e.g., do not move relative to) to the top platform 402.

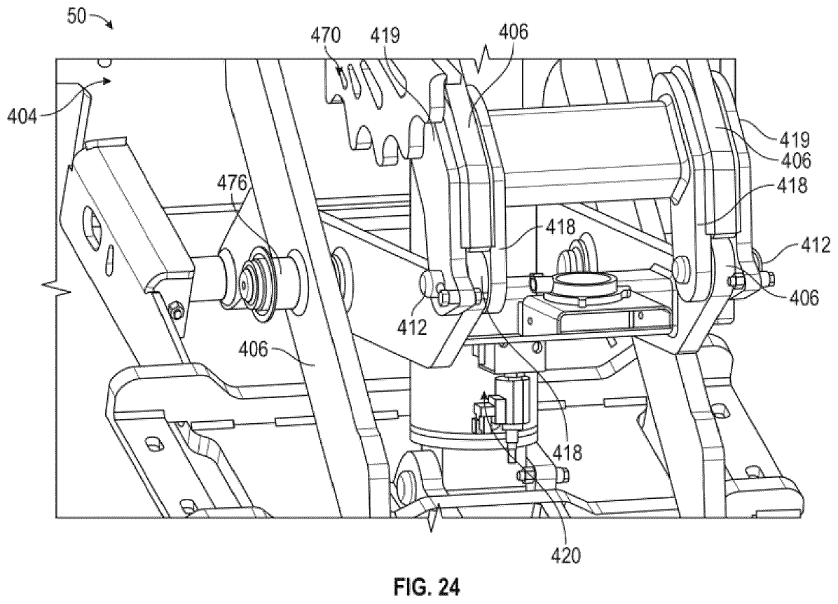

The ends of the lift arms 406 of the upper section 410 that are pivotably coupled to another end of one of the lift arms 406 in the lower section 408 (e.g., an end not coupled to the top platform 402) are rigidly coupled to a pair of intermediate brackets. For example, each lower end of the lift arms 406 in the upper section 410 is rigidly coupled to (e.g., welded) an inner intermediate bracket 418 and an outer intermediate bracket 419 (see, e.g., FIGS. 23-24). The ends of the lift arms 406 in the lower section 408 are received between the inner intermediate bracket 418 and the outer intermediate bracket 419, and one of the pivot pins 412 extends through the inner intermediate bracket 418, the outer intermediate bracket 419, and the end of the lift arm 406 in the lower section 408 to pivotably couple the ends of the lift arms 406 in the lower section 408 and the upper section 410. The pivot coupling formed between lower section 408 and the upper section 410 by the inner intermediate bracket 418 and the outer intermediate bracket 419 allows the lift arms 406 in the lower section 408 and the upper section 410 to occupy a common plane. In addition, the pivotal coupling formed between the lift arms 406 in the lower section 408 and the upper section 410 at the intermediate brackets 418, 419 is movable so that the ends of the lift arms 406 and the intermediate brackets 418, 419 (and the pivot pins 412 extending therethrough) move relative to the bottom platform 400 as the scissor assembly 404 is raised and lowered.

In some embodiments, each of the pivot pins 412 may be in a double shear arrangement (e.g., bracket-lift arm-bracket). For example, each of the base brackets 414 receives an end of a respective one of the lift arms 406 in the lower section 408, so that the end of the lift arm 406 is arranged between two bracket lobes of the base bracket 414 (e.g., a bracket lobe is arranged on both lateral sides of the lift arm 406). The pivot pin 412 extends through each bracket lobe of the base bracket 414 and the lift arm 406 to form a double shear arrangement (see, e.g., FIG. 23). Each of the top brackets 416 receives an end of a respective one of the lift arms 406 in the upper section 410, so that the end of the lift arm 406 is arranged between two bracket lobes of the top bracket 416 (e.g., a bracket lobe is arranged on both lateral sides of the lift arm 406). The pivot pin 412 extends through each bracket lobe of the top bracket 416 and the lift arm 406 to form a double shear arrangement (see, e.g., FIG. 20). Each corresponding pair of the inner intermediate bracket 418 and the outer intermediate bracket 419 receives an end of one of the lift arms 406 of the lower section 408 therebetween (e.g., one of the inner intermediate bracket 418 and the outer intermediate bracket 419 is arranged on both lateral sides of the lift arm 406). The pivot pin 412 extends through the inner intermediate bracket 418, the outer intermediate bracket 419, and the end of the lift arm 406 in the lower section 408 to form a double shear arrangement (see, e.g., FIGS. 23-24).

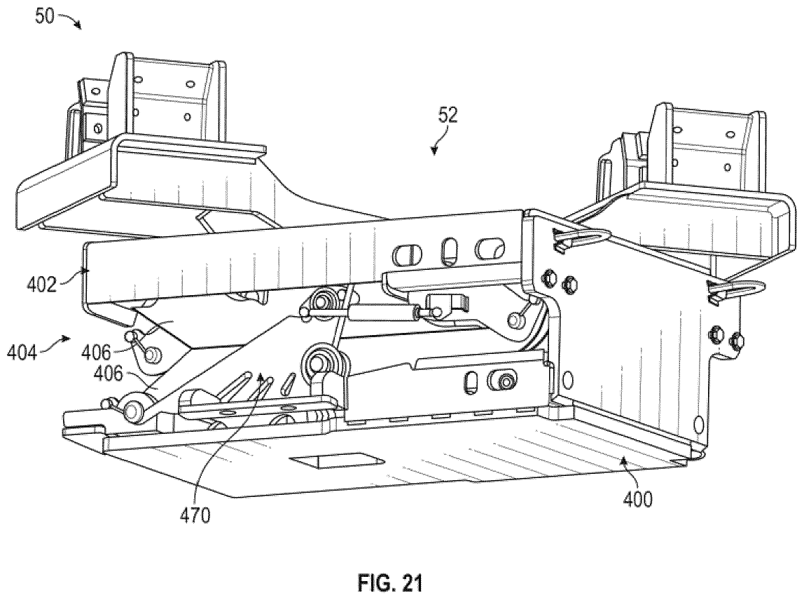

As described herein, the lifting implement 50 may includes one or more of the actuators 116 to facilitate controlled movement of various components of the lifting implement 50. In some embodiments, the lifting implement 50 includes a lift actuator 420 and one or more prop actuators 422. In general, the lift actuator 420 is configured to selectively raise the scissor assembly 404 and the top platform 402 (and the cradle 52 supported thereon). For example, the scissor assembly 404 (and the top platform 402 and the cradle 52) are movable between a raised position (see, e.g., FIG. 18-19) and a lowered or stowed position (see, e.g., FIG. 21). In the raised position, the top platform 402 and the cradle 52 are extended from the bottom platform 400 a greater distance than when the top platform 402 and the cradle 52 are in the lowered position.

The lift actuator 420 is coupled between the bottom platform 400 (and the base assembly 48 coupled thereto) and the scissor assembly 404. Specifically, one end (e.g., a base end) of the lift actuator 420 is rigidly coupled to the bottom platform 400 by an actuator bracket 424 so that the base end of the lift actuator 420 is fixed to the bottom platform 400, and an opposite end (e.g., outer or distal end) of the lift actuator 420 is coupled to a pair of the lift arms 406 in the upper section 410 (e.g., a pair of lift arms 406 that are also coupled to the top platform 402). In this way, for example, extension of the lift actuator 420 displaces the scissor assembly 404, and the top platform 402 and the cradle 52, toward the raised position where the top platform 402 and the cradle 52 move in a direction away from the bottom platform 400 and the base assembly 48. In some embodiments, the lift actuator 420 may be configured to extend toward an extended position, which corresponds with the raised position of the cradle 52, the top platform 402, and the scissor assembly 404, via one of the valves 126 selectively supplying hydraulic fluid from the pump 124 to the lift actuator 420. In some embodiments, the lift actuator 420 may be configured to retract, after being extended, toward a retracted position, which corresponds with the lowered position of the cradle 52, the top platform 402, and the scissor assembly 404, via gravity and/or a weight of the cradle 52 and the top platform 402. In some embodiments, the lift actuator 420 may be retracted via one of the valves 126 selectively removing hydraulic fluid from the lift actuator 420 and directing the hydraulic fluid to the tank 122.

In general, the selective extension/retraction of the lift actuator 420 and corresponding raising/lowering of the scissor assembly 404 results in the cradle 52 being selectively raised and lowered relative to the bottom platform 400, the base assembly 48, and the frame 12. It follows that the component (e.g., the axle of the telehandler 56), which is at least partially received within and supported by the cradle 52, may be selectively raised and lowered during the manufacturing line process by the lift assembly 54. In addition to the cradle 52 being selectively raised and lowered by the lift assembly 54, the cradle 52 is rotatably coupled to the top platform 402 to enable steering operation between two of the vehicles 10 during the manufacturing line process.

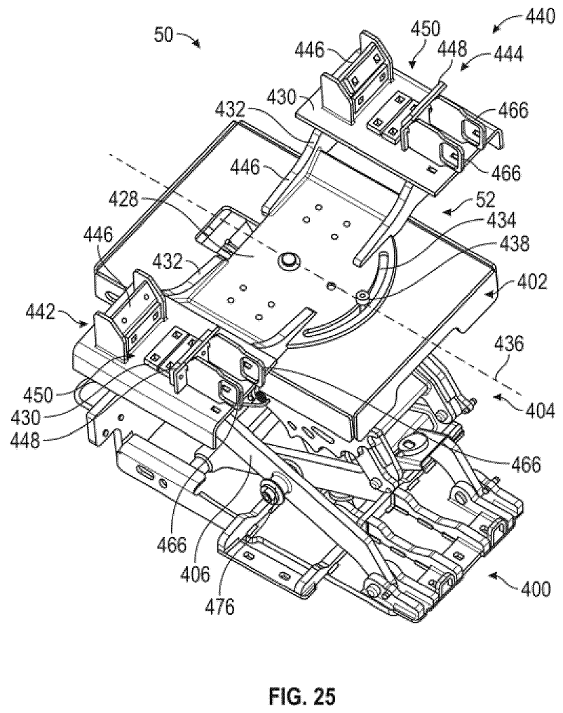

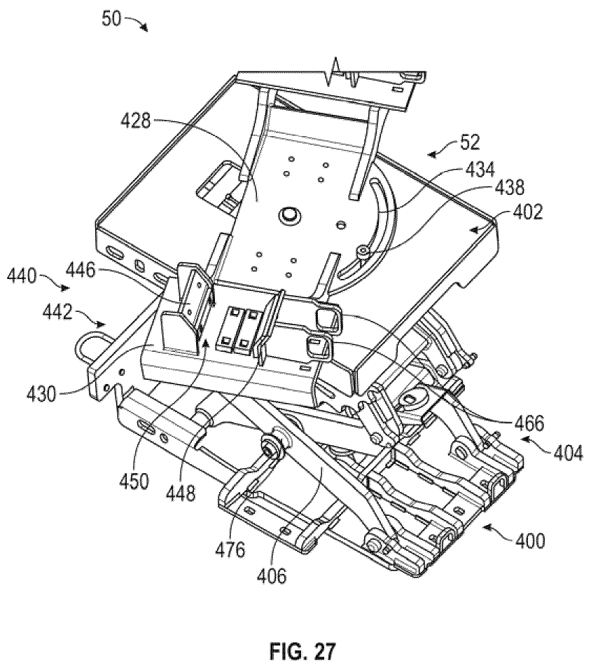

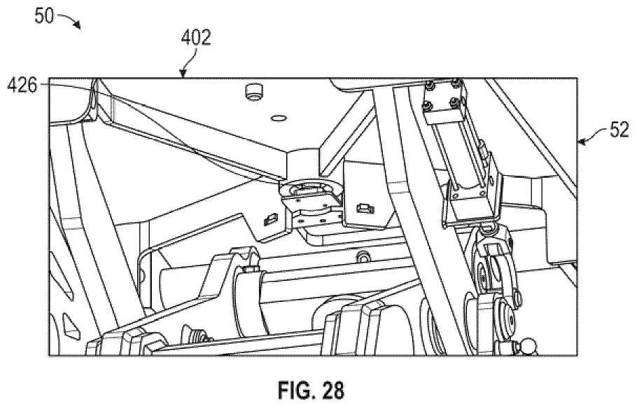

With specific reference to FIGS. 25-28, the cradle 52 is rotatably coupled to the top platform 402 by a cradle pin 426 that is coupled to and extends through the top platform 402 (see, e.g., FIG. 28). The cradle pin 426 extends though the top platform 402 and rotatably couples to the cradle 52, for example, via one or more bearings. In this way, for example, the cradle 52 is allowed to rotate relative to the top platform 402 (and relative to the base assembly 48 and the frame 12), which enables steering operations for the vehicle 10. In some embodiments, the sensors 112 include a rotation sensor (e.g., an encoder) that detects and measures a rotational position of the cradle 52 and communicates the rotational position of the cradle 52 to the controller 102. In some embodiments, the cradle 52 includes a cradle base 428 (e.g., a cradle base plate or base platform) and a pair of bracket plates 430, with one of the bracket plates 430 being coupled to each lateral end of the cradle base 428. The cradle base 428 is supported on a top surface of the top platform 402 and engages with the cradle pin 426. In some embodiments, each of the bracket plates 430 is rigidly coupled or fixed to the cradle base 428 by one or more cradle arms 432 that extend between the cradle base 428 and the respective one of the bracket plates 430.

In general, the cradle 52 includes a rotation slot or rotation limiting channel that defines a rotational range of the cradle 52 relative to the top platform 402 (and the base assembly 48 and the frame 12). In some embodiments, the cradle base 428 includes a rotation slot or arcuate slot 434 that extends through (e.g., vertically) the cradle base 428. The rotation slot 434 extends laterally across a front end of the cradle base 428. The rotation slot 434 extends past or away from both sides of a centerline 436 defined through cradle 52. In this way, for example, the cradle 52 is allowed to rotate in two directions relative to the top platform 402. Specifically, the cradle 52 is allowed to rotate in a first direction (e.g., clockwise) relative to the top platform 402, and in a second direction (e.g., counterclockwise) relative to the top platform 402. As such, the rotational coupling between the cradle 52 and the top platform 402 enables the vehicle 10 to steer in both directions (e.g., right and left).

A pin 438 is received within the rotation slot 434 and protrudes outwardly above the rotation slot 434 (e.g., above a top surface of the cradle base 428). In some embodiments, the pin 438 is in the form of a bolt, a shoulder bolt, or an equivalent structure that extends through the rotation slot 434. In general, the interface between the rotation slot 434 and the pin 438 defines a rotational range or rotational limit for the cradle 52 relative to the top platform 402. For example, the lateral ends of the rotation slot 434 act as end stops for the rotational range of the cradle 52, and as the cradle 52 rotates relative to the top platform 402, the rotation slot 434 moves relative to the pin 438 until the pin 438 engages one of the lateral ends of the rotation slot 434. Once the pin 438 engages one of the lateral ends of the rotation slot 434, the cradle 52 is prevented from rotating relative to the top platform 402 in one direction (e.g., clockwise or counterclockwise). By way of example, if the pin 438 engages a first end of the rotation slot 434 (e.g., a right end from the perspective of FIG. 25), the cradle 52 is prevented from further rotating relative to the top platform 402 in the first direction (e.g., clockwise). And if the pin 438 engages a second end of the rotation slot 434 (e.g., a left end from the perspective of FIG. 25), the cradle 52 is prevented from further rotating relative to the top platform 402 in the second direction (e.g., counterclockwise).

In general, the rotational coupling between the cradle 52 and the top platform 402 enables steering operation for the vehicle 10. As described herein, two of the vehicles 10 may support the telehandler 56 during the manufacturing line process, and the front vehicle may turn relative to the rear vehicle via the drive motors 42 or a steering motor. As the front vehicle turns relative to the rear vehicle, the cradle 52, which supports the telehandler 56, of the front vehicle may rotate relative to the top platform 402 of the front vehicle and allow the two vehicles to turn (e.g., the two vehicles are not restricted to travel in a straight line).

With reference to FIGS. 25-29, the cradle 52 includes a bracket assembly 440 that is configured to at least partially receive and support the axle of the telehandler 56. In some embodiments, the bracket assembly 440 includes a first bracket assembly 442 supported on one of the bracket plates 430 and a second bracket assembly 444 supported on another of the bracket plates 430. In general, the first bracket assembly 442 and the bracket plate 430 it interfaces with include similar components as the second bracket assembly 444 and the bracket plate 430 it interfaces with. It follows that the following description of the first bracket assembly 442 also applies to the second bracket assembly 444, with the same features identified using like reference numerals.

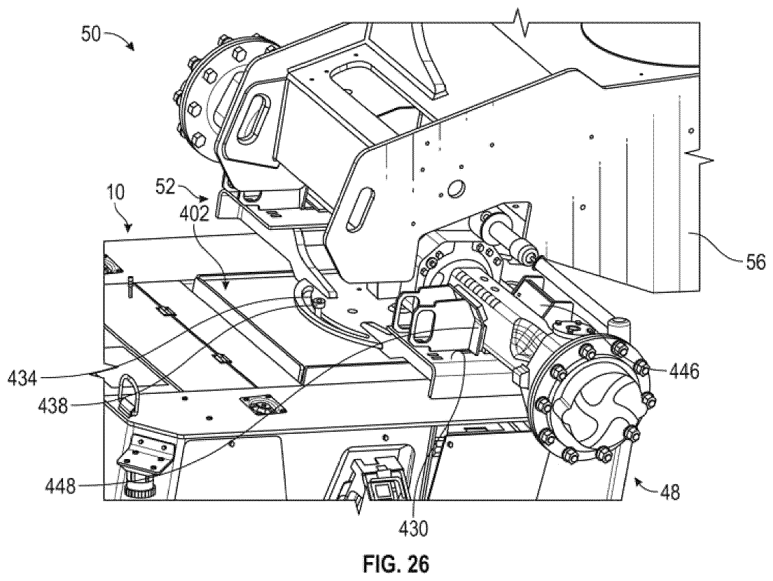

The first bracket assembly 442 includes a fixed bracket 446 and a movable bracket 448. In general, the fixed bracket 446 and the movable bracket 448 define a slot or channel 450 therebetween that is configured to at least partially receive the telehandler 56 (e.g., the axle of the telehandler 56), as shown in FIG. 26. In some embodiments, the channel 450 may define a U shape. In some embodiments, the channel 450 may define a different shape (e.g., V shaped).

The fixed bracket 446 is rigidly coupled to the bracket plate 430 so that the fixed bracket 446 does not move relative to the bracket plate 430. The movable bracket 448 may be selectively moved relative to the fixed bracket 446 (and the bracket plate 430) to adjust a size of the channel 450 defined between the fixed bracket 446 and the movable bracket 448. In some embodiments, the movable bracket 448 is selectively moved by lifting the movable bracket 448 relative to the bracket plate 430 and sliding the movable bracket 448 along an angled feature formed in the bracket plate 430. For example, the bracket plate 430 includes an angled slot 452 that extends through the bracket plate 430 and a plurality of locking slots 454, each of which extends through the bracket plate 430. The angled slot 452 is arranged at an acute angle relative to a first surface 456 of the bracket plate 430 (e.g., an angle greater than zero degrees and less than ninety degrees). In other words, a first end of the angled slot 452 is arranged closer to the first surface 456 than a second end of the angled slot 452, which defines a nonzero or acute angle between the angled slot 452 and the first surface 456. In some embodiments, an angle defined between a center line of the angled slot 452 and the first surface 456 may be between about fifteen degrees and about sixty degrees.

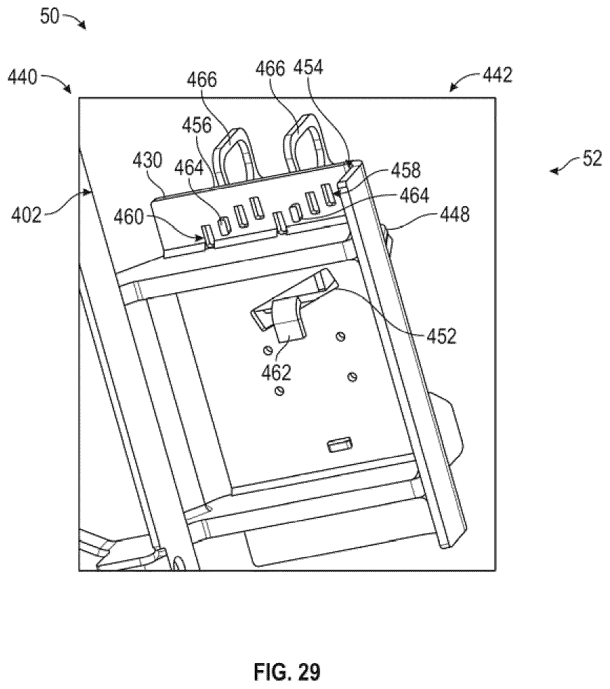

The plurality of locking slots 454 includes a first set of locking slots 458 and a second set of locking slots 460 that are laterally separated (e.g., separated in a direction generally perpendicular to the centerline 436) from the first set of locking slots 458. The first set of locking slots 458 are arranged and oriented in the same pattern as the second set of locking slots 460, except being laterally separated from the second set of locking slots 460. Each of the slots in the first set of locking slots 458 and the second set of locking slots 460 is laterally offset from an adjacent slot and arranged a different distance from the first surface 456 than an adjacent slot. For example, the locking slots on the left side (e.g., from the perspective of FIG. 29) of both the first set of locking slots 458 and the second set of locking slots 460 are arranged a furthest distance from the front surface and the slots to the right of the leftmost slot progressively move closer to the first surface 456.

The movable bracket 448 includes a clip 462, a pair of locking bars 464, and a pair of handles 466. The clip 462 extends through and is at least partially received within the angled slot 452, and the locking bars 464 are each received within a corresponding one of the locking slots in the first set of locking slots 458 and the second set of locking slots 460. To move the movable bracket 448 and adjust a size of the channel 450, a user may grasp the handles 466 of the movable bracket 448 and lift the movable bracket 448 relative to the bracket plate 430. As the handles 466 are lifted, the locking bars 464 are removed from the locking slots 458, which enables the movable bracket 448 to move relative to the fixed bracket 446. Once the locking bars 464 are removed from the locking slots 458, the movable bracket 448 is allowed to move laterally (e.g., left to right, or right to left from the perspective of FIG. 29). As the movable bracket 448 is moved laterally, the engagement between the clip 462 and the angled slot 452 moves the movable bracket 448 longitudinally (e.g., closer to or further from the fixed bracket 446). In other words, the geometry defined by the angled slot 452 allows the movable bracket 448 to move longitudinally as the movable bracket 448 is moved laterally. The movable bracket 448 may be moved both laterally and longitudinally until the locking bars 464 align with another pair of the locking slots 458. Once the locking bars 464 align with a new pair of the locking slots 458, the user may push down on the handles 466 to push the locking bars 464 into the locking slots 458, which locks the position of the movable bracket 448 relative to the fixed bracket 446 and adjusts a size of the channel 450. Accordingly, the movable bracket 448 may be selectively moved so that the locking bars 464 are inserted into a respective pair of the locking slots 458, which corresponds with a particular size of the channel 450. In this way, for example, the bracket assembly 440 is able to accommodate different size axles of the telehandler 56 during the manufacturing line process.

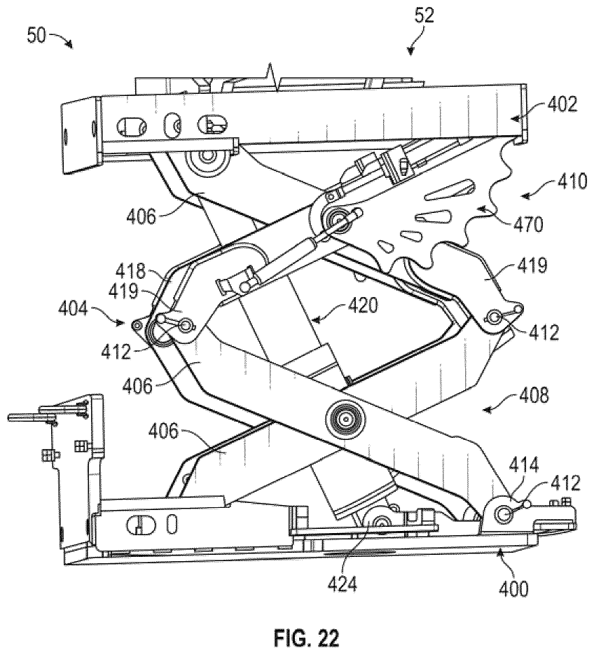

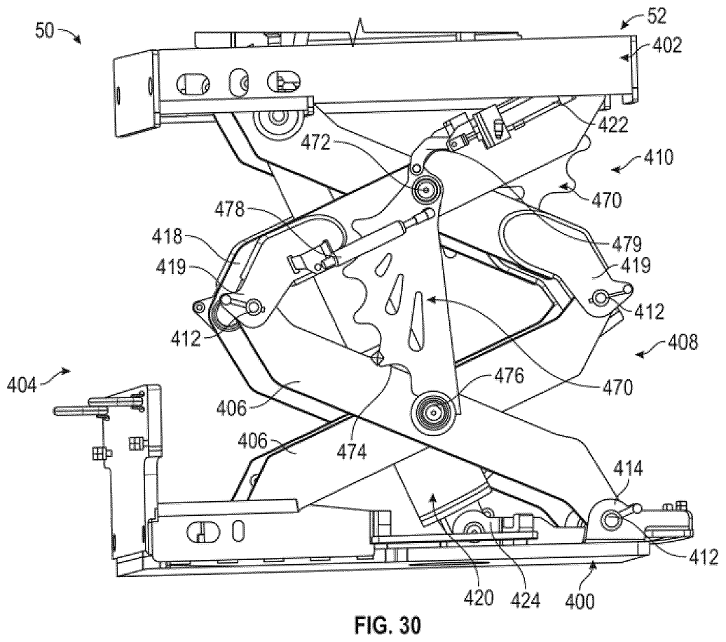

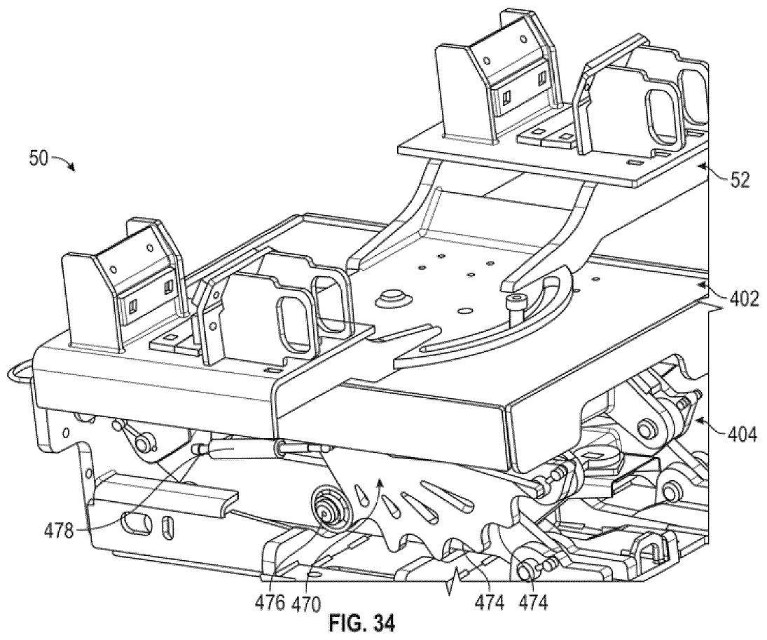

With reference to FIGS. 22, 23, and 30-34, the vehicle 10 includes a support prop or prop wing that is configured to selectively support the scissor assembly 404 in a plurality of raised positions and prevent the scissor assembly 404 (and the cradle 52 and the top platform 402 coupled thereto) from retracting or being lowered. Both lateral sides of the scissor assembly 404 include a support prop 470 pivotably coupled thereto. By placing one of the support props 470 on both lateral sides of the scissor assembly 404, the lateral sway of the scissor assembly 404 is reduced and stability is improved. In general, the design and operation of the support prop 470, and the components of the scissor assembly 404 that interface with the support prop 470, are the same on both lateral sides of the scissor assembly 404. Accordingly, the description herein of one of the support props 470 on one side of the scissor assembly 404 also applies equally to the support prop 470 on the other side of the scissor assembly 404, with similar components identified using the same reference numerals.

The support props 470 are each pivotably coupled to a side of the scissor assembly 404 by a pivot pin 472. In some embodiments, a centerline or center axis defined through the pivot pin 472 defines a pivot axis for the support prop 470. In some embodiments, the pivot pin 472 may be coupled to the scissor assembly 404 at a junction between two of the lift arms 406 in the upper section 410 (e.g., a center of the x-shaped crisscross between the two lift arms 406). The support props 470 include a plurality of notches or recesses 474 that are sequentially arranged along an outer edge or side of the support prop 470. In some embodiments, the notches 474 each define a generally rounded indent that extends inwardly into the outer edge of the support prop 470. In some embodiments, the notches 474 may define a different shape, for example, rectangular, triangular, or another polygonal shape.

In general, at least one of the notches 474 on both of the support props 470 are configured to engage a prop pin 476 that extends outwardly from a side of the scissor assembly 404. For example, one of the prop pins 476 extends outwardly from each side of the scissor assembly 404. The prop pins 476 are arranged generally below the pivot pins 472. For example, the prop pins 476 may be coupled to the scissor assembly 404 at a junction between two of the lift arms 406 in the lower section 408 (e.g., a center of the x-shaped crisscross between the two lift arms 406).

The support props 470 are both pivotably biased by a spring 478 coupled between the respective support prop 470 and the scissor assembly 404. For example, each of the springs 478 is coupled between an outer side of the support prop 470 and an outer side of the scissor assembly 404. Specifically, the springs 478 are coupled to one of the outer intermediate brackets 419 and the support prop 470. In some embodiments, the springs 478 may be in the form of a gas spring. In some embodiments, the springs 478 may both act in compression so that the springs 478 pivotably bias the support props 470 in a first direction (e.g., so that the notches 474 are rotationally biased toward the prop pins 476).

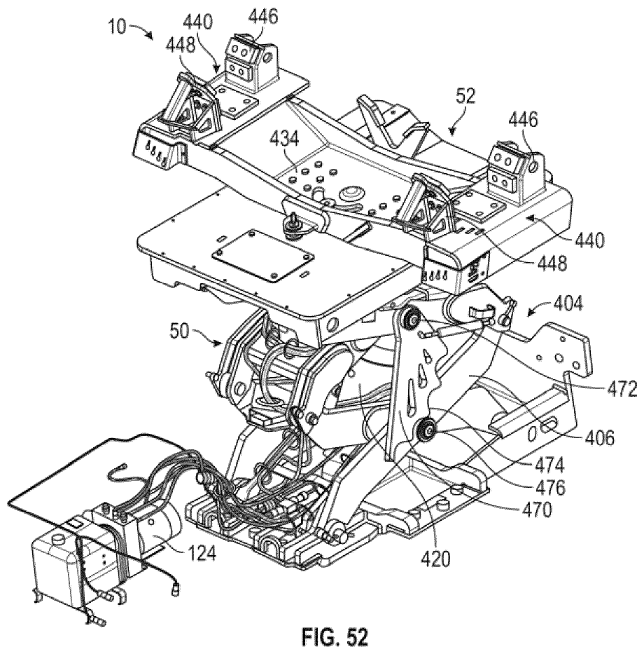

The support props 470 are both pivotably coupled to a respective one of the prop actuators 422. The prop actuators 422 are configured to selectively pivot the support props 470 in a second direction opposite to bias of the spring 478. For example, each of the prop actuators 422 are coupled to the support props 470 by a linkage 479 so that extension of the prop actuators 422 results in the linkage 479 pivoting the support props 470 away from the prop pins 476. In some embodiments, the prop actuators 422 are hydraulically operated and are configured to extend via one or more of the valves 126 selectively supplying hydraulic fluid from the pump 124 to the prop actuators 422 (see, e.g., FIG. 52). In some embodiments, one or more valves 126 that control fluid flow to and/or from the prop actuators 422 may connect the prop actuators 422 to the tank 122, unless the prop actuators 422 are commanded to pivot the support props 470 away from the prop pins 476, so that the springs 478 are allowed to pivotably bias the notches 474 toward and into engagement with the prop pins 476 as the scissor assembly 404 is raised.

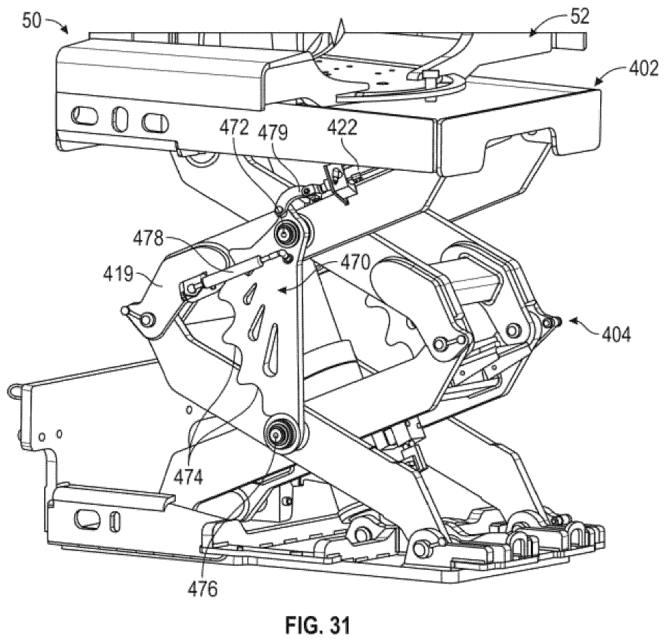

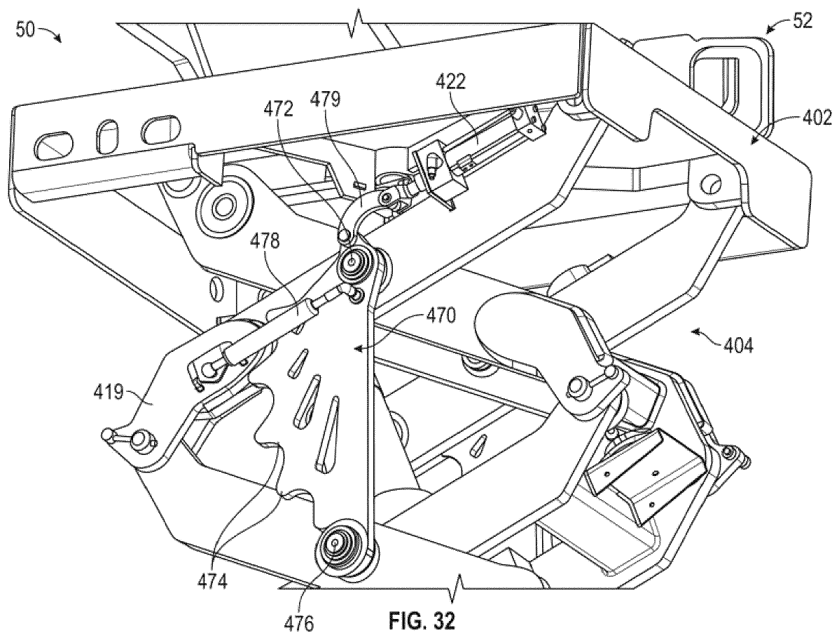

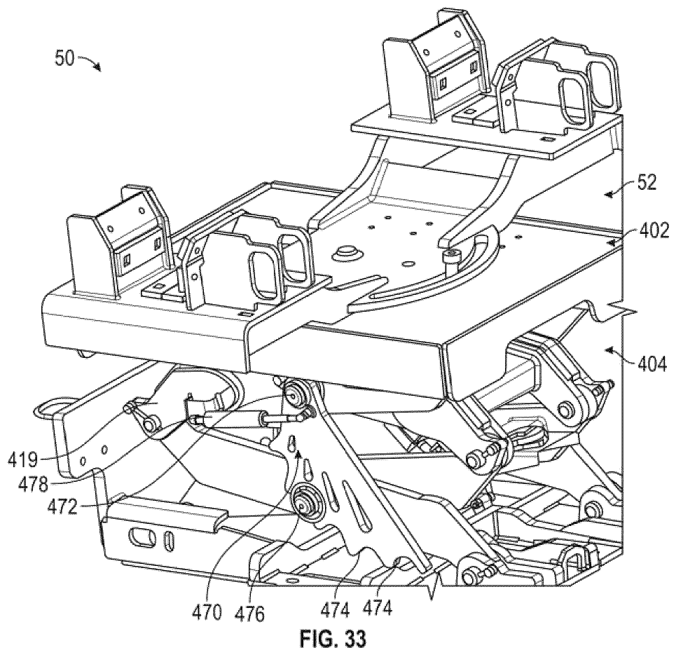

During operation, as the scissor assembly 404, the top platform 402, and the cradle 52 are raised by the lift actuator 420, the springs 478 pivotably bias the support props 470 in the first direction, which ensures that the notches 474 sequentially engage the prop pins 476 (e.g., like a rachet mechanism). In this way, for example, as the scissor assembly 404 is raised, the support props 470 always align and ensure engagement between at least one of the notches 474 with the prop pins 476 (e.g., at an intermediate position as shown in FIG. 33, at the raised position as shown in FIGS. 31 and 32, or any other position between the lowered position and the raised position). The engagement between the notches 474 on the support props 470 and the prop pins 476 (e.g., a locked position) prevents the scissor assembly 404, the top platform 402, and the cradle 52 from being lowered and prevents unintentional lowering of the scissor assembly 404, for example, in the event of a hydraulic or power failure.

To lower the scissor assembly 404, the top platform 402, and the cradle 52 from a position above the lowered position (e.g., any position between the lowered position and the raised position), the support props 470 are pivoted away from the prop pins 476 so that the scissor assembly 404 is allowed to freely retract toward the base assembly 48. For example, the prop actuators 422 are configured to selectively actuate or extend, which applies a pivotal force on the support props 470 via the linkages 479. The pivotal force applied by the prop actuators 422 counteracts (e.g., opposes) and overcomes the pivotal force of the springs 478, and the support props 470 pivot away from the prop pins 476 (e.g., in a direction toward the top platform 402 as shown in FIGS. 22, 23, and 34). With the support props 470 pivoted away from the prop pins 476 so that the notches 474 do not engage the prop pins 476 (e.g., an unlocked position), the scissor assembly 404, the top platform 402, and the cradle 52 are allowed to be lowered toward the base assembly 48 (e.g., via gravity and/or a weight of/supported on the top platform 402).

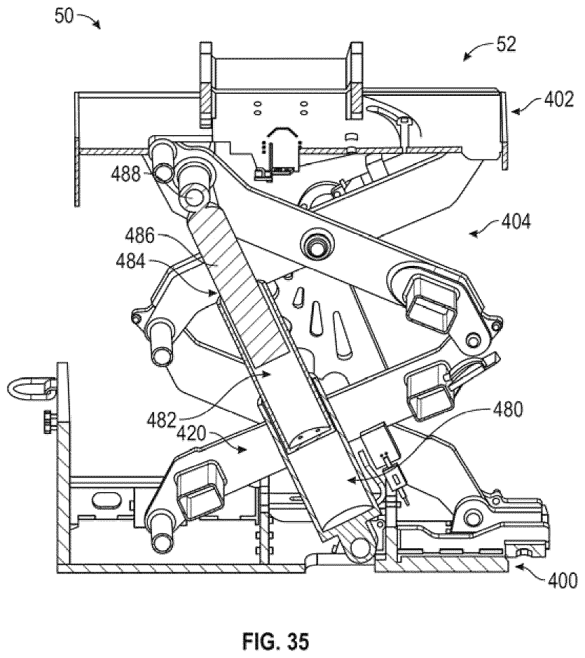

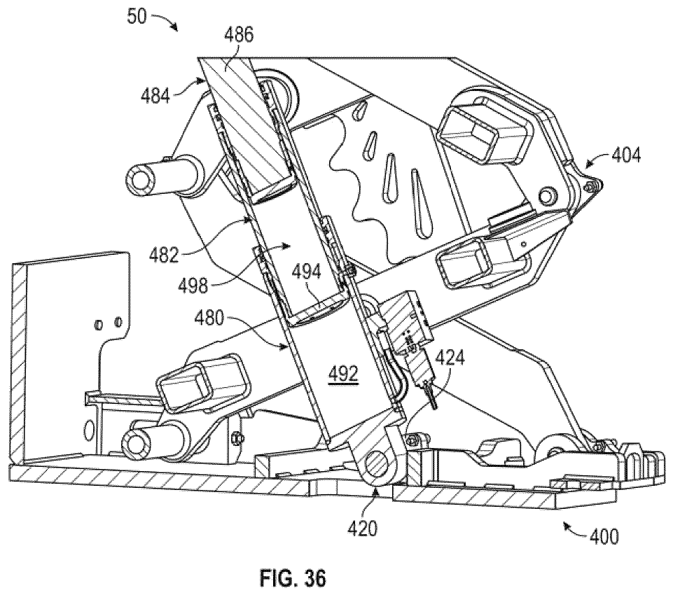

With reference to FIGS. 35-41, the lift actuator 420 is in the form of a multi-stage telescoping actuator that includes a base stage 480, an intermediate or middle stage 482, and an end or outer stage 484. The base stage 480 is pivotably coupled to the bottom platform 400 via a pin extending through the actuator bracket 424. The middle stage 482 is arranged axially between the base stage 480 and the outer stage 484. The outer stage 484 includes an actuator rod 486 that is slidably received within the middle stage 482. The middle stage 482 defines a cylinder that is slidable received within the base stage 480, which also defines a cylinder. A distal end of the outer stage 484 is pivotably coupled to a coupling rod 488, which is coupled to the scissor assembly 404 (e.g., extends between a pair of lift arms 406 in the upper section 410).

As described herein, the lift actuator 420 is configured to selectively raise the scissor assembly 404, the top platform 402, and the cradle 52. For example, one or more of the valves 126 may selectively supply pressurized hydraulic fluid from the pump 124 to a port 490 that extends through an outer wall of the base stage 480. The port 490 is in fluid communication with a base chamber 492 defined between the base stage 480 and the middle stage 482. As the pressurized hydraulic fluid enters the base chamber 492, the base chamber 492 expands and the middle stage 482 and the outer stage 484 (and the actuator rod 486) extend relative to the base stage 480.

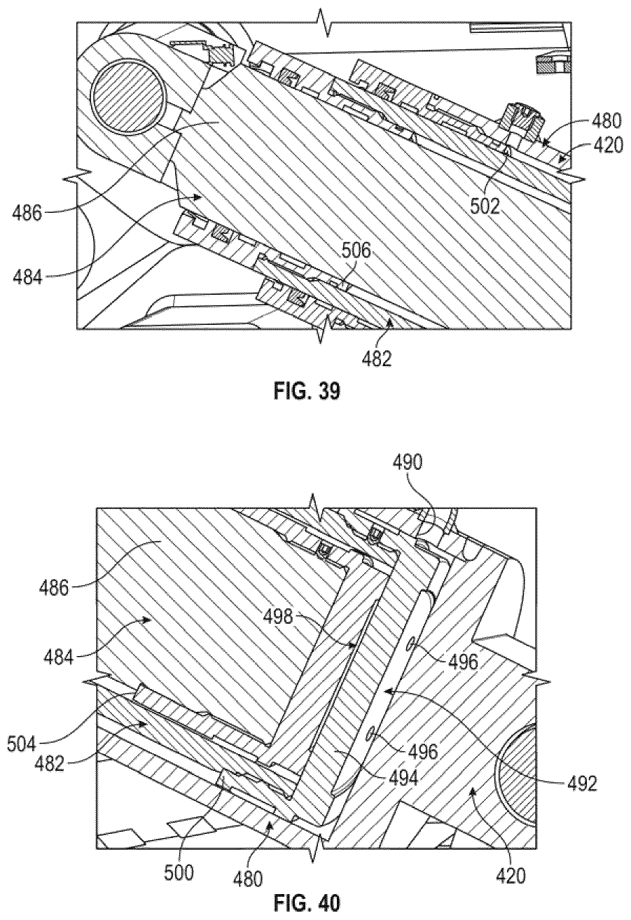

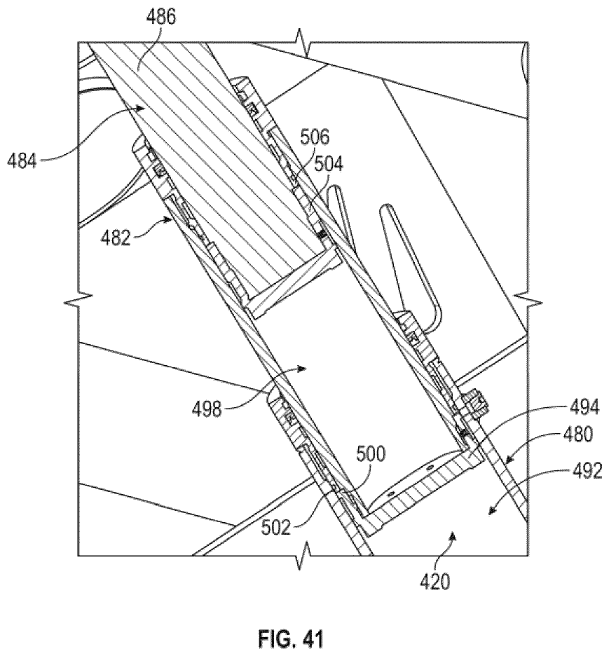

A bottom wall 494 of the middle stage 482 includes one or more holes 496 (see, e.g., FIG. 40) that provide fluid communication between the base chamber 492 and a middle chamber 498 defined between the middle stage 482 and the outer stage 484. The middle stage 482 is allowed to extend relative to the base stage 480 until a stop flange 500, formed in a base of the middle stage 482, engages a base collar 502 coupled to a distal end of the base stage 480 (e.g., an end opposite from the bottom platform 400). The base collar 502 is arranged radially between an inner wall of the base stage 480 and an outer wall of the middle stage 482 (see, e.g., FIG. 39). As the middle stage 482 extends relative to the base stage 480, the stop flange 500 comes closer and closer to the base collar 502, until the stop flange 500 eventually engages the base collar 502 and prevents the middle stage 482 and the actuator rod 486 from further extending relative to the base stage 480 (see, e.g., FIG. 41).

Once the middle stage 482 is no longer able to extend relative to the base stage 480, the holes 496 formed in the middle stage 482 provide the pressurized hydraulic fluid to the middle chamber 498, which then expands and extends the outer stage 484 and the actuator rod 486 relative to the middle stage 482 and the base stage 480. Similar to the middle stage 482, the actuator rod 486 is allowed to extend relative to the middle stage 482 until a stop flange 504, formed in a base of the actuator rod 486, engages a middle collar 506 coupled to a distal end of the middle stage 482 (e.g., an end furthest away from the base stage 480). The middle collar 506 is arranged radially between an inner wall of the middle stage 482 and an outer wall of the actuator rod 486 (see, e.g., FIG. 39). As the actuator rod 486 extends relative to the middle stage 482, the stop flange 504 comes closer and closer to the middle collar 506, until the stop flange 504 eventually engages the middle collar 506 and prevents the actuator rod 486 from further extending relative to the middle stage 482 (see, e.g., FIG. 41). In some embodiments, when both the stop flange 500 engages the base collar 502 and the stop flange 504 engages the middle collar 506, the lift actuator 420 is fully extended and the scissor assembly 404, the top platform 402, and the cradle 52 are in the fully raised position.

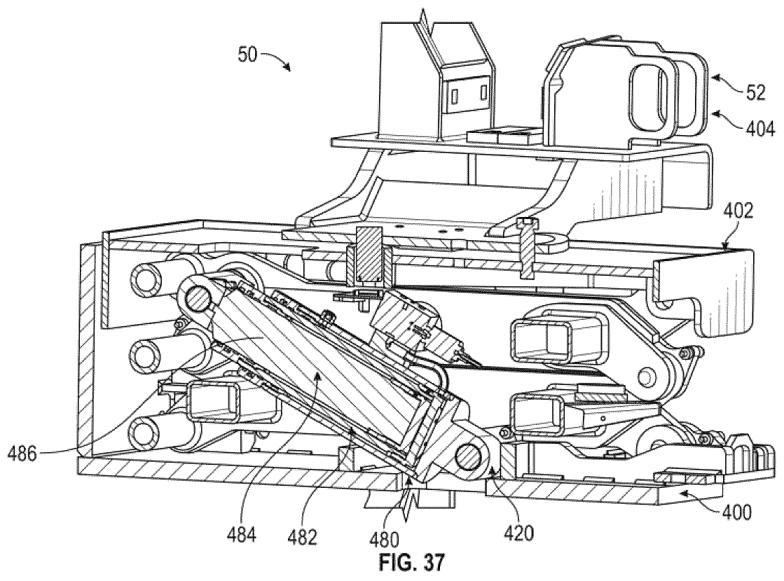

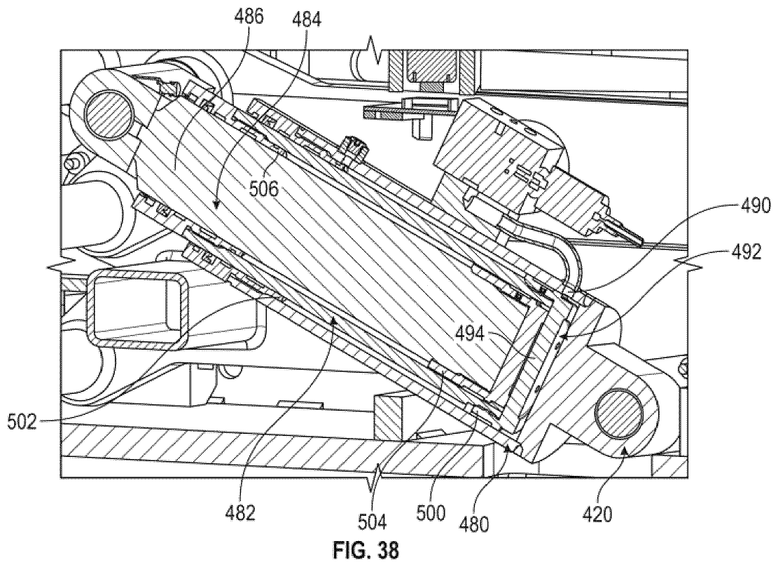

In some embodiments, the one or more valves 126 are configured to connect the port 490 to the tank 122 and allow the actuator rod 486 to telescopically retract into the middle stage 482 and the base stage 480 via gravity and/or the weight of the top platform 402 acting on the actuator rod 486. The use of a multi-stage actuator as the lift actuator 420 facilitates a compact arrangement, for example, when the lift actuator 420 is retracted (see, e.g., FIGS. 37 and 38), because the axial length of the lift actuator 420 is reduced by incorporating multiple stages, rather than using a single stage actuator that requires the entire stroke be accommodated by a single cylinder.

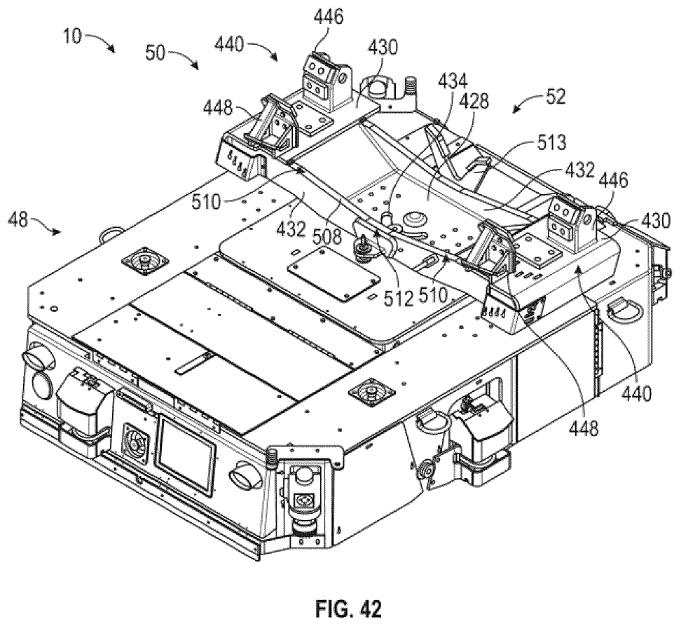

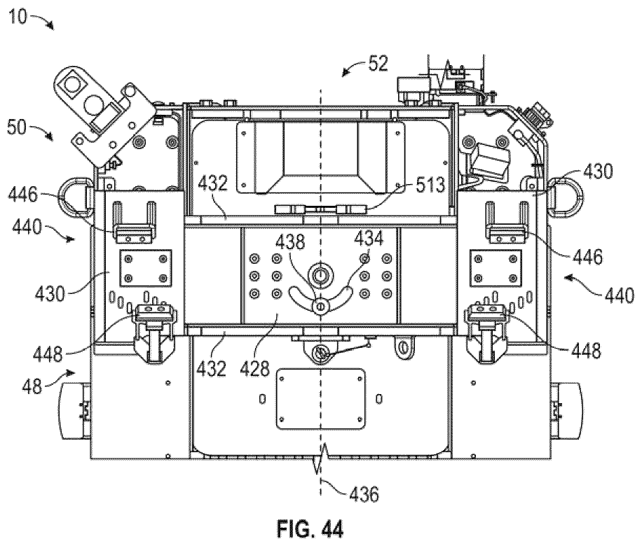

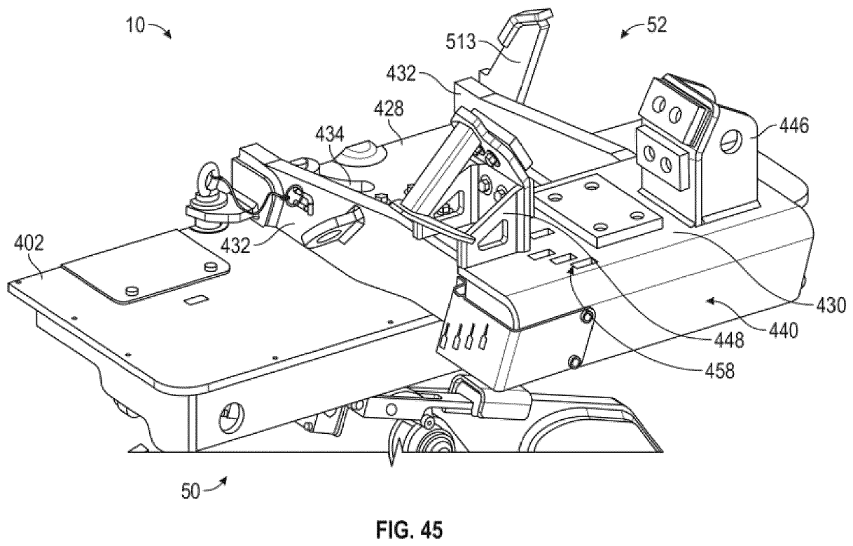

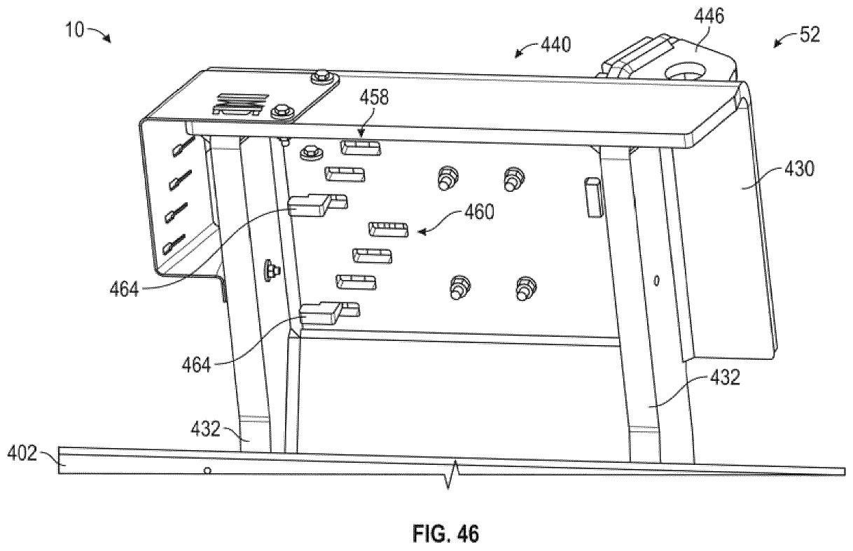

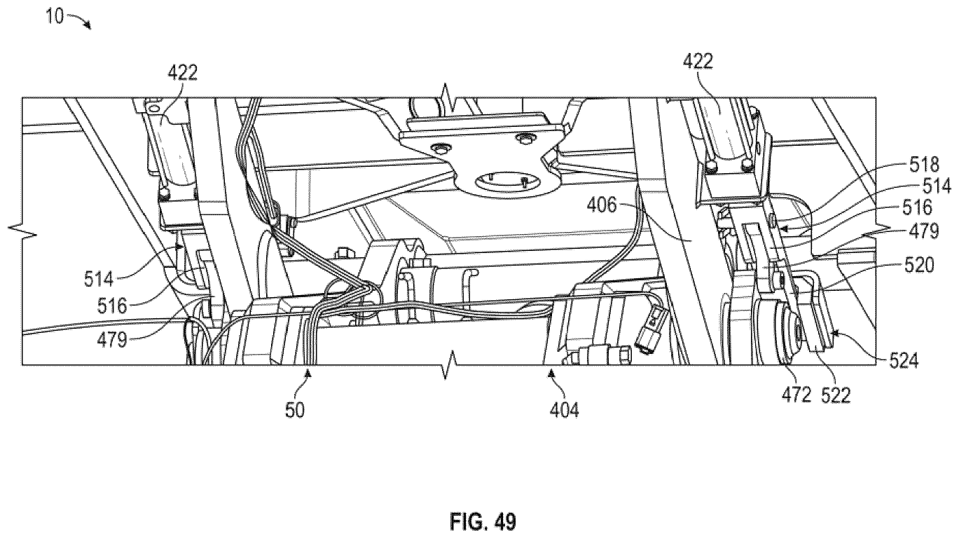

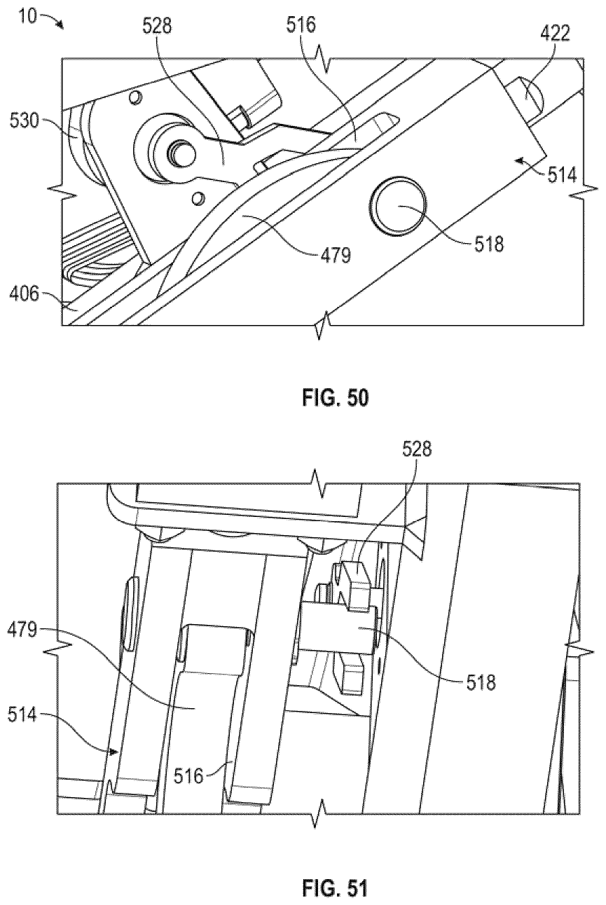

FIGS. 33-43 illustrate an exemplary embodiment of the vehicle 10 including the lifting implement 50. In general, the lifting implement 50 of FIGS. 42-52 is similar in design and functionality as the lifting implement 50 of FIGS. 18-41, with like features identified using the same reference numerals, except as described herein or as apparent from the figures. With specific reference to FIGS. 42-44, the cradle arms 432 extend laterally across and entirety of the cradle base 428. For example, each of the cradle arms 432 extends from one of the bracket plates 430, across the cradle base 428, and to the opposing one of the bracket plates 430. Additionally, each of the cradle arms 432 defines a generally V-shaped profile as it extends laterally between the bracket plates 430. Specifically, a top surface 508 of each of the cradle arms 432 defines a V-shaped profile, with two angled portions 510 (e.g., taper toward the cradle base 428) and a generally flat portion 512 (e.g., generally parallel to the cradle base 428) arranged between the two angled portions 510. The V-shaped profile defined by the cradle arms 432 aids in securing and supporting a center of the axle of the telehandler 56.

The cradle 52 includes an axle support bracket 513 coupled to an outer surface of one of the one or more cradle arms 432 (see, e.g., FIG. 42). In the illustrated embodiment, the axle support bracket 513 is coupled to a rearmost one of the cradle arms 432 and further aids in securing and supporting a center of the axle of the telehandler 56.

In the illustrated embodiment, the rotation slot 434 defines an arcuate shape, similar to FIGS. 18-41, but extends a lateral distance that is less than the rotation slot 434 shown in FIGS. 18-41. In other words, the rotation slot 434 of FIGS. 42-44 defines a greater radius than the rotation slot 434 of FIGS. 18-41, but still allows a similar rotational range for the cradle 52. In the illustrated embodiment, the support props 470 include four of the notches 474 (see, e.g., FIG. 52), while the support props 470 of FIGS. 18-41 include five notches 474. The number of the notches 474 on the support props 470 may be changed depending on the particular application and height range defined by the lifting implement 50.

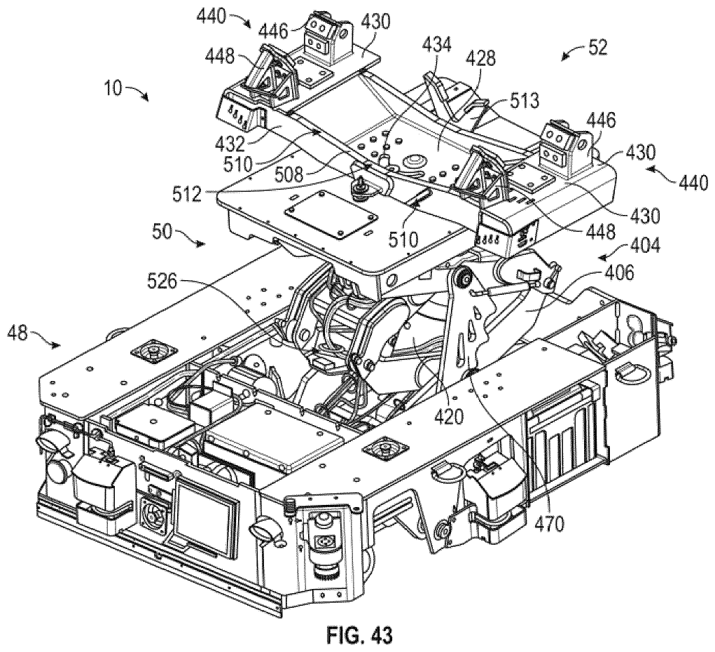

Turning to FIGS. 43-46, the bracket assembly 440 includes the fixed bracket 446 and the movable bracket 448 within each of the first bracket assembly 442 and the second bracket assembly 444. The functionality of the movable bracket 448 remains similar to that described herein, except the functionality of the clip 462 and the locking bars 464 is integrated into a single component. For example, the angled slot 452 and the clip 462 are removed from the bracket assembly 440 and the locking bars 464 are designed to be L-shaped, which enables the locking bars 464 to hook on an edge of the first set of locking slots 458 and the second set of locking slots 460 (e.g., similar to how the clip 462 hooks on the angled slot 452).

To adjust a spacing or gap between the fixed bracket 446 and the movable bracket 448, the movable bracket 448 is moved toward the fixed bracket 446, which moves the L-shaped locking bars 464 into a position where they can be removed through the first set of locking slots 458 and the second set of locking slots 460. The movable bracket 448 is then pulled up to remove the locking bars 464 from the current pair of the first set of locking slots 458 and the second set of locking slots 460 and moved (e.g., diagonally and closer to or further away from the fixed bracket 446) to align the locking bars 464 with another pair of the first set of locking slots 458 and the second set of locking slots 460, which are at a different longitudinal location along the bracket plate 430. The movable bracket 448 is then moved downwardly toward the bracket plate 430 so that the locking bars 464 are inserted into the pair of the first set of locking slots 458 and the second set of locking slots 460. With the locking bars 464 within the pair of the first set of locking slots 458 and the second set of locking slots 460, the movable bracket 448 is then moved in a direction away from the fixed bracket 446, which hooks the locking bars 464 on an edge of the pair of first set of locking slots 458 and the second set of locking slots 460, which aids in preventing the movable bracket 448 from being removed from the first set of locking slots 458 and the second set of locking slots 460 (e.g., without moving it toward the fixed bracket 446). Accordingly, the movable bracket 448 is selectively movable to any corresponding pair of the first set of locking slots 458 and the second set of locking slots 460 to adjust the distance between the fixed bracket 446 and the movable bracket 448.

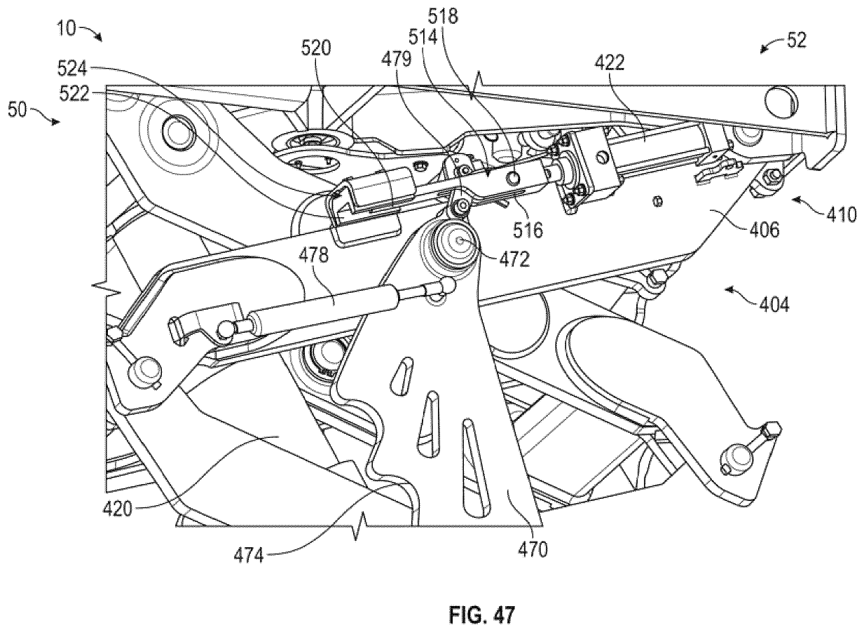

Turning to FIGS. 47-49, each of the prop actuators 422 is coupled to a support bracket 514 that provides lateral stability to the prop actuators 422 and the scissor assembly 404 (e.g., stability in a direction generally perpendicular to the centerline 436). The support brackets 514 each include a channel or slot 516 that receives at least a portion of the linkage 479 therein. A distal end of the linkage 479 is coupled to the support props 470, as in the exemplary embodiment of FIGS. 18-41, but the coupling between the prop actuator 422 and the linkage 479 is arranged within the support bracket 514. Specifically, a pin 518 extends through the support bracket 514, the linkage 479, and a rod of the prop actuator 422 to couple the prop actuator 422, the linkage 479, and the support bracket 514 to one another.

Each of the support brackets 514 includes a support bar 520 extending outwardly (e.g., in a direction away from the pin 518) from an end of the slot 516. Each of the support bars 520 is received within a support channel 522 that is formed in a support block 524. The support blocks 524 are coupled to a respective one of the lift arms 406 (e.g., the same one of the lift arms 406 in the upper section 410 that the prop actuator 422 is coupled to), and the support channel 522 slidably receives at least a portion of the support bar 520 therein. During operation, as the prop actuators 422 extend and retract to selectively pivot the support props 470, the support bracket 514, which are coupled to the prop actuators 422 via the pins 518, also extend and retract, and the support bars 520 slide or move within a respective one of the support channels 522. At least a portion of the support bar 520 remains in engagement with the support channel 522 over the entire stroke of the prop actuator 422, and the engagement between the support bar 520 and the support channel 522 provides lateral stability to the prop actuators 422 and the scissor assembly 404 during operation. In other words, with the support channel 522 and the support block 524 being rigidly coupled to one of the lift arms 406, the coupling between the support bracket 514, the prop actuators 422, and the linkage 479 acts to laterally hold or constrain the prop actuators 422, the linkage 479, and the scissor assembly 404 (e.g., inhibits or constrains lateral movement) during operation.

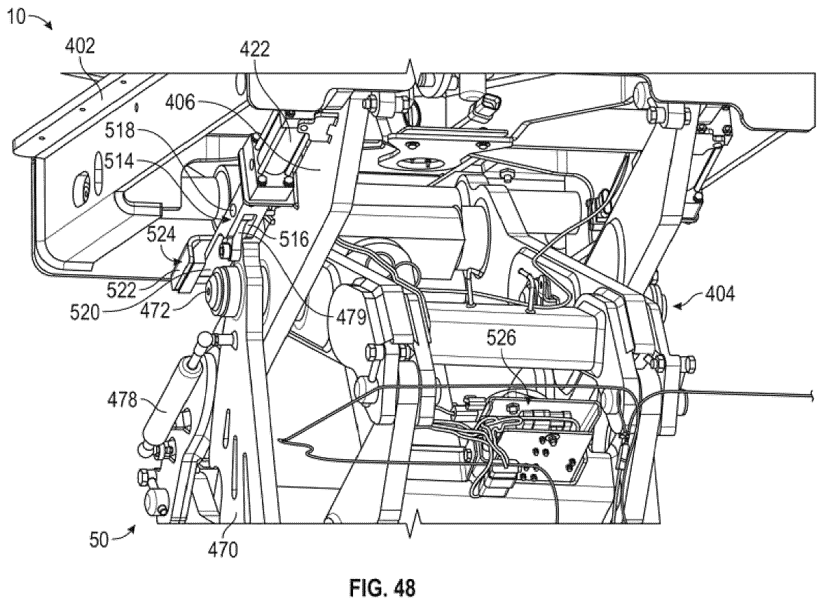

With specific reference to FIG. 48, the scissor assembly 404 includes an inertial measurement unit, show an IMU 526. The IMU 526 is included in the sensors 112 and is in communication with the controller 102. The IMU 526 is pivotably coupled to the scissor assembly 404 so that an angular position of the IMU 526 changes as the scissor assembly 404 moves, via the lift actuator 420, between the lowered position and the raised position. The angular position of the IMU 526 is correlated to the position or height of the cradle 52, the top platform 402, and the scissor assembly 404. In this way, for example, the controller 102 is configured to determine a height of the cradle 52, the top platform 402, and the scissor assembly 404 based on the angular position of the IMU 526.

Turning to FIGS. 47-51, each of the pins 518 is coupled to a prop position arm 528 that rotates in response to actuation of the support props 470 via the prop actuators 422. Each of the pins 518 extend through a corresponding one of the support brackets 514 so that a distal end of the pin 518 protrudes outwardly from the support bracket 514. Each of the prop position arms 528 engages the distal end of a corresponding one of the pins 518, so that the prop position arm 528 rotatably coupled to the pin 518 (e.g., rotation of the pin 518 results in the same magnitude of rotation of the prop position arm 528). In the illustrated embodiment, the prop position arms 528 define a generally fork-like shape, with two separated fork arms that define a slot or channel therebetween that receives the pin 518. Accordingly, the prop position arm 528 engages two opposing sides of the pin 518 so that movement of the pin 518, via actuation (e.g., extension or retraction) of the prop actuator 422, results in rotation of the prop position arm 528. The actuation direction of the prop actuator 422 is therefore correlated to a rotation direction of the prop position arm 528. With the pin 518 being coupled to both the prop position arm 528 and the support props 470, the rotational position of the prop position arm 528 is correlated to the rotational position of the support props 470.

In an exemplary embodiment, each of the prop position arms 528 is coupled to an encoder or a rotary position sensor 530 that measures a rotational position of the prop position arms 528. The rotary position sensor 530 is included in the sensors 112 and is in communication with the controller 102. The controller 102 is configured to determine a rotational position of the support props 470 based on the rotational position of the prop position arms 528 measured by the rotary position sensor 530. For example, actuation (e.g., extension) of the prop actuators 422 in a first translational direction moves the pins 518 in the along the first translation direction and pivots both the support props 470 and the prop position arms 528 to a particular rotational position (e.g., the support props 470 rotate in a first rotational direction). The distance that the pins 518 travel along the first translation direction is directly correlated to the rotational position of the prop position arms 528 and the support props 470. Similarly, actuation (e.g., retraction) of the prop actuators 422 in a second translational direction (e.g., opposite to the first translational direction) moves the pins 518 in the along the second translation direction and pivots both the support props 470 and the prop position arms 528 to a particular rotational position (e.g., the support props 470 rotate in a second rotational direction opposite to the first rotational direction). The distance that the pins 518 travel along the second translation direction is directly correlated to the rotational position of the prop position arms 528 and the support props 470. As such, the rotary position sensor 530 is configured to output a signal to the controller 102 that indicates a position of the support props 470 and provides an indication of whether the notches 474 are in engagement with the prop pins 476, or the notches 474 are pivoted away from the prop pins 476.

### Cart

Referring generally to the figures, a cart interface or coupling assembly may be coupled to a frame of vehicle to detachably couple the vehicle to a cart. More specifically, the cart interface may be coupled to a top surface of the vehicle. The cart interface includes an actuator coupled to a mounting interface, which is configured to be mounted to the top surface of the vehicle. The actuator engages a cam plate coupled to one or more pin assemblies configured to engage a bottom portion of the cart. In some embodiments, the one or more pin assemblies engage the bottom portion of the cart to couple the vehicle to the cart. The pin assemblies may be overextended to lift up on the cart, increasing the weight supported by the vehicle and increasing the traction of a drivetrain of the vehicle.

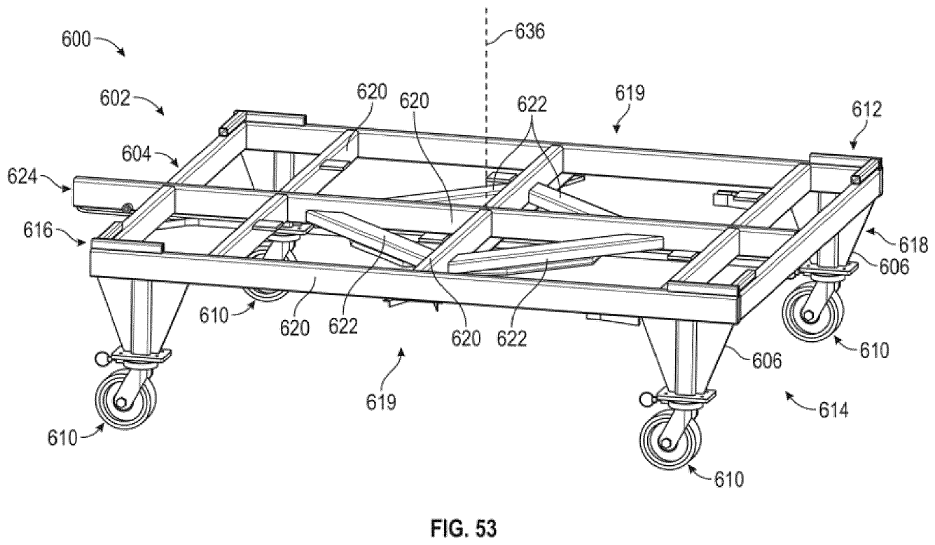

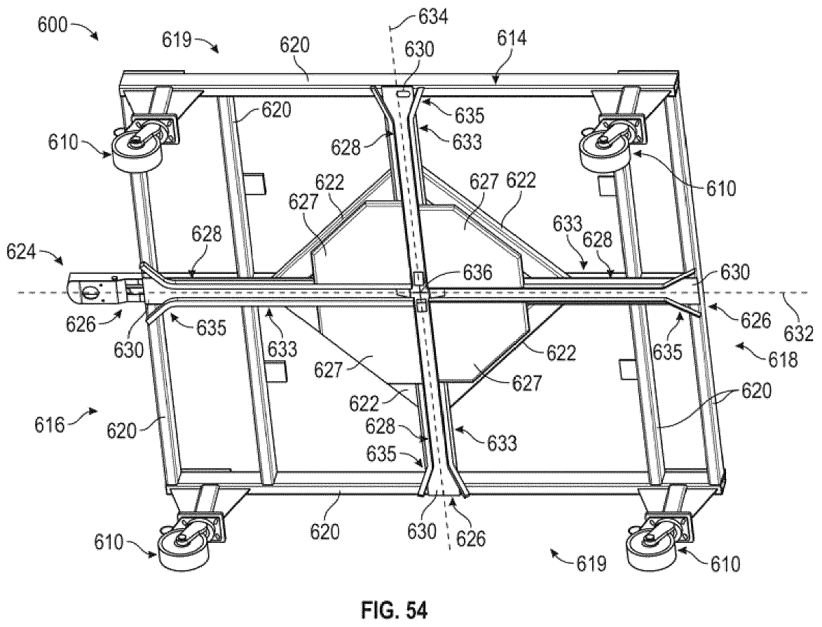

Referring to FIGS. 53 and 54, a cart 600 (e.g., the cart 66) includes a chassis or frame 602, a platform 604, one or more carts legs, shown as legs 606, extending downward from the platform 604, and one or more independent or caster wheels, shown as casters 610. The cart 600 includes a first or top portion 612, a second or bottom portion 614 opposite the top portion 616, a third or front portion 616, a fourth or rear portion 618 opposite the front portion 616, and a pair of side portions 619. The top portion 612 of the cart 600 includes the platform 604. The frame 602 includes one or more frame members, shown as frame members 620 that define the platform 604. The frame 602 also includes one or more support members, braces, or crossbars, shown as support members 622. The platform 604 defines a substantially horizontal plane that extends horizontally across the top portion 612 of the cart 600. The front portion 616 of the cart 600 includes a hitch, towing interface, or tow point, shown as tug 624, that couples the cart 600 to a driven vehicle (e.g., a forklift, etc.) or handle to facilitating towing or otherwise moving the cart 600. By way of example, the tug 624 may be used when the cart 600 is being transported by a vehicle other than the vehicle 10.

The bottom portion 614 of the cart 600 includes one or more channels or troughs (e.g., a first channel, a second channel, etc.), shown as channels 626, and one or more support or linking plates, shown as frame plates 627. The channels 626 are fixedly coupled to a bottom side or underside of the frame members 620. Each of the channels 626 includes a pair of channel walls, rails, or guards (e.g., cattle chutes), shown as guides 628, and a flat member, top member, or ceiling, shown as plate 630. A first pair of the channels 626 extend longitudinally across the cart 600 (e.g., from the front portion 616 to the rear portion 618), defining and centered about a longitudinal axis 632. A second pair of the channels 626 extend laterally across the cart 600 (e.g., between the pair of side portions 619), defining and centered about a lateral axis 634.

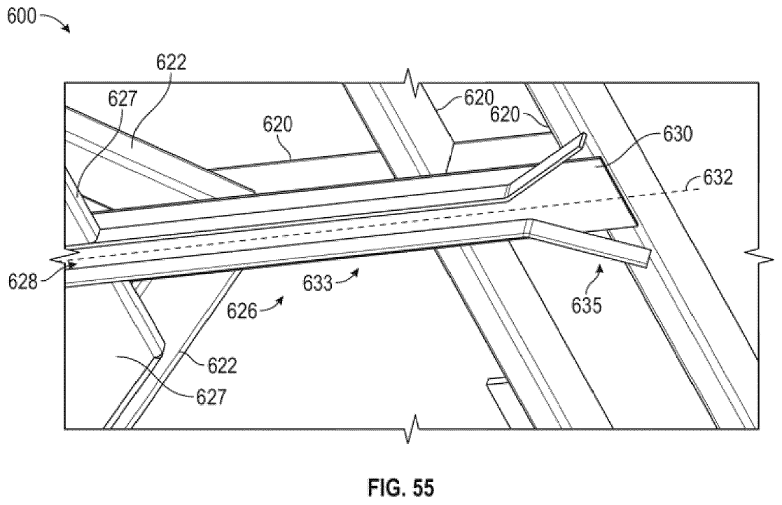

As shown in FIG. 55, the guides 628 each include a straight, constant width, or first portion 633 and a diagonal, sloped, ramped, narrowing, or second portion 635. The first portion 633 extends along (e.g., substantially parallel to) one of the longitudinal axis 632 or the lateral axis 634 and is substantially perpendicular relative to one of the frame members 620 along the front portion 616, the rear portion 618, or the pair of side portions 619 (e.g., the channels 626 extending from the front portion 616 and the rear portion 618 include the first portion 633 that is perpendicular relative to the front portion 616 and the rear portion 618, etc.). Accordingly, a width of the channel 626 defined between the first portions 633 is substantially constant. The second portion 635 is angled relative to the first portion 633. Specifically, the second portions 635 are angled toward one another as the second portions 635 extend toward the first portions 633. Accordingly, a width of the channel 626 defined between the second portions 635 decreases as the channel 626 extends toward the center of the cart 600, forming a funnel shape.

In some embodiments, the first portion 633 and the second portion 635 of each channel 626 are fixedly coupled (e.g., welded, etc.) with one another and the plate 630. In some embodiments, the guides 628 and the plate 630 are assembled to the cart 600 using a series of fasteners. In some embodiments, there are more or fewer channels 626 than shown in the FIGS. 53 and 54 (e.g., two channels 626, six channels 626, etc.). In some embodiments, the channels 626 extend only partially between the front portion 616 and the rear portion 618 or only partially between the pair of side portions 619. In some embodiments, the channels 626 may extend diagonally (e.g., from opposite corners) across the cart 600.

The channels 626 along the longitudinal axis 632 and the channels 626 along the lateral axis 634 intersect once another at a substantially vertical axis 636. In some embodiments, the cart 600 is rotatable (e.g., relative to the vehicle 10) about the substantially vertical axis 636. In some embodiments, the frame members 620 arranged on the front portion 616, the rear portion 618, and the pair of side portions 619 define an outer or external perimeter of the cart 600. In such embodiments, the substantially vertical axis 636 may be positioned within and extending through the external perimeter (e.g., the substantially vertical axis 636 is laterally and/or longitudinally centered on the cart 600).

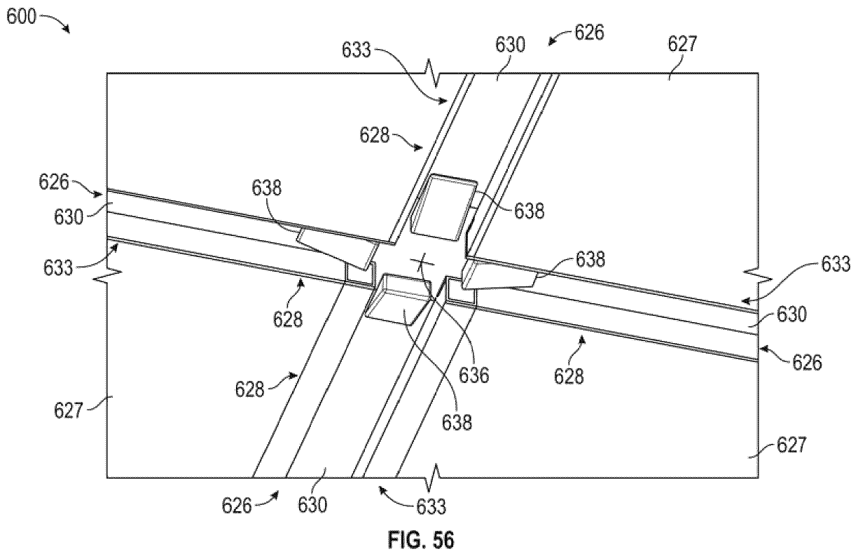

Referring to FIG. 56, the channels 626 further include a series of sloped or ramped plates or ramps, shown as a positioning members 638, each fixedly coupled to the plate 630. Each positioning member 638 has an outer edge that is substantially level with the plate 630 and gradually increases in height (e.g., slopes outward from the plate 630) as the positioning member 638 extends toward the substantially vertical axis 636. Accordingly, the highest point or edge of the positioning member is the end of the positioning member 638 that is closest to a center of the cart 600. In some embodiments, the faces of the positioning members 638 that face toward the substantially vertical axis 636 are substantially vertical.

Referring to FIG. 54, the frame plates 627 extend horizontally between adjacent portions of the channels 626. Specifically, each frame plate 627 abuts (e.g., touches) portions of two adjacent guides 628 that are closest to the substantially vertical axis 636. The bottom surfaces of the frame plates 627 may be flush with the bottom surfaces of the guides 628, such that the bottom surfaces of the frame plates 627 and the bottom surfaces of the guides 628 are coplanar.

FIG. 6 illustrates an example of the cart 600 being used to support a single boom assembly 68. In this example, the boom assembly 68 may be placed directly atop the top portion of the cart 600. In other situations, it may be advantageous to carry multiple boom assemblies or other products on a single cart. In some such situations, the manufacturing environment may be limited in how the booms can be added to the cart. By way of example, a manufacturing line may only be capable of placing boom assemblies onto a cart from one side of the cart.

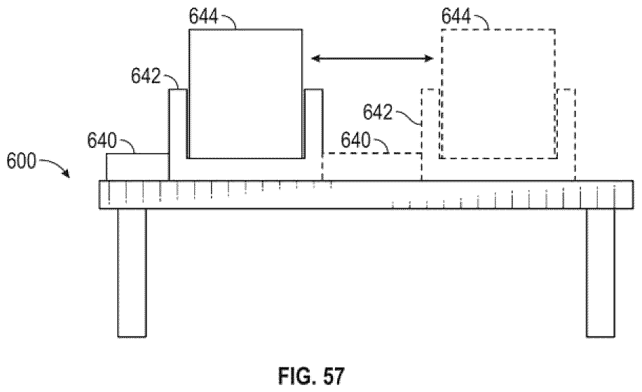

Referring to FIG. 57, the cart 600 may equipped with or coupled to an actuator 640 (e.g., a linear actuator, a hydraulic actuator, an electric actuator, a pneumatic actuator, etc.) and a slot, basket, platform, receiving member, or channel, shown as cradle 642. The actuator 640 and the cradle 642 may be arranged on the top portion 616 of the cart 600. In some embodiments, the cradle 642 is sized and/shaped to receive equipment 644 (e.g., a boom, etc.). In such embodiments, the actuator 640 may push, move, or reposition the cradle 642 to adjust a location of the equipment 644 relative to the cart 600. By way of example, the actuator 640 may translate (e.g., laterally, as shown in FIG. 57) the cradle 642 along the top portion 616 of the cart 600 from an initial position to a secondary position (e.g., shown in dashed lines) to move the equipment 644 received by the cradle 642 to a desired location.

The actuator 640 and the cradle may facilitate adding multiple products onto the cart 600 simultaneously. This may be advantageous in a manufacturing environment that is only capable of placing products onto one side of the cart 600. By way of example, a first equipment 644 may be placed into the cradle 642 in the position shown in solid lines in FIG. 57. The actuator 640 may reposition the first equipment 644 laterally to the position shown in dashed lines in FIG. 57. A second equipment 644 may then be placed in the location previously occupied by the first equipment 644. A similar process may be followed in reverse to remove the first and second equipment 644 from the cart 600.

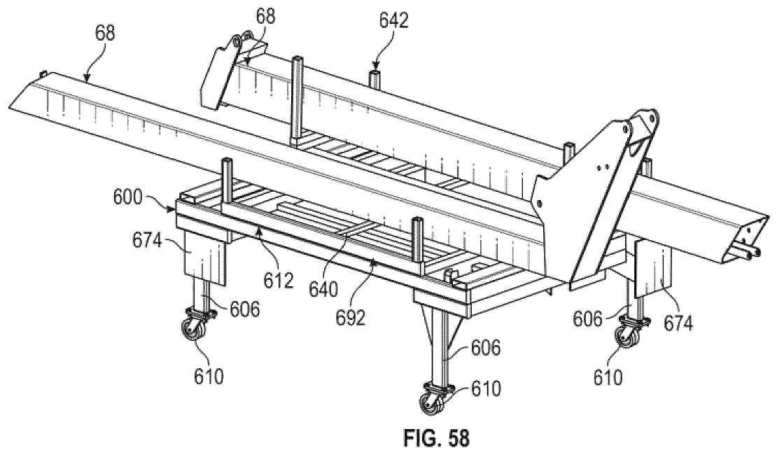

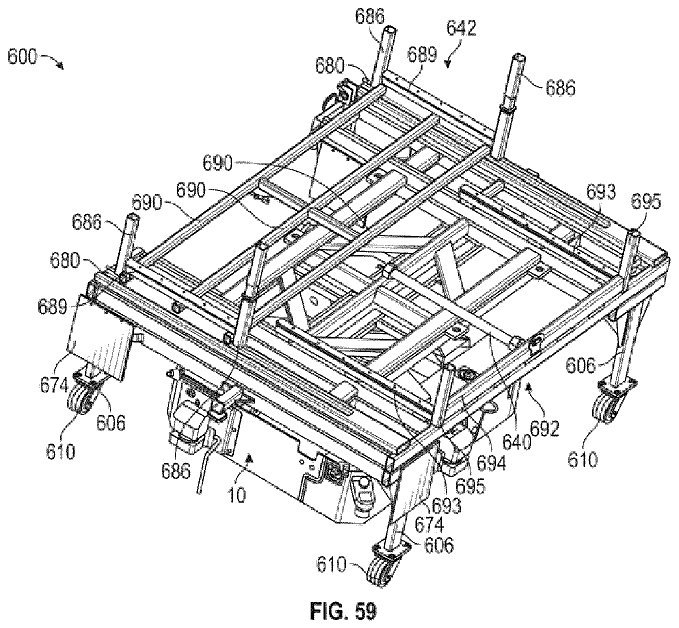

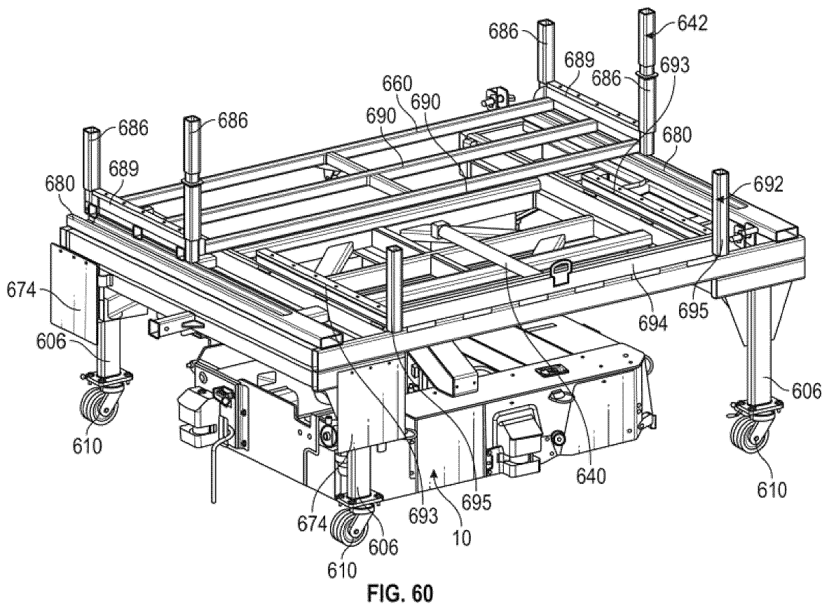

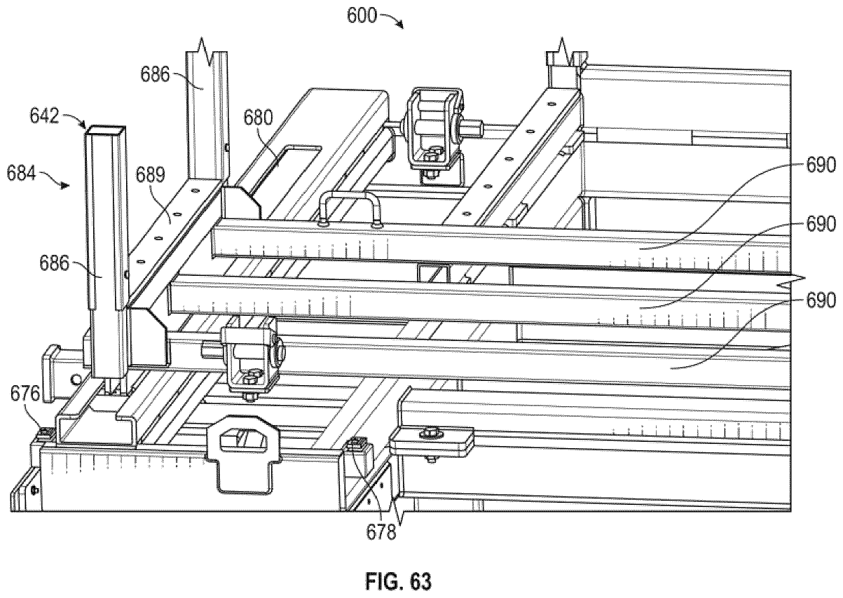

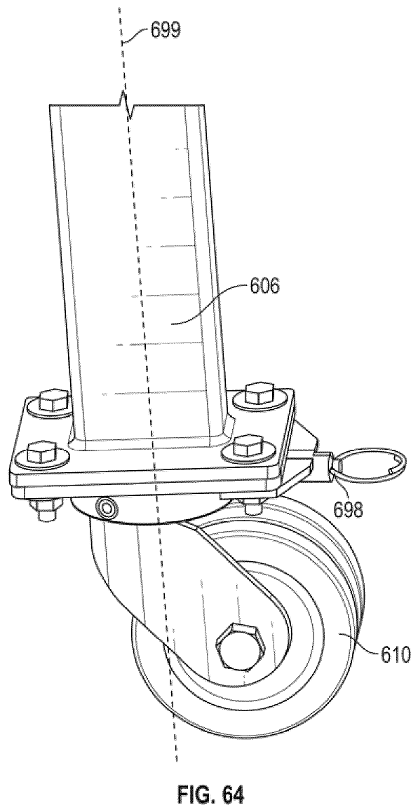

Referring generally to FIGS. 58-66, an alternative embodiment of the cart 600 is shown. The cart 600 may be similar substantially similar to the embodiment of FIGS. 53-57 except as otherwise specified herein. Accordingly, any description of the cart 600 of FIGS. 53-57 may apply to the cart 600 of FIGS. 58-66 except as otherwise specified herein.

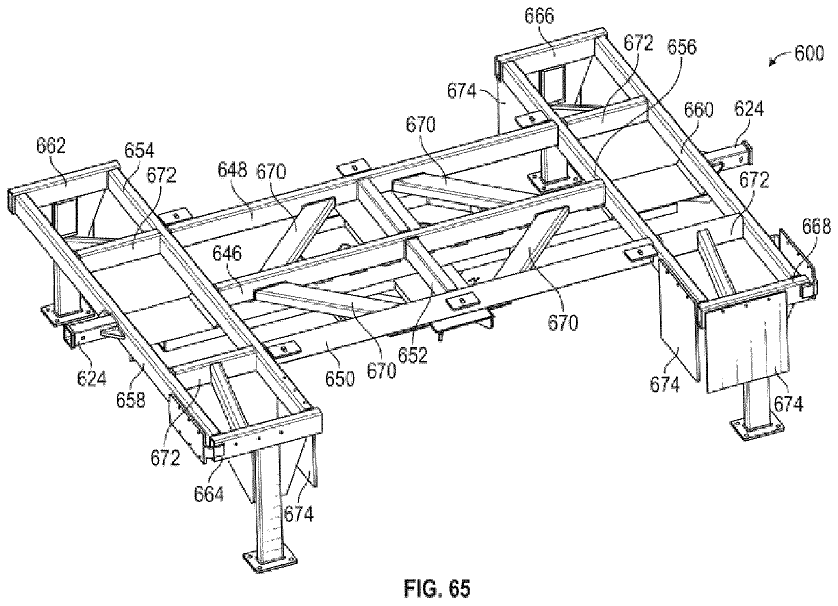

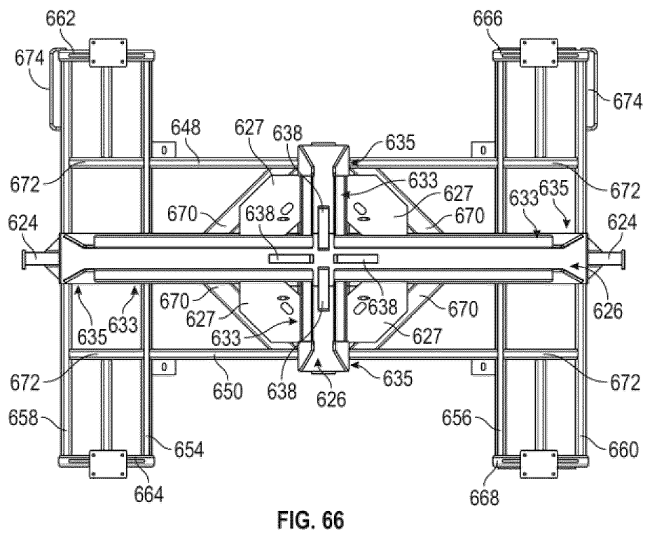

Referring now to FIGS. 65 and 66, the frame members 620 of the cart 600 include a first frame member 646, a second frame member 648, a third frame member 650, a fourth frame member 652, and a fifth frame member 654. The first frame member 646 extends along the longitudinal axis 632. The second frame member 648 extends substantially parallel to and offset from the first frame member 646 in a first direction. The third frame member 650 extends substantially parallel and offset from the first frame member 646 in a second direction opposite the first direction. The third frame member 650 is substantially the same length as the second frame member 648. The third frame member 650 is longer than the first frame member 646. The fourth frame member 652 extends along the lateral axis 634, and intersects at least a portion of the first frame member 646, the second frame member 648, and the third frame member 650. The fifth frame member 654 extends substantially parallel to and offset from the fourth frame member 652 in a third direction.

The frame members 620 include a sixth frame member 656, a seventh frame member 658, and an eighth frame member 660. The sixth frame member 656 extends substantially parallel to and offset from the fourth frame member 652 in a fourth direction opposite the third direction. The fifth frame member 654 intersects at least a portion of the first frame member 646, second frame member 648, and the third frame member 650. The sixth frame member 656 is substantially the same length as the fifth frame member 654 and is longer than the fourth frame member 652. The sixth frame member 656 intersects at least a portion of the first frame member 646, the second frame member 648, and the third frame member 650. The seventh frame member 658 extends substantially parallel to the fifth frame member 654 and is offset from the fifth frame member 654 in the third direction. The eighth frame member 660 extends substantially parallel to the sixth frame member 656, and is offset from the sixth frame member 656 in the fourth direction.

The frame members 620 includes a ninth frame member 662, a tenth frame member 664, an eleventh frame member 666, and a twelfth frame member 668. The ninth frame member 662 extends between a first end of the fifth frame member 654 and a first end of the seventh frame member 658, and the tenth frame member 664 extends between a second end of the fifth frame member 654 and a second end of the fifth frame member 654, the first ends opposite the second ends. The eleventh frame member 666 extends between a first end of the sixth frame member 656 and a first end of the eighth frame member 660, and the twelfth frame member 668 extends between a second end of the sixth frame member 656 and a second end of the eight frame member 660, the second end opposite the first end.

The support members 622 include a series of first support members 670 and a series of second support members 672. The first support members 670 are each angled with respect to the corresponding frame members 620, and the second support members 672 are each perpendicular with respect to the corresponding frame members 620. Two of the first support members 670 extend between the first frame member 646 and the second frame member 648, and two of the first support members 670 extend between the first frame member 646 and the third frame member 650. Two of the second support members 672 extend between the fifth frame member 654 and the seventh frame member 658, and two of the second support members 672 extend between the sixth frame member 656 and the eighth frame member 660.

The shape, size, and arrangement of the frame members 620 and the support members 622 cause the frame 602 to form an I shape as viewed from above. Specifically, the lateral width of the frame 602 is greater at the front end and the rear end of the frame 602 than in the longitudinal center of the frame. This arrangement forms a first recess between the fifth frame member 654, the second frame member 648, and the sixth frame member 656, and a second recess between the fifth frame member 654, the third frame member 650 and the sixth frame member 656. These recesses extend laterally inward from the left and right sides of the frame 602. The recesses may provide clearance for lifting forks used to place the boom assemblies 68 or other equipment 644 onto the cart 600, while still ensuring that the front and rear ends of the boom assemblies 68 are supported by the cart 600.

The cart 600 includes a series of side panels 674, as shown in FIGS. 58-61, 65, and 66. Each of the side panels 674 is fixedly coupled to extends from one or more of the frame members 620. Two of the side panels 674 extend from the fifth frame member 654, one of the side panels 674 extends from the ninth frame member 662, one of the side panels 674 extends from the sixth frame member 656, one of the side panels 674 extends from the eleventh frame member 666, and one of the side panels 674 extends from the twelfth frame member 668.

The side panels 674 face outward from the frame 602. Each of the side panels 674 includes a visual indicator (e.g., QR code, etc.) that can be viewed by a vehicle 10 nearby the cart 600. The visual indicators each provide information visually. A sensor 112 of the vehicle 10, such as a camera, may detect and read the visual indicator to gather information about the cart 600. By way of example, the visual indicators may contain information used to identify the cart 600 or a component carried by the cart 600 (e.g., an identification number). By way of another example, the visual indicators may be placed at predetermined locations on the cart 600, such that by locating the visual indicators, the controller 102 may determine a position of the cart 600 relative to the vehicle 10.

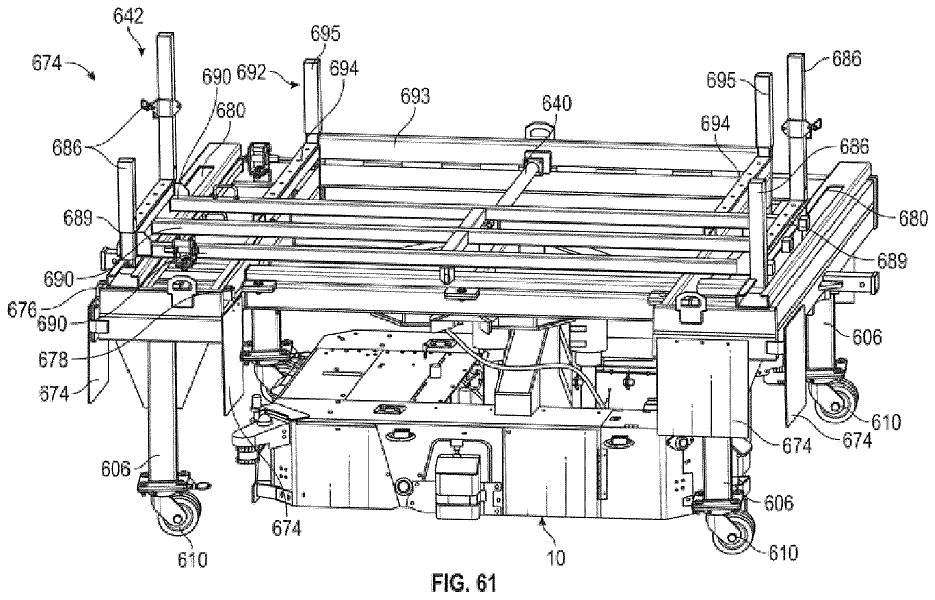

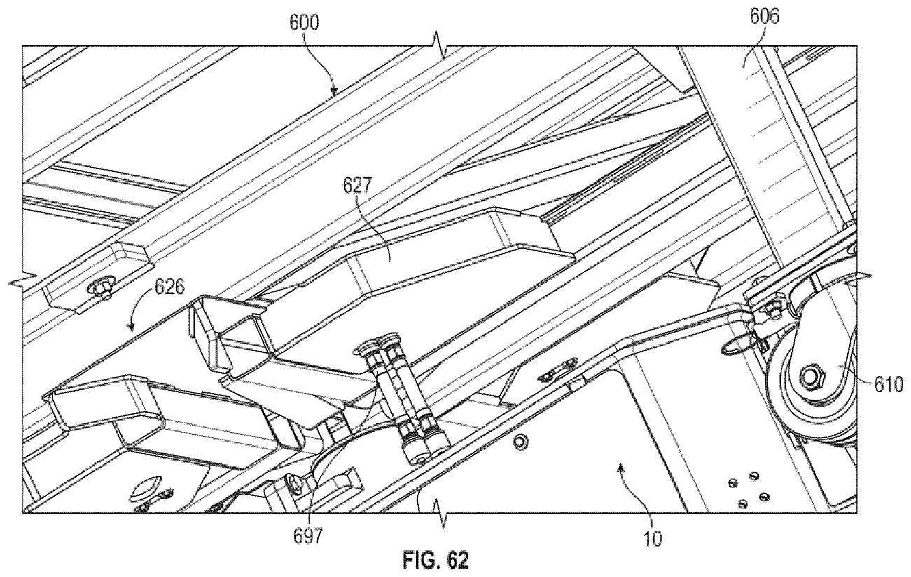

Referring to FIGS. 61 and 62, the top portion 612 of the cart 600 includes a first switch 676 and a second switch 678 coupled to the frame 602. The first switch 676 and the second switch 678 are configured to control movement of the actuator 640 to reposition of the cradle 642. The actuator 640, the first switch 676, and the second switch 678 may be operatively coupled to the controller 102, and the controller 102 may operate the actuator 640 based on inputs received through the first switch 676 and the second switch 678. The first switch 676 may be operated to indicate a desired direction of motion (e.g., forward or backward). The controller 102 may require the operator to interact with (e.g., press) the second switch 678 simultaneously with the first switch 676 in order to enable operation of the first switch 676. The controller 102 may prevent operation of the actuator 640 unless both of the switches are pressed simultaneously. This may verify the operator's intent and prevent unintentional operation of the actuator 640.

A of slots 680 are arranged along the seventh frame member 658 and the eighth frame member 660 of the cart 600, and are configured to receive the cradle 642. The slots 680 extend from locations vertically aligned with the ninth frame member 662 and the eleventh frame member 666 to locations closer to the tenth frame member 664 and the twelfth frame member 668 than the ninth frame member 662 and the eleventh frame member 666. The cradle 642 is configured to extend between and slide along the slots 680.

Referring now to FIGS. 58-61 and 63, the cradle 642 includes a frame 684. The frame 684 includes series of vertical members 686, a series of lateral members 689, and a series of longitudinal members 690, that are fixedly coupled (e.g., welded) to one another to form the cradle 642. The lateral members 689 are each slidably received within one of the slots 680. The longitudinal members 690 extend between the lateral members 689 and are configured to receive the boom assembly 68. The vertical members 686 extend upward from the lateral members 689, and are configured to prevent the boom assembly 68 from leaving the cradle 642.

The cart 600 further includes a secondary cradle 692 fixedly coupled to the frame 602. The secondary cradle 692 includes a series of lateral members 693, a longitudinal member 694, and a series of vertical members 695. The longitudinal member 694 extends between the tenth frame member 664 and the twelfth frame member 668, and is substantially parallel and offset from the third frame member 650 along the second direction. The lateral members 693 each extend from the longitudinal member 694 towards the second frame member 648. The vertical members 695 each extend from the lateral members 693 and the longitudinal member 694. The actuator 640 extends from the longitudinal member 694 of the secondary cradle 692. The cradle 642 is vertically offset from the secondary cradle 692, facilitating movement of the cradle 642 relative to the secondary cradle 692.

As shown in FIG. 58, a first boom assembly 68 may be received within and supported by the cradle 642. In response to a user interaction with the first switch 676 and the second switch 678, the actuator 640 may reposition the cradle 642 with the first boom assembly 68 inot the position shown in FIG. 58. A second boom assembly 68 may then be received within and supported by the secondary cradle 692.

Referring now to FIG. 62, the cart 600 includes an actuator connection 697. The actuator connection 697 includes a pair of conduits or hoses that fluidly couple the actuator 640 to a pump onboard the vehicle 10. The hoses of the actuator connection 697 may extend from a pump within the vehicle 10, through an upper surface of the vehicle 10, through one of the frame plates 627, and to the actuator 640. The actuator connection 697 may be disconnected when moving the cart 600 relative to the vehicle 10.

Referring now to FIG. 64, each of the casters 610 includes a pin 698. The pin 698 is reconfigurable between a first state and a second state. In the first state, the pin 698 engages the caster 610 to prevent the caster 610 rotating about a vertical axis 699. In the second state, the pin 698 is disengaged from the caster 610, and the caster 610 is permitted to rotate about the vertical axis 699 (e.g., in the first state the location of the caster 610 is fixed and in the second state the caster 610 can spin freely). A user may manually reconfigure the pin 698 between the first state and the second state (e.g., by pulling the pin 698). By way of example, the first state may be used when pulling the cart 600 through the tug 624, and second state may be used when connecting the cart 600 to the vehicle 10.

### Cart Interface

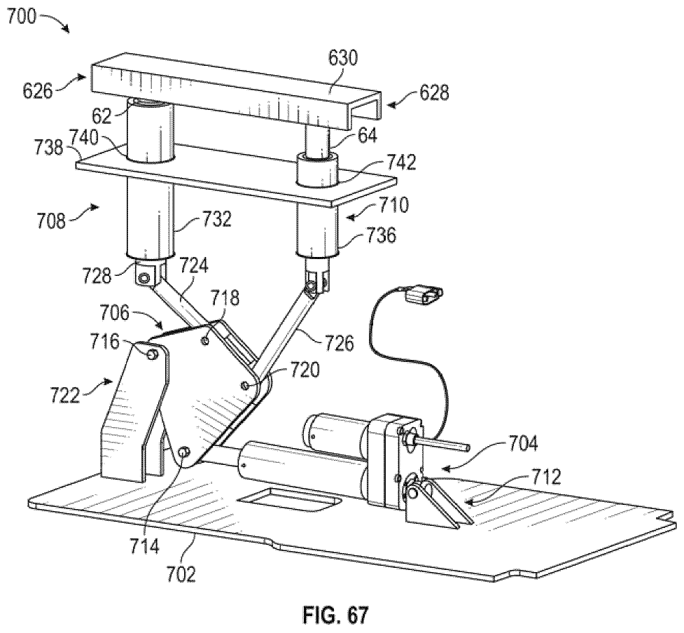

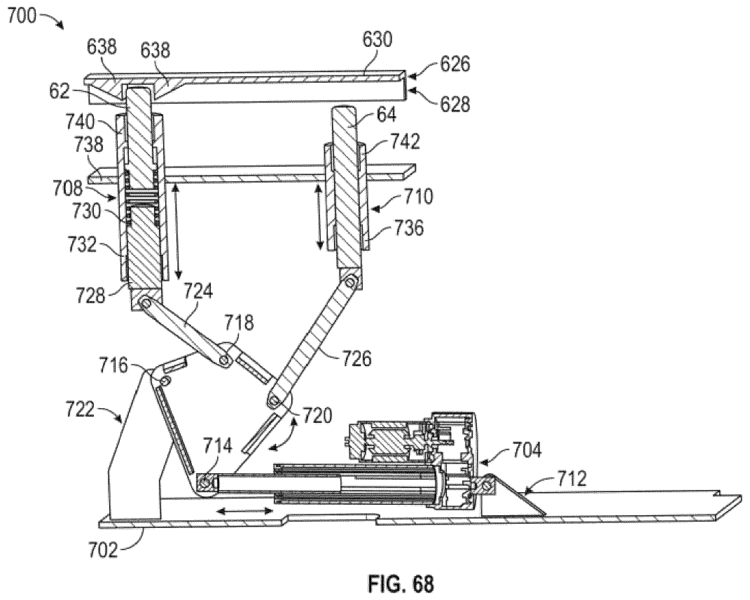

Referring generally to FIGS. 67 and 68, a cart interface or coupling assembly, shown as cart interface 700, may be coupled to the frame 12 of vehicle 10. The cart interface 700 may be an example of the cart implement 60. The cart interface 700 includes an actuator coupled to a mounting interface, which is configured to be mounted (e.g., removably coupled) to the frame 12 of the vehicle 10. The actuator engages a cam plate coupled to one or more pin assemblies configured to engage the bottom portion 614 of the cart 600. In some embodiments, the one or more pin assemblies engage the cart 600 to couple the vehicle 10 to the cart 600.

FIG. 67 shows a coupling assembly, shown as cart interface 700, which includes a mounting plate or base plate, shown as mounting interface 702, an actuator 704 (e.g., a linear actuator, hydraulic actuator, electric actuator, pneumatic actuator, etc.), a cam assembly or rotating plate, shown as cam plate 706, a first pin assembly 708 coupled to the cam plate 706, and a second pin assembly 710 coupled to the cam plate 706. The first pin assembly 708 and the second pin assembly 710 are configured to engage the bottom portion 614 of the cart 600. In some embodiments, the first pin assembly 708 and the second assembly 710 engage a portion of the channel 626 of the cart 600. In some embodiments, the mounting interface 702 is coupled to the frame 12 of the vehicle 10. In other embodiments, the mounting interface 702 is integrally formed with the frame 12 or the top surface 30 of the vehicle 10. In some embodiments, the cart interface 700 includes more or fewer pin assemblies than a first pin assembly 708 and a second pin assembly 710.

The actuator 704 is coupled to the mounting interface 702 by a first mounting bracket 712. In some embodiments, the actuator 704 is rotatably or pivotably coupled to the first mounting bracket 712 to permit movement of the actuator 704 relative to the mounting interface 702 (e.g., as the cam plate 706 rotates). In some embodiments, the actuator 704 includes an electric motor, which may be configured to drive, power, or move the actuator 704 to actuate. In some embodiments, the actuator 704 is an electric linear actuator. A distal end portion of the actuator 704 is further coupled to the cam plate 706.

The cam plate 706 defines one or more apertures or aperture pairs, shown as a first aperture 714, a second aperture 716, a third aperture 718, and a fourth aperture 720. The first aperture 714 is positioned towards the bottom (e.g., in a direction towards the mounting interface 702) of the cam plate 706 and receives a fastener (e.g., bolt, rivet, screw, or other fastening device) to pivotally couple an end portion of the actuator 704 to the cam plate 706. The second aperture 716 is positioned towards the front (e.g., in a direction away from the actuator 704) of the cam plate 706 and receives a fastener to pivotally couple the cam plate 706 to the mounting interface 702 by a second mounting bracket 722. The third aperture 718 is positioned towards the top (e.g., in a direction away from the mounting interface 702) of the cam plate 706 and receives a fastener to pivotally couple the cam plate 706 to the first pin assembly 708 by or through a first linkage 724. The fourth aperture 720 is positioned towards the rear (e.g., in a direction towards the actuator 704) of the cam plate 706 and receives a fastener to pivotally couple the cam plate 706 to a second pin assembly 710 by or through a second linkage 726. In some embodiments, the position and/or quantity of the first aperture 714, the second aperture 716, the third aperture 718, or the fourth aperture 720 may vary based on one or more of a shape or size of the cam plate 706, the position or orientation of the actuator 704, the position or orientation of the first mounting bracket 712 or the second mounting bracket 722, or the position, orientation, or quantity of pin assemblies (e.g., the first pin assembly 708, the second pin assembly 710).

FIG. 68 shows a cross-sectional view of the cart interface 700, according to an exemplary embodiment. Referring to FIGS. 67 and 68, the first pin assembly 708 includes the first linkage 724, a first rod, shaft, or sliding member, shown as first pin 728, coupled to the first linkage 724, a second rod or shaft, shown as driving pin 62, a biasing element, shown as spring 730, and a housing 732 that receives a portion of the pin 728 and the driving pin 62. In some embodiments, the pin 728 is configured to move along a central axis defined by the housing 732 and engage the spring 730, which in turn engages the driving pin 62. The housing 732 limits movement of the driving pin 62 and the pin 728 except along the central axis. In such embodiment, the engagement of the spring 730 with the driving pin 62 applies a biasing force onto the driving pin 62 that biases the driving pin 62 to move upward along the central axis defined by the housing 732, toward the plate 630 of the channel 626.

The spring 730 has an uncompressed length. If the driving pin 62 is not in engagement with plate 630, the spring 730 is permitted to expand to the uncompressed length without resistance. Accordingly, in such a situation, the driving pin 62 has a predetermined vertical offset distance from the pin 728. Varying the vertical position of the pin 728 raises or lowers the driving pin 62. If the driving pin 62 engages the plate 630, the plate 630 limits upward movement of the driving pin 62 and begins to compress the spring 730. Varying the vertical position of the pin 728 increases or decreases the biasing force of the spring 730 and thus the biasing force applied to the plate 630 through the driving pin 62.

In some situations, such as when the vehicle 10 drives relative to the cart 600, the drive pin 62 moves along a channel 626 (e.g., along one of the longitudinal axis 632 or the lateral axis 634). As the drive pin 62 moves along the channel 626, the driving pin 62 may encounter one of the positioning members 638. The driving pin 62 may engage the positioning member 638, and the positioning member 638 may force the driving pin 62 downward and compress the spring 730. Once the driving pin 62 reaches the space between the positioning members 638, the spring 730 may force the driving pin 62 upward and into the space.

The second pin assembly 710 includes the second linkage 726, a turning pin 64, and a housing 736 that receives a portion of the turning pin 64. In some embodiments, the turning pin 64 is configured to move along a central axis defined by the housing 736 and engage the plate 630 of the channel 626. Because the second linkage 726 is directly coupled to the turning pin 64, the turning pin 64 does not have the freedom of movement relative to the second linkage 726 that the driving pin 62 is provided by the spring 730. Accordingly, each position of the second linkage 726 has a corresponding position of the turning pin 64.

The first pin assembly 708 and the second pin assembly 710 are coupled to one another by a plate 738. The plate 738 includes a first aperture 740 that receives the housing 732 of the first pin assembly 708 and a second aperture 742 that receives the housing 736 of the second pin assembly 710. The housing 732 and the housing 736 are both fixedly coupled to the plate 738. Accordingly, the plate 738 prevents movement of the housing 732 relative to the housing 736.

Referring to FIGS. 67 and 68, the cart interface 700 has one degree of freedom (e.g., as illustrated by two-sided arrows). By way of example, the actuator 704 may actuate (e.g., extend or retract) to move or position the cam plate 706 along a substantially horizontal axis or substantially parallel axis relative to the mounting interface 702. As such, the actuator 704 translates to position a lower portion (e.g., towards the first aperture 714) of the cam plate 706. By way of another example, as the actuator 704 translates the lower portion of the cam plate 706, the actuator 704 causes the cam plate 706 to pivot (e.g., rotate) about the second aperture 716. As the cam plate 706 pivots about the second aperture 716, lower ends of the first linkage 724 and the second linkage 726 also rotate about the lateral axis of the second aperture 716. This rotation causes the first linkage 724 to move the first pin assembly 708 along the housing 732 and causes the second linkage 726 to move the second pin assembly 710 along a substantially vertical axis or substantially perpendicular axis relative to the mounting interface 702 to engage or disengage the plate 630 of the channel 626.

In operation, the actuator 704 may be used to reposition the driving pin 62 and the turning pin 64 and control engagement between the vehicle 10 and the cart 600. Each position of the actuator 704 may have a corresponding position of the cam plate 706. Accordingly, by controlling the extension of the actuator 704, the positions of the driving pin 62 and the turning pin 64 may be controlled. In some embodiments, the actuator 704 includes a sensor 112 that provides feedback regarding the position or extended length of the actuator 704. The controller 102 may utilize this feedback to perform closed-loop control over the position of the cam plate 706.

In some embodiments, the actuator 704 extends fully, moving the cam plate 706 to an extreme clockwise position, referred to as a fully retracted position. In the fully retracted position, the driving pin 62 and the turning pin 64 are retracted low enough to where neither the driving pin 62 nor the turning pin 64 can enter into the channel 626. Accordingly, the cart interface 700 does not interface (e.g., is incapable of interfacing) with the cart 600. The fully retracted position may be useful when it is desirable for the vehicle 10 navigate beneath a cart 600 without engaging the cart 600. The actuator 704 may return the cam plate 706 to the fully retracted position at any time to release the vehicle 10 from engagement with a cart 600.

In some embodiments, the actuator 704 retracts or actuates the cam plate 706 to pivot counterclockwise about the second aperture 716 to an extended or single engagement position. In the single engagement position, the cam plate 706 is positioned such that the second driving pin 62 of the first pin assembly 708 extends high enough to enter into the channel 626, but the turning pin 64 of the second assembly 710 is low enough to prevent the turning pin 64 from engaging with the channel 626. The single engagement position may be used when initially coupling the vehicle 10 to a cart 600. By way of example, a vehicle 10 may begin by approaching the cart 600. The vehicle 10 may align the driving pin 62 with a channel 626 of the cart 600. The increased width of the second portion 635 may facilitate this alignment. As the vehicle 10 continues to move toward the cart 600, the tapered shape of the second portion 635 may automatically align the first portion 633 with the driving pin 62.

The vehicle 10 may continue to move along the length of the channel 626 until the driving pin 62 reaches a positioning member 638. The spring 730 may compress to permit the driving pin 62 to move along the positioning member 638 until the driving pin 62 reaches the space between the driving pints 62. The spring 730 may then force the driving pin 62 into the space between the positioning members 638. Engagement between the tall, flat walls of the positioning members 638 and the driving pin 62 prevents the driving pin 62 from leaving the space. Accordingly, the cart 600 is then positionally tied (i.e., forced to move along the same path) as the vehicle 10. In this configuration, the substantially vertical axis 636 and the central axis 46 of the vehicle 10 may be aligned. Accordingly, the vehicle 10 can freely rotate about its central axis 46 to adjust the orientation of the vehicle 10 relative to the cart 600. By way of example, the vehicle 10 may drive in a first direction (e.g., north), then turn and drive in a second direction (e.g., west) without varying an orientation of the cart 600.

In some embodiments, the actuator 704 extends to actuate the cam plate 706 to pivot about the second aperture 716 to a neutral or dual engagement position. In the dual engagement position, the cam plate 706 is positioned such that the driving pin 62 of the first pin assembly 708 and the turning pin 64 of the second assembly 710 are raised to a height where both the driving pin 62 and the turning pin 64 would extend into the channel 626. If the turning pin 64 is aligned with one of the channels 626, the turning pin 64 will enter into the channel 626 and prevent rotation of the cart 600 relative to the vehicle 10. Accordingly, the dual engagement position may be useful to adjust the orientation of the cart 600. Due to the arrangement of the channels 626, the vehicle 10 may have twice as many orientations where the turning pin 64 may enter a channel 626 as there are channels 626 (e.g., two for each channel 626).

If the actuator 704 attempts to bring the turning pin 64 to the dual engagement position without the turning pin 64 being aligned with one of the channels 626, the turning pin 64 may instead engage a guide 628 and/or a frame plate 627. Because the frame plates 627 are flush with the guides 628, the vehicle 10 may simply rotate to slide the turning pin 64 along the frame plates 627 and the guides 628 until alignment is reached. At that point, the actuator 704 may force the turning pin 64 into the channel 626.

In the single engagement position and the dual engagement position, the turning pin 64 may be separated from the plate 630 or may lightly touch the plate 630. Accordingly, minimal vertical force is transferred between the cart 600 and the vehicle 10. Because of this, the vehicle 10 generally supports only the weight of the vehicle 10. While the cart 600 and/or any products supported by the cart 600 may have a significant weight, the majority of that weight may be directed to the ground through the casters 610. Accordingly, the structure of the vehicle 10 can be made lighter and more cost effective, as the vehicle 10 does not have to support the additional weight of the cart load.

In some embodiments, the actuator 704 is configured to actuate the cam plate 706 so that the driving pin 62 and the turning pin 64 are in a traction configuration or traction position. By way of example, while the vehicle 10 is driving the cart 600 (e.g., the driving pin 62 is extended upward and arranged between the positioning members 638 and the turning pin 64 is extended upward and received within at least one of the channels 626 in the dual engagement position), the controller 102 may detect, via the sensors 112 (e.g., a wheel encoder, a speed sensor, etc.), that one or more of the tractive elements 44 have lost or reduced traction (e.g., detect wheel slip, or wheel traction below a predefined threshold). In response to detecting that one or more of the tractive elements have lost or reduced traction, the controller 102 may instruct the actuator 704 to rotate the cam plate 706 (e.g., counterclockwise from the perspective of FIG. 67) so that the driving pin 62 remains between the positioning members 638 and the turning pin 64 is actuated further upwardly toward the plate 630. Specifically, the turning pin 64 is actuated so that a distal end of the turning pin 64 engages the plate 630, which acts to lift the cart 600 and apply a downward force (e.g., toward a ground on which the vehicle 10 is traveling) on the mounting interface 702. The downward force on the mounting interface 702 is transferred to the frame 12 and to the tractive elements 44 to in an attempt to increase traction. Once the controller 102 determines that the tractive elements 44 have stopped spinning, the controller 102 may command the actuator 704 to return the cam plate 706 to the dual engagement position.

### Alternative Cart Interface

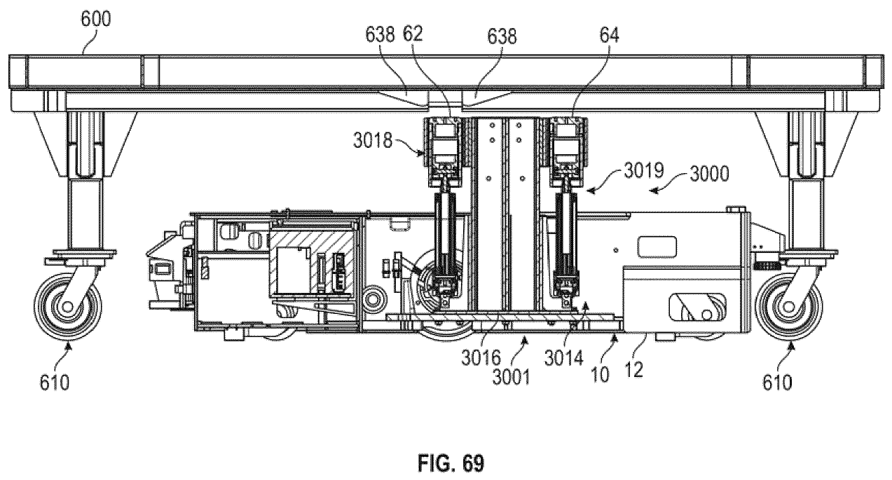

Referring generally to FIGS. 69-82, a cart interface or coupling assembly is shown as cart interface 3000, according to an exemplary embodiment. The cart interface 3000 may be substantially similar to the cart interface 700 except as otherwise specified herein. Accordingly, any description with respect to the cart interface 700 may apply to the cart interface 3000 except as otherwise specified herein. Additionally, any embodiment of the vehicle 10 that includes the cart interface 700 may include the cart interface 3000 in place of the cart interface 700.

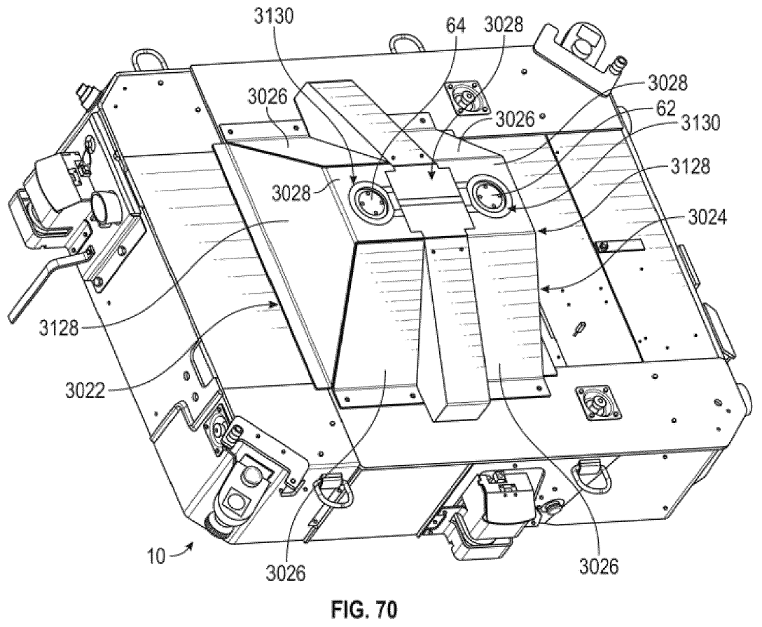

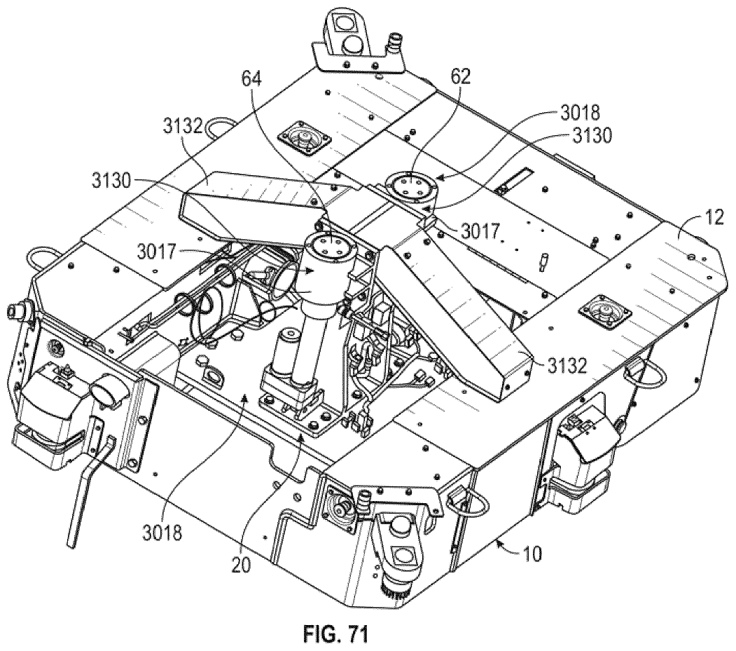

Referring to FIGS. 69-71, the cart interface 3000 includes a driving pin 62 and a turning pin 64. The driving pin 62 and the turning pin 64 engage the cart 600 to selectively cause the cart 600 to move with the vehicle 10 (e.g., selectively couple the cart 600 to the vehicle 10). FIG. 69 shows the vehicle 10 outfitted with the cart interface 3000. As shown in FIG. 70, the cart interface 3000 includes a first cover 3022 and a second cover 3024 that cover portions of the cart interface 3000 and prevent debris from entering into the vehicle 10 around the cart interface 3000. Both the first cover 3022 and the second cover 3024 have a pair of side surfaces 3026 (e.g., angled with respect to a horizontal plane, facing laterally outward), a top surface 3028, and a pair of longitudinal surfaces 3128 (e.g., a front surface and a rear surface). The side surfaces 3026 and the longitudinal surfaces 3128 are angled relative to a horizontal plane, such that the side surfaces 3026 and the longitudinal surfaces 3128 redirect any material (e.g., fasteners, rocks, dirt, or other debris) dropped onto the first cover 3022 and the second cover 3024 away from the cart interface 3000. The side surfaces 3026 face laterally outward (e.g., upward and laterally outward), the longitudinal surface 3128 of the first cover 3022 faces forward (e.g., upward and forward), and the longitudinal surface 3128 of the second cover 3024 faces rearward (e.g., upward and rearward).

The first cover 3022 and the second cover 3024 each define a hole, opening, or passage, shown as pin aperture 3130. The aperture 3130 of the second cover 3024 receives the driving pin 62. The aperture 3130 of the second cover 3024 receives the turning pin 64. The apertures 3130 facilitate extension of the driving pin 62 and the turning pin 64.

As shown in FIG. 71, the cart interface 3000 is received in the implement recess 20 defined by the frame 12 of the vehicle 10. The cart interface 3000 may be coupled to the frame 12 of the vehicle 10. The cart interface 3000 includes a first actuator assembly 3018 and a second actuator assembly 3019 coupled to and supported by a frame assembly 3001. The frame assembly 3001 is coupled to the frame 12 of the vehicle 10. By way of example, the frame assembly 3001 may be removably coupled to the frame 12 using a series of fasteners that pass through the frame assembly 3001 and engage the frame 12. A pair of actuator assemblies, shown as actuator assembly 3018 and actuator assembly 3019, include and control motion of the driving pin 62 and the turning pin 64, respectively. By way of example, the first actuator assembly 3018 may raise and lower the driving pin 62 relative to the frame 12. Similarly, the second actuator assembly 3019 may raise and lower the turning pin 64 relative to the frame 12.

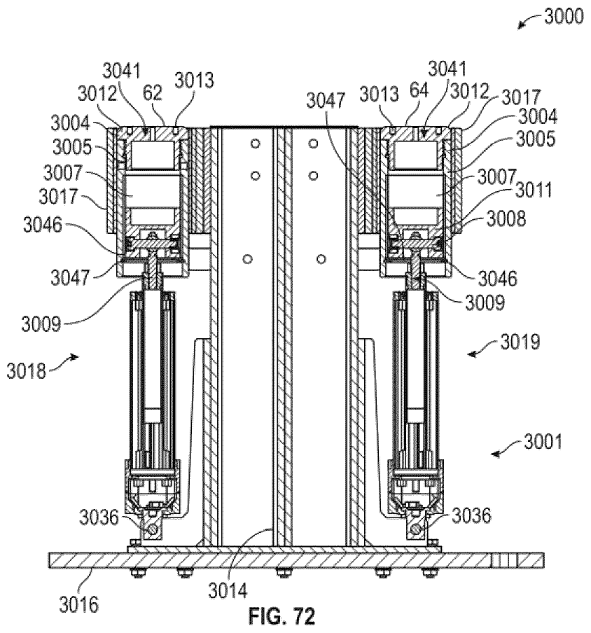

Referring to FIGS. 71 and 72, the frame assembly 3001 includes a central structural portion or base, shown as base frame 3014. The base frame 3014 connects and supports the other components of the frame assembly 3001. The base frame 3014 extends vertically from a lower end portion to an upper end portion.

The frame assembly 3001 further includes a pair of receivers, receiving cups, annular members, or support arms, shown as guiding sleeves 3017. The guiding sleeves 3017 are each fixedly coupled to a top end portion of the base frame 3014. A first one of the guiding sleeves 3017 extends longitudinally forward from the base frame 3014 and receives and supports the pin 62. The other of the guiding sleeves 3017 extends longitudinally rearward from the base frame 3014 and receives and supports the turning pin 64.

The base frame 3014 includes a base plate or mounting plate, shown as mounting interface 3016, that is fixedly coupled to a lower end of the base frame 3014. The mounting interface 3016 is directly and fixedly coupled to the frame 12 to couple the cart interface 3000 to the vehicle 10. The mounting interface 3016 and the mounting interface 702 may have similar mounting features to make the cart interface 3000 interchangeable with the cart interface 700. The mounting interface 3016 generally extends horizontally (e.g., within a horizontal plane). The base frame 3014 is fixedly coupled to the mounting interface 3016 and extends upward from a top surface of the mounting interface 3016.

Referring to FIGS. 70 and 71, the frame assembly 3001 further includes a pair of support structures, outriggers, or lateral frame arms, shown as support arms 3132. The support arms 3132 are each fixedly coupled to the upper end portion of the base frame 3014 and each extend laterally outward and downward from the base frame 3014. A distal end portion of each support arms 3132 is fixedly coupled to a top surface of the frame 12 of the vehicle 10. The support arms 3132 may increase the stability of the frame assembly 3001 and limit lateral movement of the driving pin 62 and the turning pin 64 relative to the frame 12 of the vehicle 10.

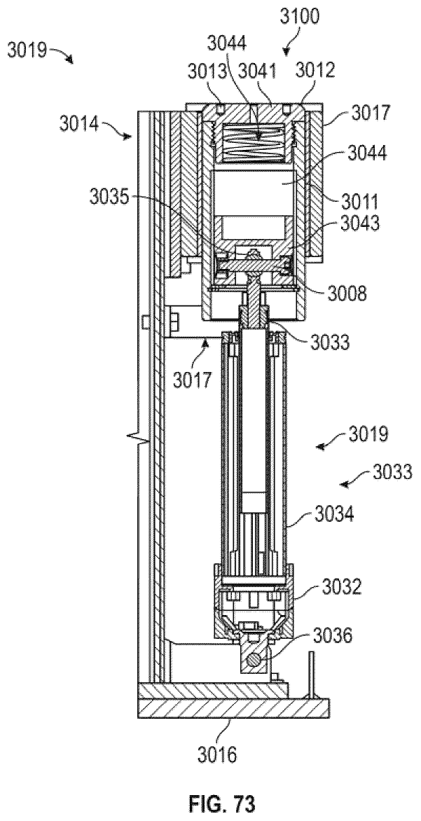

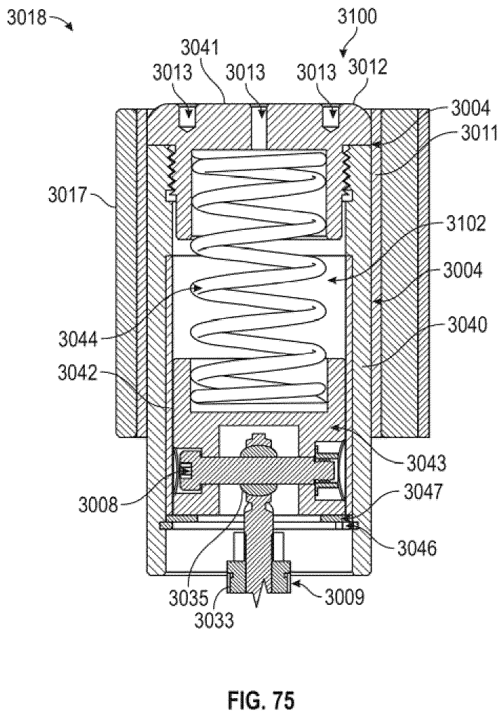

Referring to FIGS. 72, 73, and 75, the arrangements of the first actuator assembly 3018 and the second actuator assembly 3019 are shown according to an exemplary embodiment. Specifically, FIG. 72 shows both the first actuator assembly 3018 and the second actuator assembly 3019, FIG. 73 shows the second actuator assembly 3019, and FIG. 75 shows a portion of the first actuator assembly 3018. The first actuator assembly 3018 and the second actuator assembly 3019 may have similar constructions, such that the description of the components and layout of the first actuator assembly 3018 may similarly apply to the second actuator assembly 3019 and vice versa.

The first actuator assembly 3018 and the second actuator assembly 3019 each include a linear actuator (e.g., an electric linear actuator), shown as actuator 3030, and a protraction, pin, or sliding assembly, shown as pin assembly 3100. The actuator 3030 of the first actuator assembly 3018 may control raising and lowering of the pin assembly 3100 of the first actuator assembly 3018. Similarly, the actuator 3030 of the first actuator assembly 3018 may control raising and lowering of the pin assembly 3100 of the second actuator assembly 3019. The pin assembly 3100 of the first actuator assembly 3018 may serve as or include the driving pin 62. The pin assembly 3100 of the second actuator assembly 3019 may serve as or include the turning pin 64.

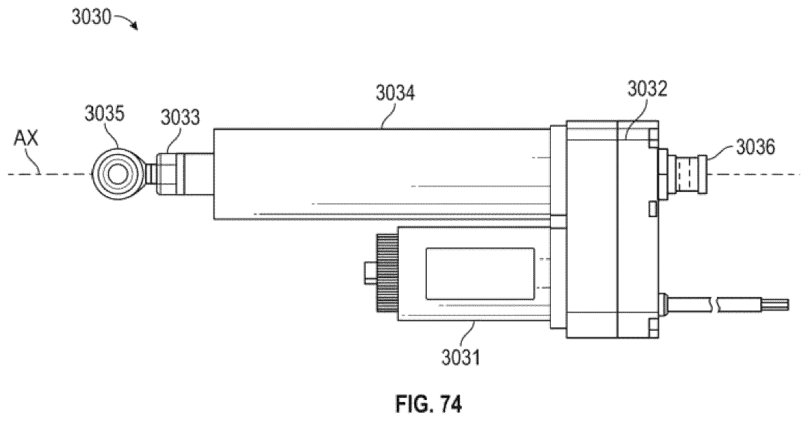

Referring to FIGS. 73 and 74, each of the actuators 3030 includes a motor 3031 (e.g., an electric motor, a hydraulic motor, a pneumatic motor, etc.), a power transmission or gearbox, shown as transmission 3032, a rod 3033, and a housing, shown as body 3034. The motor 3031 is coupled to the rod 3033 by the transmission 3032. The rod 3033 is slidably coupled to the body 3034, such that the rod 3033 is received within the body 3034 in a telescoping arrangement. Operation of the motor 3031 causes the rod 3033 to extend and retract relative to the body, varying an overall length of the actuator 3030. The rod 3033 has a first actuator interface 3035 at a first end of the actuator 3030 which is pivotably coupled to the first pin assembly 3002. The body 3034 has a second actuator interface 3036 at a second end of the actuator 3030 that is pivotably coupled to the frame assembly 3001 (e.g., to the base frame 3014).

In operation, the motor 3031 rotates to extend and retract the first actuator 3030 along an axis AX that is centered along the rod 3033 and the body 3034. Rotational mechanical energy from the motor 3031 may be transferred to the actuator rod 3009 by the transmission 3032. The motor 3031 my rotate in a first direction to extend the actuator 3030 outwards and raise the pin assembly 3100. The motor 3031 may rotate in an opposing second direction to retract the actuator 3030 inward and lower the pin assembly 3100. The actuator 3030 may be continuously repositionable throughout a range of motion between a fully retracted position and a fully extended position. In some embodiments (e.g., where the actuator rod 3009 includes a screw that is rotated to extend and retract the actuator rod 3009), the motor 3031 is capable of holding the actuator 3030 at any desired position within the range of motion.

Operation of the motor 3031 may be controlled by the controller 102. By way of example, the controller 102 may supply electrical energy from the batteries 110 to the motor 3031 to control operation of the motor 3031. The controller 102 may control the speed and direction of the actuator 3030 and whether the actuator 3030 is holding its current position. In some embodiments, a sensor 112 (e.g., an encoder, a linear potentiometer, etc.) provides sensor data indicating a current extended length of the actuator 3030. This sensor data may be used by the controller 102 to provide closed-loop control over the length of the actuator 3030.

Referring to FIGS. 73 and 75, each pin assembly 3100 includes an annular member, shown as pin body 3040, and an upper member, shown as pin cap 3012. The first pin body 3040 has an annular outer surface, such that the first pin body 3040 is substantially cylindrical. The threaded pin cap 3012 is in threaded engagement with the first pin body 3040, such that the first pin body 3040 is fixedly coupled to the threaded pin cap 3012. Together, the first pin body 3040 and the threaded pin cap 3012 define an internal volume 3102 (e.g., an internal pin volume) of the pin assembly 3100. The pin cap 3012 has a top surface 3041. A series of recesses or passages, shown as spanner wrench passages 3013, extend vertically downward from the top surface 3041 and into the threaded pin cap 3012. The spanner wrench passages 3013 permit engagement between a spanner wrench or other levering tool and the threaded pin cap 3012 to facilitate tightening or loosening the threaded connection between the threaded pin cap 3012 and the first pin body 3040.

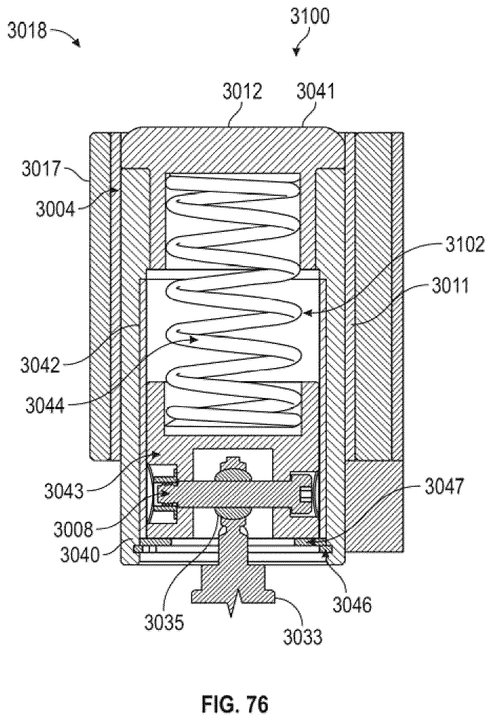

Referring to FIG. 76, an alternative embodiment of the pin assembly 3100 is shown according to an exemplary embodiment. Specifically, FIG. 76 illustrates an alternative attachment configuration of the threaded pin cap 3012 to the first pin body 3040. The pin assembly 3100 of FIG. 76 may be used in place of any of the other pin assemblies 3100 disclosed herein. In the embodiment of FIG. 76, the first pin cap 3012 is shown as being inserted and welded into the first pin body 3040. By welding the threaded pin cap 3012 to the first pin body 3040, the spanner wrench passages 3013 may be omitted.

Referring again to FIGS. 73 and 76, each guiding sleeve 3017 receives a bushing member or friction-reducing member, shown as bearing 3011, that is fixedly coupled to the guiding sleeve 3017. By way of example, the bearing 3011 may be or include a composite material. The bearing 3011 defines a vertical passage or aperture, shown as pin passage 3004, that extends vertically from a top surface of the guiding sleeves 3017 to a bottom surface of the guiding sleeves 3017. The pin assembly 3100 is received within the pin passage 3004. The bearing 3011 slidably couples the pin assembly 3100 to the guiding sleeve 3017, such that the pin assembly 3100 is slidable (e.g., vertically, up and down, etc.) along the length of the pin passage 3004. The bearing 3011 may limit lateral and longitudinal movement of the pin assembly 3100, maintaining the orientation of the pin assembly 3100 within the pin passage 3004. Accordingly, the pin assembly 3100 may remain centered within the pin passage 3004 while being translatable along the axis AX.

The pin body 3040 receives a bushing member or friction-reducing member, shown as bearing 3042, fixedly coupled to the first pin body 3040. The bearing 3042 may be annular and may define a circumference of the internal volume 3102. The bearing 3042 may form the internal volume 3102 as a vertical passage or aperture that is centered within the pin passage 3004 and the pin body 3040.

An adapter, sliding member, sliding element, or cup, shown as spring cup 3043, is received within the internal volume 3102. Specifically, the spring cup 3043 is received within the bearing 3042. The bearing 3042 may facilitate relative vertical movement of the first pin body 3040 and the spring cup 3043. Accordingly, the spring cup 3043 may move along a length of the internal volume 3102.

The spring cup 3043 is coupled to the first actuator interface 3035 by a fastener, shown as shoulder bolt 3008. The shoulder bolt 3008 extends laterally through the spring cup 3043 and through an aperture defined by the first actuator interface 3035 of the actuator rod 3009. The shoulder bolt 3008 may be in threaded engagement with a portion of the spring cup 3043 to fixedly couple the shoulder bolt 3008 to the spring cup 3043. The shoulder bolt 3008 may pivotably couple the spring cup 3043 to the end of the actuator rod 3009, such that the spring cup 3043 moves with the actuator rod 3009 as the actuator 3030 extends and retracts.

A biasing element, shown as compression spring 3044, is received within the internal volume 3102 between the threaded pin cap 3012 and the spring cup 3043. The spring cup 3043 defines a first recess that receives a first, lower end of the compression spring 3044. The threaded pin cap 3012 defines a second recess that receives a second, upper end of the compression spring 3044. The compression spring 3044 couples the pin assembly 3100 to the spring cup 3043 and the actuator 3030 while permitting movement of the pin assembly 3100 relative to the first pin assembly 3002. The compression spring 3044 applies an upward biasing force onto the threaded pin cap 3012 that forces the threaded pin cap 3012 away from the spring cup 3043. Accordingly, the compression spring 3044 biases the first pin assembly 3002 upward.

The first pin assembly 3002 further includes a fastener or snap ring, shown as internal circlip 3046, that is received within an annular groove along an inner surface of the first pin body 3040. The annular groove limits vertical movement of the internal circlip 3046. A washer or spacer, shown as spacer 3047, is positioned within the internal volume 3102 between the internal circlip 3046 and the spring cup 3043. Accordingly, engagement between the bottom portion of the spring cup 3043 and the top portion of the spacer 3047 and engagement between and the top portion of the internal circlip 3046 and the bottom portion of the spacer 3047 limit downward movement of the spring cup 3043 relative to the first pin body 3040. Accordingly, the internal circlip 3046 and the spacer 3047 limit extension of the compression spring 3044.

Referring to FIGS. 72 and 77-82, in operation, the actuators 3030 of the first actuator assembly 3018 and the second actuator assembly 3019 reposition the driving pin 62 and turning pin 64 to engage the cart 600. The actuators 3030 may be controlled by the controller 102 (e.g., autonomously, manually, according to a predefined set of instructions, etc.). The actuators 3030 may be independently controlled by the controller 102, such that operation of the first actuator assembly 3018 is independent of operation of the second actuator assembly 3019. By way of example, the actuator 3030 of the first actuator assembly 3018 may reposition the driving pin 62 without requiring movement of the turning pin 64 (e.g., regardless of whether the turning pin 64 is moving or stationary). Similarly, the actuator 3030 of the second actuator assembly 3019 may reposition the turning pin 64 without requiring movement of the driving pin 62 (e.g., regardless of whether the driving pin 62 is moving or stationary).

Throughout operation, a downward force may be applied to each pin assembly 3100 (e.g., on the top surface 3041) to cause compression of the compression spring 3044, permitting the first pin body 3040 to move downward relative to the spring cup 3043. The compression spring 3044 resists this movement so that when downward force is removed, the biasing force of the compression spring 3044 causes the pin assembly 3100 to return to its original position where the bottom portion of the spring cup 3043 is engaged with the internal circlip 3046 and the spacer 3047. Accordingly, the actuators 3030 may raise and lower the driving pin 62 and the turning pin 64, but the driving pin 62 and the turning pin 64 may be forced downward or biased upward without requiring movement of the actuator 3030.

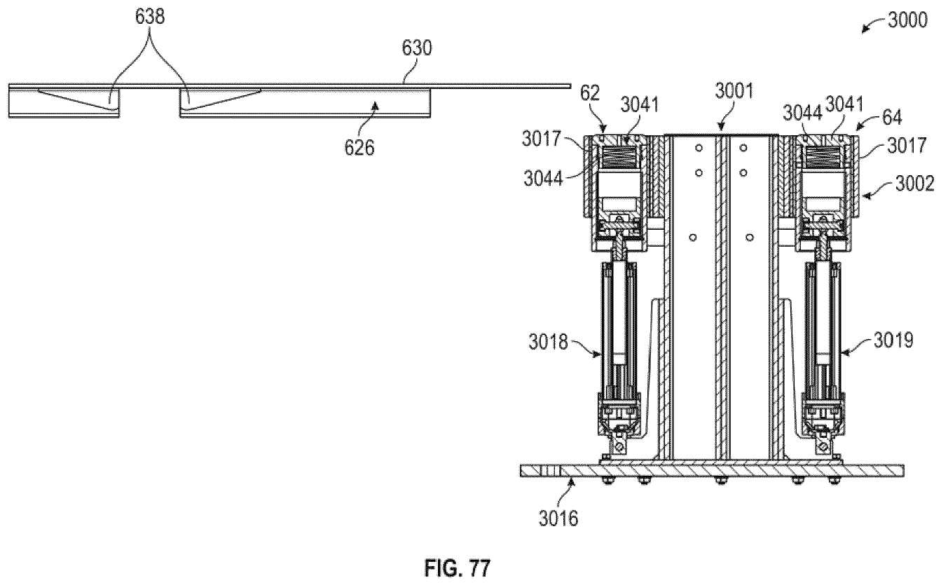

Referring to FIGS. 77-82, a process or method of connecting the cart interface 3000 with the cart 600 is shown according to an exemplary embodiment. The process may be similar to the process used to engage the cart interface 700 with the cart 600, except as otherwise specified herein.

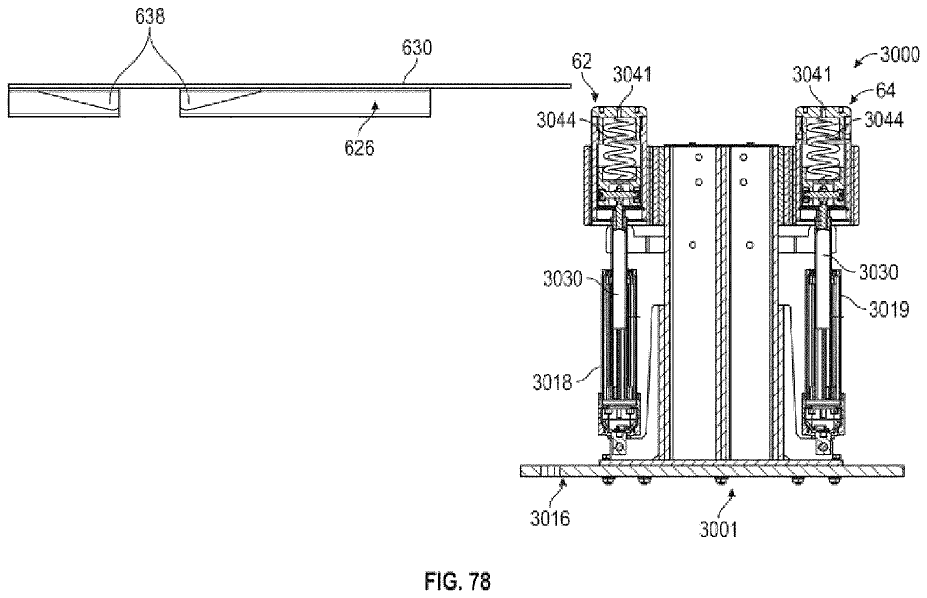

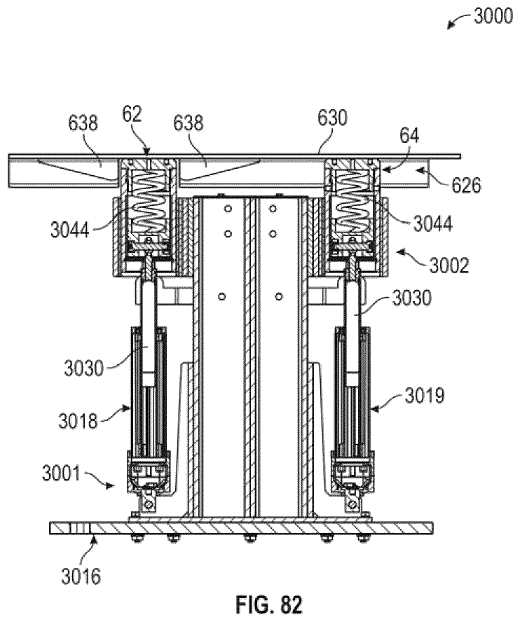

Throughout this process, the actuators 3030 move the pin assemblies 3100 to three different positions: a lowered position (e.g., shown in FIG. 77), an intermediate position or engagement position (e.g., shown in FIG. 78), and a raised position or lifting position (e.g., shown in FIG. 82). In the lowered position, the pin assemblies 3100 are offset below the cart 600, such that the vehicle 10 may drive beneath the cart 600 without engaging the cart 600. In the intermediate position, the pin assemblies 3100 are raised to a height where pin assemblies 3100 may be received within the channels 626, but where the pin assemblies 3100 still are not high enough to contact the plate 630. In the raised position, the pin assembly 3100 are raised sufficiently to engage the plate 630.

FIG. 77 shows the cart interface 3000 disconnected from the cart 600. In this configuration, the driving pin 62 and the turning pin 64 are in respective lowered positions, which lowers the overall height of the vehicle 10 such that the vehicle 10 can drive freely beneath the cart 600 without coming into contact with the cart 600.

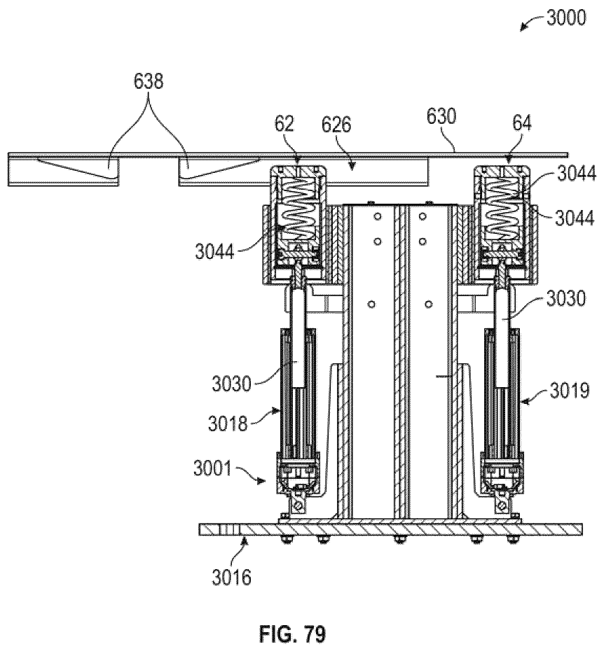

FIG. 78 illustrates the cart interface 3000 separated from the cart 600 with the driving pin 62 and the turning pin 64 raised to the intermediate position. In the intermediate position, the driving pin 62 and the turning pin 64 are at a sufficient height to be received within the channel 626. In the configuration of FIG. 79, the vehicle 10 has driven toward the cart 600, such that the driving pin 62 and the turning pin 64 are received within the channel 626.

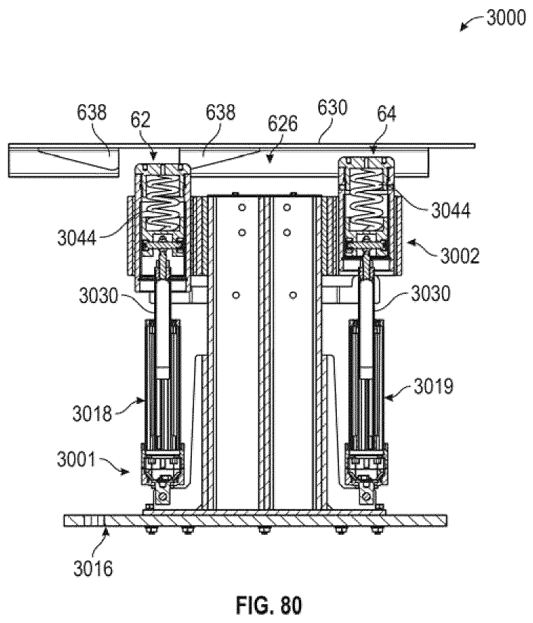

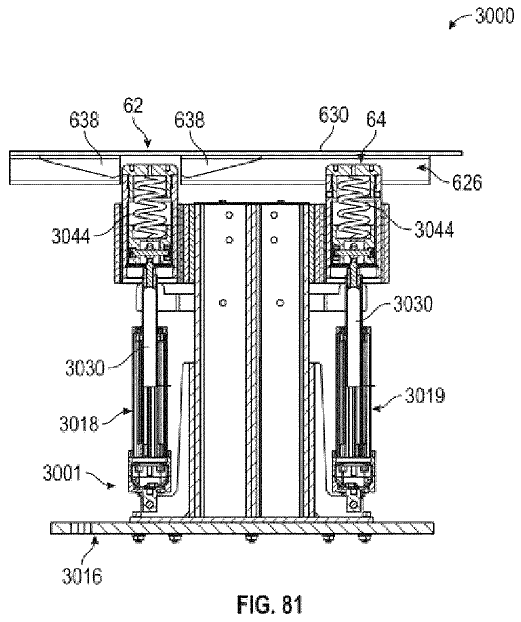

In the configuration of FIG. 80, the vehicle 10 is driven forward until the driving pin 62 engages a positioning member 638. The driving pin 62 is forced downward by contact with the positioning member 638, and the compression spring 3044 of the driving pin 62 is forced to compresses, permitting the driving pin 62 to move downward without adjusting the extended length of the actuator 3030.

In the configuration of FIG. 81, the vehicle 10 drives forward until the driving pin 62 aligns with the space between the positioning members 638. The driving pin 62 is captured between the positioning members 638, and the turning pin 64 is captured within the channel 626, such that movement of the cart 600 relative to the cart interface 3000 is limited (e.g., prevented).

In the configuration of FIG. 82, the driving pin 62 and the turning pin 64 are raised to the raised position, such that the driving pin 62 and the turning pin 64 push upward on the bottom surface of the plate 630. This causes a portion of the weight of the cart 600 and the objects supported by the cart 600 to be supported by the vehicle 10, which in turn increases traction of the tractive elements 44.

To disengage the cart interface 3000 from the cart 600, the actuators 3030 may return the driving pin 62 and the turning pin 64 to the lowered positions. Lowering the turning pin 64 without lowering the driving pin 62 may permit rotation of the vehicle 10 relative to the cart 600 about the substantially vertical axis 636 while still limiting translation of the cart 600 relative to the vehicle 10. Lowering both the driving pin 62 and the turning pin 64 may completely disengage the cart interface 3000 from the cart 600.

### Sensing System and Sensor Configuration

Referring generally to the figures, an autonomous vehicle system includes a vehicle having a control system, a base assembly, and one or more tractive elements. A sensor system is coupled to the vehicle. The sensor system is configured to detect one or more objects located in an area near the vehicle and communicate the detection of the one or more objects to the control system. Based on receiving the communication regarding the detection of the one or more objects, the control system is configured to generate one or more controls for one or more of the base assembly or the one or more tractive elements. The control system is further configured to send the one or more controls to the one or more of the base assembly or the one or more tractive elements.

The sensors 112 of the vehicle 10 may facilitate autonomous navigation of the vehicle 10 throughout the manufacturing environment without the need for guide wires or other physical guiding devices, dedicated travel lanes, floor markings, etc. The sensors 112 may operate at a distance from any potentially sensed object, and no contact is required between the sensors 112 and an object to be sensed.

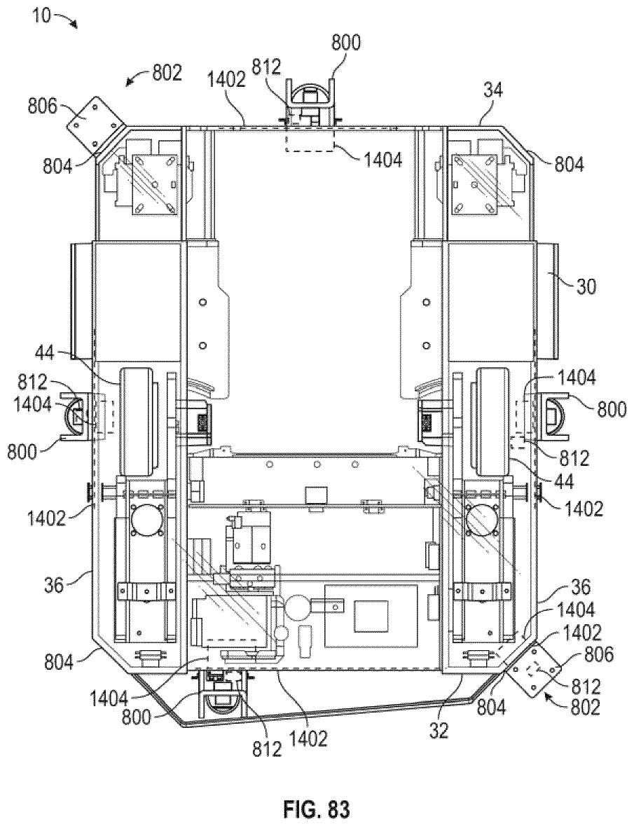

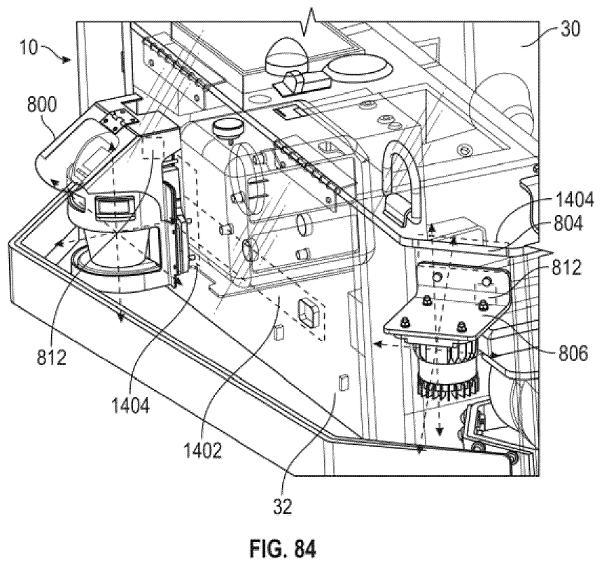

Turning now to FIGS. 83 and 84, the sensors 112 include short-range sensors 800 and long-range sensors 802 positioned around the exterior or perimeter of body of the vehicle 10. Each of the sensors 800 and sensors 802 may be movable coupled to the vehicle 10, such that the position of the sensor 800, 802 can be adjusted (e.g., manually, automatically) in response to one or more events such as an obstruction in a sensor 800, 802 field of view. According to an exemplary embodiment, the sensors 112 include one or more sensors 112 positioned about the frame 12, the drive modules 14, the controls enclosure 16, the back plate 18, and/or any other component of the vehicle 10 to acquire information or data relating to the operation of the vehicle 10 and the one or more components thereof. The sensors 112 may include any type of distance, proximity, image, and/or object sensors, such as one or more light curtain sensors, ultrasonic sensors, laser sensors, visible light cameras, full-spectrum cameras, light detection and ranging (LIDAR) cameras/sensors, radar sensors, infrared cameras, image sensors (e.g., charged-coupled device (CCD), complementary metal oxide semiconductor (CMOS) sensors, etc.), or any other type of suitable distance sensor, proximity sensor, or imaging device. In some embodiments, short-range sensors 800 are light curtain sensors, and the long-range sensors 802 are LIDAR sensors. In other embodiments, the short-range sensors 800 are ultrasonic sensors.

Data captured by or acquired using the short-range sensors 800 and the long-range sensors 802 may include, for example, data that may be used (e.g., by the controller 102) to determine a proximity of the vehicle 10 or any component of the vehicle 10 to an object (e.g., an obstacle, a wall, a person, etc.) while the vehicle 10 is stationary or in motion. By way of another example, data captured by the short-range sensors 800 and the long-range sensors 802 may include data that may be used to detect objects near or around the vehicle 10 or any component of the vehicle 10. In some embodiments, the data captured by the short-range sensors 800 and the long-range sensors 802 may be used to determine a state in which the vehicle 10 and/or any component of the vehicle 10 are operating. By way of example, the short-range sensors 800 and the long-range sensors 802 may be configured to acquire data to facilitate monitoring operation of the actuators 116, and such data may be used to determine whether the lift assembly 54 is in an extended position, a retracted position, any other position therebetween, and/or whether the lift assembly 54 is in the process of extending or retracting. By way of another example, the short-range sensors 800 and the long-range sensors 802 may be configured to acquire data to facilitate monitoring an orientation of the lift assembly 54 including a decline or depression angle, a rotation angle, and/or incline angle of the lift assembly 54.

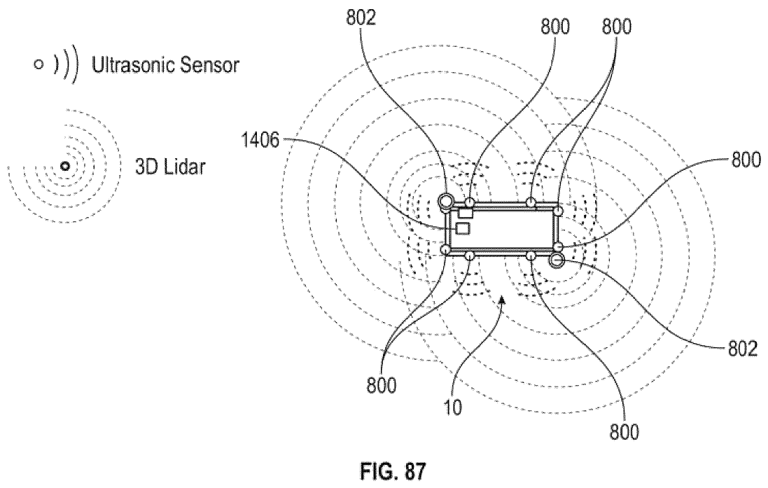

In the embodiment of FIG. 83, four of the short-range sensors 800 are shown positioned around the vehicle 10. Specifically, a first short-range sensor 800 is positioned along a front side of the vehicle 10 (e.g., the front surface 32). This short-range sensor 800 is laterally offset from a longitudinal centerline of the vehicle 10. A second short-range sensor 800 is positioned along a rear side of the vehicle 10 (e.g., the rear surface 34). This short-range sensor 800 is substantially laterally centered on the vehicle 10 (e.g., positioned along the longitudinal centerline). A third short-range sensor 800 is positioned along a left side of the vehicle 10 (e.g., a side surface 36), and a fourth short-range sensor 800 is positioned along a right side of the vehicle 10 (e.g., a side surface 36). The third and fourth short-range sensors 800 may be substantially longitudinally centered on the vehicle 10. This arrangement may permit the short-range sensors 800 to monitor the entire area surrounding the vehicle 10 (e.g., providing 360-degree coverage without any blind spots). FIG. 87 illustrates an alternative embodiment including eight of the short-range sensors 800.

The short-range sensors 800 may be considered secondary sensors to the long-range sensors 802, discussed further herein. The four short-range sensors 800 are each positioned on front, rear, left, and right sides of the vehicle 10. The short-range sensors 800 are oriented to perform sensing operations for areas in front of the vehicle 10, behind the vehicle 10, and/or to the sides of the vehicle 10. In other embodiments, fewer or more than four of the short-range sensors 800 may be included and/or the short-range sensors 800 may positioned or oriented differently. For example, the vehicle 10 may have eight of the short-range sensors 800, with two of the short-range sensors 800 positioned on each of the front, rear, left, and right sides of the vehicle.

In some embodiments, the short-range sensors 800 are light curtain sensors. The light curtain sensors may use an array of photoelectric beams to detect intrusion into a space (e.g., a sensing field, a plane, a curtain, etc.). An intrusion may be detected when an object interrupts one or more of the photoelectric beams within the sensing field. When an intrusion is detected, the light curtain sensors may send a signal (e.g., to the control system 100, etc.) to limit (e.g., cease) operations of the vehicle 10.

In some embodiments, the short-range sensors 800 are ultrasonic sensors. The ultrasonic sensors may use a transducer to send and receive ultrasonic pulses (e.g., sound waves, etc.) that relay information back to the ultrasonic sensor regarding the proximity of an object. The ultrasonic sensors may measure distances of objects sensed in various directions around the vehicle 10. In order to determine a direction (e.g., an angular position, etc.) in which the object was sensed at a distance away from the vehicle 10, multiple ultrasonic sensors may be used (e.g., overlapping, etc.). The multiple ultrasonic sensors may communicate to triangulate the location of the object and thereby determine the distance and position of the object relative to the vehicle 10. For example, the multiple ultrasonic sensors may each measure a distance of an object from the vehicle 10 and transmit the distance to the control system 100 or another computing device, which may mathematically calculate a location of the object, including a direction of the object.

The long-range sensors 802 may have a longer range or larger field of view than the short-range sensors 800 and may be able to detect objects at further distances from the vehicle 10 than the short-range sensors 800. As shown in FIG. 83, two of the long-range sensors 802 are positioned on opposite corners of the vehicle 10. For example, as seen from a top view, one of the long-range sensors 802 may be positioned on a front left corner of the vehicle 10, and another one of the long-range sensors 802 may be positioned on a rear right corner of the vehicle 10. In other embodiments, the long-range sensors 802 may be positioned or oriented differently.

Each corner of the frame 12 defines an angled or chamfered surface 804 extending between (a) the front surface 32 or the rear surface 34 and (b) one of the side surfaces 36. The chamfered surfaces 804 extend at approximately a 45-degree angle relative to the adjacent surfaces. Each of the long-range sensors 802 is coupled to one of the chamfered surfaces 804 by a bracket 806, and the long-range sensor 802 extends below the corresponding bracket 806. By including the chamfered surfaces 804 that are angled relative to the front surface 32, the rear surface 34, and the side surfaces 36, the frame 12 is prevented from obstructing the fields of view of the long-range sensors 802. Accordingly, the chamfered surfaces 804 facilitate full sensor coverage around the vehicle 10 with only two long-range sensors 802.

In some embodiments, the long-range sensors 802 are LIDAR sensors. The LIDAR sensors may use light in the form of a rapidly firing laser (e.g., pulsed, strobed, etc.) to measure distances of objects from the vehicle 10. The light is sent from a source (e.g., a transmitter, etc.) and is reflected by objects. The reflected light is detected by a receiver, and the amount of time taken for the light to travel back to the receiver (e.g., time of flight (TOF), time delay, etc.) is recorded. The reflected light and the recorded amount of time are used to develop a three-dimensional (3D) map of the area surrounding the LIDAR sensor, including any objects present.

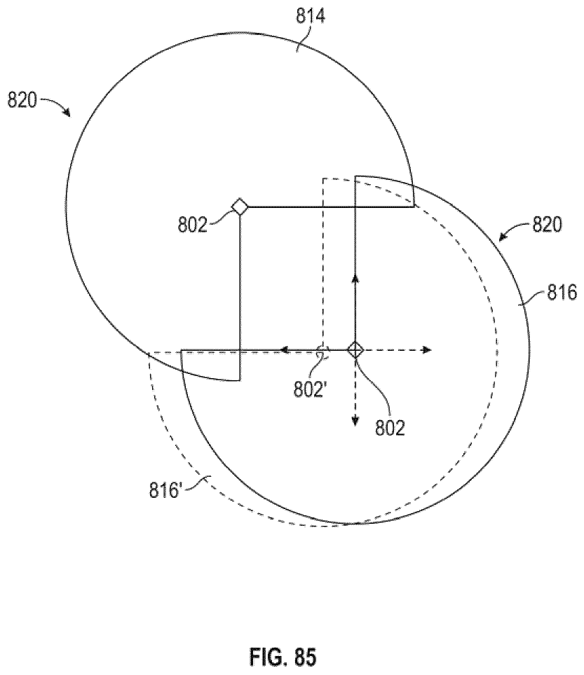

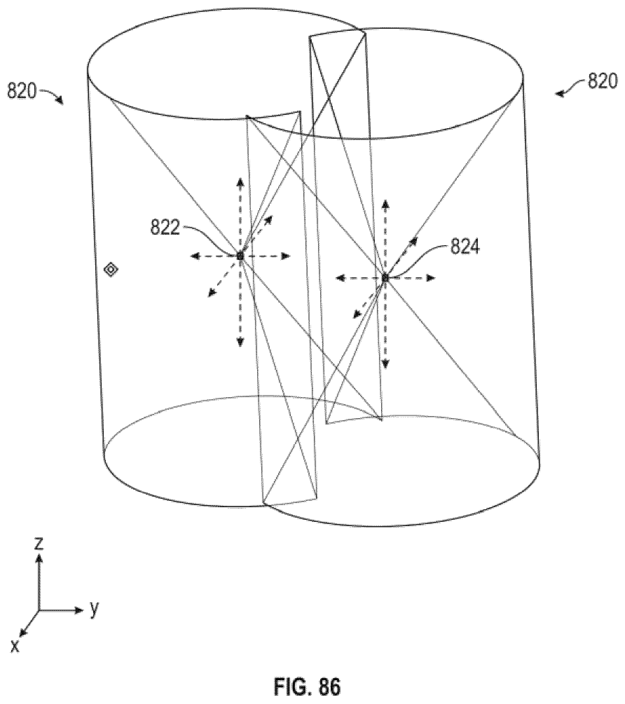

The long-range sensors 802 may generate a point map (e.g., a three-dimensional map of the surroundings) to facilitate navigation of the vehicle 10. In the sensor configuration of FIG. 83, exemplary sensing fields 820 (e.g., fields of view) for the long-range sensors 802 are shown in FIGS. 85 and 86. As depicted in FIG. 85, for which FIG. 86 is a 3D view, each of the long-range sensors 802 may be oriented in opposite directions, substantially symmetrically sensing in opposing directions to cover a 360-degree field of view. For example, one of the long-range sensors 802 may be coupled to the vehicle 10 at point 822 (e.g., a front left corner of the vehicle 10), and another one of the long-range sensors 802 may be coupled to the vehicle at point 824 (e.g., a rear right corner of the vehicle 10). Each of the long-range sensors 802 may have a field of view of approximately 270 degrees as seen from above (e.g., as shown in FIG. 85). For example, the long-range sensor 802 located at the point 822 may have a field of view including the areas in front of the vehicle 10 and to the left side of the vehicle 10. The long-range sensor 802 located at the point 824 may have a field of view including the areas behind the vehicle 10 and to the right side of the vehicle 10. Together, the long-range sensors 802 have a 360-degree field of view in all directions around the vehicle 10.

The long-range sensors 802 may also facilitate locating a position of the vehicle 10 within an environment. For example, the point map generated by the long-range sensors 802 may map the environment surrounding the vehicle 10 and allow the long-range sensors to determine the position of the vehicle 10 within the environment. In another example, the control system 100 may receive a pre-generated map from a remote device 134, and may compare data from the pre-generated map to data gathered by the long-range sensors 802. The comparison of data between the pre-generated map and the long-range sensors may allow the control system 100 to determine the position of the vehicle 10 within the environment.

The sensors 112, including the short-range sensors 800 and the long-range sensors 802, may function to limit operations of the vehicle 10. For example, if the vehicle 10 is stationary and the short-range sensor 800 or the long-range sensor 802 positioned on the front of the vehicle 10 detects an object within the corresponding sensing field, the short-range sensor 800 or the long-range sensor 802 may send a signal to the control system 100 to prevent the vehicle 10 from moving in a forward direction. The vehicle 10 may remain stationary until the object is removed from the path of the vehicle 10. By way of another example, if the vehicle 10 is driving forward and the short-range sensor 800 or the long-range sensor 802 detects an object within the corresponding sensing field, the short-range sensor 800 or the long-range sensor 802 may send a signal to the control system 100 to cease driving operations of the vehicle 10 such that the vehicle 10 comes to a stop. The vehicle 10 may remain at a stop until the object is removed from the path of the vehicle 10, at which time the vehicle 10 may resume motion and proceed forward again.

In general, the short-range sensors 800 are responsible for controlling movement of the vehicle 10 in response to the detection of an object. The long-range sensors 802 are generally responsible for mapping an environment surrounding the vehicle 10 and determining a position of the vehicle 10 in the environment. When the short-range sensors 800 detect an object, the short-range sensors may function to limit operations of the vehicle 10 in various manners. For example, the short-range sensors 800 may stop all movement of the vehicle 10 when an object is detected, or may stop movement of the vehicle 10 only in the direction in which the short-range sensor 800 detected the object. By way of another example, the short-range sensors 800 may function to reduce the speed of the vehicle 10 in response to detecting an object. The short-range sensors 800 may also function to limit or control any other operation of the vehicle 10 such as steering, lifting, etc.

As shown in FIG. 87, the short-range sensors 800 and the long-range sensors 802 may work together in combination with overlapping fields of view to facilitate navigating or driving functions and obstacle avoidance. The long-range sensors 802 may provide a wider field of view, but may experience blind spots at shorter ranges due to a non-zero minimum detection distance. The short-range sensors 800 offer reliable detection capabilities within a short range, and can provide intelligence in the blind spots of the long-range sensors 802.

The vehicle 10 may include a lighting system or other visual or auditory alert system, shown in FIG. 87 as alert system 1406, to provide alerts or information regarding the status of operation of the vehicle 10. For example, during normal operating conditions and while performing a task such as driving, the vehicle 10 may display one or more green lights via the alert system 1406. If there is an object in the path of the vehicle 10, an obstacle obstructing the movement of the vehicle 10, or another condition resulting in halted operation of the vehicle 10, the vehicle 10 may display one or more red lights via the alert system 1406. The vehicle 10 may display other colored lights via the alert system 1406 such as one or more yellow lights, for example, if the vehicle 10 is resuming or about to resume operation after a period of halted operation, or as another example, if the vehicle 10 is proceeding with caution after the removal of the object or obstacle. In some embodiments, the alert system 1406 may be an electronic message board, sounds (e.g., beeping, an alarm, spoken words or phrases, etc.), etc. The alert system 1406 or the vehicle 10 may require a manual reset upon the changing of conditions of operation of the vehicle 10, or any such reset may be performed automatically by the vehicle 10. For example, the one or more lights of the alert system 1406 on the vehicle 10 may turn red upon the detection of an object in the path of the vehicle 10 while the vehicle 10 is driving, and may remain red until the object is removed or the path otherwise becomes clear, at which time the one or more lights on the vehicle 10 may automatically turn green and the vehicle 10 may begin driving again.

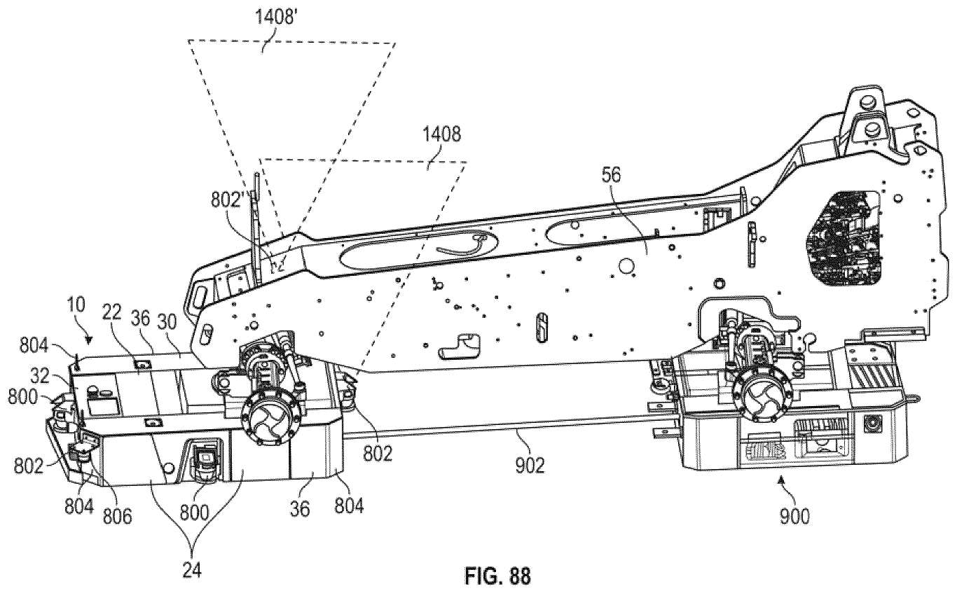

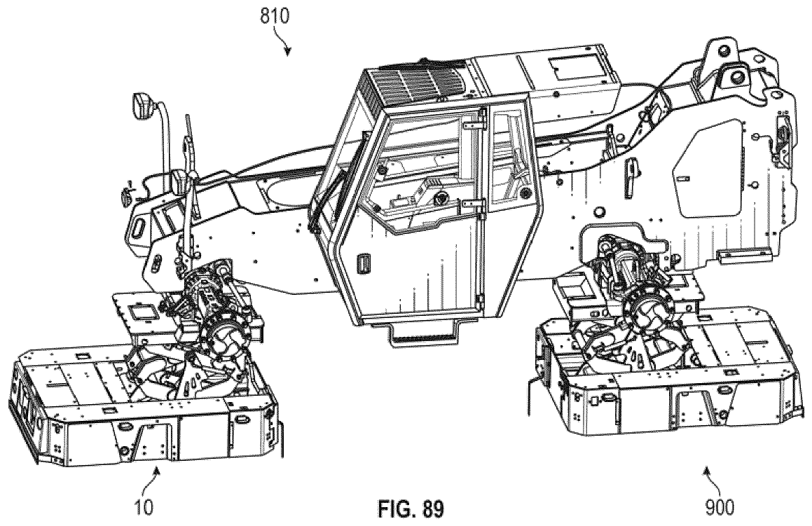

Turning now to FIGS. 88 and 89, in some embodiments, the vehicle 10 may be working in connection with another vehicle 10, or in some embodiments, the vehicle 10 may have a skate 900 coupled to the vehicle 10 by a tow bar 902. The skate 900 may include many of the same features as the vehicle 10, such as the base assembly 48, the lifting implement 50, etc., but may not include other features. For example, the skate 900 may not have the drivetrain 40 and may not possess any means of driving. As another example, the skate 900 may or may not include any of the sensors 112.

The skate 900 may be pulled or towed behind the vehicle 10. As such, the skate 900 may only move in a forward direction. In this respect, an object located behind or to the sides of the skate 900 may not trigger one or more of the sensors 112 to halt operation of the vehicle 10. If an object is present in a location between the vehicle 10 and the skate 900, the short-range sensors 800 and the long-range sensors 802 of the vehicle 10 may detect the object and may halt operation of the vehicle 10, thereby ceasing movement of the skate 900.

The vehicle 10 and the skate 900 may together support a load 810. The load 810 may be a component, a machine, an assembly, a product, a tool, etc. As shown in FIG. 89, the load 810 may be at least partially supported by each of the vehicle 10 and the skate 900. The vehicle 10 and the skate 900 may transport the load 810 between various locations in a production environment.

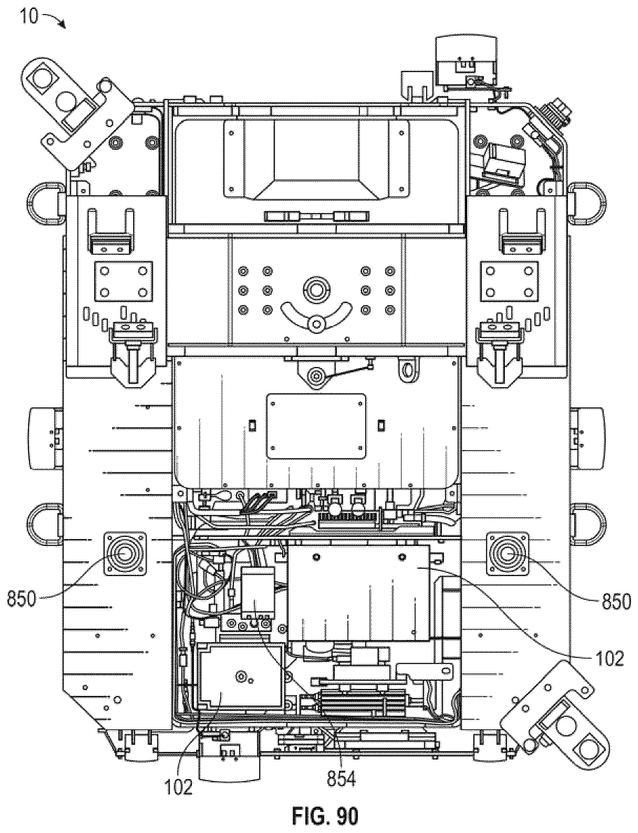

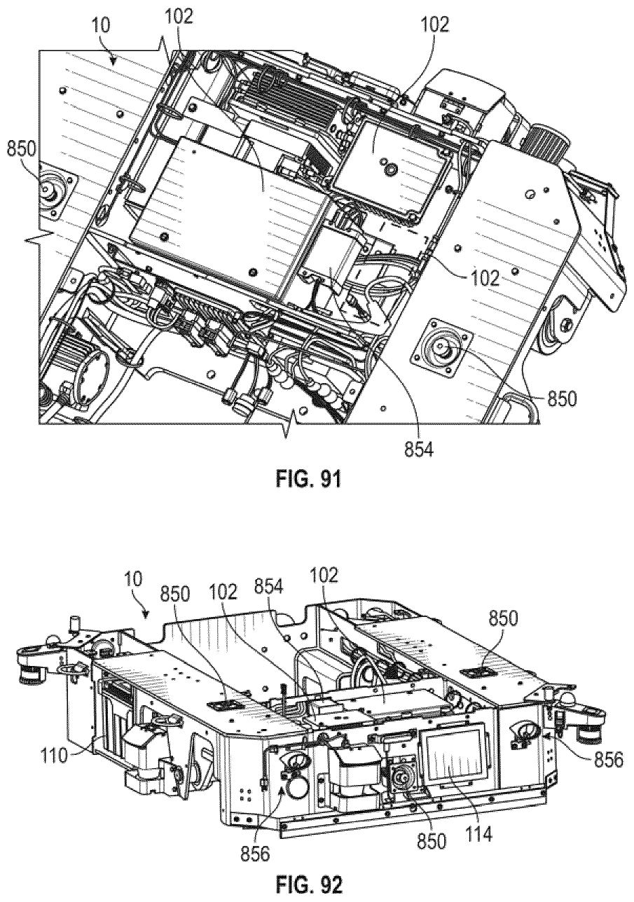

Turning now to FIGS. 90-94, the vehicle 10 as previously described herein is shown according to additional embodiments. The vehicle 10 may include emergency stop buttons 850 as part of user interface 114 which may be pressed by an operator to stop functions of the vehicle 10 in the event of an emergency. As shown in the top view of FIGS. 90 and 91, the vehicle 10 includes the controller 102 coupled to the vehicle 10 within a recess in a top surface of the vehicle 10. The controller 102 may include an autonomy controller, a controller linking the vehicle 10 to the production environment, a hydraulic pump controller, etc. Another device coupled to the vehicle 10 within the recess and/or as part of the controller 102 is an inertial measurement unit 854. A panel may cover the recess to protect the components contained within the recess.

Positioned on a front side of the vehicle 10 may be one or more headlights 856 configured to illuminate the area in front of the vehicle 10. The headlights 856 may also indicate the direction of travel for the vehicle 10. The vehicle 10 also includes a user interface 114 with screen (e.g., a touchscreen, etc.) which may provide information accessible by an operator and may receive input from the operator. Although the user interface 114 is shown on the front side of the vehicle 10, the user interface 114 may be positioned anywhere on the vehicle 10. Additionally, the vehicle 10 may include one or more batteries 110 which may be positioned on a side of the vehicle 10, or anywhere else on the vehicle 10. The batteries 110 may be rechargeable or replaceable.

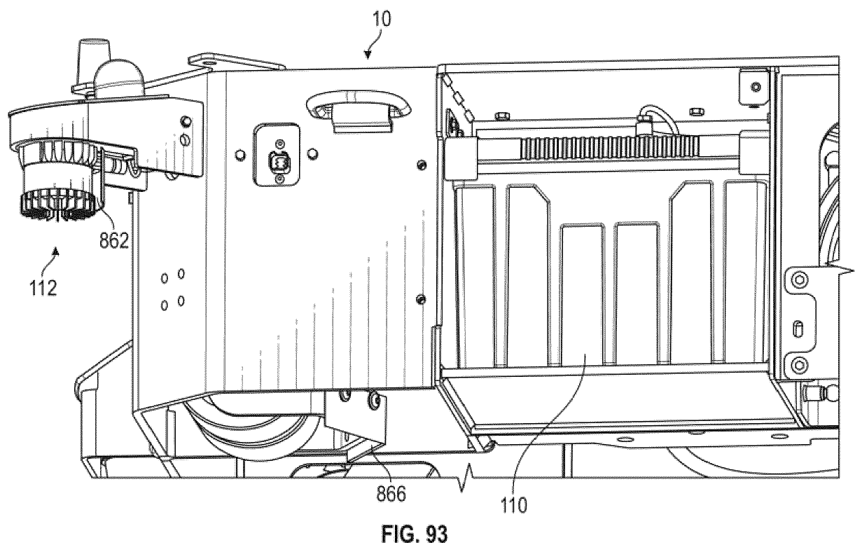

As shown in FIG. 93, the vehicle 10 may include one of the sensors 112 positioned near the front of the vehicle 10. In the example as shown in FIG. 93, the sensor 112 may be a LIDAR sensor. Positioned behind the sensor 112 may be a shield 862. The shield 862 may be, for example, a reflective shield that prevents the sensor 112 from detecting the body of the vehicle 10.

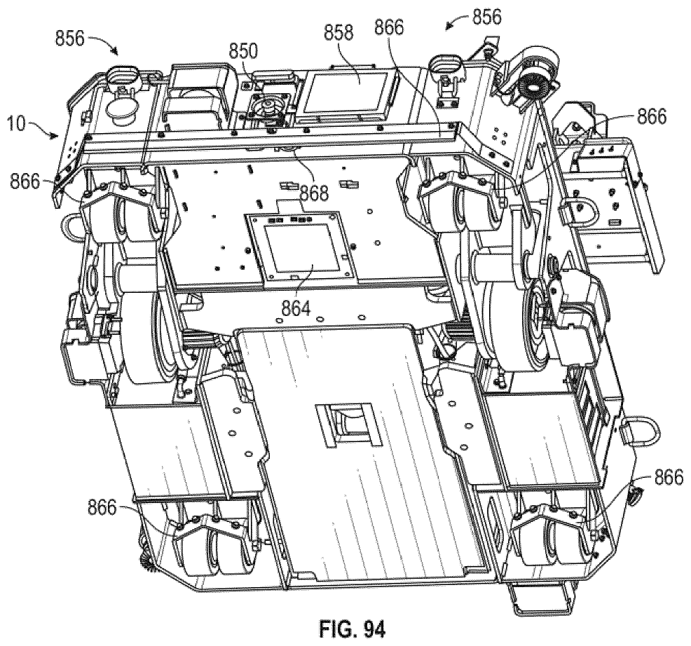

FIG. 94 depicts a bottom view of the vehicle 10, including a wireless charging pad 864. In some embodiments, the vehicle 10 may be able to drive over or be otherwise positioned over the wireless charging pad 864 for easy recharging. Also positioned on the bottom of the vehicle 10 are one or more wipers 866 (e.g., brushes, sweepers, etc.). The wipers 866 may be positioned generally in front of the vehicle 10 and in front of the tractive elements of the vehicle 10. The wipers 866 may be in contact with the ground and may be configured to push debris out of the way of the vehicle 10. Additionally positioned on or near a bottom side of the vehicle 10 may be a ground speed sensor 868 (e.g., a light sensor, etc.). The ground speed sensor 868 may be configured to point towards the ground and send light towards the ground and back, measuring a distance of how far the vehicle 10 has traveled.

A method of operating the vehicle 10 and the system described herein may include several processes. For example, the method may include coupling a sensor system to an autonomous vehicle comprising a base assembly and one or more tractive elements and positioning the autonomous vehicle in an environment. The method may also include driving the vehicle along a path. Additionally, the method may include detecting, by the sensor system, one or more objects located in an area near the autonomous vehicle, and communicating the detection of the one or more objects to a control system. The method may further include generating one or more controls for one or more of the base assembly or the one or more tractive elements and sending the one or more controls to the one or more of the base assembly or the one or more tractive elements. Generating the one or more controls may include generating a stop control. Detecting the one or more objects may include detecting an obstacle or a person.

The method may include additional processes such as coupling a lift assembly to the autonomous vehicle, generating one or more controls for the lift assembly, and sending the one or more controls to the lift assembly. Coupling the sensor system to the autonomous vehicle may include coupling short-range sensors and long-range sensors to the autonomous vehicle. The method may also include generating, by the long-range sensors, a point map mapping an environment surrounding the autonomous vehicle. The method may additionally include receiving, to the control system, a pre-generated map of the environment and comparing, by the control system the pre-generated map to the point map.

### Adjustable Sensor System

Referring generally to the figures, an autonomous vehicle includes one or more sensors for sensing the environment around the vehicle. The vehicle may support a product through various stages of assembly along an assembly line. In some embodiments, the product may obscure one or more sensors of the vehicle. To compensate for the field of view of the one or more sensors, the vehicle may adjust a position of the one or more sensors on the vehicle. In some embodiments, the vehicle preemptively moves/repositions the one or more sensors prior to the obstruction. For example, the vehicle may track the current stage of assembly for the product and include predetermined information regarding the position of the product relative to the vehicle at each stage. Prior to the product being positioned to obscure a sensor, the vehicle can adjust the sensor position to ensure the sensor field of view is not compromised, or to at least reduce the obstruction caused by the product. The sensor may be moved automatically to a predetermined position or may be moved until the sensor determines that the obstruction is reduced. The position of the sensor may be monitored by a second sensor to confirm the first sensor position and relocation, if necessary. In some embodiments, the vehicle may additionally and/or alternatively adjust an output of the sensor to compensate for the obstruction or the stage of assembly. In some embodiments, the vehicle may simply disable or temporarily inactivate or otherwise ignore the signal from one or more sensors the vehicle determines are obstructed. In some embodiments, the vehicle may additionally activate a secondary sensor to replace the sensor which was deactivate. The secondary sensor may be positioned in a position which is less obstructed by the product than the first sensor. The vehicle is therefore configured to detect an obstruction of one or more of the one or more sensors coupled to the vehicle, determine a corrective action, and automatically perform the corrective action to compensate for the obstructed sensor.

As the vehicle 10 facilitates movement of a load (e.g., a product or components of a product, etc.) throughout a manufacturing environment, changes during the movement or changes in the state or configuration of the product may cause one or more of the sensors 112 (e.g., the short-range sensors 800, the long-range sensors 802, etc.) to become obstructed. For example, the vehicle 10 may be facilitating movement of a product during various stages of assembly. As such, the specifications of the product may change during the various stages of assembly. Certain components of the product may therefore be positioned differently on the vehicle 10 at different points in time and may cause an obstruction to the sensors 112. For example, a piece of machinery having a boom may be undergoing assembly. When the boom is added to the assembly during the production of the machinery, the boom may overhang the vehicle 10 or otherwise be positioned to cause an obstruction to a field of view or sensor range of one or more of the sensors 112 (e.g., the booms hangs in front of an ultrasonic sensor on the vehicle 10, etc.).

To account for obstruction of the sensors 112, the vehicle 10 may detect the obstruction and automatically perform a corrective action from a plurality of corrective actions to compensate for the obstruction. The corrective action may include repositioning the sensors 112, activating additional sensors 112, deactivating the obstructed sensors 112, ignoring the signals from the obstructed sensors 112, adjusting a parameter or output of the sensors 112, or other coupling a new sensor 112 to the vehicle 10 and/or the product. The corrective action (repositioning of the sensors 112 on the vehicle 10 or adding additional sensors 112 to the vehicle 10, etc.) may occur automatically in response to an obstruction of one or more of the sensors 112 or it may occur on a certain interval (e.g., when the vehicle 10 reaches a certain station or stage of assembly, etc.).

In some embodiments, the corrective action includes the one or more of the sensors 112 being repositioned or added to the vehicle 10 manually. In such embodiments, the corrective action may include providing a notification to a user indicating the obstruction and what sensors 112 should be moved or added to the vehicle 10. For example, one or more of the sensors 112 may detect an obstruction of one or more of the sensors 112. In response, the controller 102 may submit a request to an operator (e.g., a manager, a user, etc.) to manually reposition one or more of the sensors 112 or add an additional sensor 112 to the vehicle 10. In another example, an operator may detect an obstruction of one or more of the sensors 112. The operator may manually reposition one or more of the sensors 112 or add an additional sensor 112 to the vehicle 10. The operator may reposition or add one or more of the sensors 112 from an offline state on the vehicle 10. The operator may cause the offline sensor 112 to become online, thereby adding the newly online sensor 112 to the sensing system of the vehicle 10. The newly online sensor 112 may remain in place or the operator may reposition the newly online sensor 112 to a different position on the vehicle 10. In some embodiments, the operator may add an additional sensor 112 not already located on the vehicle 10. For example, the operator may have access to a stock of additional sensors 112 that can be added (e.g., coupled, etc.) to the vehicle 10.

In some embodiments, the sensors 112 may be repositioned or moved on the vehicle 10 automatically (e.g., via an actuator, etc.) as the corrective action. Referring back to FIGS. 83-86, the sensors 112, 800, and/or 802 are shown coupled to the one or more tracks, rails, guides, channels, etc. shown as tracks 1402. The tracks 1402 allow the sensors 112 (e.g., sensor 800, 802) to translate along the tracks and move between a plurality of positions relative to the vehicle 10. In some embodiments, the plurality of positions are predetermined positions. In some embodiments, the sensors 112 can move to any position along the track 1402 as determined by the signal from the respective sensor 112. Additionally coupled to one or more of the sensors 112 are actuators, motors, etc. shown as sensor actuators 1404. The sensor actuators 1404 are coupled to the controller 102 of the vehicle 10 and controllable therefrom. Each of the sensor actuators 1404 control a position of the corresponding sensor 112 on the tracks 1402. The sensor actuators 1404 may move the sensors 112 in any of the x, y, or z directions relative to the vehicle 10. For example, there may be a set of vertical tracks slidably coupled to the lateral tracks 1402, with the sensors 112 coupled to the vertical tracks such that the sensors 112 can move both in the horizontal and vertical directions. In some embodiments, the sensors 112 may additionally and/or alternatively be configured to extend and retract towards and away from a center of the vehicle 10. The vehicle 10 also includes secondary sensors 812 for monitoring the positions of the movable primary sensors 112 (e.g., sensors 800, 802). In some embodiments, the controller 102 controls the actuators 1404 based on signal from the secondary sensors 812 indicating the position of the primary sensors 112. In some embodiments, the position of the sensors 112 is inferred from the sensor actuator 1404 position.

In operation, one or more of the sensors 112 may detect an obstruction of one or more of the sensors 112. In response, the controller 102 may automatically control the corresponding sensor actuator 1404 to move the obstructed sensor 112 to a different position (e.g., an unobstructed position on the vehicle 10, etc.). The control 102 may rely on the secondary sensors 812 to determine the position of the obstructed sensors 112 and to monitor the movement of the obstructed sensor 112 to its new position. In some embodiments, the controller 102 is configured to move the sensors 112 through a range of positions until a signal from the sensor 112 indicates the field of view of the sensor 112 is either not obstructed or is obstructed below a threshold amount such that the sensor 112 can operate accurately.

Referring specifically to FIG. 85, the field of views 814 and 816 for two sensors 802 are shown. As described above, in cases where in the sensor 802 is obstructed in some way, the sensors 802 can be moved to a new position, represented by sensors 802″. With the new position, the sensors 802′ also has a new field of view, shown as FOV 816′. Referring now to FIG. 86, the sensors at points 822 and 824 may be repositioned in one or more of the x, y, and z directions to adjust the positions of the sensing fields 820.

Referring again to FIGS. 83-88, in some embodiments, the vehicle 10 may have one or more of the sensors 112 which are located on the vehicle 10 but are in an offline or deactivated state. The controller 102 may cause the offline sensor 112 to become online, thereby adding the newly online sensor 112 to the sensing system of the vehicle 10. The newly online sensor 112 may remain in place or may be repositioned into a different position on the vehicle 10. In some embodiments, the obstructed sensor 112 is brought offline. Beneficially, this can save power and reduce the computational load on the controller 102.

In some embodiments, an additional sensor 112 may be added to the vehicle 10 and/or the product. For example, at a stage of manufacturing where the product extends far longer than the vehicle 10, a sensor 112 can be coupled to a front or end of the product and wirelessly communicate with the controller 102 to provide the controller with accurate information regarding the environment around the vehicle. For example, referring now to FIG. 88, the rear sensor 802 may have a field view 1408 obstructed by the component of the telehandler 56. An additional sensor 802′ can be attached to the component of the telehandler 56 with a field of view 1408′. The additional sensor 802′ is communicably coupled to the vehicle 10, such that the vehicle 10 can deactivate the sensor 802 at the rear of the vehicle 10 and use the sensor 802′ instead. Any one or more additional sensors 112 may be attached to the load (e.g., telehandler 56) via the fixture. The additional one or more sensors 112 may take the place of an obstructed one or more of the sensors 112 or may provide additional sensing in addition to the sensors 112 located on the vehicle 10. Additionally or alternatively, the operator may remove one or more or the sensors 112 from the vehicle 10 and may use the fixture to reattach the one or more sensors 112 to the load (e.g., the operator repositions the one or more sensors 112 from the vehicle to the load via the fixture). Repositioning one or more of the sensors 112 from the vehicle 10 to the fixture attached to the load may provide for a newly unobstructed range of sensing for the one or more repositioned sensors 112. For example, a fixture may be supplied to attach one or more of the sensors 112 to the load. Upon obstruction of one or more of the sensors 112, an operator may use the fixture to attach an additional one or more of the sensors 112 to the load. The fixture may be product-specific for particular loads or may be configured to attach to any type of load. For example, a load may be positioned on the vehicle 10 such that the load extends beyond the chassis (e.g., the frame 12) of the vehicle 10. The fixture may attach one or more of the sensors 112 to a distal end of the load extending beyond the chassis of the vehicle 10.

Any additional sensors 112 added to the vehicle 10 (e.g., added to the vehicle 10, added to a load via a fixture, etc.) may be temporary. For example, an additional sensor 112 may be added to the vehicle 10 or to the load in an advantageous position (e.g., a better position for sensing based on the location of the vehicle 10 or a current task of the vehicle 10, etc.). One or more of the sensors 112 on the vehicle 10 or on the load (e.g., an obstructed sensor, etc.) may be turned off temporarily.

In some embodiments, the controller 102 monitors a state or condition of the product (e.g., manufacturing station, assembly station, assembly state, etc.) and preemptively performs a corrective action to avoid or reduce a predetermined and/or predicted obstruction of a field of view of a sensor. For example, the controller may receive a signal indicating the vehicle 10, and the product it carries, such as boom assembly 68, are prior to a stage wherein the boom assembly 68 will be modified and thereafter obstruct the field of view of a sensor 112. To preemptively account for the upcoming obstruction, the controller 102 may control one or more sensor actuators 1404 to adjust a position of one or more sensors 112 to reduce or eliminate the upcoming obstruction. In some embodiments, the controller 102 includes a plurality of predetermined obstruction states. Each predetermined obstruction state may be associated with the one or more sensors 112 affected by the obstruction, and with positions for the one or more sensors 112 to be moved to accommodate the obstruction. The state or condition of the product can be provided to the vehicle 10 or monitored and/or determined directly via the vehicle 10 by the one or more sensors 112.

In some embodiments, the corrective action includes adjusting a sensor output, signal, or parameter of the sensor 112 based on an obstruction. The parameter or sensor output can be a threshold required to trigger an alert, a threshold require to detect an object, a minimum allowable distance between the vehicle 10 and a detected object, etc. This parameter can be adjusted to accommodate the obstruction. In some embodiments, the corrective action includes the controller 102 ignoring or ‘muting’ the signal from the obstructed sensor 112. For example, if during normal operation (i.e., unobstructed) the sensor 112 may trigger an alert, but the controller 102 has determined the sensors 112 is obstructed (e.g., based on a signal from the sensors 112, a stage or condition of the product, a signal from secondary sensors 812, etc.) the controller 102 can ignore the signal from the obstructed sensor 802 and therefore “mute” the sensor 112.

In some embodiments, the vehicle 10 may have a plurality of operating modes, each corresponding to an arrangement of sensors 112. The plurality of operating modes includes an autonomous mode, a semi-autonomous mode, a manual mode, a slow mode, a fast mode, etc.). For example, if the sensors 112 are in a first position, the controller 102 may control the vehicle 10 in an autonomous mode. If one or more of the sensors 112 are obstructed, the controller 102 may determine the arrangement of the sensors 112 now meets the conditions for a second operation mode such as a semi-autonomous operating mode.

Based on the positioning of the sensors 112 onboard the vehicle 10, a status or confirmation of a status of the sensors 112, or the operating mode, the vehicle 10 may perform various functions. For example, when the sensors 112 are in a first configuration onboard the vehicle 10, the vehicle 10 may be configured to perform certain functions (e.g., only predetermined functions, a first set of steps, etc.). After repositioning of one or more of the sensors 112 or the addition of additional sensors 112, the sensors 112 may be in a second configuration onboard the vehicle 10. In the second configuration, the vehicle 10 may perform certain functions (e.g., only predetermined functions, a second set of steps, etc.) which are different from the functions performed by the vehicle 10 when the sensors 112 are in the first configuration. The vehicle 10 may perform any functions or combination of functions when the sensors 112 are in any configuration onboard the vehicle 10.

The vehicle 10 may also monitor and track the stages of assembly of a product by receiving various inputs (e.g., via the sensors 112, manually by an operator, with a camera, etc.) and processing the inputs. For example, the vehicle 10 may determine a current stage of assembly of the product. The vehicle 10 may then determine an effect on the sensors 112 onboard the vehicle 10 based on the current stage of assembly of the product. The vehicle 10 may determine how the sensors 112 will be affected by one or more stages of assembly of the product and may adjust the sensors 112 accordingly. For example, the vehicle 10 may change the threshold required to trigger a notification or an action. As another example, the vehicle 10 may mute a notification or prevent an action that would be generated by a sensor 112 known to be obstructed at the current stage of assembly of the product.

A method of manufacturing a vehicle according to the description provided herein may include several processes. The method may include providing a frame and coupling an interface assembly configured to support a product to the frame. The method may also include coupling one or more sensors to the frame, the sensors configured to sense an environment around the vehicle. The method may further include communicably coupling a controller to the one or more sensors, the controller configured to receive a signal from the one or more sensors, detect an obstruction in the field of view of the one or more sensors, determine a corrective action to compensate for the obstruction, and automatically perform the corrective action. The controller may be further configured to determine the corrective action by selecting a corrective action from a plurality of corrective actions.

The method may also include one or more additional processes. Configuring the controller to determine the corrective action to compensate for the obstruction may include configuring the controller to reposition one or more of the sensors on the vehicle. The method may include coupling a sensor actuator to one or more of the sensors, the sensor actuator configured to move the sensor between a plurality of positions. Configuring the controller to automatically perform the corrective action may also include moving one or more of the sensors from a first position in the plurality of positions to a second position in the plurality of positions based on the signal, wherein the second position is the position least obstructed according to the signal.

### Modular Implements

Referring generally to the figures, a vehicle includes multiple interchangeable implements. The vehicle includes a frame defining a recess and a series of flanges extending along the recess. Each of the flanges defines a series of first apertures. Each implement includes a base frame defining a series of second apertures. The second apertures align with the first apertures, such that bolts can be inserted through both sets of apertures to fixedly and removably couple the base frame of the implement to the frame of the vehicle. By utilizing a common bolt pattern between the base frames of different implements, the implements may be quickly and easily removed and interchanged by removing the bolts.

Referring to FIGS. 3 and 5, the lifting implement 50 and the cart implement 60 (e.g., the cart interface 700, the cart interface 3000, etc.) are each shown coupled to the base assembly 48. In some embodiments, the lifting implement 50 and the cart implement 60 are configured as self-contained modules that are removably coupled to the base assembly 48. The base assembly 48 includes a universal implement interface, such that the implements can be swapped or otherwise exchanged with one another based on the desired use case for the vehicle 10. By way of example, the lifting implement 50 may be removed and replaced with the cart implement 60. Similarly, the cart implement 60 may be removed and replaced with the lifting implement 50. This exchange may be performed without modifying the base assembly 48.

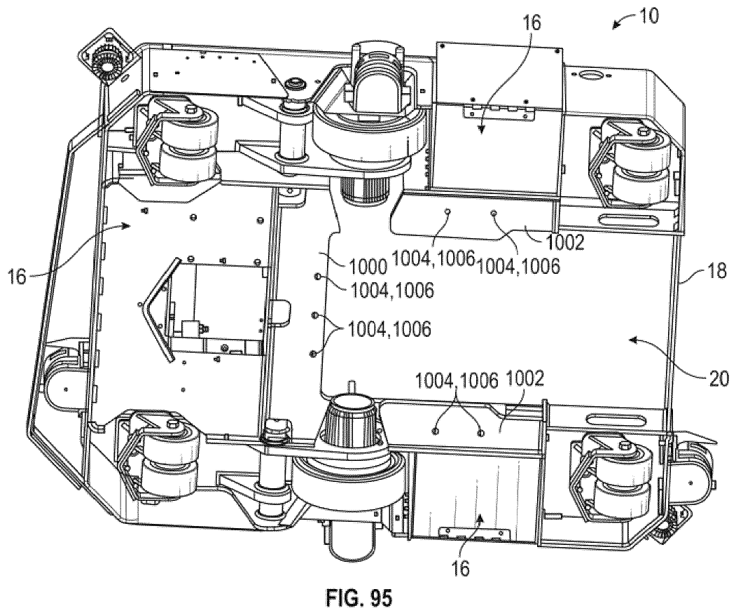

Referring to FIGS. 1, 2, 95, and 96, the frame 12 is configured to facilitate interchangeability of the implements. The frame 12 includes a series of protrusions, plates, or implement mounting flanges, shown as front flange 1000 and a pair of side flanges 1002. The front flange 1000 is fixedly coupled to (e.g., welded to) the controls enclosure 16 and extends rearward, toward the implement recess 20 and the back plate 18. Each side flange 1002 is fixedly coupled to one of the drive modules 14 and extends laterally inward, toward the implement recess 20 and a longitudinal centerline of the frame 12. The front flange 1000 and the side flanges 1002 extend within a common horizontal plane that defines the bottom of the implement recess 20. Together, the front flange 1000 and the side flanges 1002 function as a mounting interface for coupling the implements to the frame 12.

The front flange 1000 and the side flanges 1002 each define a series of apertures or passages, shown as fastener apertures 1004. Specifically, the front flange 1000 defines three fastener apertures 1004 spaced laterally apart from one another. Each of the side flanges 1002 defines a pair of fastener apertures 1004 spaced longitudinally from one another. In other embodiments, the front flange 1000 and/or the side flanges 1002 define more or fewer fastener apertures 1004.

The fastener apertures 1004 extend vertically through the respective flanges. The fastener apertures 1004 may extend completely through the flanges (e.g., may be through holes) or extend partially through the flanges (e.g., may be blind holes). Each of the fastener apertures 1004 is configured (e.g., sized and shaped) to receive a corresponding fastener 1006 to secure an implement to the frame 12. In some embodiments, the fastener apertures 1004 are threaded to threadedly engage the fasteners 1006. In other embodiments, the fastener apertures 1004 are through holes, and the fasteners 1006 engage with a nut or other retainer on a bottom side of the corresponding flange.

The back plate 18 defines a series of apertures or passages, shown as fastener apertures 1010. Specifically, the back plate 18 defines four fastener apertures 1010 spaced laterally apart from one another. In other embodiments, the back plate 18 defines more or fewer fastener apertures 1004.

The fastener apertures 1010 extend longitudinally through the back plate 18. The fastener apertures 1010 may extend completely through the flanges (e.g., may be through holes). Each of the fastener apertures 1010 is configured (e.g., sized and shaped) to receive a corresponding fastener 1012 to secure an implement to the frame 12. In some embodiments, the fastener apertures 1010 are clearance holes permitting the fasteners 1012 to pass completely through the back plate 18.

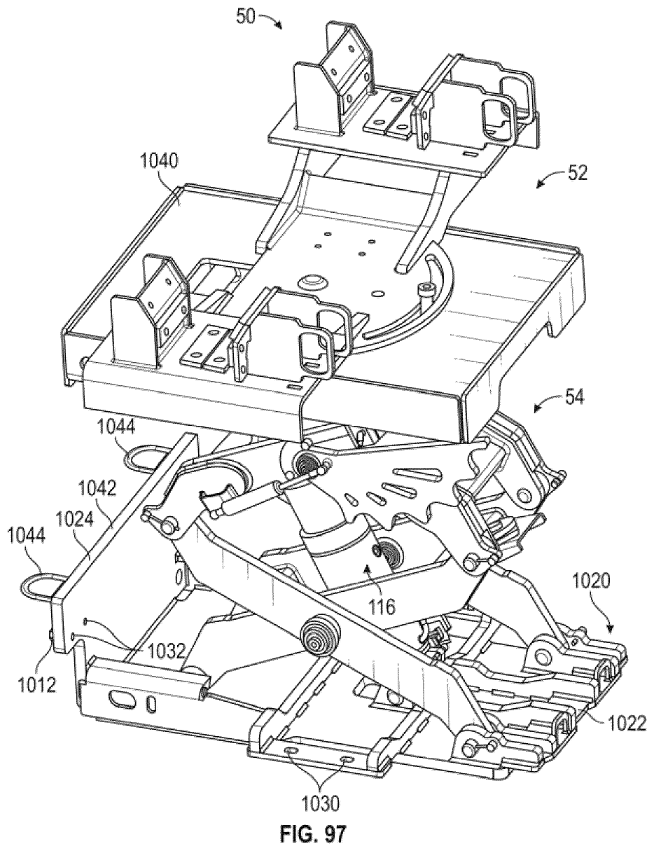

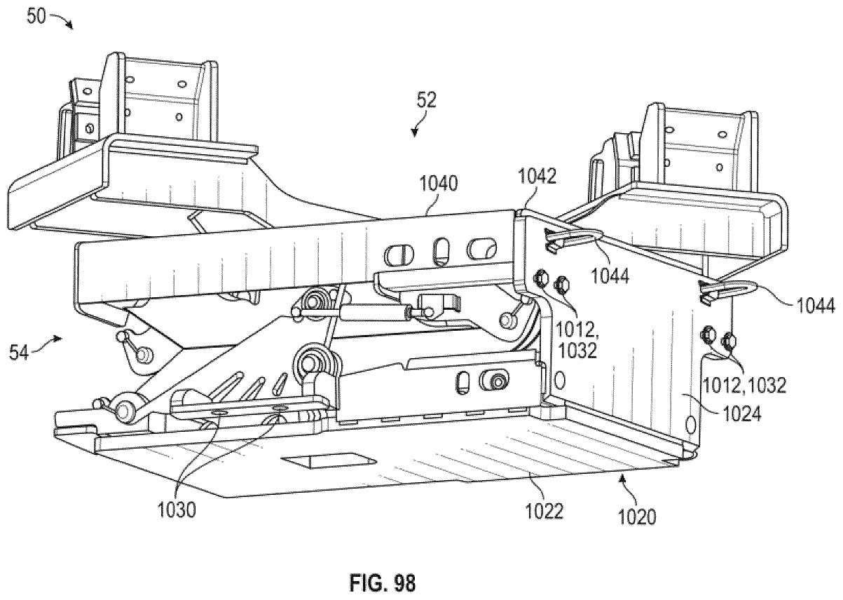

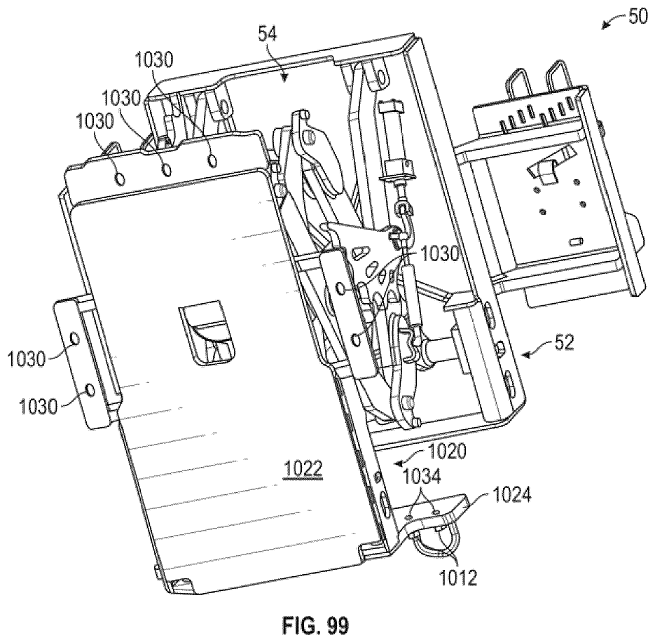

Referring to FIGS. 3 and 97-99, the lifting implement 50 is shown according to an exemplary embodiment. The lifting implement 50 includes a base portion, frame, or subframe, shown as base frame 1020. The base frame 1020 includes a first portion or horizontal portion, shown as base plate 1022, and a second portion or vertical portion, shown as back plate 1024. The base plate 1022 extends substantially horizontally, and the back plate 1024 extends substantially vertically and laterally. The back plate 1024 is fixedly coupled to (e.g., welded to) the base plate 1022 and extends upward from the base plate 1022. The lift assembly 54 is directly coupled to the base plate 1022. Accordingly, the base frame 1020 supports the cradle 52 and the telehandler 56 through the lift assembly 54.

The base plate 1022 defines a series of passages or apertures, shown as slots 1030. The slots 1030 are similar in quantity and position to the fastener apertures 1004. The slots 1030 extend vertically through the base plate 1022 and are each sized to receive one of the fasteners 1006 therethrough. The slots 1030 each have a first lateral dimension and a second longitudinal dimension. The longitudinal dimension is larger than the lateral dimension, such that the slots 1030 are wider longitudinally than laterally. Accordingly, the slots 1030 permit adjustment of the longitudinal positions of the fasteners 1006 relative to the base frame 1020.

The back plate 1024 defines a series of apertures or passages, shown as fastener apertures 1032. The fastener apertures 1032 are similar in quantity and position to the fastener 1012. The fastener apertures 1032 extend longitudinally through the back plate 1024. Each of the fastener apertures 1032 is configured (e.g., sized and shaped) to receive a corresponding fastener 1012 to secure the lifting implement 50 to the frame 12. In some embodiments, the fastener apertures 1032 are threaded to threadedly engage the fasteners 1012.

To assemble the lifting implement 50 with the base assembly 48, the base frame 1020 is inserted into the implement recess 20. The base plate 1022 rests atop the front flange 1000 and the side flanges 1002. Accordingly, the engagement between the base plate 1022, the front flange 1000, and the side flanges 1002 limits downward movement of the base frame 1020 relative to the frame 12 (e.g., supports downward forces on the lifting implement 50).

The slots 1030 align with the fastener apertures 1004. Accordingly, the fasteners 1006 may be inserted through the slots 1030 and engage with the fastener apertures 1004. Engagement between the fasteners 1006 and the sides of the slots 1030 limits lateral movement of the base frame 1020 relative to the frame 12. While the fasteners 1006 are loose, the slots 1030 permit longitudinal adjustment of the base frame 1020 relative to the frame 12.

The base frame 1020 is adjusted rearward until the back plate 1024 engages the back plate 18. Engagement between the back plate 1024 and the back plate 18 limits rearward movement of the base frame 1020 relative to the frame 12. The fastener apertures 1010 align with the fastener apertures 1032. Accordingly, the fasteners 1012 may be inserted through the fastener apertures 1032 and engage with the fastener apertures 1010. Engagement between the fasteners 1012 and the back plate 18 limits forward movement of the base frame 1020 relative to the frame 12. The fasteners 1006 and the fasteners 1012 are tightened to fixedly couple the base frame 1020 to the frame 12. The actuators 116, sensors 112, and/or any other functional components of the lifting implement 50 may be operatively coupled (e.g., electrically and/or hydraulically coupled) to the base assembly 48 (e.g., by one or more electrical connectors and/or hydraulic connectors). At this point, the lifting implement 50 may be ready for use.

To remove the lifting implement 50 from the base assembly 48, the electrical and hydraulic connectors may be disconnected. The fasteners 1006 and 1012 may be removed. The lifting implement 50 may then be lifted out of the implement recess 20. After the lifting implement 50 is removed, it may be replaced with another implement (e.g., the cart implement 60).

Referring to FIGS. 3, 97, and 98, the cradle 52 is vertically repositionable by the lift assembly 54. A portion of the cradle 52 has a substantially horizontal top surface, shown as a top surface 1040. The back plate 1024 has a substantially horizontal top surface, shown as top surface 1042. With the base frame 1020 fixedly coupled to the frame 12, the top surface 1042 is flush with the top surface 30 of the frame 12. When the cradle 52 is raised, the top surface 1040 of the cradle 52 is positioned above the top surface 30. When the cradle 52 is lowered to a fully lowered position, the top surface 1040, the top surface 1042, and the top surface 30 are substantially coplanar. Accordingly, every part of the lifting implement 50 below the top surface 1040 may fit completely within the implement recess 20.

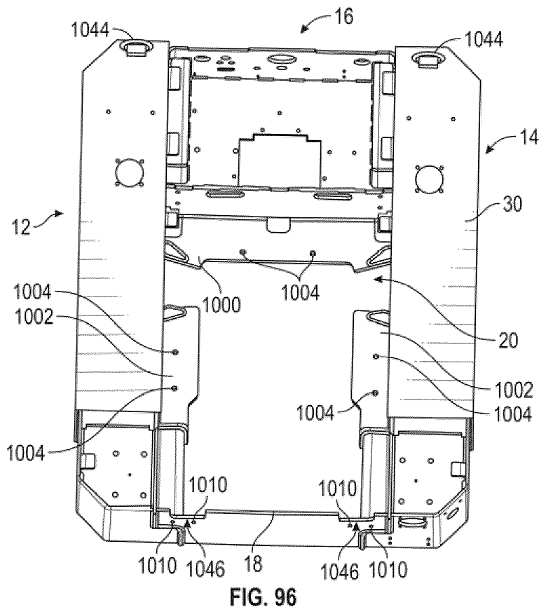

Referring to FIGS. 96-98, the vehicle 10 includes a series of interfaces or tow points, shown as pull rings 1044. The pull rings 1044 each define a closed loop configured to receive a hook, ring, chain, rope, or other interface that can be pulled or dragged to reposition the vehicle 10. The pull rings 1044 may be repositionable (e.g., pivotable) for storage when not in use. Two of the pull rings 1044 are directly coupled to the frame 12 at a front end portion of the vehicle 10. Two of the pull rings 1044 are directly coupled to the back plate 1024 at a rear end portion of the vehicle 10. To provide clearance for these pull rings 1044, the back plate 18 defines a pair of recesses 1046 that receive the pull rings 1044 therethrough.

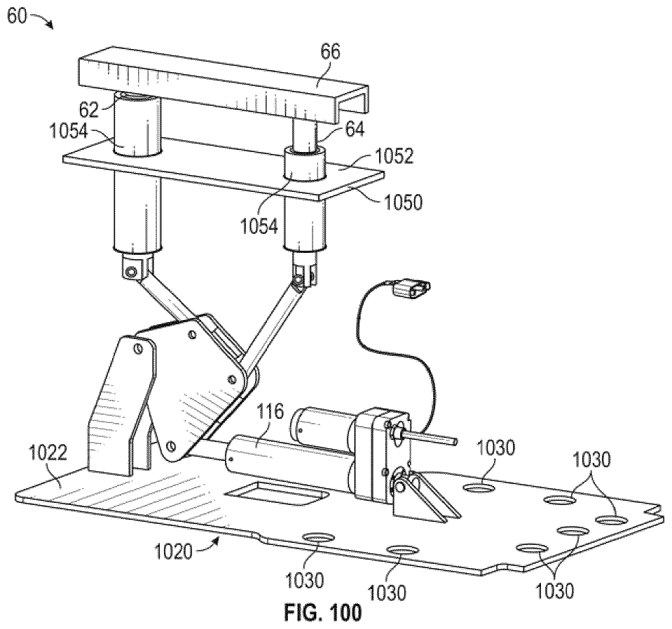

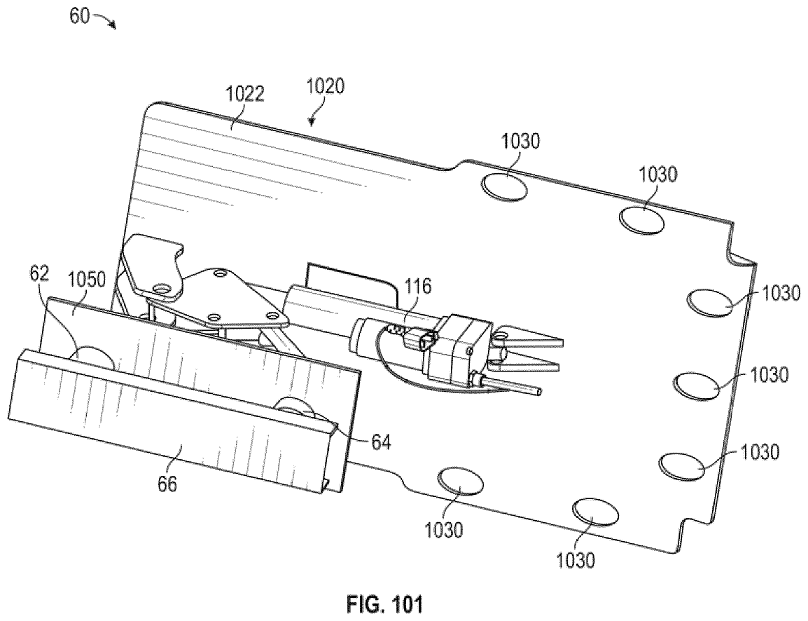

Referring to FIGS. 5, 100, and 101, the cart implement 60 is shown according to an exemplary embodiment. The cart implement 60 also includes a base frame 1020. As shown, the base frame 1020 includes the base plate 1022, but omits the back plate 1024. In other embodiments, the base frame 1020 includes the back plate 1024. Because the lifting implement 50 and the cart implement 60 both utilize similar base frames 1020, the lifting implement 50 and the cart implement 60 may both be coupled to the frame 12 in the same way, and can be easily interchanged.

The cart implement 60 includes a substantially horizontal top plate 1050 that has a substantially horizontal top surface, shown as a top surface 1052. The top surface 1052 defines a pair of apertures, shown as pin apertures 1054, that each receive either the driving pin 62 or the turning pin 64. With the base frame 1020 fixedly coupled to the frame 12, the top surface 1052 is flush with the top surface 30 of the frame 12. Accordingly, every part of the cart implement 60 below the top surface 1052 may fit completely within the implement recess 20.

The cart implement 60 may represent the cart interface 700 and/or the cart interface 3000. Accordingly, the cart interface 700 and the cart interface 3000 may each be interchangeably coupled with the frame 12. The base frame 1020 may represent or include the mounting interface 702 and/or the mounting interface 3016.

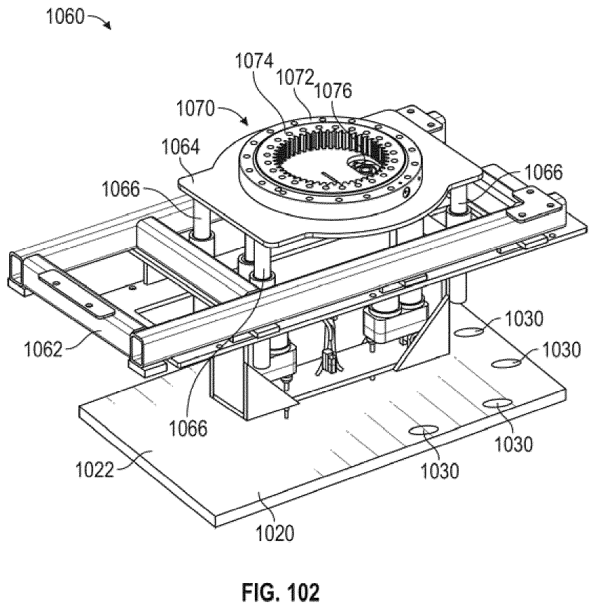

Referring to FIG. 102, a third implement is shown as turning implement 1060 according to an exemplary embodiment. Similar to the lifting implement 50 and the cart implement 60, the turning implement 1060 includes a base frame 1020. Accordingly, the turning implement 1060 is interchangeable with any of the other implements described herein through a similar process.

The turning implement 1060 includes a structure, shown as frame 1062. The frame 1062 is fixedly coupled to the base frame 1020 and extends upward from the base frame 1020. The turning implement 1060 includes a movable portion, shown as lift table 1064. The lift table 1064 is slidably coupled to the frame 1062 by a series of linear bearings or linear guides, shown as guides 1066. The guides 1066 permit the lift table 1064 to move vertically relative to the frame 1062, but prevents movement in other directions.

The turning implement 1060 includes a pair of actuators (e.g., actuators 116), shown as lift actuators 1068. By way of example, the lift actuators 1068 may be or include electric linear actuators. The lift actuators 1068 are each coupled to the frame 1062 and to the lift table 1064. The lift actuators 1068 are configured to raise and lower the lift table 1064 relative to the frame 1062.

The turning implement 1060 further includes a rotational member (e.g., a slewing bearing), shown as turntable 1070. The turntable 1070 includes a first portion, shown as base section 1072, and a second portion, shown as rotating section 1074. The base section 1072 is fixedly coupled to the lift table 1064, and the rotating section 1074 is rotatably coupled to the base section 1072. The rotating section 1074 is configured to rotate about a substantially vertical axis. The rotating section 1074 may be coupled to a product, such as the telehandler 56 or the boom assembly 68. By way of example, the rotating section 1074 may be coupled to a cradle 52 that supports a product.

The turning implement 1060 includes an actuator (e.g., an actuator 116), shown as turning actuator 1076. By way of example, the turning actuator 1076 may be or include an electric motor. The turning actuator 1076 is coupled to the frame 1062 and to the rotating section 1074. The turning actuator 1076 is configured to rotate the rotating section 1074 relative to the frame 1062.

### Modular Frame

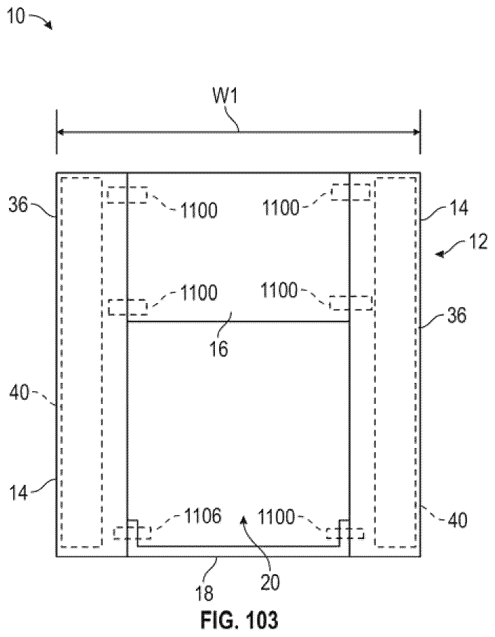

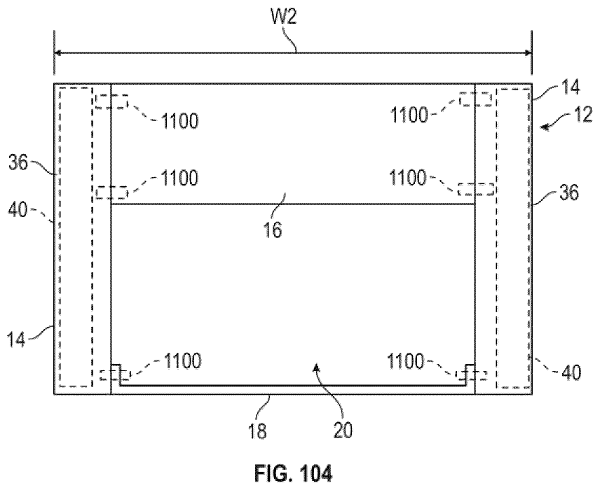

Referring to FIGS. 103 and 104, the frame 12 of the vehicle 10 is reconfigurable to vary an overall width of the vehicle 10, according to an exemplary embodiment. As shown, the drive modules 14 are coupled to the controls enclosure 16 and to the back plate 18 through a series of removable connections, shown as fasteners 1100. Accordingly, the controls enclosure 16 and the back plate act as cross members that couple the drive modules to one another and define the width of the frame 12. The fasteners 1100 may include any type of coupler or other connection that permits non-destructively disconnecting the drive modules 14 from the controls enclosure 16 and the back plate 18 without destroying or otherwise damaging the drive modules 14. By way of example, the fasteners 1100 may include a bolted connection. By way of another example, the fastener 1100 may include a pop rivet or other fastener that can be drilled out without damaging or otherwise altering the drive modules 14 so as to prevent the drive modules 14 from being reused. In some embodiments, the fasteners 1100 may be removed without damaging the controls enclosure 16 or the back plate 18.

As shown in FIG. 103, the frame 12 has a first width W₁, measured laterally between the side surfaces 36. The size of the width W₁ is dictated by the widths of the drive modules 14, the controls enclosure 16, and the back plate 18. As shown in FIG. 104, the frame 12 has a second width W₂ that is larger than the first width W₁. Both configurations of the frame 12 utilize the same drive modules 14. However, the controls enclosure 16 and the back plate 18 are replaced with a controls enclosure 16 and a back plate 18 having a larger width in the configuration of FIG. 104. To accomplish this, the fasteners 1100 are removed, the controls enclosure 16 and the back plate 18 are replaced with larger components, and new fasteners 1100 are used to reassemble the frame 12. Accordingly, the width of the vehicle 10 can be reconfigured without replacing the drive modules 14. It may be desirable to vary the width of the vehicle 10, for example, to permit transporting products of different widths or to fit within corridors of a specific size. Additionally, a common set of drive modules 14 (e.g., left right modules and right drive modules that are the same) may be used to produce a variety of different vehicle configurations having different widths by having cross members of different lengths. This may reduce the cost and complexity of production relative to a system that utilizes different drive modules for each vehicle configuration.

As shown in FIGS. 2, 103, and 104, the drivetrain 40 is directly coupled to and/or contained within the drive modules 14. Specifically, a right portion of the drivetrain 40 is directly coupled to a first drive module 14, and a left portion of the drivetrain 40 is directly coupled to a second drive module 14. Because of this arrangement, the width of the vehicle 10 can be varied or adjusted without having to replace or reconfigure the drivetrain 40.

### Vehicle Coupling System

Referring generally to the figures, a first vehicle may be utilized with a second vehicle to cooperatively operate to support a product and facilitate moving the product (e.g., through various stages of assembly). The first vehicle may include a drive motor to propel the first vehicle along a ground surface with which the first vehicle is engaged. The first vehicle may be coupled with the second vehicle with a tow bar extending therebetween. The tow bar may be pivotally coupled with the first vehicle and fixedly coupled with the second vehicle. In response to the drive motor propelling the first vehicle, the tow bar exerts a force on the second vehicle to maintain a distance between the first vehicle and the second vehicle. In this manner, the second vehicle does not include a drive motor, and is instead driven by the coupling with the first vehicle via the tow bar.

The products carried by the first vehicle and the second vehicle may have varying lengths. A distance between the first vehicle and the second vehicle may change based on the length of the product to be carried thereby. To accommodate for the change in the distance between the first vehicle and the second vehicle (and the varying lengths of the products), the tow bar may include two or more members telescopically coupled to each other to enable varying a length of the tow bar.

The first vehicle and the second vehicle may be coupled together by a conduit configured to transfer at least one of (i) electrical energy, (ii) fluid power, or (iii) information between the first cart and the second cart. By way of example, the first vehicle may transfer, via the conduit, electrical energy from batteries of the first vehicle to power one or more components of the second vehicle. By way of another example, the first vehicle may transfer, via the conduit, fluid power from a hydraulic system to fluidly power one or more components of the second vehicle. By way of yet another example, the first vehicle may transfer, via the conduit, data associated with the operation of the first vehicle to the second vehicle (e.g., to control one or more components of the second vehicle). A conduit management system may be used to support a portion the conduit extending across a space defined by a distance between the first vehicle and the second vehicle. By way of example, the conduit may be routed through an interior cavity of the tow bar to couple (e.g., electrically couple, fluidly couple, and/or communicably couple) the first vehicle and the second vehicle to each other.

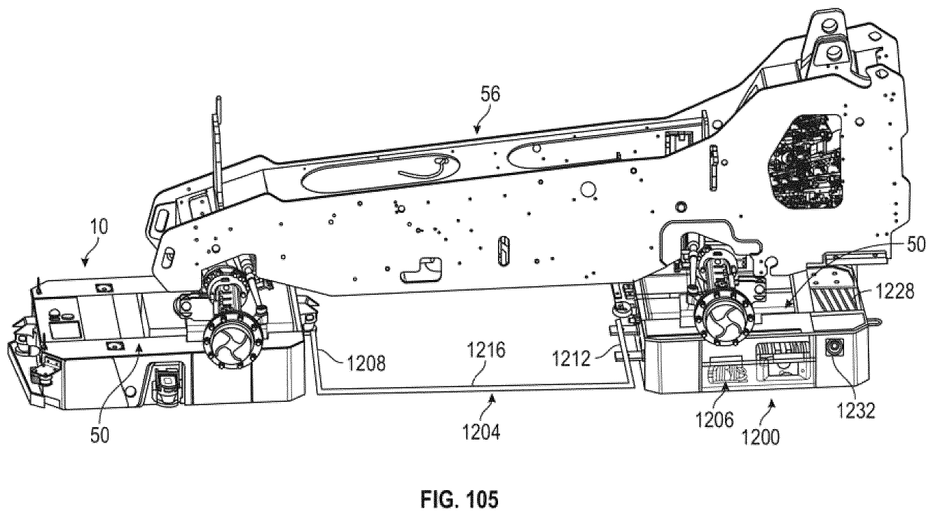

Referring to FIG. 105, the vehicle 10 is utilized with a second vehicle (e.g., cart), shown as skate 1200, to support a product such as the telehandler 56. The vehicle 10 and the skate 1200 may cooperatively operate to facilitate steering the product and distributing the weight of the product during transportation. The skate 1200 may be substantially similar to the vehicle 10 except as otherwise specified herein.

According to an exemplary embodiment, the skate 1200 omits the drive motors 42 and is instead propelled and steered by the vehicle 10. The skate 1200 and the vehicle 10 may be mechanically coupled to each other by a mechanical linkage (e.g., tube, bar, coupler, etc.), shown as tow bar 1204, extending therebetween to maintain a distance between the skate 1200 and the vehicle 10 (e.g., as the vehicle 10 travels). The tow bar 1204 may be pivotably coupled to the vehicle 10 (e.g., by a pivot joint, by a pin about which the tow bar 1204 can pivot, etc.) and fixedly coupled to the skate 1200 such that when the drive motors 42 of the vehicle 10 provide rotational mechanical energy to drive the tractive elements 44 and propel the vehicle 10, the tow bar 1204 pulls the skate 1200 with the vehicle 10. In this manner, responsive to the vehicle 10 being driven, the tow bar 1204 exerts a force on the skate 1200 such that the skate 1200 is driven at the same speed, in the same direction, and is maintained at a fixed distance (e.g., the fixed distance being a length of the tow bar 1204) from the vehicle 10 (e.g., even if the vehicle 10 and the skate 1200 are not collectively supporting the product). By way of example, when the vehicle 10 turns, the tow bar 1204 pivots relative to the vehicle 10 and exerts a force on the skate 1200 to pull the skate 1200 such that the skate 1200 trails the vehicle 10.

Referring still to FIG. 105, the cradle 52 of the vehicle 10 may be configured to pivot relative to the frame 12. By way of example, when the vehicle 10 turns and the cradle 52 is supporting the product, the cradle 52 can pivot relative to the frame 12. In such examples, the maximum angle at which cradle 52 can pivot relative to the frame 12 may be limited (e.g., by a pin contacting a mechanical stop). In some embodiments, the cradle 52 included in the skate 1200 is fixed relative to the frame thereof (e.g., rotation of the cradle 52 relative to the frame of the skate 1200 is inhibited). The frame of the skate 1200 and various components coupled to the frame form a base portion of the skate 1200, shown as base assembly 1206.

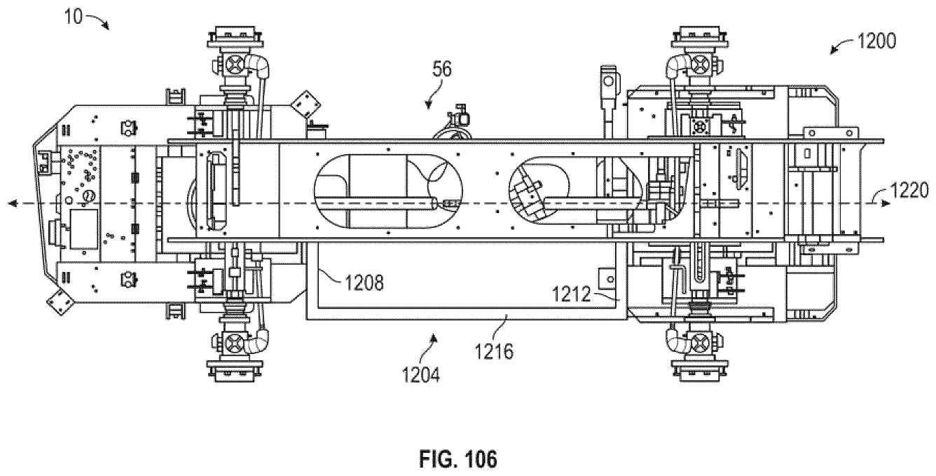

Referring to FIGS. 105 and 106, the tow bar 1204 includes one or more straight or bent sections. As shown in FIGS. 105 and 106, the tow bar 1204 includes a first portion, shown as first lateral section 1208, configured to pivotably couple with the vehicle 10: a second portion, shown as second lateral section 1212, configured to fixedly couple with the skate 1200; and a third portion (e.g., intermediate portion, middle portion, etc.), shown as longitudinal section 1216, extending between the first lateral section 1208 and the second lateral section 1212. The first lateral section 1208 may be pivotably coupled with the vehicle 10 at a pivot (e.g., mounting location, joint, coupler, hitch, ball joint, etc.) substantially centered in a lateral direction along the back plate 18 (e.g., the rear surface 34) and extend in a lateral direction away from the pivot. In some embodiments, the first lateral section 1208 is otherwise coupled with the vehicle 10 (e.g., at another suitable location, using another suitable coupling mechanism, etc.). The second lateral section 1212 may be fixedly coupled with the skate 1200 at a mounting location (e.g., fixation point) substantially centered in a lateral direction along a front plate (e.g., front surface 32) of the skate 1200 and extend in a lateral direction away from the mounting location. In some embodiments, the second lateral section 1212 is otherwise coupled with the skate 1200 (e.g., at another suitable location, using another suitable coupling mechanism, etc.). As shown in FIGS. 105 and 106, the longitudinal section 1216 couples and extends between the first lateral section 1208 and the second lateral section 1212. In such a configuration, the longitudinal section 1216 is laterally offset from an axis (e.g., a lateral center axis, an axis extending in a longitudinal direction and centered in a lateral direction, etc.), shown as center axis 1220, of the product, the vehicle 10, the skate 1200, etc., such the tow bar 1204 generally defines a U-shape. With the longitudinal section 1216 offset from the center axis 1220 of the product, the vehicle 10, the skate 1200, etc., the section of the product between the vehicle 10 and the skate 1200 is more easily accessible to perform a manufacturing, assembly, testing, or other process thereon. By way of example, when the product is the telehandler 56, with the longitudinal section 1216 offset from the center axis 1220, the bottom surface of the telehandler 56 is more easily accessible to assemble one or more components of the telehandler 56 such as a driveshaft, hoses, wires, etc. In other embodiments, the tow bar 1204 does not include the first and second lateral sections 1208, 1212, and the longitudinal section 1216 extends directly between the vehicle 10 and the skate 1200 and is offset from the center axis 1220.

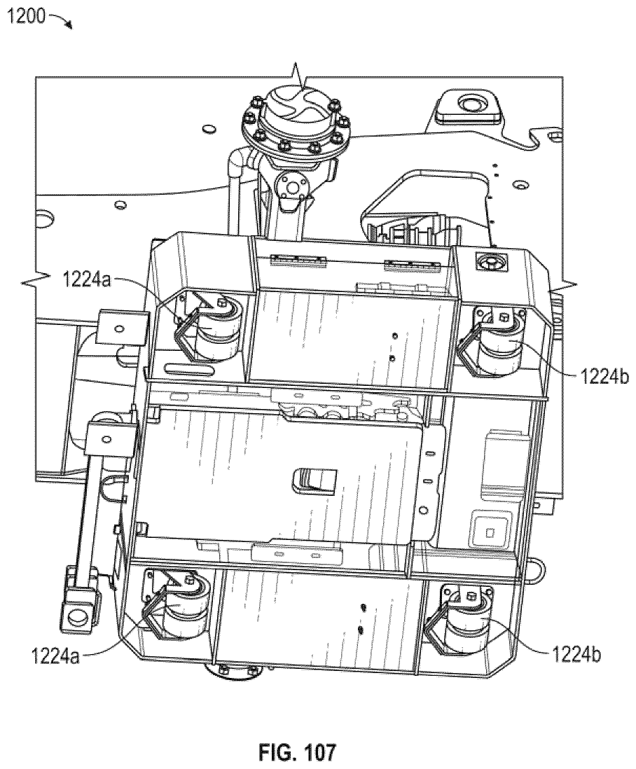

Referring to FIG. 107, the skate 1200 includes one or more tractive elements, shown as casters 1224, to facilitate movement of the skate 1200 along a ground surface. By way of example, when the skate 1200 is pulled by the tow bar 1204 when the vehicle 10 is propelled, the casters 1224 support the weight of the skate 1200 and facilitate movement of the skate 1200. In some embodiments, the casters 1224 positioned proximate a front surface of the skate 1200 are swivel casters 1224a that are capable of freely rotating about a vertical axis. By way of example, when the vehicle 10 and the skate 1200 are turning, the swivel casters 1224a can rotate about a vertical axis to facilitate free movement of the skate 1200. In some embodiments, the casters 1224 positioned proximate a rear surface (e.g., rear surface 34) of the skate 1200 are fixed casters 1224b that are fixed relative to a vertical axis (e.g., the fixed casters 1224b are unable to rotate about the vertical axis). In other embodiments, each caster 1224 of the skate 1200 is a swivel caster 1224a. In yet other embodiments, each caster 1224 of the skate 1200 is a fixed caster 1224b.

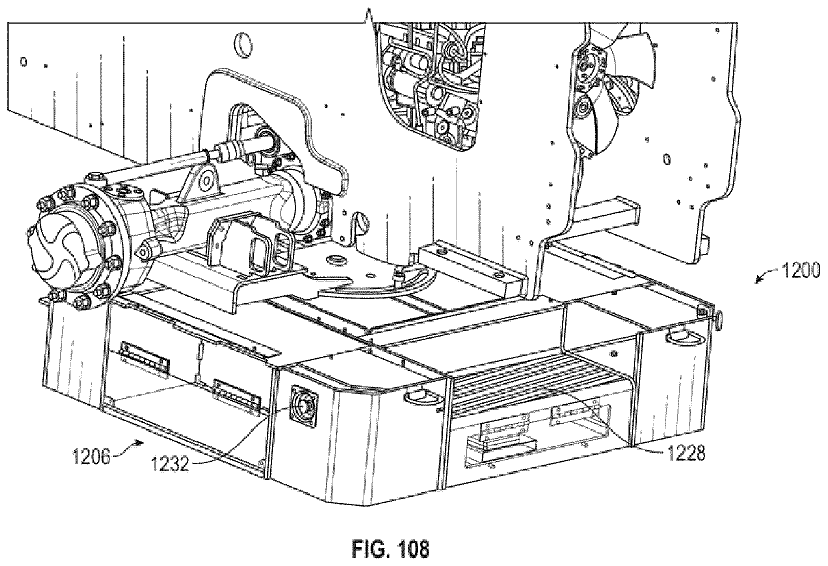

Referring to FIG. 108, the skate 1200 includes a support surface, shown as step 1228, extending in a substantially horizontal plane (e.g., a plane substantially parallel to the ground surface) and provides a surface onto which a user can step. In some embodiments, the step 1228 is positioned proximate the rear surface of the skate 1200 between the lateral side surfaces. In other embodiments, the skate 1200 includes one or more steps 1228 variously positioned about the skate 1200.

Referring still to FIG. 108, the skate 1200 includes one or more operator interface elements (e.g., input devices, output devices, etc.), shown as user interface 1232. As shown in FIG. 108, the user interface 1232 is configured as an emergency stop button. The emergency stop button may be engaged by a user to manually override one or more operations of the vehicle 10, the skate 1200, and/or any one or more components included therein. In some embodiments, the user interface 1232 may include buttons, switches, knobs, touchscreens, microphones, or other input devices that receive information (e.g., commands) from one or more users. In some embodiments, the user interface 1232 may include displays, speakers, lights, haptic feedback (e.g., vibrators, etc.), or other output devices that provide information to one or more users.

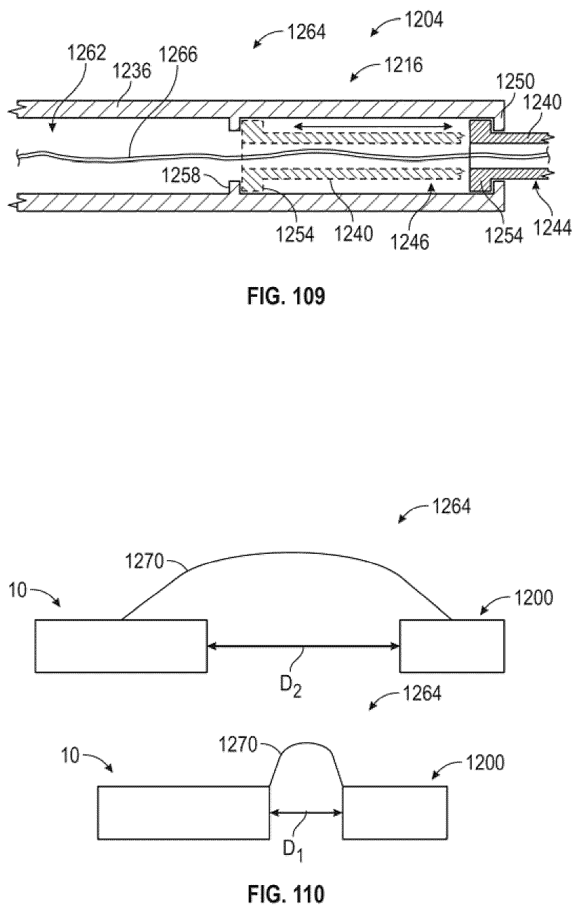

Referring to FIG. 109, the longitudinal section 1216 may include a telescoping section configured to facilitate varying a length of the tow bar 1204. Varying the length of the tow bar 1204 enables the vehicle 10 and the skate 1200 to support or otherwise accommodate for products having different lengths. The longitudinal section 1216 includes an outer telescoping portion (e.g., an outer casing), shown as first telescoping section 1236, and an inner telescoping portion, shown as second telescoping section 1240. The first telescoping section 1236 is configured to receive at least a portion of the second telescoping section 1240 (e.g., at least a portion of the second telescoping section 1240 is nested within the first telescoping section 1236). The first telescoping section 1236 and the second telescoping section 1240 are slidable relative to each other to facilitate varying the length of the longitudinal section 1216. In other words, the first telescoping section 1236 and the second telescoping section 1240 are telescopically coupled to each other to accommodate for a change in the distance between the vehicle 10 and the skate 1200. As shown by the direction of the arrows in FIG. 109, the second telescoping section 1240 may translate within the first telescoping section 1236 to transition the tow bar 1204 between a first, extended position, shown as lengthened position 1244 and a second, retracted position, shown as shortened position 1246. In the lengthened position 1244, the tow bar 1204 is fully extended to a maximum length (e.g., a maximum distance between the vehicle 10 and the skate 1200). In the shortened position 1246, the tow bar 1204 is shortened to a minimum length (e.g., a minimum distance between the vehicle 10 and the skate 1200).

The first telescoping section 1236 includes a flange 1250 configured to engage with a shoulder 1254 of the second telescoping section 1240 to prevent translation of the shoulder 1254 beyond the flange 1250, thereby maintaining the second telescoping section 1240 within the first telescoping section 1236. By way of example, when the tow bar 1204 is in the lengthened position 1244, the flange 1250 may engage with the shoulder 1254 to prevent translation of the shoulder 1254 past the flange 1250. Similarly, the first telescoping section 1236 includes a flange 1258 configured to engage with the shoulder 1254 of the second telescoping section 1240 to prevent translation of the shoulder 1254 past the flange 1258, thereby maintaining the second telescoping section 1240 within the first telescoping section 1236. By way of example, when the tow bar 1204 is in the shortened position 1246, the flange 1258 may engage with the shoulder 1254 to prevent translation of the shoulder 1254 past the flange 1258.

Referring still to FIG. 109, vehicle 10 and the skate 1200 use a conduit management system 1264 to facilitate coupling the vehicle 10 and the skate 1200 together with a conduit 1266 (e.g., tether, tube, hose, etc.). According to an exemplary embodiment, the conduit management system 1264 may be or include the tow bar 1204 (e.g., the first lateral section 1208, the second lateral section 1212, and the longitudinal section 1216) defining an interior cavity 1262. In some embodiments, the conduit 1266 is configured to be routed from the vehicle 10 to the skate 1200 through the tow bar 1204 via the interior cavity 1262. The conduit 1266 is configured to facilitate transferring at least one of (i) electrical energy, (ii) fluid power, or (iii) information between the vehicle 10 and the skate 1200. The tow bar 1204 may support a portion of the conduit 1266 extending between and coupling the vehicle 10 with the skate 1200 (e.g., support the conduit 1266 extending across the space defined by the distance between the vehicle 10 and the skate 1200).

In some embodiments, the conduit 1266 is or includes an electrical energy transfer conduit (e.g., wire, cable, etc.) configured to transfer electrical energy between the vehicle 10 and the skate 1200. In such embodiments, the conduit 1266 electrically couples an electrical energy source of the vehicle 10 (e.g., the batteries 110) with the skate 1200 to facilitate delivering electrical energy to one or more components thereof and power the same. By way of example, the conduit 1266 may be configured to deliver electrical energy from the batteries 110 of the vehicle 10 to power a control system (e.g., control system 1300) of the skate 1200, the user interface 1232, the actuators 116 of the lifting implement 50 included in the skate 1200 (e.g., in an embodiment where the actuators 116 are electrically powered), or other components of the skate 1200.

In some embodiments, the conduit 1266 is or includes a fluid transfer conduit (e.g., hose, pipe, tube, hydraulic fluid line, pneumatic fluid line, etc.) configured to transfer fluid power between the vehicle 10 and the skate 1200. In such embodiments, the conduit 1266 fluidly couples a fluid supply source of the vehicle 10 (e.g., the hydraulic system 120, a pneumatic pump, etc.) with the skate 1200 to facilitate delivering fluid power to one or more components thereof. By way of example, the conduit 1266 may be configured to supply pressurized hydraulic fluid from the hydraulic system 120 of the vehicle 10 to the hydraulic system 120 of the skate 1200 to fluidly power the actuators 116 of the lifting implement 50 included in the skate 1200 (e.g., in an embodiment where the actuators 116 are hydraulically powered) or other components of the skate 1200.

In some embodiments, the conduit 1266 is or includes a data transfer conduit (e.g., wire, cables, CAN, Ethernet, etc.) configured to transfer data between the vehicle 10 and the skate 1200. In such embodiments, the conduit 1266 is a wired connection that communicably couples the control system 100 of the vehicle 10 with skate 1200 to facilitate transmitting information to the skate 1200 to control operation thereof. By way of example, the control system 100 of the vehicle 10 can transmit control signals to a control system (e.g., control system 1300) of the skate 1200 and/or directly to one or more components of the skate 1200 via the conduit 1266 to control operation thereof. Additionally or alternatively, the communication interface 108 may facilitate wireless communication (e.g., through Bluetooth, Wi-Fi, radio transmission, inductive transmission of energy, etc.) between the vehicle 10 and the skate 1200. By way of another example, the control system of the skate 1200 can transmit control signals and/or other information associated with the operation of thereof to the vehicle 10 via the conduit 1266 and/or wirelessly via communications established between a communication interface (e.g., communication interface 1308) of the skate 1200 and the communication interface 108 of the vehicle 10.

Referring to FIG. 110, in addition to or as an alternative to the conduit 1266 coupling (e.g., electrically coupling, fluidly coupling, and/or communicably coupling) the vehicle 10 with the skate 1200 via the interior cavity 1262 of the tow bar 1204, the conduit management system 1264 may be or include a flexible rod (e.g., flexible member, deformable member, etc.), shown as conduit rod 1270, configured to support the conduit 1266 to facilitate routing the conduit 1266 between the vehicle 10 and the skate 1200. As shown in FIG. 110, the conduit rod 1270 may be configured to couple to the vehicle 10 and the skate 1200. The conduit rod 1270 may be configured to deform (e.g., bend, arc, curl, etc.) when the vehicle 10 and the skate 1200 are brought closer together. By way of example, when the vehicle 10 and the skate 1200 are spaced by a distance D₁ that is shorter than a distance D₂, the conduit rod 1270 deforms to accommodate for the change in distance while remaining coupled to each of the vehicle 10 and the skate 1200. The conduit rod 1270 may be manufactured from one or more sections of straight or bent sections. The conduit rod 1270 may be manufactured from a material such as fiberglass or another suitable material capable of withstanding repeated deformation. The conduit rod 1270 may include an interior cavity configured to receive the conduit 1266 and support a portion of the conduit 1266 extending between and coupling the vehicle 10 with the skate 1200 (e.g., support the conduit 1266 extending across the space defined by the distance between the vehicle 10 and the skate 1200).

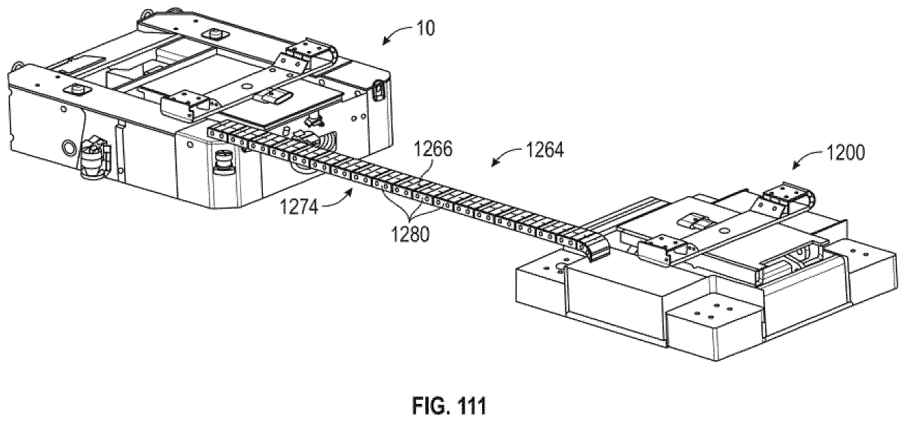

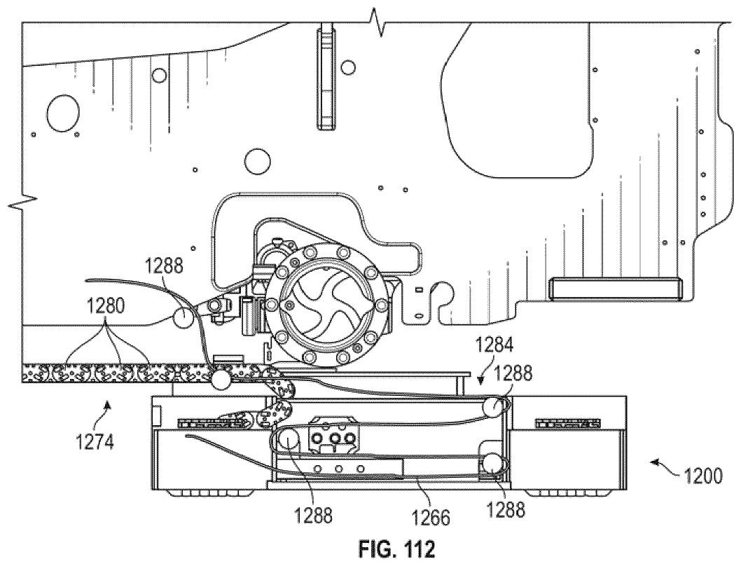

Referring to FIGS. 111 and 112, in addition to or as an alternative to the conduit 1266 coupling the vehicle 10 with the skate 1200 via the interior cavity 1262 of the tow bar 1204, the conduit management system 1264 may be or include a power track (e.g., cable guide, cable support linkage, etc.), shown as conduit track 1274, to facilitate routing the conduit 1266 between the vehicle 10 and the skate 1200. The conduit track 1274 may be a flexible chain configured to couple to the vehicle 10 at a first end and coupled to the skate 1200 at a second end opposite the first end. The conduit track 1274 may include a plurality of links 1280 pivotably linked together such that the conduit track 1274 can bend and flex. The links 1280 may be arranged in series (i.e., in a chain) and may be rotatable with respect to adjacent links 1280. In some embodiments, the links 1280 are rotatable in only a first direction of rotation relative to adjacent links 1280. This rotation may cause conduit track 1274 to bend or fold in a predictable manner (e.g., in a predictable direction, at a predictable angle, etc.). By way of example, as shown in FIG. 112, the second end of the conduit track 1274 is coupled to the skate 1200 and the conduit track 1274 is configured to bend and roll along a top surface of the skate 1200 to accommodate for a change in distance between the skate 1200 and the vehicle 10. In some embodiments, when the conduit track 1274 is fully extended, no portion of the conduit track 1274 is rolled along the top surface of the skate 1200, and as the vehicle 10 and the skate 1200 come closer together, at least a portion of the conduit track 1274 bends and rolls along the top surface of the skate 1200 (as shown in FIG. 112). The conduit track 1274 may be configured to accommodate (e.g., receive, contain, etc.) the conduit 1266 to support a portion of the conduit 1266 extending between and coupling the vehicle 10 with the skate 1200 (e.g., support the conduit 1266 extending across the space defined by the distance between the vehicle 10 and the skate 1200), thereby providing a flexible and protected path for the conduit 1266 accommodated therein. In some embodiments, the conduit track 1274 is configured to bend and roll along a top surface 30 of the vehicle 10 to accommodate for a change in distance between the skate 1200 and the vehicle 10.

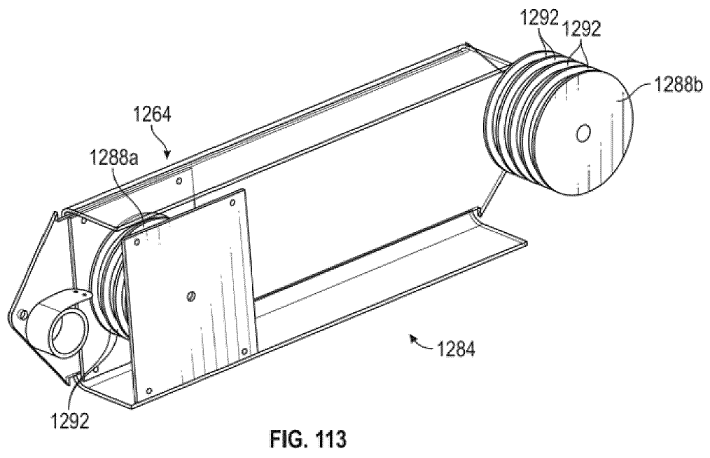

Referring to FIGS. 112 and 113, the conduit management system 1264 may be or include a pulley system 1284 to facilitate letting out the conduit 1266 and taking up the conduit 1266 as the distance between the vehicle 10 and the skate 1200 changes. As shown, the pulley system 1284 includes a plurality of pulleys 1288 each including one or more journals 1292 (e.g., cable supports, cable tracks, etc.) configured to receive at least a portion of the conduit 1266 and retain the portion of the conduit 1266 (e.g., during take-up and let-out of the conduit 1266). The pulley system 1284 can facilitate routing the conduit 1266 in a compact and organized manner. The pulleys 1288 may be positioned and oriented to control the direction in which the conduit 1266 is routed (e.g., to supply the conduit 1266 to a desired location, to route the conduit 1266 to avoid one or more obstacles, etc.).

Referring to FIG. 113, the pulley system 1284 may include a fixed pulley 1288a and a translatable pulley 1288b configured to translate relative to the fixed pulley 1288a. The translatable pulley 1288b may be biased (e.g., spring biased) in a direction away from the fixed pulley 1288a. Each of the fixed pulley 1288a and the translatable pulley 1288b are shown to include four journals 1292. In some embodiments, the pulleys 1288 include more or fewer than four journals 1292. The journals 1292 may be configured to receive the conduit 1266 such that the conduit 1266 is routed (e.g., snaked) between the fixed pulley 1288a and the translatable pulley 1288b. When the distance between the vehicle 10 and the skate 1200 is increased, the pulley system 1284 may let-out a section of the conduit 1266 to accommodate for the increased distance. The translatable pulley 1288b may overcome the bias and translate in a direction towards the fixed pulley 1288a to let-out the conduit 1266 received in the journals 1292. The number of the journals 1292 included in the fixed pulley 1288a and the translatable pulley 1288b (and about which the conduit 1266 is routed) is correlated with the length of conduit 1266 let-out therefrom. By way of example, with four journals 1292 each, the amount of conduit 1266 that is let-out may be eight times greater than the amount that the translatable pulley 1288b translates. In other words, with four journals 1292 each, for every inch of translation of the translatable pulley 1288b in a direction towards the fixed pulley 1288a, eight inches of conduit 1266 may be let-out from the pulley system 1284. When the distance between the vehicle 10 and the skate 1200 is decreased, the pulley system 1284 may take-up a section of the conduit 1266 to accommodate for the decreased distance. By way of example, the translatable pulley 1288b may translate in a direction away from the fixed pulley 1288a (e.g., due to being biased away from the fixed pulley 1288a) to take-up the conduit 1266.

In some embodiments, the when the vehicle 10 and the skate 1200 are cooperatively operating to facilitate steering the product and distributing the weight of the product during transportation, the conduit 1266 may be routed between the vehicle 10 and the skate 1200 along the product. By way of example, at least a portion of the section of the conduit 1266 extending between the vehicle 10 and the skate 1200 may be coupled to the product (e.g., by one or more hooks, adhesives, fasteners, channels, tip-ties, etc.). By way of another example, the conduit 1266 may be supported by (e.g., rest on, couple with, etc.) one or more components of the product (e.g., a frame of the telehandler 56).

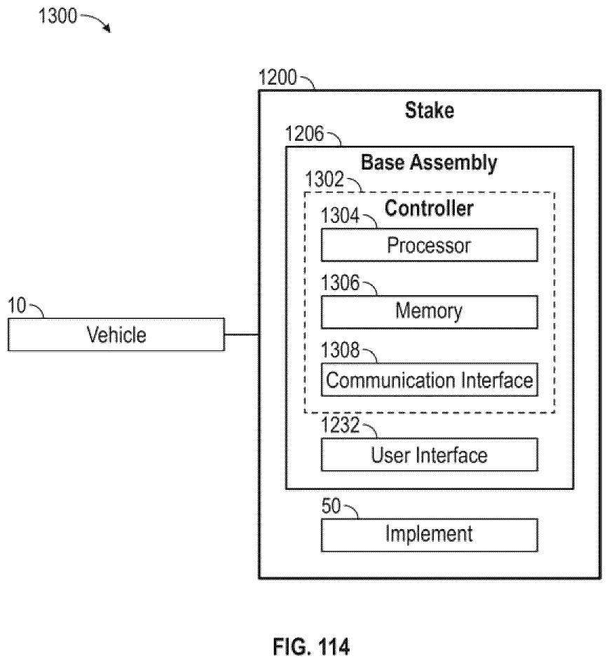

Referring to FIG. 114, the skate 1200 and a control system 1300 for the skate 1200 are shown according to an exemplary embodiment. The control system 1300 may facilitate operation of the skate 1200 and/or other devices of a production environment. The skate 1200 may include a controller 1302 that controls operation of the skate 1200. The controller 1302 includes a processing circuit, shown as processor 1304, and a memory device, shown as memory 1306. The memory 1306 may contain one or more instructions that, when executed by the processor 1304, cause the processor to perform the various functions described herein. The controller 1302 further includes a communication interface 1308 (e.g., a communication circuit, a network interface, etc.) that facilitates communication with (e.g., to and from) other components of the skate 1200 and/or the control system 1300. The communication interface 1308 may facilitate wired communication (e.g., via the conduit 1266, through CAN, Ethernet, communication of power, etc.). Additionally or alternatively, the communication interface 1308 may facilitate wireless communication (e.g., through Bluetooth, Wi-Fi, radio transmission, inductive transmission of energy, etc.).

The base assembly 1206 may include one or more user interfaces 1232. The user interface 1232 may be configured as an emergency stop button that can be engaged by a user to manually override one or more operations of the vehicle 10, the skate 1200, and/or any one or more components included therein. As described in greater detail above, the user interface 1232 may include one or more other operator interface elements (e.g., input devices, output devices, etc.).

The skate 1200 includes the implement 50 configured to receive and directly support a product and raise or lower the product. The controller 1302 may control operation of the implement 50 and the components thereof.

The control system 1300 may include the vehicle 10 and the skate 1200. The vehicle 10 and the skate 1200 may be coupled (e.g., electrically coupled, fluidly coupled, and/or communicably coupled) to each other via the conduit 1266. The controller 1302 of the skate 1200 may control the transfer of electrical energy, the transfer of fluid power, and/or the transfer of data between the vehicle 10 and the skate 1200. By way of example, responsive to a signal received from the controller 1302 of the skate 1200, the vehicle 10 may (i) transfer electrical energy from the batteries 110 of the vehicle 10 to power one or more components of the skate 1200, (ii) transfer fluid power from the hydraulic system 120 to fluidly power one or more components of the skate 1200, and/or (iii) transfer data associated with the operation of the vehicle 10 to the skate 1200 (e.g., to control one or more components of the skate 1200) via the conduit 1266. In some embodiments, the skate 1200 transmits data associated with the operation thereof to the vehicle 10 (e.g., wirelessly via the communication interface 1308 and/or via a wired connection). Responsive to the data, the controller 102 of the vehicle 10 may determine whether to transfer electrical energy, fluid power, and/or data to the skate 1200. In some embodiments, the controller 102 is communicably coupled with the skate 1200 to control operation of the components thereof. In such an embodiment, the skate 1200 does not include the controller 1302 and operational control and processing is performed remote from the skate 1200 (e.g., by the controller 102, by a remote server, etc.).

In some embodiments, the skate 1200 includes one or more sensors (e.g., sensors 112) operatively coupled to the controller 1302 and/or the controller 102. The sensors may provide sensor data indicative of the current status of the vehicle 10, the skate 1200, and/or the surrounding environment. In such embodiments, vehicle 10 may communicate with the skate 1200 to share information and facilitate operation. By way of example, the vehicle 10 may provide commands to the skate 1200 to coordinate transportation of a large item that is carried by both the vehicle 10 and the skate 1200. By way of another example, the vehicle 10 may provide its location to the skate 1200 to facilitate path generation and avoid collisions. In such embodiments, the skate 1200 may include one or more drive motors (e.g., drive motors 42) to provide rotational mechanical energy to drive rotation of one or more tractive elements and propel the skate 1200 to maintain a fixed distance from the vehicle 10 without the use of the tow bar 1204.

### Vehicle Coupling

Referring generally to the figures, a vehicle that is utilized in a manufacturing line or process is shown. The vehicle includes a frame and a base assembly coupled to the frame. The base assembly is configured to couple various implements to the frame, and the implements facilitate positioning, supporting, and/or lifting of a component of a product (e.g., a telehandler or an axle assembly of a telehandler). In some embodiments, the implement includes a lift implement with a cradle that receives and supports the component of the product and a lift assembly coupled between the cradle and the base assembly. The lift assembly includes a platform to which the cradle is rotatably coupled to.

In some embodiments, a first vehicle and a second vehicle (that are substantially similar or identical to each other) cooperatively support the product for movement, and the front vehicle (e.g., the first vehicle or the second vehicle) may turn relative to the rear vehicle (e.g., the first vehicle or the second vehicle) via drive motors or a steering motor. As the front vehicle turns relative to the rear vehicle, the cradle of the front vehicle may rotate relative to the platform of the front vehicle and permit the two vehicles to turn. The first vehicle and the second vehicle each include a rotation locking assembly configured to selectively permit or inhibit rotation of the cradle relative to the platform based on which vehicle of the first vehicle or the second vehicle is the front vehicle. The rotation locking assembly includes a pin configured to extend within an aperture of a bracket coupled with the cradle and an aperture of the platform in a first position to inhibit rotation of the cradle relative to the platform. The pin is movable out of the first position (e.g., out of engagement with the cradle and the platform) to a second position to permit rotation of the cradle relative to the platform.

To transition from a first configuration in which the first vehicle is the front vehicle and the second vehicle is the rear vehicle to a second configuration in which the second vehicle is the front vehicle and the first vehicle is the rear vehicle, a pin of the first vehicle is transitioned from the second position to the first position and the pin of the second vehicle is transitioned from the first position to the second position. Similarly, to transition from the first configuration to the second configuration, the pin of the first vehicle is transitioned from the first position to the second position and the pin of the second vehicle is transitioned from the second position to the first position. Transitioning between the first configuration and the second configuration is advantageous in certain operational scenarios in which it is difficult or impossible (e.g., due to space constraints) to transition the front vehicle (e.g., turn the front vehicle and the rear vehicle supporting the product) from traveling in a first direction to traveling in a second direction opposite the first direction while remaining in one of the first configuration or the second configuration.

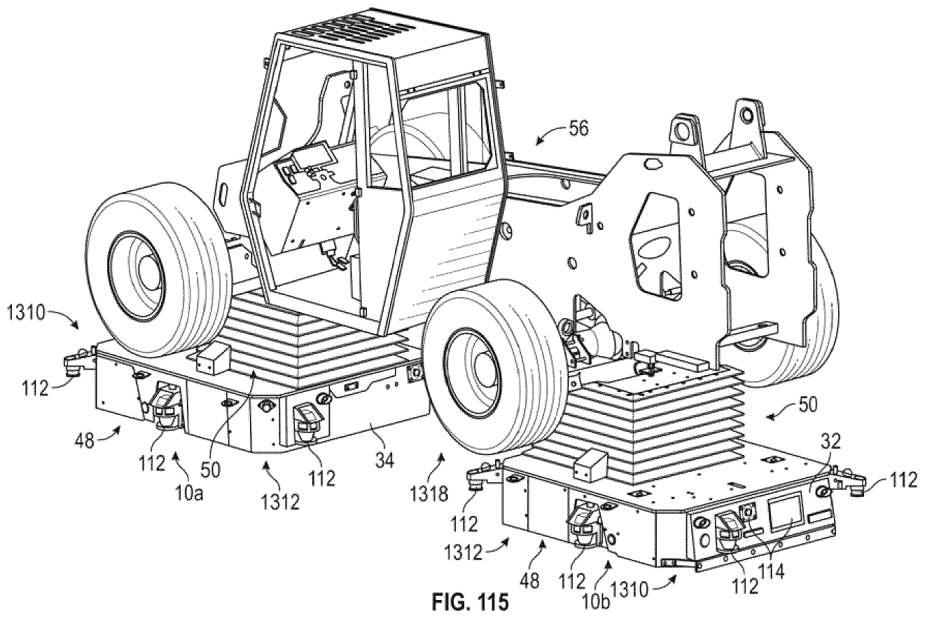

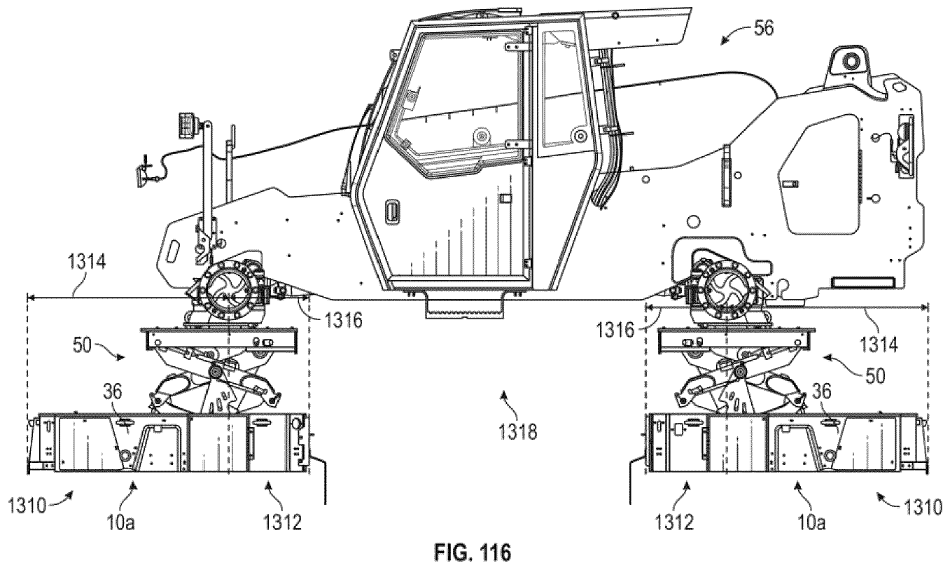

As shown in FIGS. 115 and 116, the vehicle 10 is a first vehicle 10a utilized with a second vehicle 10b to support a product such as the telehandler 56. The first vehicle 10a and the second vehicle 10b may cooperatively operate to facilitate moving the product, steering the product, and distributing the weight of the product during transportation. The first vehicle 10a and the second vehicle 10b may substantially similar and perform substantially similar operations. By way of example, each of the first vehicle 10a and the second vehicle 10b include a frame 12, a drivetrain 40, a base assembly 48, a lifting implement 50, and a control system 100.

According to an exemplary embodiment, any of the functions or processes described herein with respect to the first vehicle 10a may be performed by the second vehicle 10b. In such an embodiment, any of the functions or processes described herein with respect to the control system 100 of the first vehicle 10a may be performed by the control system 100 of the second vehicle 10b and/or one or more servers (e.g., remote devices 134). By way of example, data collection may be performed by the control system 100 of the first vehicle 10a and control over one or more components to move or steer the product may be performed by the control system 100 of the second vehicle 10b. By way of example, data collection may be performed by the control system 100 of the second vehicle 10b and control over one or more components to move or steer the product may be performed by the control system 100 of the first vehicle 10a. By way of still another example, a first portion of data collection may be performed by the control system 100 of the first vehicle 10a, a second portion of data collection may be performed by the control system 100 of the second vehicle 10b, and control over one or more components to move or steer the product may be performed by the control system 100 of the first vehicle 10a and/or the control system 100 of the second vehicle 10b.

As shown in FIGS. 115 and 116, the vehicle 10 defines a long side (e.g., first longitudinal side, a first portion of the base assembly 48, etc.), shown as first side 1310, and a short side (e.g., second longitudinal side, a second portion of the base assembly 48, etc.), shown as second side 1312. The first side 1310 defines a length (e.g., longitudinal length extending in a longitudinal direction), shown as first length 1314, from the front surface 32 to a center axis of an axle of the telehandler 56. The second side 1312 defines a length (e.g., longitudinal length extending in a longitudinal direction), shown as second length 1316, from the rear surface 34 to the center axis of an axle of the telehandler 56. According to an exemplary embodiment, the first length 1314 is greater than the second length 1316 such that the first side 1310 is longitudinally longer than the second side 1312 (e.g., the first side 1310 extends farther away from the lifting implement 50 than the second side 1312). In some embodiments, the first length 1314 is a length between the front surface 32 and a respective point (e.g., arbitrary location) along a longitudinal length of the vehicle 10 and the second length 1316 is a length between the rear surface 34 and the same respective point such that the first side 1310 is longitudinally longer than the second side 1312. In such embodiments, the respective point along the longitudinal length of the vehicle 10 is different than the center axis of an axle of the telehandler 56. By way of example, the respective point may be a location of the cradle 52.

As shown in FIGS. 115 and 116, the first vehicle 10a and the second vehicle 10b are collectively supporting the telehandler 56 and are longitudinally spaced apart by a distance such that the first vehicle 10a and the second vehicle 10b define a space 1318 therebetween. The first vehicle 10a is oriented in a first direction with the first side 1310 thereof away from the space 1318 (e.g., the front surface 32 facing away from the space 1318) and the second side 1312 thereof adjacent to the space 1318 (e.g., the second side 1312 of the second vehicle 10b being closer to the space 1318 than the first side 1310, the rear surface 34 facing the space 1318, etc.). The second vehicle 10b is oriented in a second direction opposite the first direction (e.g., 180 degrees about a vertical axis) with the first side 1310 thereof away from the space 1318 (e.g., the front surface 32 facing away from the space 1318) and the second side 1312 thereof adjacent to the space 1318 (e.g., the second side 1312 of the second vehicle 10b being closer to the space 1318 than the first side 1310, the rear surface 34 facing the space 1318, etc.). In other words, when the first vehicle 10a and the second vehicle 10b are collectively supporting the telehandler 56 and the first vehicle 10a and the second vehicle 10b are not being steered (e.g., traveling in a substantially straight direction, oriented substantially parallel with the telehandler 56, etc.) the first vehicle 10a and the second vehicle 10b are facing opposite directions (e.g., the second vehicle 10b is rotated about 180 degrees about a vertical axis relative to the first vehicle 10a).

With the first vehicle 10a and the second vehicle 10b oriented as shown and described, when the first vehicle 10a and/or the second vehicle 10b are steered to turn the product supported thereby, the first vehicle 10a does not contact the second vehicle 10b. By way of example, one or both of the first vehicle 10a or the second vehicle 10b were oriented with the first side 1310 positioned proximate the space 1318, when the first vehicle 10a and/or the second vehicle 10b are steered to turn the product, the first vehicle 10a and the second vehicle 10b may contact each other and potentially cause damage (e.g., scrapes, abrasions, dents, etc.) to each other. Further, with the first sides 1310 of the first vehicle 10a and the second vehicle 10b positioned away from the space 1318, the space 1318 is larger (e.g., compared to the space 1318 if one or both of the first vehicle 10a or the second vehicle 10b were oriented with the first side 1310 positioned proximate the space 1318) to provide access to a greater area of the bottom surface of the product.

As shown in FIG. 115, the user interface 114 is positioned at the first side 1310 along the front surface 32 of the vehicle 10. The first vehicle 10a and the second vehicle 10b are oriented with the first side 1310 and the front surface 32 facing outwards and away from the space 1318 such that an operator can access (e.g., provide inputs to, receive information from, etc.) the user interface 114 with out needing to enter the space 1318 between the first vehicle 10a and the second vehicle 10b and below the product supported thereby.

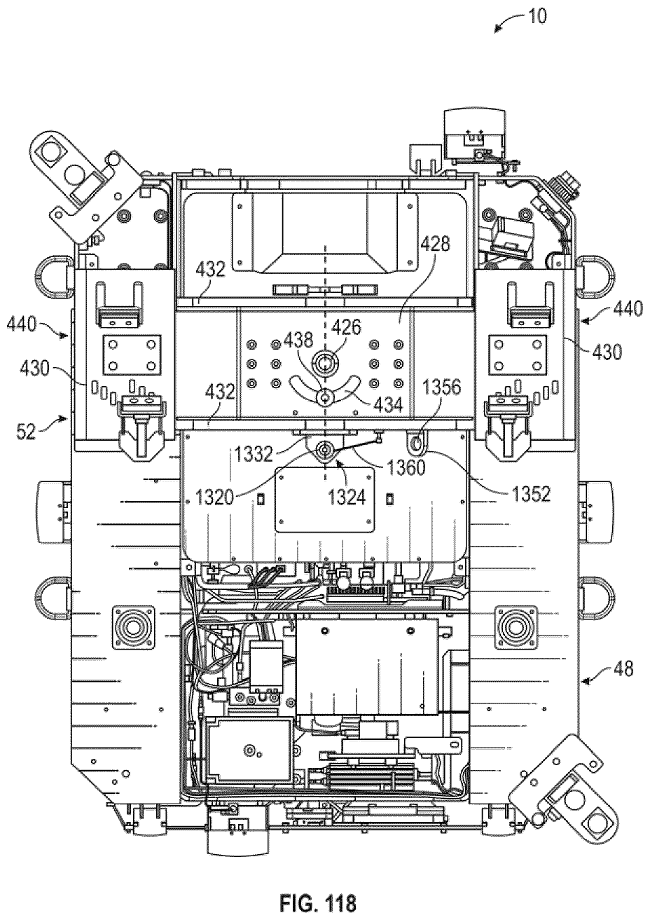

As shown in FIG. 118, and as discussed in greater detail above, the cradle base 428 includes the rotation slot 434 through which the pin 438 is received. The cradle base 428 is rotatable relative to the top platform 402 via the cradle pin 426 and the rotation slot 434 is arcuate to define a rotational range for the cradle base 428 to rotate in relative to the top platform 402. The ends of the rotation slot 434 serve as mechanical stops with which the pin 438 engages to inhibit rotation of the cradle base 428 beyond (e.g., outside of, past, etc.) the rotational range. The rotational coupling between the cradle 52 and the top platform 402 via the cradle pin 426 enables steering operation for the vehicle 10. The first vehicle 10a and the second vehicle 10b may support the telehandler 56 during the manufacturing line process, and the front vehicle 10 (e.g., the first vehicle 10a or the second vehicle 10b) may turn relative to the rear vehicle 10 (e.g., the first vehicle 10a or the second vehicle 10b) via the drive motors 42 or a steering motor. As the front vehicle 10 turns relative to the rear vehicle 10, the cradle 52, which supports the telehandler 56, of the front vehicle 10 may rotate relative to the top platform 402 of the front vehicle 10 and permit the two vehicles 10 to turn (e.g., the two vehicles 10 are not restricted to travel in a straight line).

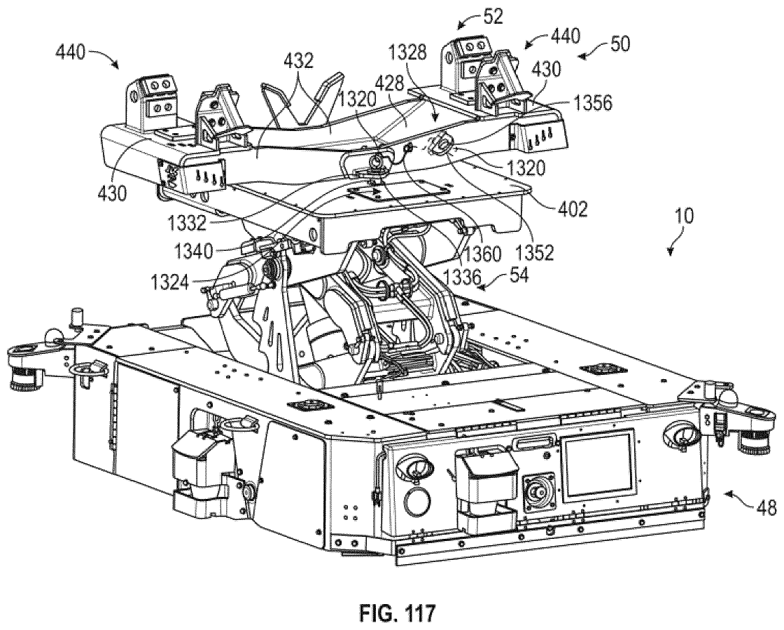

As shown in FIGS. 117 and 118, the vehicle 10 includes a rotation locking assembly including a locking pin (e.g., fastener, bolt, etc.), shown as pin 1320, that is movable between a locked position, shown as first position 1324, and an unlocked position, shown as second position 1328. In the first position 1324, the pin 1320 is received within (i) a first aperture, shown as first bracket aperture 1336, of a first bracket 1332, and (ii) a second aperture, shown as platform aperture 1340, of the top platform 402. The first bracket 1332 is coupled to and extends away from the cradle arm 432 closest to the front end portion of the vehicle 10. In other embodiments, the first bracket 1332 is positioned along the cradle arm 432 closest to the rear end portion of the vehicle 10. As shown in FIG. 19, a pin support (e.g., support member), shown as shoulder 1348, extends from a bottom surface 1344 of the top platform 402 and defines at least a portion of the platform aperture 1340 extending through the top platform 402. The shoulder 1348 is configured to circumferentially engage with a portion of the pin 1320 (e.g., when the pin 1320 is in the first position 1324) to support the pin 1320 and provide additional rigidity to the pin 1320. By way of example, when the pin 1320 is in the first position 1324 and a load is exerted on the pin 1320 (e.g., by the cradle base 428 and/or the top platform 402), the shoulder 1348 may reinforce the pin 1320 by distributing the load across the shoulder 1348 to prevent deformation of the pin 1320 under the load. In some embodiments, the top platform 402 does not include the shoulder 1348.

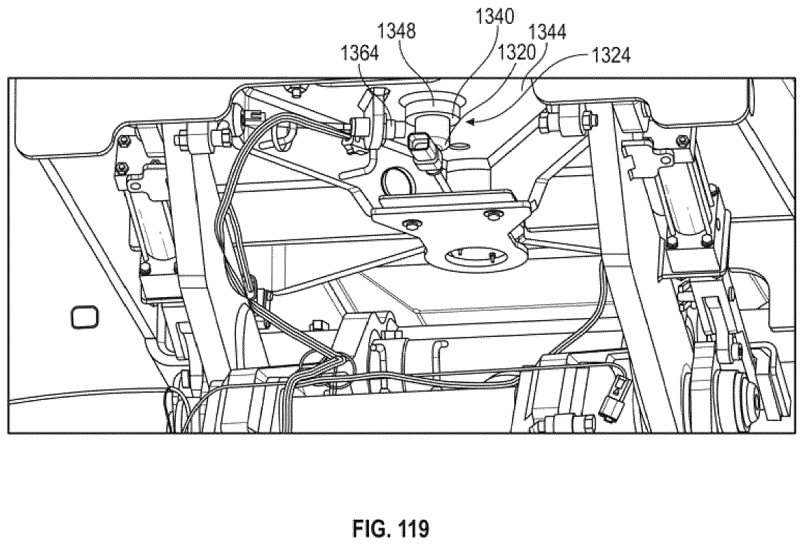

As shown in FIG. 117, the first bracket aperture 1336 extends through (e.g., vertically) the first bracket 1332, and, as shown in FIG. 119, the platform aperture 1340 extends through (e.g., vertically) the top platform 402. In the first position 1324, the pin 1320 is received in the first bracket aperture 1336 defined by the first bracket 1332 to engage with the cradle 52 and the platform aperture 1340 defined by the top platform 402 to engage with the top platform 402 such that rotation of the cradle 52 relative to the top platform 402 is inhibited. Specifically, in the first position 1324, the pin 1320 retains the cradle 52 in a position such that the pin 438 is substantially centered along the arc defined by the rotation slot 434 and the centerline 436 extends through the pin 438. In other words, in the first position 1324, the pin 1320 retains the cradle 52 such that the axle supported thereby is substantially perpendicular to a direction of travel of the vehicle 10 supporting the axle. In the first position 1324, rotation of the cradle 52 relative to the top platform 402 is inhibited such that the cradle 52 is rotationally fixed and inhibited from rotating in a first direction (e.g., clockwise) relative to the top platform 402 and in a second direction (e.g., counterclockwise) relative to the top platform 402.

In the second position 1328, the pin 1320 extends through a third opening, shown as second bracket opening 1356, defined by a second bracket 1352. As shown in FIGS. 117 and 118, the second bracket 1352 is coupled to and extends away from the cradle arm 432 closest to the front end portion of the vehicle 10. In other embodiments, the second bracket 1352 is positioned along the cradle arm 432 closest to the rear end portion of the vehicle 10. When the pin 1320 is in the second position 1328, rotation of the cradle 52 relative to the top platform 402 is permitted (e.g., not inhibited by the pin 1320) to facilitate steering the vehicle 10 in both directions (e.g., right and left). When the pin 1320 is in the second position 1328, the second bracket 1352 and the second bracket opening 1356 may secure the pin 1320 to prevent unintentional movement thereof when the pin 1320 is not in use. By way of example, when the pin 1320 is not in the first position 1324 such that rotation of the cradle 52 is permitted, the second bracket 1352 and the second bracket opening 1356 may secure the pin 1320 to prevent unintentional movement thereof during driving operations of the vehicle 10. In some embodiments, the vehicle 10 does not include the second bracket 1352 such that the pin 1320 is otherwise stored when not in the first position 1324. By way of example, the vehicle 10 may include a space (e.g., a pocket, a hook, a compartment, etc.) to store or otherwise secure the pin 1320 when not in use.

As shown in FIGS. 117 and 118, the vehicle 10 includes a tether (e.g., rope, string, cable, chain, strap, etc.), shown as cord 1360, coupled between the pin 1320 and the cradle arm 432 to which the first bracket 1332 and the second bracket 1352 are coupled. The cord 1360 may be manufactured from a flexible, pliable, bendable, etc., material to provide free movement of the pin 1320 (e.g., when the pin 1320 is not in the first position 1324) relative to the vehicle 10 (e.g., within a range defined by a length of the cord 1360). The cord 1360 is configured to prevent the pin 1320 from being lost or misplaced when it is not secured or stored in the first position 1324 or the second position 1328, respectively. In some embodiments, the vehicle 10 does not include the cord 1360.

When the cradle 52 is positioned (e.g., rotated) such that the first bracket aperture 1336 is aligned (e.g., vertically aligned, vertically coaxial, etc.) with the platform aperture 1340, the first bracket aperture 1336 and the platform aperture 1340 may cooperatively receive the pin 1320 (e.g., in the first position 1324) to inhibit rotation of the cradle 52. Similarly, in such a position, the pin 1320 may be removed from the first bracket aperture 1336 and the platform aperture 1340 out of engagement with the cradle 52 and the top platform 402 (e.g., by an operator) and placed in the second bracket opening 1356 to transition (e.g., move) the pin 1320 to the second position 1328. In some embodiments, the pin 1320 is otherwise moveable to transition between the first position 1324 and the second position 1328 (or another position that is not the first position 1324) to selectively permit rotation of the cradle 52 relative to the top platform 402. By way of example, the pin 1320 may be coupled with a solenoid configured to move the pin 1320 between the first position 1324 and the second position 1328 (or another position that is not the first position 1324). In some embodiments, the rotation locking assembly does not include the pin 1320 and uses another suitable mechanism to selectively permit rotation of the cradle 52 relative to the top platform 402. By way of example, the rotation locking assembly may include a lock (e.g., a pad lock) configured to lock in the first position 1324 or the second position 1328 (or another position that is not the first position 1324) such that an operator with access to the lock (e.g., an operator with a key to lock/unlock the lock, an operator with a password (e.g., pin, combination, etc.), etc.) can transition the lock between the first position 1324 and the second position 1328 (or another position that is not the first position 1324). By way of another example, the rotation locking assembly may include an electromagnetic lock configured to selectively magnetically couple the cradle 52 with the top platform 402. By way of another example, the rotation locking assembly may include a brake system configured to selectively induce a friction force between the cradle 52 and the top platform 402.

As shown in FIG. 119, the vehicle 10 includes a sensor 1364 configured to monitor a position of the pin 1320 and transmit a signal associated with information acquired to the control system 100. The sensor 1364 may include proximity sensors, motion sensors, position sensors (e.g., Hall effect sensors, limit switches, encoders, etc.), vision sensors, cameras, among others operatively coupled to the controller 102. The sensor 1364 may provide sensor data indicative of a position of the pin 1320 to the controller 102 to determine whether the pin 1320 is in the first position 1324 (and the rotation locking assembly is in a locked state) or the second position 1328 (and the rotation locking assembly is in an unlocked state). As shown in FIG. 119, the sensor 1364 is positioned along the bottom surface 1344 of the top platform 402 and configured to monitor whether the pin 1320 is extending through the platform aperture 1340. In some embodiments, the vehicle 10 includes a sensor 1364 (e.g., in addition to the sensor 1364 positioned along the bottom surface 1344) positioned and configured to monitor whether the pin 1320 is received in the first bracket aperture 1336 of the first bracket 1332. In other embodiments, a single sensor 1364 is configured to monitor whether the pin 1320 is received in one or both of the first bracket aperture 1336 and the platform aperture 1340. In some embodiments, the vehicle 10 includes a sensor 1364 positioned and configured to monitor whether the pin 1320 is received in the second bracket opening 1356 of the second bracket 1352 in the second position 1328.

According to an exemplary embodiment, the rotation locking assembly enables selectively permitting and inhibiting rotation of the cradle 52 relative to the top platform 402 for the first vehicle 10a and the second vehicle 10b to enable steering of the first vehicle 10a and the second vehicle 10b while supporting the telehandler 56. As described herein, the first vehicle 10a and the second vehicle 10b may support the telehandler 56 (e.g., during the manufacturing line process), and the front vehicle 10 of the first vehicle 10a or the second vehicle 10b may turn relative to the rear vehicle 10 of the other one of the first vehicle 10a or the second vehicle 10b via the drive motors 42 or a steering motor. The pin 1320 of the front vehicle 10 may be positioned in the second position 1328 (or another position not in the first position 1324) such that as the front vehicle 10 turns relative to the rear vehicle 10, the cradle 52, which supports the telehandler 56, of the front vehicle 10 may rotate relative to the top platform 402 of the front vehicle 10, and the pin 1320 of the rear vehicle 10 may be positioned in the first position 1324 such that as the front vehicle 10 turns relative to the rear vehicle 10, the cradle 52 is inhibited from rotating relative to the top platform 402 of the rear vehicle 10 and allow the two vehicles to turn (e.g., the two vehicles are not restricted to travel in a straight line). By way of example, when the first vehicle 10a is the front vehicle 10 and the second vehicle 10b is the rear vehicle 10, the pin 1320 of the first vehicle 10a may be in the second position 1328, and the pin 1320 of the second vehicle 10b may be in the first position 1324. By way of another example, when the second vehicle 10b is the front vehicle 10 and the first vehicle 10a is the rear vehicle 10, the pin 1320 of the second vehicle 10b may be in the second position 1328, and the pin 1320 of the first vehicle 10a may be in the first position 1324. In this manner, regardless of which vehicle 10 of the first vehicle 10a or the second vehicle 10b is the front vehicle 10 and which vehicle 10 of the first vehicle 10a or the second vehicle 10b is the rear vehicle 10, the pin 1320 is repositionable to selectively permit or inhibit rotation of the cradle 52 relative to the top platform 402 depending on the arrangement of the vehicles 10.

According to an exemplary embodiment, to transition from a first configuration in which the first vehicle 10a is the front vehicle 10 and the second vehicle 10b is the rear vehicle 10 to a second configuration in which the second vehicle 10b is the front vehicle 10 and the first vehicle 10a is the rear vehicle 10, the pin 1320 of the first vehicle 10a is transitioned (e.g., moved) from the second position 1328 to the first position 1324 (e.g., removed from the second bracket opening 1356 and received in the first bracket aperture 1336 and the platform aperture 1340) and the pin 1320 of the second vehicle 10b is transitioned from the first position 1324 to the second position 1328 (e.g., removed from the first bracket aperture 1336 and the platform aperture 1340 and received in the second bracket opening 1356). Similarly, to transition from the first configuration to the second configuration, the pin 1320 of the first vehicle 10a is transitioned from the first position 1324 to the second position 1328 and the pin 1320 of the second vehicle 10b is transitioned from the second position 1328 to the first position 1324. In some embodiments, transitioning between the first configuration and the second configuration is advantageous in certain operational scenarios in which it is difficult or impossible (e.g., due to space constraints) to transition the front vehicle 10 (e.g., turn the front vehicle 10 and the rear vehicle 10 supporting the telehandler 56) from traveling in a first direction to traveling in a second direction opposite the first direction while remaining in one of the first configuration or the second configuration. By way of example, if the first vehicle 10a is the front vehicle 10 traveling in a first direction along the manufacturing line 156 between the stations 160 and then needs to travel in a second direction along the manufacturing line 156 (e.g., to a previous stations 160 or another stations 160, after delivering a first telehandler 56 and receiving a second telehandler 56, etc.), instead of turning the first vehicle 10a and the second vehicle 10b supporting the telehandler 56 around such that the first vehicle 10a remains the front vehicle 10, the rotation lock assembly enables transitioning from the first configuration to the second configuration such that the second vehicle 10b becomes the front vehicle 10 and can travel in the second direction along the manufacturing line 156. In some embodiments, the vehicle system includes a single pin 1320 for the rotation locking assemblies of the first vehicle 10a and the second vehicle 10b. By way of example, in the first configuration, the single pin 1320 may be in the first position 1324 at the first vehicle 10a, and in the second configuration, the single pin 1320 may be in the first position 1324 at the second vehicle 10b.

According to an exemplary embodiment, based on the sensor data indicating that the pin 1320 is extending through the first bracket aperture 1336 and the platform aperture 1340, the controller 102 determines that the pin 1320 is in the first position 1324 and that rotation of the cradle 52 relative to the top platform 402 is inhibited. In some embodiments, when the sensor data indicates that the pin 1320 is extending through one of the first bracket aperture 1336 or the platform aperture 1340 and not the other (e.g., the pin 1320 is extending through the first bracket aperture 1336 and not through the platform aperture 1340) or is otherwise improperly received in the first bracket aperture 1336 or the platform aperture 1340, the controller 102 determines that the pin 1320 is not in the first position 1324 and that rotation of the cradle 52 relative to the top platform 402 may be unintentionally permitted. In some embodiments, when the sensor data indicates that the pin 1320 is extending through the second bracket opening 1356, the controller 102 determines that the pin 1320 is in the second position 1328 and that rotation of the cradle 52 relative to the top platform 402 is permitted.

According to an exemplary embodiment, in response to the determination that the pin 1320 of the front vehicle 10 is in the second position 1328 and that the pin 1320 of the rear vehicle 10 is in the first position 1324, the controller 102 facilitates normal, unrestricted operation of the front vehicle 10 and the rear vehicle 10 (e.g., permits operation of the front vehicle 10 and the rear vehicle 10 in a first mode of operation). By way of example, in the first mode of operation, the controller 102 may permit normal, unrestricted operation of the drivetrain 40, the base assembly 48, the lifting implement 50, and/or any other component of the first vehicle 10a and the second vehicle 10b (e.g., the front vehicle 10 and the rear vehicle 10). In some embodiments, in response to a determination that (i) the pin 1320 of the front vehicle 10 is not in the second position 1328 (e.g., in the first position 1324, hanging from the cradle arm 432 by the cord 1360, improperly received in the first bracket aperture 1336 or the platform aperture 1340, etc.) and/or (ii) the pin 1320 of the rear vehicle 10 is not in the first position 1324 (e.g., in the second position 1328, hanging from the cradle arm 432 by the cord 1360, improperly received in the first bracket aperture 1336 or the platform aperture 1340, etc.), the controller 102 (i) limits operation of the front vehicle 10 and/or the rear vehicle 10 (e.g., in a second mode of operation) and/or (ii) provides an alert (e.g., visually or audibly via the user interface 114) indicative of an improper position of the pin 1320 of the front vehicle 10 and/or the rear vehicle 10. By way of example, in the second mode of operation, the controller 102 may (i) limit operation of the drive motors 42 such that the first vehicle 10a and/or the second vehicle 10b cannot exceed a threshold speed (e.g., 5 miles per hour, 2 miles per hour, 0 miles per hour, etc.), (ii) limit operation of the lift assembly 54 such that the lifting implement 50 cannot be raised or lowered, and/or (iii) any other control to limit operation of the first vehicle 10a and/or the second vehicle 10b. The first vehicle 10a and/or the second vehicle 10b may be limited to the second mode of operation until the pin 1320 of the front vehicle 10 is in the second position 1328 and the pin 1320 of the rear vehicle 10 is in the first position 1324.

### Pathing Generation System

Referring generally to the figures, a system includes a vehicle, one or more input devices, and one or more memory devices storing instructions thereon. When executed by one or more processors, the instructions cause the one or more processors to retrieve, from the one or more memory devices, a floorplan of a production system, receive a current position of the vehicle, and receive, from the one or more input devices, one or more inputs. The one or more inputs include one or more of one or more locations in the production system, a footprint of the vehicle, or one or more obstacles. The instructions also cause the one or more processors to generate a route for the vehicle from the current position of the vehicle to the one or more locations based on the one or more inputs.

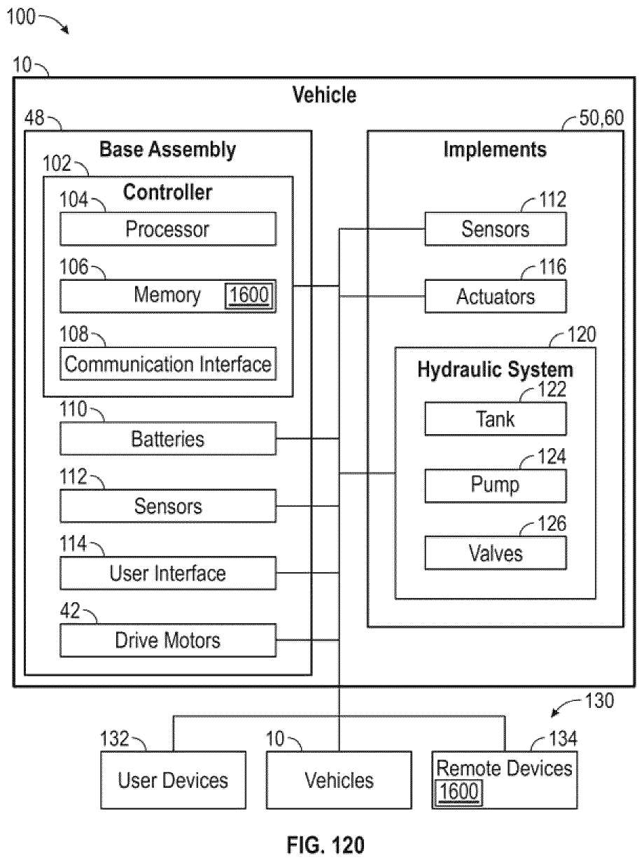

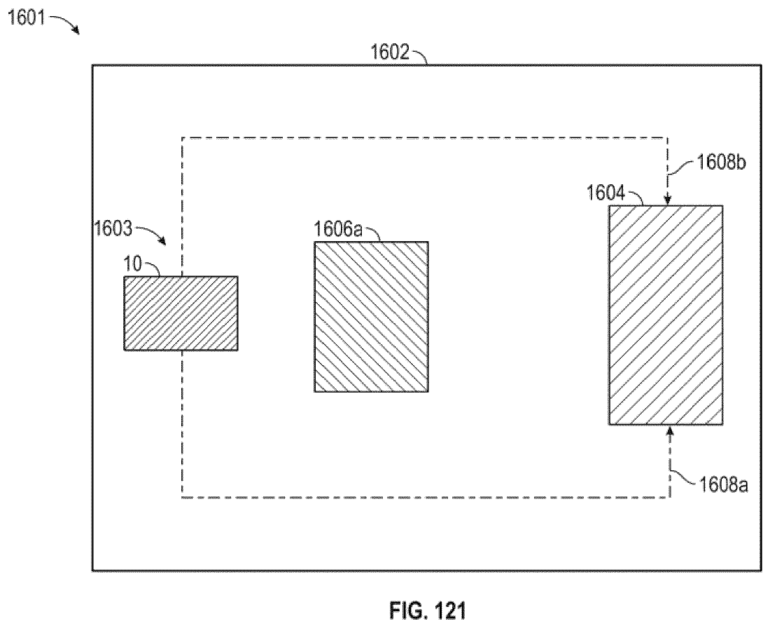

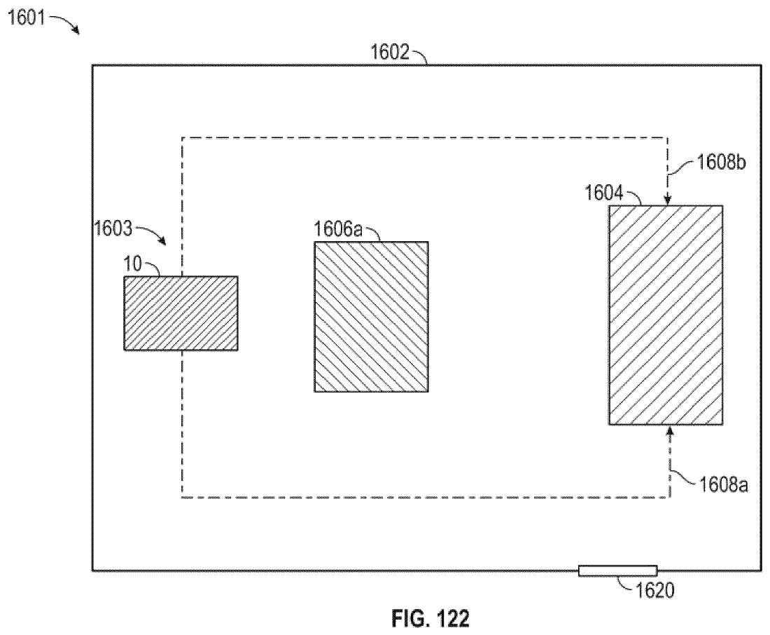

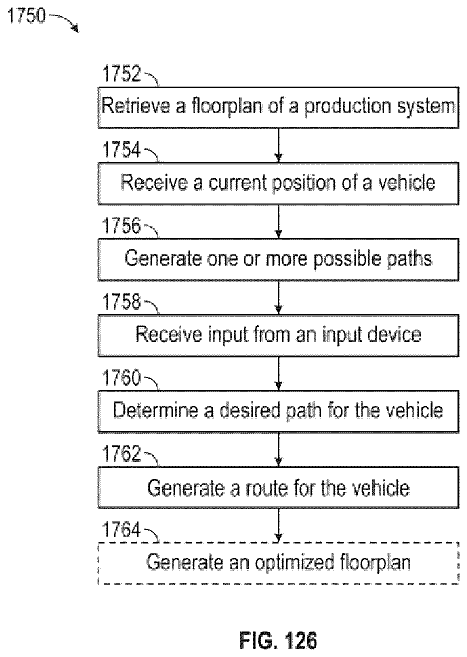

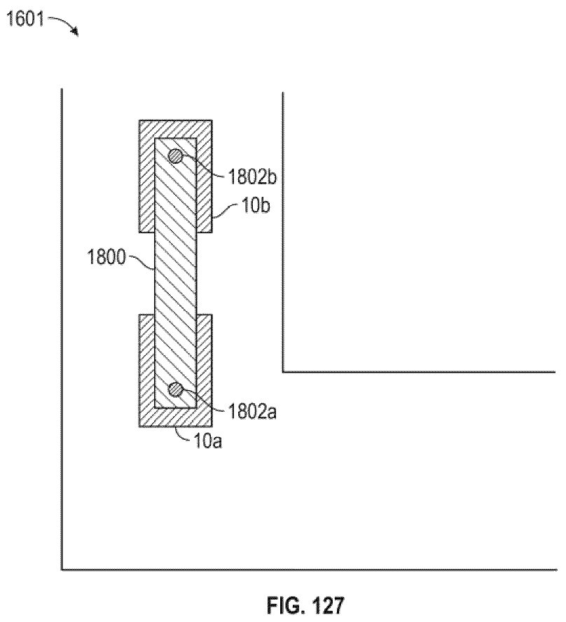

Referring now to FIG. 120, the vehicle 10 and the various components and systems of the vehicle 10 may include a pathing generation system, shown as pathing generation system 1600. Turning now to FIG. 121, the vehicle 10 is shown in a manufacturing environment or production system 1601. Prior to operation of the vehicle 10, a floorplan 1602 (e.g., a layout, etc.) of the production system 1601 may be uploaded to the pathing generation system 1600, such as to the memory 106. A target location 1604 is also shown within the production system. The target location 1604 may be a station (e.g., the station 160) or another area to which the vehicle 10 may need to travel, referred to herein as a target location. The floorplan 1602 may include one or more of the target locations 1604, as well as any other relevant details regarding the layout of the production system 1601. An outer boundary of the floorplan 1602, as depicted in FIGS. 121-126, may serve to represent one or more walls of the production system 1601, another boundary such as an operational boundary of the vehicle 10, or may not have any such bounding significance.

The production system 1601 may include one or more obstacles (e.g., shown in FIG. 121 as obstacle 1606a) such as another station, an object, a machine, a person, an egress point, a staircase, etc. The obstacle 1606a may be in a direct path between the vehicle 10 and the location 1604. As such, the vehicle 10 may need to travel in a path around the obstacle 1606a. The obstacle 1606a may be included in the floorplan 1602 provided to the vehicle 10. In some embodiments, the vehicle 10 may detect the obstacle 1606a (and the target location 1604) via the sensors 112. Once the floorplan 1602 of the production system 1601 is retrieved from the memory 106, the pathing generation system 1600 may generate one or more possible paths for the vehicle 10 to take from an initial location of the vehicle 10 to the location 1604. The pathing generation system 1600 may be in communication with one or more input devices. An operator may use the input device to view and edit the possible paths generated by the pathing generation system 1600 for the vehicle 10 or one or more characteristics of the possible paths such as start points, milestones, and endpoints. For example, the generated possible paths may not take into account the obstacle 1606a, for various reasons. The obstacle 1606a may be movable or not permanent, and therefore may not always be in the same current location. The operator can edit the floorplan 1602 to include one or more of the obstacles 1606a if the obstacle 1606a is not already accounted for in the floorplan 1602.

Once the operator has edited the floorplan 1602 to include the obstacle 1606a, if necessary, the pathing generation system 1600 may generate one or more routes, such as route 1608a and route 1608b, of possible paths from the current location 1603 of the vehicle 10 to the target location 1604. As shown in FIG. 121, there may be one or more paths that the vehicle 10 could take to circumvent the obstacle 1606a. In some embodiments, there may be only on possible path for the vehicle 10, or in other embodiments, there may be many possible paths for the vehicle 10. In the embodiment of FIG. 121, the route 1608a and the route 1608b are substantially the same. For example, the route 1608a and the route 1608b may be substantially the same distance, it may take the vehicle 10 substantially the same amount of time to traverse the route 1608a and the route 1608b, the route 1608a and the route 1608b may have substantially the same rate of efficiency, etc. In such a scenario, it may not matter whether the vehicle 10 travels the route 1608a or the route 1608b. The pathing generation system 1600 may automatically pick either the route 1608a or the route 1608b, or the operator may manually choose between the route 1608a or the route 1608b. In some embodiments, one or more characteristics of the route 1608a may be different from one or more characteristics of the route 1608b, and the pathing generation system 1600 may compare one or more characteristics of the route 1608a may be different from one or more characteristics of the route 1608b to select a preferred route. The one or more characteristics may include a travel time, a distance, a number of obstacles along the route, a number of waypoints along the route, a number of required changes in direction along the route, and/or a factor of safety along the route. The factor of safety may be a metric based on a footprint of the vehicle 10 and any load it may be moving as compared to the maximum allowable dimension of the route. A route with a higher factor of safety may have a greater difference between the maximum footprint of the vehicle 10 and/or any load it may be moving and the maximum allowable dimensions of the route, such that vehicle 10 can travel along a route with a lower likely of accidentally contact with obstacles 1606a in along the route.

As shown in FIG. 122, in some embodiments, the production system 1601 may include a feature 1620. The feature 1620 may be, for example, an egress point, a staircase, a window, a sign, a wall marking, a person, etc. While it may be difficult for the vehicle 10 to run into, run over, or become blocked by the feature 1620, it may nevertheless be desirable to prevent the vehicle 10 from traveling near or in close proximity to the feature 1620 for various reasons, for example, to avoid blocking an egress point, a staircase, a window, a sign, a wall marking, etc., or to avoid the vehicle 10 getting in the way of a person. Similar to the process for the obstacle 1606a, an operator may add the feature 1620 to the floorplan 1602 if the feature 1620 is not already accounted for in the floorplan 1602, or the features 1620 may be sensed by the sensors 112 of the vehicle 10. In the embodiment of FIG. 122, although the route 1608a and the route 1608b are still substantially the same, the route 1608a may be less preferable because it passes near the feature 1620. As such, the pathing generation system 1600 may be configured to automatically prefer the route 1608b to avoid any potential issues with the feature 1620, or the operator may manually choose the route 1608b.

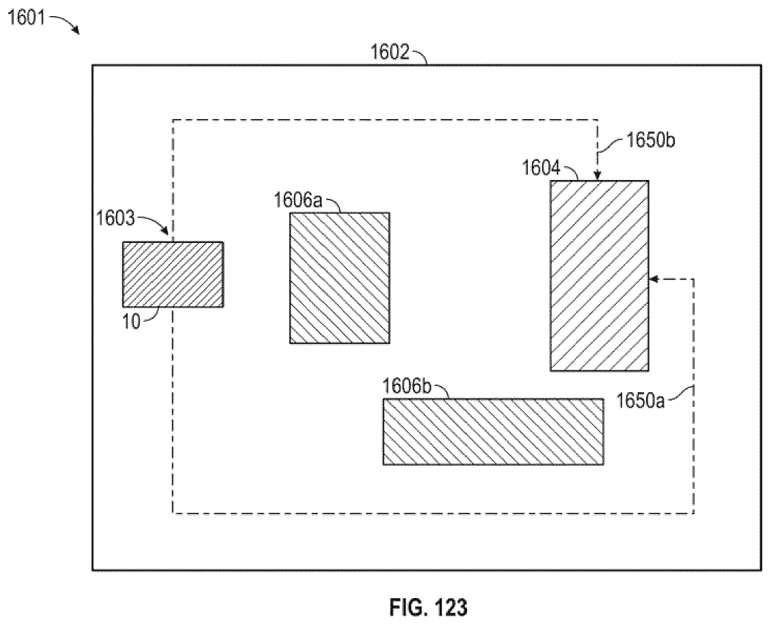

In the embodiment of FIG. 123, an obstacle 1606b is shown within the production system 1601. As previously discussed, the obstacle 1606b may already appear in the floorplan 1602 retrieved by the pathing generation system 1600, or an operator may add the obstacle 1606b into the floorplan 1602, or the obstacle may be sensed by the sensors 112. The pathing generation system 1600 may generate a route 1650a and a route 1650b. As shown in FIG. 123, the route 1650a may be at least somewhat longer in distance and/or more cumbersome for the vehicle 10 than the route 1650b, resulting in lower efficiency. As such, the route 1650b may be preferable over the route 1650a. The route 1650a may also enter the target location 1604 at a different point than the route 1650b, which may result in further inefficiencies, or may not matter in some situations. The pathing generation system 1600 may be configured to automatically prefer the most efficient route (e.g., the shortest or fastest route, etc.), for example, the route 1650b, or the operator may manually choose the route 1650b.

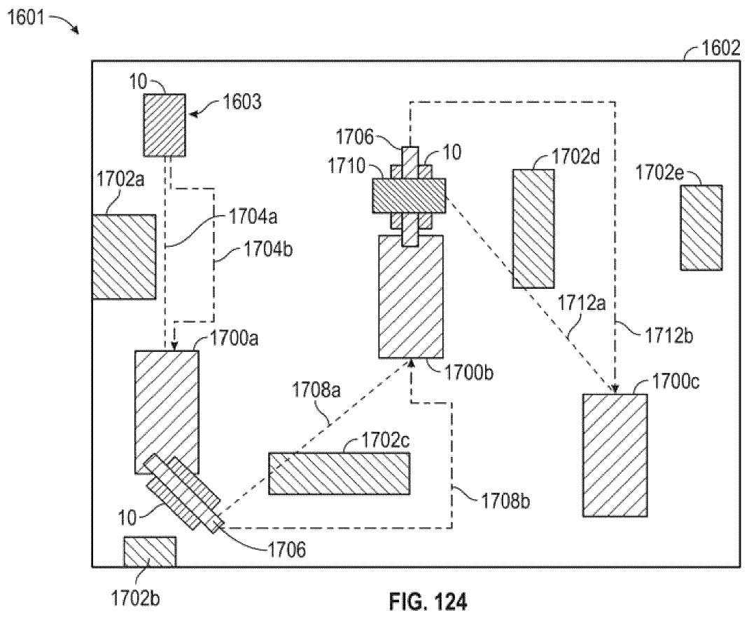

Turning now to FIG. 124, an exemplary embodiment of the production system 1601 is shown. It should be noted that the components and systems as shown in FIG. 124 serve to provide only a non-limiting example and that configurations of the production system 1601 may be utilized. The production system 1601 may include a target location 1700a, a target location 1700b, and a target location 1700c. An operator may use the input device to provide an indication of which locations the vehicle 10 should visit, and in which order. The indications may be saved into a plan which may be uploaded to the memory 106 for future use. An operator may be able to access saved plans for reuse with the floorplan 1602. The pathing generation system 1600 may then generate possible paths for the vehicle 10, and the operator may view and edit the possible paths.

As described further herein, route 1704a, route 1708b, and route 1712a depict the most efficient path (e.g., the shortest or fastest path, etc.) between two points (e.g., the vehicle 10 and a location), without regard to any potential obstacles between the two points. The route 1704a, the route 1708b, and the route 1712a are depicted as dashed lines to indicate a reference path for greater understanding of the embodiments disclosed herein, although the route 1704a, the route 1708b, and the route 1712a may not appear as possible paths or generated routes on the user interface or to an operator of the pathing generation system 1600.

The pathing generation system 1600 may generate the routes 1704 based one or more characteristics of the vehicle 10 and/or the load being moved by the vehicle 10. The one or more characteristics can include a capacity of the vehicle 10, a weight of the vehicle 10 and/or the load, a size or envelope of the vehicle 10, a size of the load (e.g., telehandler 56), a desired distance between the vehicle 10 or the load and an obstacle, or other characteristics of the vehicle 10 and/or the load. The size or footprint of the vehicle 10 (e.g., a length, width, and height) which defines outer boundaries of the vehicle 10 may be predetermined or may be measured by one or more sensors. For example, the vehicle 10 may be a predetermined and is known to the pathing generation system 1600. In some embodiments, the footprint of the vehicle 10 may be monitored and/or measured by one or more cameras, sensors, etc., during various stages of operation of the vehicle 10 within the production system 1601. In some embodiments, the footprint of the vehicle 10 may be determined based on a current stage of assembly of the product being moved by the vehicle 10. The current stage can be determined by a weight of the product, tracking waypoints at each stage of manufacturing the product, a location of the vehicle 10 and/or the product in the production system 1601, by an input from an operator, or by one or more sensors monitoring the product and/or the production system 1601. As such, the footprint of the vehicle 10 may be automatically communicated to the pathing generation system 1600 at various stages of operation. The vehicle 10 may have a base footprint of the vehicle 10 alone, or the vehicle 10 may have a load footprint when the vehicle 10 is carrying one or more loads, such as a component of a product assembly, a part, a machine, a tool, etc. The footprint of the vehicle 10 may be taken into account by the pathing generation system 1600 when the pathing generation system 1600 is determining one or more possible paths the vehicle 10 could take. The vehicle 10 may not be able to travel in a substantially straight path from a current location of the vehicle 10 to the target location 1700a, for example along route 1704a, due to the footprint of the vehicle 10 and the obstacle 1702a. Instead, the pathing generation system 1600 may generate a route 1704b, which avoids the obstacle 1702a.

In some embodiments, the routes 1704 are generated incrementally, based on the floorplan 1602 and/or the signals from the sensors 112, such that a route to a second target location after a first target location is not determined until after the vehicle 10 is at or near the first target location. In some embodiments, based on signals from the sensors 112, the vehicle 10 may adjust a route 1704 or may switch from one route 1704 to another route 1704.

Referring still to FIG. 124, at the target location 1700a, the vehicle 10 may receive a first load 1706. The first load 1706 may change the footprint of the vehicle 10. For example, the first load 1706 may change the length, width, and/or height of the outer boundaries of the vehicle 10. The changed footprint may be monitored and or determined by the pathing generation system 1600 which may then adjust the one or more routes 1704 based on the updated footprint, as when the vehicle 10 is carrying the first load 1706, the vehicle 10 may need to operate differently. For example, the vehicle 10 may not be able to travel as closely to obstacles, walls, stations, humans, features, etc. or turn as sharply as the vehicle 10 may be able to without the first load 1706. In the embodiment of FIG. 124, the first load 1706 is configured to change at least the length of the footprint of the vehicle 10.

Near the exit of the target location 1700a, the production system 1601 may include an obstacle 1702b and an obstacle 1702c. In an embodiment where the vehicle 10 exits the target location 1700a without the first load 1706, the vehicle 10 alone may be able to travel along any number of paths around the obstacle 1702c, including by turning left and traveling between the target location 1700a and the obstacle 1702c, or turning right and passing along a right side portion of the obstacle 1702c. However, due to the change in footprint, when the vehicle 10 exits the target location 1700a with the first load 1706, the vehicle 10 may not be able to turn onto one or more of the possible paths. For example, the vehicle 10 carrying the first load 1706 may have a longer footprint (i.e., a length of the vehicle 10 is increased when the vehicle 10 is carrying the first load 1706). Due to the longer footprint, the vehicle 10 may not be able to make as sharply of a turn as when the vehicle 10 moves throughout the production system 1601 without any load. In some situations, the vehicle 10 could reverse one or more times to move into a position to maneuver a turn (e.g., a three-point turn, etc.). However, due to the longer footprint of the vehicle 10 carrying the first load 1706, the vehicle 10 may no longer be able to reverse to maneuver a turn. For example, as shown in FIG. 124, the obstacle 1702b may prevent the vehicle 10 from reversing due to the longer footprint of the vehicle 10 carrying the first load 1706. As such, the vehicle 10 may not be able to turn sharply enough to turn left and travel around a left side portion of the obstacle 1702c. Therefore, the vehicle 10 may need to travel around the right side portion of the obstacle 1702c by taking a route 1708b rather than the route 1708a or any other route which passes along the left side portion of the obstacle 1702c. It should be understood that reference to any particular arrangement of obstacles or left or right directional terms only serve to illustrate non-limiting examples of the operations of the vehicle 10 within the production system 1601.

The vehicle 10 may drive along the route 1708b to arrive at the target location 1700b. At the target location 1700b, the vehicle 10 may receive a second load 1710. The second load 1710 may change the footprint of the vehicle 10. For example, the second load 1710 may change the length, width, and/or height of the outer boundaries of the vehicle 10. The target location 1700b may be the next stage in a manufacturing process after the stage at target location 1700a. In some embodiments, the second load 1710 is a modification or addition to the first load 1706 that is added or performed at the target location 1700b. When the vehicle 10 is carrying the first load 1706 and the second load 1710, the vehicle 10 may need to operate differently. For example, the vehicle 10 may not be able to travel as closely to obstacles, walls, stations, humans, features, etc. or turn as sharply as the vehicle 10 may be able to without the second load 1710. In the embodiment of FIG. 124, the second load 1710 is configured to change at least the width of the footprint of the vehicle 10.

Near the exit of the target location 1700a, the production system 1601 may include an obstacle 1702d. In an embodiment where the vehicle 10 exits the location 170ba without the second load 1710, the vehicle 10 alone may be able to travel along any number of paths around the obstacle 1702d, including by turning right and passing around a left side portion of the obstacle 1702d, or by turning farther right and traveling between the target location 1700b and the obstacle 1702d. However, due to the change in footprint, when the vehicle 10 exits the target location 1700b with the second load 1710, the vehicle 10 may not be able to turn onto one or more of the possible paths. For example, the vehicle 10 carrying the second load 1710 may have a wider footprint (i.e., a width of the vehicle 10 is increased when the vehicle 10 is carrying the second load 1710). Due to the wider footprint, the vehicle 10 may or may not be able to make as sharply of a turn as when the vehicle 10 moves throughout the production system 1601 without any load. In the embodiment of FIG. 124, the vehicle 10 alone without any load, or the vehicle 10 carrying only the first load 1706, may be able to maneuver the turn to pass between the target location 1700b and the obstacle 1702d. However, due to the wider footprint of the vehicle 10 carrying the second load 1710, the second load 1710 may make the footprint too wide for the vehicle 10 carrying the second load 1710 to pass between the target location 1700b and the obstacle 1702d. As shown in FIG. 124, there may be sufficient space to allow the vehicle 10 carrying the first load 1706 and the second load 1710 to travel along a route 1712b between the obstacle 1702d and an obstacle 1702e to the target location 1700c.

In contrast to the embodiment described with respect to the obstacle 1702b potentially preventing the vehicle 10 from reversing to execute the left turn when exiting the target location 1700a, at the exit of the target location 1700b, in the embodiment of FIG. 124, there may be sufficient space to allow for the vehicle 10 to reverse. For example, the vehicle 10 alone without any load, or the vehicle 10 carrying only the first load 1706, may be able to reverse one or more times to move into a position to maneuver a turn (e.g., a three-point turn, etc.) between the target location 1700b and the obstacle 1702d because the production system 1601 provides sufficient space to accommodate the vehicle 10 reversing one or more times, even if the vehicle 10 is carrying the first load 1706. However, if the vehicle 10 is also carrying the second load 1710, even though the longer footprint will not prevent the vehicle 10 from maneuvering into a position to take a path which passes between the target location 1700b and the obstacle 1702d, the vehicle 10 still may not be able to take the route which passes between the target location 1700b and the obstacle 1702d because of the wider footprint of the vehicle 10 due to the second load 1710. Therefore, the vehicle 10 may need to travel around the left side portion of the obstacle 1702d by taking a route 1712b rather than the route 1712a or any other route which passes along the right side portion of the obstacle 1702d. It should be understood that reference to any particular arrangement of obstacles or left or right directional terms only serve to illustrate non-limiting examples of the operations of the vehicle 10 within the production system 1601.

Turning now to FIG. 14, an optimized floorplan 1720 is shown. In some embodiments, the pathing generation system 1600 may generate the optimized floorplan 1720 as a recommended change from a current floorplan. In some embodiments, the pathing generation system 1600 may apply mapping data to optimize the locations 1700 layout in the optimized floorplan 1720. For example, the pathing generation system 1600 may be configured to identify and quantify (i.e., measure) locations 1700, obstacles 1702, the routes 1704 of other vehicles 10, and other areas in the production system 1601. In some embodiments, the pathing generation system 1600 can detect one or more stages of an assembly line and measure an area around the stages to define a target location 1700. The pathing generation system 1600 can analyze data gathered from the sensors 112, various floorplans, possible paths, generated routes, selected routes, traveled routes, locations, sizes, and shapes of obstacles, features, or stations (e.g., locations, etc.), and/or input from an operator or the input device to learn about and/or recognize inefficiencies within the production system 1601, including inefficiencies associated with the vehicle 10 traveling throughout the production system 1601. The pathing generation system 1600 may recommend changes and determine a more optimal configuration or arrangement for the production system 1601 (e.g., of the obstacles 1702, the target locations, the egress points, etc.) such as the optimized floorplan 1720, which optimizes the use of floor space, minimizes travel time for the vehicle 10 and maintains clear paths for vehicles, machines, robots, personnel, etc. The pathing generation system 1600 also records locations where the vehicle 10 becomes trapped and/or unable to move and stores the locations in a database on the memory 106 and in some embodiments also saves and stores the associated route the vehicle 10 was traveling on. A vehicle 10 passing the location where the vehicle 10 or another vehicle 10 was previously trapped or interfered with may adopt a new strategy for traversing around/through the location, such as a new route. The pathing generation system 1600 thus iteratively develops strategies for avoiding obstacles or passing over or around obstacles and determines preferences for successful strategies while avoiding failed strategies.

In some embodiments, the optimized floorplan 1720 may only be generated once or a small number of times in relation to the regular generation of floorplans by the pathing generation system 1600. In other words, the optimized floorplan 1720 may not be generated each and every time a floorplan is generated by the pathing generation system 1600. For example, the production system 1601 may already be operating under the most efficient possible configuration or arrangement.

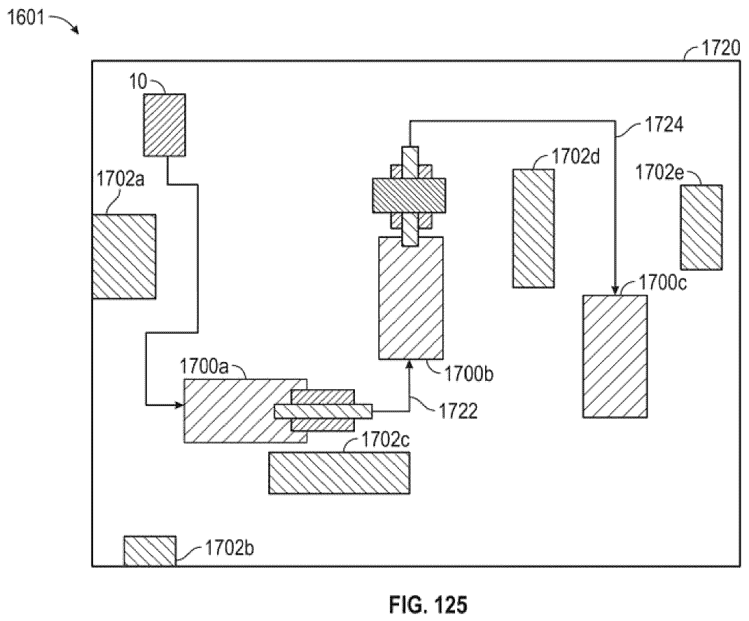

As shown in FIG. 125, the optimized floorplan 1720 includes recommended changes such as a repositioning of one or more locations 1700 and/or obstacles 1702. In some embodiments, certain locations 1700 and/or obstacles 1702 may not be able to be moved or repositioned for various reasons, or it may not be desirable and/or necessary to move or reposition certain locations 1700 and/or obstacles 1702. For example, in the embodiment of FIG. 125, the target location 1700a and the target location 1700c may be moved, while none of the obstacles 1702 may be moved. In other embodiments, only obstacles 1702 may be moved, locations 1700 may not be moved, or both locations 1700 and obstacles 1702 may be moved.

In the embodiment of FIG. 125, the target location 1700a has been rotated counterclockwise substantially 90 degrees. In some embodiments, in addition to indicating a target location such as target location 1700a, each location 1700 may also include a target entry point into the location 1700 and a target exit point out of the location 1700. As such, with the target location 1700a rotated counterclockwise substantially 90 degrees, the vehicle 10 may exit the target location 1700a at a position that is substantially near the target location 1700b. The obstacle 1702b and the obstacle 1702c may no longer have much of an effect, if any, on the operation of the vehicle 10. The vehicle 10 may be able to travel substantially directly to the target location 1700b along the most efficient possible path (e.g., the shortest or fastest path, etc.), such as a route 1722, regardless of any load carried by the vehicle 10. It should be understood that reference to any particular arrangement of locations or directional terms only serve to illustrate non-limiting examples of the operations of the vehicle 10 within the production system 1601.

Additionally, the target location 1700c has been moved towards the obstacle 1702d and the obstacle 1702e. The pathing generation system 1600 may determine that, given the footprint of the vehicle 10 at the exit of the target location 1700b (e.g., the vehicle 10 is carrying the second load 1710), any route that passes between the target location 1700b and the obstacle 1702d will not be able to be traveled by the vehicle 10. As such, the pathing generation system 1600 may determine that it is acceptable to move the target location 1700c in a manner which blocks or further hinders a more efficient possible path (e.g., a route that passes between the target location 1700b and the obstacle 1702d) because the vehicle 10 will not take that possible path due to the footprint of the vehicle 10. By moving the target location 1700c towards the obstacle 1702d and the obstacle 1702e, a route 1724 may be able to be generated which shortens the distance and travel time between the target location 1700b and the target location 1700c. It should be understood that reference to any particular arrangement of locations or directional terms only serve to illustrate non-limiting examples of the operations of the vehicle 10 within the production system 1601.

In an embodiment in which the vehicle 10 exits the target location 1700b without the second load 1710 or without any load, it may still be preferable to move the target location 1700c towards the obstacle 1702d and the obstacle 1702e. Even though moving the target location 1700c towards the obstacle 1702d and the obstacle 1702e may block or further hinder a more efficient possible path (e.g., a route that passes between the target location 1700b and the obstacle 1702d) for the vehicle 10, because the vehicle 10 still has one or more possible paths to the target location 1700c (e.g., the route 1724), moving the target location 1700c towards the obstacle 1702d and the obstacle 1702e opens up a larger amount of space within the production system 1601 (e.g., in the lower right quadrant of the optimized floorplan 1720). An increase in space within the production system 1601 can be beneficial, allowing for better overall use of space within the production system 1601. As real estate generally holds great value, saving floor space and providing for a larger area for additional stations, machines, storage, personnel, etc. results in overall cost savings or greater profits.

FIG. 15 depicts a process 1750 generally executed by the pathing generation system 1600. At step 1752, a floorplan (e.g., the floorplan 1602) of the production system 1601 may be retrieved by the pathing generation system 1600. The floorplan may be retrieved from a memory device, such as the memory 106 or mapped by the vehicle 10 using the sensors 112 The floorplan may include one or more locations 1700 which may be visited by the vehicle 10 and/or one or more obstacles 1702. At step 1754, the pathing generation system 1600 may receive a current location (e.g., current location 1603) of the vehicle 10. The current location of the vehicle 10 may be somewhere within the floorplan 1602 of the production system 1601. At step 1756, the pathing generation system 1600 may generate one or more possible paths (e.g., route 1704) for the vehicle 10 to visit one or more locations (e.g., locations 1700) throughout the production system 1601, taking into account the footprint of the vehicle 10 and the floorplan. The pathing generation system 1600 may display the one or more possible paths to an operator of the pathing generation system 1600 on the user interface.

At step 1758, the pathing generation system 1600 may receive one or more inputs from the input device. For example, the operator of the pathing generation system 1600 input a series of target locations and/or an order of approaching the target locations for the vehicle 10 throughout the production system 1601. As another example, the operator of the pathing generation system 1600 may edit the floorplan to include one or more of obstacles, locations, or egress points if the obstacle, location, or egress point is not already accounted for in the floorplan.

At step 1760, the pathing generation system 1600 may determine a desired path for the vehicle 10. For example, the desired path may avoid one or more obstacles. As another example, the desired path may be a most efficient path (e.g., the shortest or fastest path, etc.) for the vehicle 10. In some embodiments, the desired path may be automatically generated by the pathing generation system 1600. In other embodiments, the operator of the pathing generation system 1600 may provide input, such as an input selecting or preferring the desired path over any other possible path.

At step 1762, a route may be generated for the vehicle 10. The route may be the same as the desired path or it may vary. For example, in some embodiments, the desired path may be generated in combination with the possible paths generated in the step 1756 (e.g., prior to any input from the input device). Subsequent to the one or more inputs from the input device, the route generated for the vehicle 10 at the step 1762 may differ from the desired path. The vehicle 10 may then travel along the route generated at the step 1762. In some embodiments, the route may be updated while the vehicle is traveling along the route based on data from one or more sensors coupled to the vehicle (e.g., the sensors 112).

At step 1764, an optimized floorplan may be generated. For example, the pathing generation system 1600 may be configured to analyze data gathered from various floorplans, possible paths, generated routes, and/or input from an operator or the input device to learn about and/or recognize inefficiencies within the production system 1601, including inefficiencies associated with the vehicle 10 traveling throughout the production system 1601. In some embodiments, the optimized floorplan may only be generated once or a small number of times in relation to the regular generation of floorplans by the pathing generation system 1600. In other words, the optimized floorplan may not be generated each and every time a floorplan is generated by the pathing generation system 1600. For example, the production system 1601 may already be operating under the most efficient possible configuration or arrangement. Step 1764 is an optional step and may or may not be performed. In some embodiments, step 1764 is performed on its own based on mapping data provided to or obtained by the vehicle 10.

### 6541 Coordinated Motion System

Referring generally to the figures, a system includes a first vehicle, a second vehicle coupled to the first vehicle, and a load supported by the first vehicle and the second vehicle. The system also includes one or more input devices and one or more memory devices storing instructions thereon. When executed by one or more processors, the instructions cause the one or more processors to retrieve, from the one or more memory devices, a floorplan of a production system and receive a first current position of the first vehicle and a second current position of the second vehicle, and receive, from the one or more input devices, one or more inputs. The one or more inputs include one or more of one or more locations in the production system, a footprint of the first vehicle, the second vehicle, and the load, or one or more obstacles. The instructions also cause the one or more processors to retrieve a route for the first vehicle and the second vehicle, from the first current position of the first vehicle and the second current position of the second vehicle to the one or more locations based on the one or more inputs and generate a series of coordinated motions between the first vehicle and the second vehicle based on the route and the one or more inputs.

As shown in FIG. 127, one or more of the vehicles 10 may be used together within the production system 1601. For example, a vehicle 10a may be coupled to a vehicle 10b. The vehicle 10a may be coupled to the vehicle 10b via an electrical coupling, a wireless connection, or a physical coupling, or a load (e.g., load 1800, a component of a product assembly, a part, a machine, a tool, cart, etc.) may couple the vehicle 10a and the vehicle 10b via one or more coupling points (e.g., lifting implement 50, cart implement 60). The vehicle 10a and/or the vehicle 10b may have one or more cameras or sensors (e.g., distance sensors) which may assist in the positioning of the vehicle 10a and the vehicle 10b. For example, the cameras and/or sensors may communicate to maintain a specified or desired distance between the vehicle 10a and the vehicle 10b and/or to ensure that the vehicle 10a and the vehicle 10b do not collide.

The load 1800 may be coupled to the vehicle 10a and/or the vehicle 10b at one or more coupling points (e.g., coupling point 1802a, coupling point 1802b, etc.). The coupling point 1802a and the coupling point 1802b may be a component on the vehicle 10a or the vehicle 10b which is configured to secure the load 1800 in a fixed or rotatable manner (e.g., a turntable), or the coupling point 1802a and the coupling point 1802b may be a mechanism external to the load 1800 and the vehicle 10a and the vehicle 10b (e.g., a strap, a bolt, etc.). In some embodiments, the coupling points 1802 may be implements such as lifting implement 50 or cart implement 60. In some embodiments, the load 1800 may be large, bulky, unwieldy, etc., and one vehicle 10 may not be sufficient to support the load 1800 alone. In some embodiments, it may be preferable to have two or more of the vehicles 10 supporting the load 1800 to increase the maneuverability of the load amongst other benefits.

The vehicle 10a and the vehicle 10b may need to move through the production system 1601 in various ways, such as by making a turn around a corner, an obstacle, a station, etc. With respect to the embodiments previously described herein relating to the operation of the vehicle 10 within the production system 1601, the operation of the vehicle 10a and the vehicle 10b may be substantially similar or may differ. For example, the use of two or more vehicles, such as the vehicle 10a and the vehicle 10b, may increase difficulty of movement within the production system 1601.

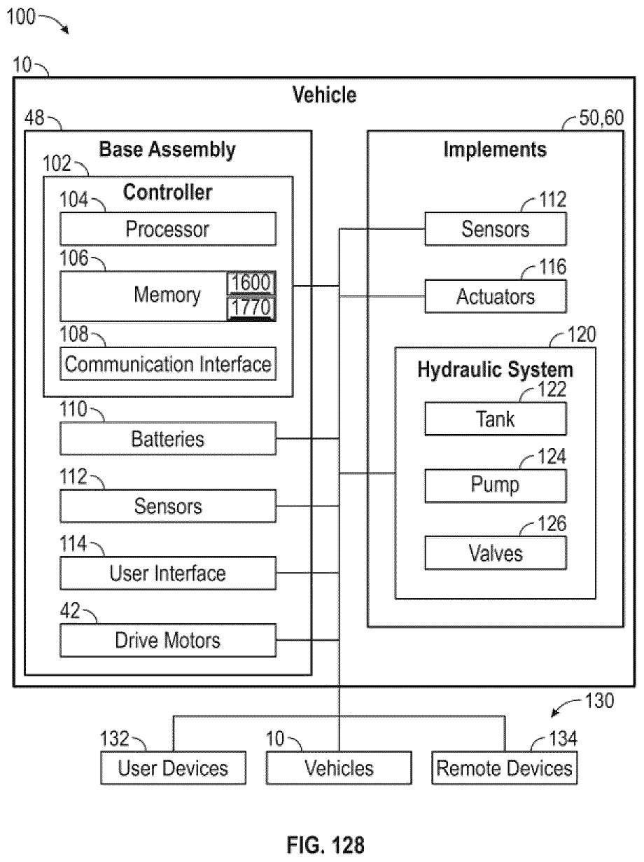

Referring now to FIG. 128, a coordinated motion system shown as coordinated motion system 1770 may coordinate movement of the vehicle 10a and the vehicle 10b. For example, the coordinated motion system 1770 may generate a series of coordinated motions between the vehicle 10a and the vehicle 10b to assist with movement of an assembly comprising the vehicle 10a, the vehicle 10b, and the load 1800. The coordinated motion system 1770 may communicate and operate with the pathing generation system 1600. For example, the coordinated motion system 1770 may provide input to and receive input from the pathing generation system 1600 with respect to the vehicle 10a and the vehicle 10b navigating turns, moving throughout the production system 1601, fitting between or around locations, obstacles, or features, etc. The coordinated motion system 1770 and the pathing generation system 1600 may have to take into account a footprint of the assembly including the vehicle 10a, the vehicle 10b, and the load 1800. In some embodiments, the pathing generation system 1600 may be included as part of the coordinated motion system 1770. In some embodiments, the coordinated motion system 1770 is included as part of a user device 132, or a remove device 134.

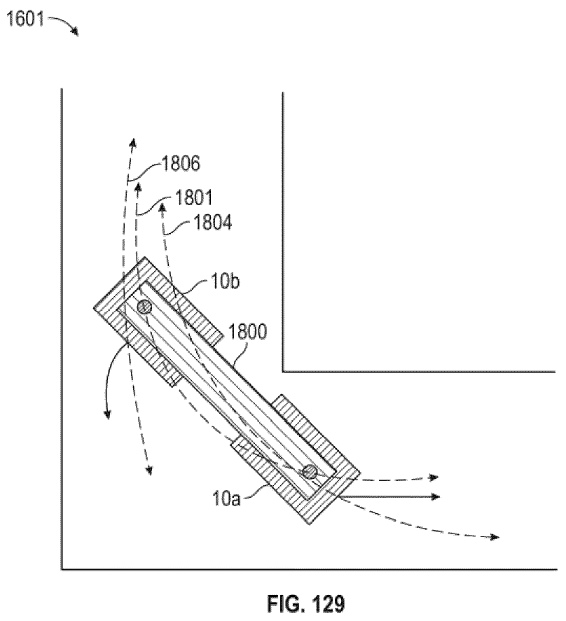

The coordinated motion system 1770 is configured to generate one or more paths or routes for one or more of the load 1800, the vehicle 10a, and the vehicle 10b. As shown in FIG. 129, in some embodiments, the coordinated motion system 1770 (i.e., the coordinated motion system 1770 and the pathing generation system 1600) determines a load route (e.g., load route 1801) for the load 1800, and then determines vehicle routes for the vehicle 10a (e.g., vehicle route 1804) and the vehicle 10b (e.g., vehicle route 1806) based on the route for the load 1800, such that as the vehicles 10a, 10b move along the vehicle routes, the combination or superposition of the vehicles routes results in the load 1800 moving along the load route. In some embodiments, the load route is based on the footprint of the vehicles 10a, 10b and the load 1800. In some embodiments, the vehicle routes also include orientation requirements, speeds, and drop, and/or pick up points, such that a route might include a vehicle dropping the load 1800, repositioning, and then picking up the load 1800 again to continue moving the load along the load route. In some embodiments, the vehicle route for the vehicle 10a is different from the vehicle route for the vehicle 10b. The different vehicle routes allow for independent articulation of each of the load 1800 to facilitate rotating the load around tight corners or obstacles (e.g., obstacles 1702). In some embodiments, in addition to generating the vehicle routes based on the load route, the vehicle routes may also be generated to satisfy one or more path conditions. The one or more path conditions may include predetermined separation distance between the vehicle 10a and the vehicle 10b, a speed minimum or maximum, a distance minimum or maximum, etc.

In FIG. 129, the vehicle 10a and the vehicle 10b are shown mid-turn. In the embodiment of FIG. 129, the vehicle 10a and the vehicle 10b may both be powered vehicles. In some embodiments, the vehicle 10a may be a primary vehicle such that the vehicle 10a controls the movement of the assembly and contains and/or communicates with the coordinated motion system 1770 and the pathing generation system 1600 while the vehicle 10b follows along. The vehicle 10b may still be powered and driving, but may not exert any control over the assembly and follows direction from the vehicle 10a. The vehicle 10a may include a greater number of cameras and/or sensors 112 and a greater amount of processing power than the vehicle 10b. As such, the vehicle 10b may be able to be produced at a lower cost. In some embodiments, a leader vehicle such as vehicle 10a may use the sensors 112 to monitor a position of a follower vehicle such as vehicle 10b while moving the load 1800. In other embodiments, the vehicle 10a and the vehicle 10b may both have at least some control over the movement of the assembly and may both communicate with the coordinated motion system 1770 and the pathing generation system 1600. In some embodiments, the follower vehicle may include sensors 112 to monitor a position of the load 1800, the vehicle 10a, and the vehicle 10b, and may be communicably coupled to the vehicle 10a. In some embodiments, the follower vehicle includes brakes which may be controlled by the follower vehicle itself or in some embodiments by the leader vehicle.

Alternatively, in the embodiment of FIG. 129, the vehicle 10a may be powered, while the vehicle 10b is not powered. In some embodiments, the vehicle 10b may be a dolly (i.e., a platform supported by a plurality of tractive elements), with or without any cameras, sensors, power, braking, steering, or capability of driving. In embodiments in which the vehicle 10b is a dolly, the coordinated motion system 1770 and the pathing generation system 1600 may instruct the vehicle 10a to travel in a manner which accounts for the movement of the vehicle 10b, similar to, for example, a trailer. The movement of the vehicle 10b as a dolly may be at least somewhat unexpected or unpredictable, and the coordinated motion system 1770 and the pathing generation system 1600 may have to make adjustments during operation of the assembly.

As shown in FIG. 129, one example of navigating a turn may include the vehicle 10a being fixedly coupled to the load 1800, and the load 1800 being fixedly coupled to the vehicle 10b. As such, the vehicle 10a may maintain a certain orientation with respect to the vehicle 10b, and the vehicle 10a and the vehicle 10b may maintain a certain orientation with respect to the load 1800. The vehicle 10a may drive forward in a substantially normal manner to navigate the turn. For example, the tractive elements of the vehicle 10a may turn to steer the vehicle 10a forward around the turn. The vehicle 10b may follow the vehicle 10a and the tractive elements 44 of the vehicle 10b may turn as necessary to accommodate the turn. For example, as shown in FIG. 127, the tractive elements 44 of the vehicle 10a may turn towards the left, while the tractive elements 44 of the vehicle 10b may turn towards the right. A rear end of the assembly (e.g., towards the vehicle 10b) may swing around the turn in a wider arc with respect to the turning of the vehicle 10a. The assembly may make a substantially wider turn than a single one of the vehicles 10. Accordingly, the vehicles 10a and 10b may follow separate routes to ensure the load 1800 follows a desired route.

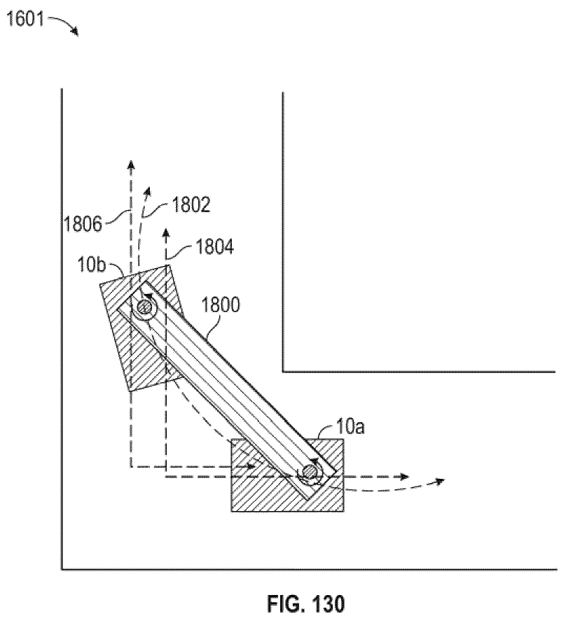

As shown in FIG. 130, another example of navigating a turn may include the vehicle 10a being movably coupled to the load 1800, and the load 1800 being movably coupled to the vehicle 10b. For example, the load 1800 may be rotatably coupled to the vehicle 10a and the vehicle 10b. The vehicle 10a and the vehicle 10b may both navigate the turn and may rotate with respect to the load 1800. In some embodiments, the vehicles 10a, 10b include one or more motors or actuators to cause the load 1800 rotate relative to the vehicle 10a, 10b or vice versa. In the embodiment of FIG. 130, the tractive elements 44 of the vehicle 10a turn to the left to make the turn and the tractive elements 44 of the vehicle 10b also turn to the left to make the turn. The vehicle 10b may follow along substantially the same path as the vehicle 10a (e.g., the vehicle route 1804 and the vehicle route 1806 may be substantially the same). For example, the vehicle 10a and the vehicle 10b may both be powered and may both drive along the route independently. The load 1800 may move along the load route 1801 as the vehicle 10a drives along the vehicle route 1804 and the vehicle 10b drives along the vehicle route 1806.

In the embodiment of FIG. 130, the movement of the vehicle 10b with respect to the movement of the vehicle 10a may not be as much of a concern with respect to the movement of the assembly due to the rotatable coupling of the load 1800 to the vehicle 10a and the vehicle 10b as the vehicle 10a and the vehicle 10b are both capable of driving and navigating turns independently. Instead, the footprint of the assembly may affect the movement of the assembly to a greater degree, as the load 1800 may cause the assembly to have a varied footprint throughout the production system 1601. As shown in FIG. 130, because the vehicle 10a and the vehicle 10b have rotated with respect to the load 1800, there is a greater risk that a central portion of the load 1800 may collide with a corner or protrusion and become stuck on the corner or protrusion.

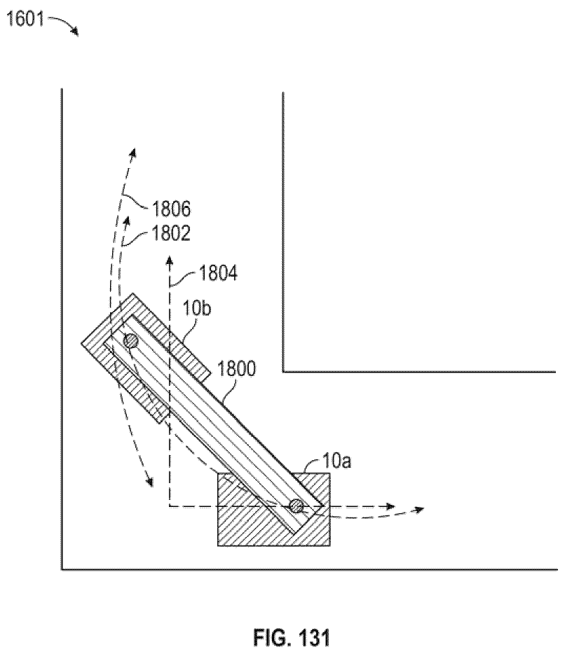

As shown in FIG. 131, another example of navigating a turn may include the vehicle 10a being movably coupled to the load 1800, and the load 1800 being fixedly coupled to the vehicle 10b. The vehicle 10b may be powered or unpowered, or may be a dolly. The vehicle 10a generally navigates through the production system 1601 taking into account the footprint of the assembly and the movement of the vehicle 10b. As depicted in FIG. 131, the vehicle 10a may rotate with respect to the load 1800 to navigate the turn, while the vehicle 10b follows along. For example, the vehicle 10a may make a left turn, such as along the vehicle route 1804, while the vehicle 10b follows along, such as along the vehicle route 1806, moving in a wider arc with respect to the left turn. Accordingly, the load 1800 may be moved along the load route 1801.

As shown in FIGS. 129-131, a path or route for the load 1800, such as the load route 1801, may be determined between two locations (e.g., stations, etc.) or positions in order to advance the load 1800 from a first position to a second position. The vehicle route 1804 and the vehicle route 1806 may be generated based on the load route 1801. The motion of the vehicle 10a along the vehicle route 1804 and the motion of the vehicle 10b along the vehicle route 1806 results in the load 1800 moving along the load route 1801.

Turning now to FIG. 122, a process 2100 which may be executed by the coordinated motion system 1770 is shown. At step 2102, a floorplan (e.g., the floorplan 1602) of the production system 1601 may be retrieved by the coordinated motion system 1770. The floorplan may be retrieved from a memory device, such as the memory 106 or be mapped and/or determined by the vehicle 10. The floorplan may include one or more locations which may visited by the vehicle 10a and the vehicle 10b and/or one or more obstacles. At step 2104, the coordinated motion system 1770 may receive a current position of the vehicle 10a and/or the vehicle 10b. The current position of the vehicle 10a and/or the vehicle 10b may be located somewhere within the floorplan of the production system 1601. At step 2106, the coordinated motion system 1770 may receive or retrieve, from the pathing generation system 1600, one or more possible paths for the vehicle 10a and the vehicle 10b to visit one or more locations throughout the production system 1601, taking into account the footprint of the vehicle 10a, the vehicle 10b, the load 1800, and the floorplan.

At step 2108, the coordinated motion system 1770 may receive or retrieve, from the pathing generation system 1600, the one or more inputs from one or more of the input devices. For example, the operator may input a series of stops and/or an order of the series of stops for the vehicle 10a and the vehicle 10b at various locations throughout the production system 1601. As another example, the operator may edit the floorplan to include one or more of obstacles if the obstacle is not already accounted for in the floorplan. The one or more input devices also may communicate the footprint of the vehicle 10 to the pathing generation system 1600 at various stages of operation of the vehicle 10.

At step 2110, the pathing generation system 1600 may determine a desired path for the load 1800 and/or the vehicle 10a and the vehicle 10b, taking into account the footprint of the vehicle 10a, the vehicle 10b, and the load 1800. For example, the desired path may avoid one or more obstacles. As another example, the desired path may be a shortest path, a fastest path, or a most efficient path for the vehicle 10a and the vehicle 10b. In some embodiments, the desired path for the vehicles 10a, 10b is based on the desired path for the load 1800. The desired path may be communicated from the coordinated motion system 1770 to the pathing generation system 1600. In some embodiments, the desired path may be automatically generated by the coordinated motion system 1770 which may include the pathing generation system 1600. In other embodiments, the operator may provide input, such as an input selecting or preferring the desired path over any other possible path.

At step 2112, the coordinated motion system 1770 may receive or retrieve, from the pathing generation system 1600, a route for the vehicle 10a and the vehicle 10b. The route may be the same as the desired path or it may vary. For example, in some embodiments, the desired path may be generated in combination with the possible paths generated in the step 2106 (e.g., prior to any input from the input device). Subsequent to the one or more inputs from the input device, the route generated for the vehicle 10 at the step 2112 may differ from the desired path.

At step 2114, the coordinated motion system 1770 may generate a series of coordinated motions between the vehicle 10a and the vehicle 10b based on the route and the one or more inputs. In some embodiments, the series of coordinated motions in combination result in the load 1800 moving along the desired load path. For example, the coordinated motion system 1770 may instruct the vehicle 10a to drive in a specified manner, as previously described herein. The coordinated motion system 1770 may or may not instruct the vehicle 10b to drive in a specified manner based on the instructions provided to the vehicle 10a. Generating the series of coordinated motions between the vehicle 10a and the vehicle 10b may include changing a position of one or more of the vehicle 10a relative to the vehicle 10b or the vehicle 10b relative to the vehicle 10a along at least a portion of the route. Generating the series of coordinated motions between the vehicle 10a and the vehicle 10b may also include avoiding obstacles and maintaining a distance between the vehicle 10a and the vehicle 10b along at least a portion of the route.

### Vehicle Data Sharing

Referring generally to the figures, a system includes a first vehicle, a second vehicle coupled to the first vehicle, and a load supported by the first vehicle and the second vehicle. The system also includes one or more input devices and one or more memory devices storing instructions thereon. When executed by one or more processors, the instructions cause the one or more processors to retrieve, from the one or more memory devices, a floorplan of a production system and receive a first current position of the first vehicle and a second current position of the second vehicle, and receive, from the one or more input devices, one or more inputs. The one or more inputs include one or more of one or more locations in the production system, a footprint of the first vehicle, the second vehicle, and the load, or one or more obstacles. The instructions also cause the one or more processors to retrieve a route for the first vehicle and the second vehicle, from the first current position of the first vehicle and the second current position of the second vehicle to the one or more locations based on the one or more inputs and generate a series of coordinated motions between the first vehicle and the second vehicle based on the route and the one or more inputs.

One of the first vehicle and the second vehicle also includes an audio output device and/or a visual output device to provide audible and/or visual alerts to operators within an area around the vehicles. The vehicles can provide a plurality of alerts based on a plurality of conditions. At least some of the plurality of conditions may be of the same condition type, and thereby one or more aspects of the alerts for each of the conditions of the same condition type may be the same. For example, the visual alert may be the same while audible alert may change. In this manner, the interaction between the audible alert and the visual alert may provide sufficient information even to an operator who may only be familiar with the condition type and not the condition itself.

The first vehicle and the second vehicle may also be connected by a local area network established by the first vehicle and the second vehicle. The local area network may facilitate mapping a worksite around the first vehicle and the second vehicle based on the sensors of both the first vehicle and the second vehicle.

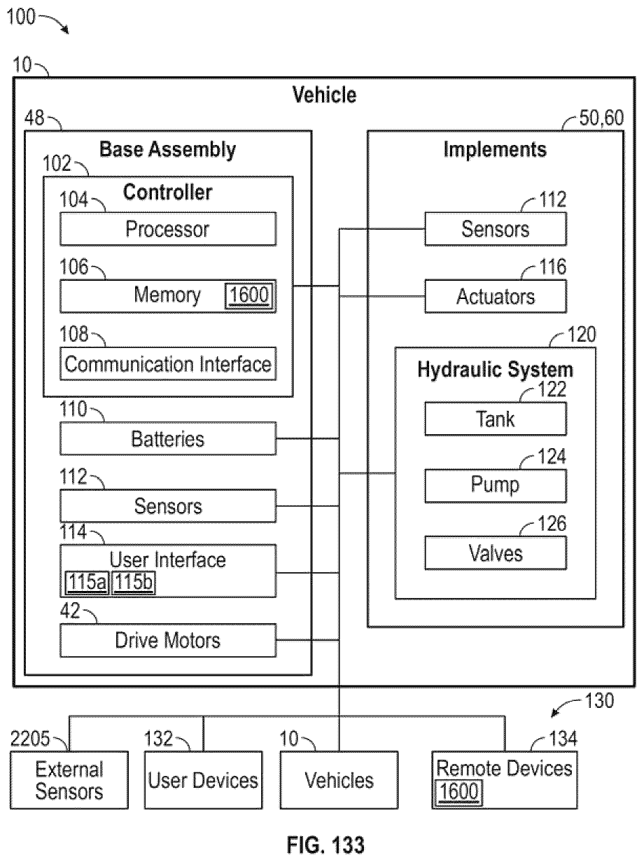

Referring now to FIG. 133, a block diagram of the vehicle 10 and its various components is shown, according to an exemplary embodiment. Vehicle 10 includes a user interface which includes an audio output device 115a (e.g., a speaker, a transducer, an alarm, etc.) for outputting an audible alert. The vehicle 10 is capable of producing a variety of audible alerts with different characteristics such as tone, frequency, rate, sound level, etc. The user interface 114 also includes a visual output device 115b (e.g., a light, light tower, plurality of lights, etc.) for outputting a visual alert. The vehicle 10 is capable of producing a variety of visual alerts with different characteristics including different colors or combinations of colors, different brightness levels, different strobing frequencies. In some embodiments, the audio output device 115a and the visual output device 115b are contained in the same housing.

One or both of the audible alerts or the visual alerts may be generated by a vehicle 10 in response to a plurality of conditions. In some embodiments, each condition of the plurality of conditions is associated with a unique combination of an audible alert and/or a visual alert. The plurality of conditions may include when a first vehicle 10 is pairing with a second vehicle 10, when a first vehicle 10 is paired with a second vehicle 10 such that movement of the first vehicle 10 and the second vehicle 10 is coordinated, a state of charge of a power source of the vehicle 10 (e.g., a battery level), a charging status of the vehicle 10 (e.g., charging, not charging, charged, etc.), if power is being provided from the vehicle to an accessory, an implement, and/or a load, a fault, the direction of travel of the vehicle 10, when carrying a load, when traversing a path, or when communicating with another vehicle 10, amongst other conditions.

In some embodiments, the plurality of conditions are each associated with one or more types of a plurality of types. The plurality of types may include pairing, communicating, vehicle status, or safety. Each type may include a subset of the plurality of conditions. For example, the condition of pairing and the condition of being paired each fall under the type of pairing. The conditions of communicating with a user controller (e.g., user device 132), communicating with a remote device (e.g., remote device 134) or communicating with another vehicle 10 each fall under the type of communicating. The conditions of being active, inactive, charged, discharged, etc. each fall under the type of status. The conditions of an error, fault, or other safety alert may fall under the type of safety. While only some conditions have times have been elaborated on herein, it should be understand that other conditions and types exist which may be included and/or determined by the vehicle 10.

In some embodiments, the subset of plurality of conditions of the same type share one or more common alert features. In some embodiments, for example, alerts for a first type of condition (e.g., pairing, communicating, status, etc.) may have the same audible alerts, but different visual alerts, or vice versa. In some embodiments, the alerts may share other common features such as, for audible alerts, a spoken word content, a loudness level, a key, a repetition rate, etc. and for visual alerts a color, an intensity, a brightness, a flashing rate, etc. For example, when pairing, a first vehicle 10 and a second vehicle 10 may each have flashing blue lights, and when paired, the first vehicle 10 and the second vehicle 10 may have solid blue lights. The common alert feature in this case is the color of the light, while the strobing frequency is varied from one condition to the other. For another example, when considering conditions of the type safety, the visual alert for each condition may be the same, such as a strobing red or yellow light, while the audible alert may vary based on the condition, such that each condition of the type safety has a different audible alert but the same visual alert. Additionally details regarding the structure of the user interface 114, the audio output device 115a, the visual output device 115b, and the operation of the same for various alerts may be found with reference to indicator 1204 in U.S. patent application Ser. No. 17/576,717, filed Jan. 14, 2022, and U.S. patent application Ser. No. 17/576,798, filed Jan. 14, 2022, the disclosures of which are incorporated herein by reference in their entirety.

Technically and beneficially, the interaction of audible and visual alerts according to known types with common alert features establishes a generic alert language to facilitate operator's understanding of a given alert even in circumstances where an operator may not understand or be able to sense the entire alert. For example, an operator may be aware that blue lights indicating a vehicle 10 is paired or pairing in some way with another vehicle, but may not know the difference between a solid blue light and a flashing blue light. However, because each alert shares a common alert feature (i.e., a blue color) the operator at least has a base line understanding of what a blue color alert may be referring to, even though the operator lacks complete knowledge.

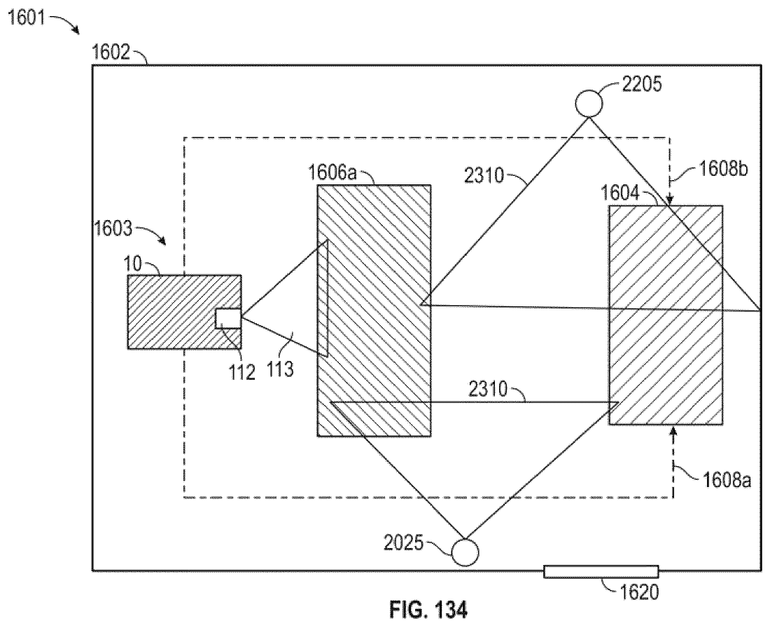

Referring now to FIG. 134, the vehicle 10 is shown in a manufacturing environment or production system 1601. The vehicle 10 may is mapping a floorplan 1602 (e.g., layout, etc.) of the production system 1601 to be using by the pathing generation system 1600. In some embodiments, the vehicle 10 uses the sensors 112 for mapping the floorplan 1602. The sensors 112 have a vehicle field of view 113 which is limited, such that the vehicle 10 can only view a part of the production system 1601 at any given time. To augment the field of view 113 of the sensors 112 of the vehicle 10, the vehicle 10 is communicably coupled to one or more external sensor 2205. The external sensors 2205 may be sensors similar to sensors 112 (e.g., radar, LIDAR, cameras, proximity sensors, etc.) configured to sense the arrangement of the floorplan 1602 and objects within the floorplan 1602. The external sensor 2205 has a remote device field of view 135 which is different than the field of view 113 of the vehicle 10. The different field of view 135 therefore augments the information available to the vehicle 10 for mapping and/or navigating the floorplan 1602. For example, the external sensor 2205 can sense the target location 1604 while the vehicle 10 is blocked by the obstacle 1606a. In some embodiments a plurality of remove devices 134 are included to provide even greater additional field of view to the vehicle 10.

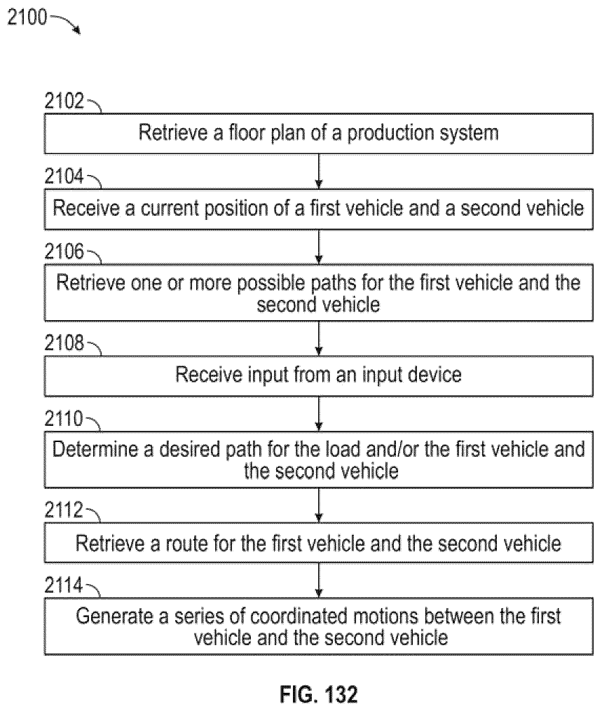

In some embodiments, the vehicle 10 is connected to other vehicles 10 over a wireless connection that facilitates sharing information between the vehicles 10. This connection allows a plurality of vehicles 10 to combine the output of the respective sensors 112 when mapping a floorplan 1602. The combined output facilitates quicker and more efficient mapping but using multiple vehicles which can move and map different areas of a floorplan 1602 simultaneously. The vehicles 10 may be configured to wirelessly communicate with each other using a local area network established by the each of the vehicles 10 themselves. In some embodiments, the wireless network connecting vehicle 10 and vehicle 10 as shown in FIG. 132 is a self-organizing network on a work site. In some embodiments, the communications means between vehicles 10 connected to the network of vehicles may include wired networking, short range radio frequency networking (e.g. Bluetooth, Bluetooth Low Energy, Wi-Fi, VHF, or UHF), optical communications networking, or long range radio frequency networking (e.g. satellite communications). In some embodiments, the network of vehicles may be a mesh network. Additional information regarding the local area network which connects a vehicle 10 with another vehicle 10 may be found in World Intellectual Property Organization Application No. WO2022155540A1, filed Jan. 14, 2022, and World Intellectual Property Organization Application No. WO2024191843A1, filed Jan. 14, 2022, the disclosures of which are incorporated by reference herein in their entireties.

As the vehicles 10 map a floorplan 1602, they may communicate data to each other across the local area network to establish the complete floorplan 1602 to be used by a pathing generation system 1600 as described herein.

In some embodiments, the sensors 112 are omitted, and the mapping is facilitated entirely by the external sensors 2205. In such cases, each of the vehicles 10 may be controlled by a remote device 134 (e.g., server) which is communicably coupled to the external sensors 2205 and the vehicles 10. The autonomous operation of the vehicles 10 thus relies on the mapping and sensing of the external sensors 2205. In such embodiments, the pathing generation system 1600 may be found in the remote devices 134 for controlling one or more of the vehicles 10.

### Overall Manufacturing System

Referring generally to the figures, a manufacturing method includes a load-based verification of assembly of a product at each stage of production in a production system. The production system is configured to move a product through a manufacturing line to different stations using one or more vehicles. Each station may be associated with a different manufacturing or assembly process that is performed there. At each station, the build process may not be completed properly, which undesirably impacts the final product.

To counteract this a manufacturing system includes a parameter-based verification of assembly, such as load-based verification of assembly, at each stage of production to determine if assembly is completed properly. The manufacturing system includes one or more vehicles that move a product through the production line. Each vehicle includes a chassis. The chassis is coupled to one or more interfaces that support the product. The interface is coupled to a force sensor that detects the position and magnitude of mass of the product supported by that interface. The vehicle includes a controller, operatively coupled to the sensors, and trained to determine expected force sensor readings at each stage of assembly. At each station, the controller receives measured sensor readings of the current status of the product. The controller compares the measured sensor readings to the expected sensor readings. In response to the determination that measured sensor readings differ from expected sensor readings, the controller provides a notification to the user of potential reasons for the unacceptable load.

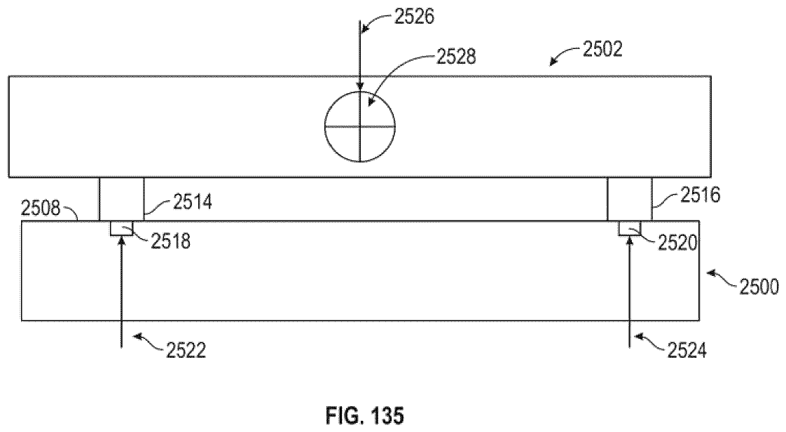

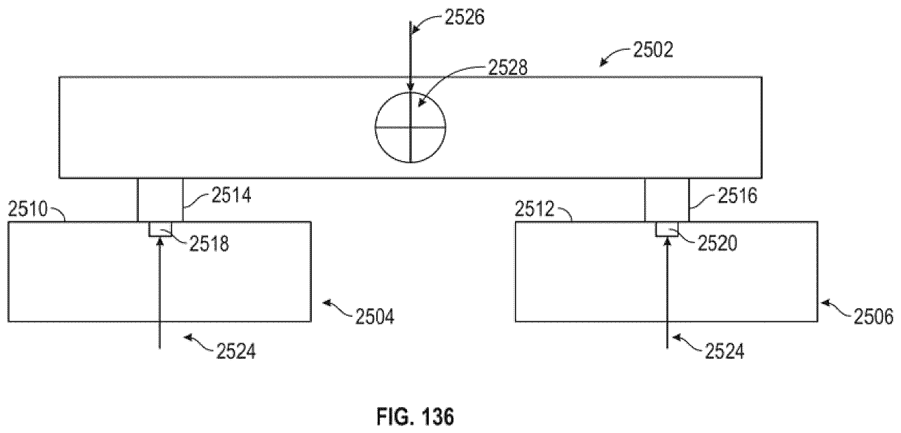

Referring to FIGS. 135 and 136, a manufacturing system includes a vehicle 2500. The vehicle 2500 may move a product 2502 (e.g., another vehicle 2500 or machine) along a manufacturing line as the product 2502 is assembled. In some embodiments, the manufacturing line is the production system 150, shown in FIG. 8. In some embodiments, the manufacturing system is configured to have a first vehicle 2504 and a second vehicle 2506 configured to move the product 2502 along the production line 150, as shown in FIG. 136. For example, certain large products, such as a telehandler, may be difficult to support with only a single vehicle 2500. To facilitate steering the product and spreading out the weight of the product the first vehicle 2504 and the second vehicle 2506 may be utilized.

In the example, shown in FIG. 136 a front end of the product 2502 is supported by the first vehicle 2504 and a back end of the product 2502 is supported by the second vehicle 2506. In some embodiments, the first vehicle 2504 and the second vehicle 2506 are independently operable. In other embodiments, operation of the first vehicle 2504 and/or the second vehicle 2506 is dependent on operation of the first vehicle 2504 and/or the second vehicle 2506. By way of example, the first vehicle 2504 may supply electrical energy to, propel, and/or control operation of the other vehicle. By way of example, the vehicle 2500, first vehicle 2504, and second vehicle 2506 may be the vehicle 10 shown in FIG. 1. By way of example, the product 2502 may be the telehandler 56 shown in FIG. 4.

The vehicle 2500 includes a chassis 2508. The chassis 2508 is configured to support other components of the vehicle 2500. In embodiments, which include a first vehicle 2504 and a second vehicle 2506, the first vehicle 2504 has a first chassis 2510 and the second vehicle has a second chassis 2512. By way of example, the chassis 2508, first chassis 2510, and second chassis 2512 may be the frame 12 shown in FIG. 1.

The vehicle 2500 includes a first interface 2514 and a second interface 2516. The first interface 2514 is configured to support a first portion of the product 2502. The second interface 2516 is configured to support a second portion of the product 2502. In some embodiments, a single interface (e.g., first interface 2514, second interface 2516) can be configured to support the entire product 2502. The first interface 2514 and the second interface 2516 are coupled to the chassis 2508. The first interface 2514 is coupled to a first portion (e.g., front end, etc.) of the chassis 2508 and the second interface 2516 is coupled to a second portion (e.g., back end, etc.), laterally separated from the first portion, of the chassis 2508. In embodiments which include a first vehicle 2504 and a second vehicle 2506, the first interface 2514 is coupled to the first chassis 2510 and the second interface 2516 is coupled to the second chassis 2512. In some embodiments, the first interface 2514 and the second interface 2516 may be interchangeable (e.g., cradle 52, lifting device, lift assembly 54, driving pin 62, turning pin 64, etc.). For example, the first interface 2514 can be changed from the cradle 52 to the lift assembly 54.

The vehicle 2500 includes a first sensor 2518. The first sensor 2518 is coupled to the first interface 2514. The first sensor 2518 can be configured to provide first sensor data indicating a first measured force 2522 (e.g., normal force, weight) on the first interface 2514. In some embodiments, the first sensor 2518 can be configured to provide first sensor data indicating a force of gravity 2526 on the product 2502. In embodiments with more than one vehicle 2500, the first sensor 2518 is coupled to the first interface 2514 on the first vehicle 2504. In some embodiments, the first sensor 2518 is a force sensor (e.g., load cell, inertial measurement unit, etc.). In some embodiments, the first sensor 2518 is at least one of a current sensor, a voltage sensor, or a pressure sensor, which infer the force of the product 2502 based on a sensed value (e.g., a load on an electrical actuator, a load on a drive motor, a hydraulic pressure, etc.).

In some embodiments the first measured force 2522 can be the normal force on the first interface 2514. Additionally or alternatively, the first measured force 2522 can be the weight of the product 2502 on the first interface 2514. In such embodiments, the first sensor 2518 may communicate with other components of the manufacturing system (e.g., a controller 102, etc.) to calculate a center of gravity 2528 of the product 2502.

The vehicle 2500 includes a second sensor 2520. The second sensor 2520 is coupled to the second interface 2516. The second sensor 2520 can be configured to provide second sensor data indicating a second measured force 2524 (e.g., normal force, weight) on the second interface 2516. In some embodiments, the second sensor 2520 can be configured to provide second sensor data indicating the force of gravity 2526 on the product 2502. In embodiments with more than one vehicle 2500, the second sensor 2520 is coupled to the second interface 2516 on the second vehicle 2506. In some embodiments, the second sensor 2520 is a force sensor (e.g., load cell, inertial measurement unit, etc.). In some embodiments, the second sensor 2520 is at least one of a current sensor, a voltage sensor, or a pressure sensor, which infer the force of the product 2502 based on a sensed value (e.g., a load on an electrical actuator, a load on a drive motor, a hydraulic pressure, etc.).

In some embodiments the second measured force 2524 can be the normal force on the second interface 2516. Additionally or alternatively, the second measured force 2524 can be the weight of the product 2502 on the second interface 2516. In such embodiments, the second sensor 2520 may communicate with other components of the manufacturing system (e.g., a controller 102, etc.) to calculate the center of gravity 2528 of the product 2502.

The manufacturing system further includes a controller 102. The controller 102 is operatively coupled to the first sensor 2518 and the second sensor 2520. The controller 102 is configured to move the product 2502 from one stage of assembly to another stage of assembly (e.g., from one station 160 to another station 160). The controller 102 is configured to receive sensor data from the first sensor 2518 and the second sensor 2520 indicating a first measured force 2522 on the first interface 2514 and a second measured force 2524 on the second interface 2516. By way of example, the controller 102 may be part of the control system 100 and may include a processor 104, a memory 106, and a communication interface 108 as shown in FIG. 7.

The controller 102 is configured to receive an indication of a current stage of assembly of the product 2502 (e.g., components that need to be added, etc.). The controller can be configured to determine an expected force (e.g., first expected force on the first interface 2514, second expected force on the second interface 2516) based on the current stage of assembly of the product 2502. In some embodiments, the indication includes the expected force for a stage of the manufacturing process. In some embodiments, the memory 106 may store first expected force data and second expected force data. In such embodiments, first expected force data is the expected force (e.g., expected normal force, expected force of gravity, etc.) of the product 2502 on the first interface 2514 and second expected force data is the expected force (e.g., expected normal force, expected force of gravity, etc.) of the product 2502 on the second interface 2516.

In some embodiments, the memory 106 may contain one or more instructions (e.g., comparative analysis, center of gravity calculations, etc.), that when executed by the processor 104, may cause the processor 104 to perform various functions (e.g., compare expected and measured values, calculate center of gravity 2528, etc.). After receiving the indication of the current stage of assembly of the product 2502, the controller 102 is configured to compare the measured force (e.g., first measured force 2522, second measured force 2524) with the expected force (first expected force, second expected force) using the instructions.

The controller 102 can be configured to perform one or more control actions in response to a difference between expected force data and measured force data (e.g., first measured force 2522 differs from first expected force, second measured force 2524 differs from second expected force, etc.). The control actions can be at least one of notifying a user, controlling an operating parameter (e.g., speed, direction of travel, acceleration of the vehicle 2500, etc.) of the vehicle 2500, the first vehicle 2504, and/or the second vehicle, controlling the operation of another vehicle 2500, controlling the operation of the production line 150, etc.,

The controller 102 can further be configured to determine if the station 160 is complete (e.g., all components are properly installed on the product 2502, etc.) or if an error has occurred (e.g., components are not properly installed, a tool is left on the product 2502, etc.). For example, the controller 102 can be configured to receive first sensor 2518 and second sensor 2520 data indicating a first measured force 2522 and a second measured force 2524, respectively. In such example, the controller 102 can compare the measured force data (e.g., first measured force 2522, second measured force 2524) to the expected force data (e.g., first expected force, second expected force, etc.) to determine if there is a difference between the expected force data and the measured force data. In response to a difference between expected force data and measured force data the controller 102 can be configured to determine that the station 160 is incomplete or an error has occurred.

The first expected force data and the second expected force data can be for a number of parameters (e.g., weight, center of gravity, time at station, etc.) and can be a range of acceptable values. Ranges of acceptable values can be provided for each station 160, and may vary from station 160 to station 160.

The controller 102 can be configured to calculate a center of gravity 2528 of the product 2502. For example, the controller 102 can be configured to perform center of gravity calculations using the first measured force 2522 (e.g., weight of the product 2502 on the first interface 2514) and the second measured force 2524 (e.g., weight of the product 2502 on the second interface 2516). The center of gravity 2528 can be configured to be a range of acceptable positions along the product 2502. If the measured center of gravity 2528 falls outside the range of acceptable center of gravity positions, the controller 102 can be configured to determine the station 160 is incomplete or an error has occurred. In response to the determination that the station 160 is incomplete, the controller 102 can perform a control action. The control action can include providing a notification to the user and/or adjusting an operating parameter of the vehicle 2500. The operating parameter is at least one of a speed, a direction of travel, or an acceleration of the vehicle 2500. In some embodiments, a station 160 is incomplete when a component is not installed on the product 2502. In some embodiments, an error has occurred when a component is installed incorrectly or in the wrong position on the product 2502, additional items (e.g., tools, other product components, etc.) are left on the product 2502, and/or a failed first sensor 2518 and/or second sensor 2520 reading.

In response to an error and/or an incomplete assembly the controller 102 can notify the user of the status of the product 2502. The notification can be visual or aural. For example, the notification may be a flashing light, or an alarm. In some embodiments, the notification includes a prediction of the cause of the error. For example, one or more parameters of the notification can be based on the outcome of the comparison between the measured value and the expected range of values for that specific parameter (e.g., weight, center of gravity 2528, etc.), and one or more other sensed values such as time at station 160. For example, in response to the comparison indicating the measured weight falls below an expected weight range and/or the time at station 160 being less than an expected time at station 160, the controller 102 can notify a user with an alarm that indicates, either through tone, color, spoken language, etc., that the product 2502 may not include the component as expected in that specific station 160. Similarly, if the measured weight falls above the expected weight, the notification may indicate that a tool was left on the vehicle 2500. In this way, the controller 102 can both detect the issue and attempt to predict the source of the issue based on the values of the measured weight and how it compares to the expected value range.

In some embodiments, the controller 102 may also control the vehicle 10, such as the controller 102 may prohibit further movement of the vehicle 10 from one station 160 to another until the measured value (e.g., weight, center of gravity) falls within the acceptable range. In some embodiments, the controller 102 may automatically control the vehicle 2500 to move out of the main product line 150, for example to a staging or waiting area, to allow the production line 150 to continue and to allow for a safe space for a user to troubleshoot the problem. Beneficially, this can allow the production line 150 to continue to run while a problem at a single station 160 is resolved. In some embodiments, in response to an input from a user, the vehicle 2500 can ignore a condition such as a measured value exceeding a range. For example, a user may input an override request and control the vehicle 2500 to the next station 160 despite, according to the vehicle sensors (e.g., the first sensor 2518, the second sensor 2520), the measured value is outside of the expected value.

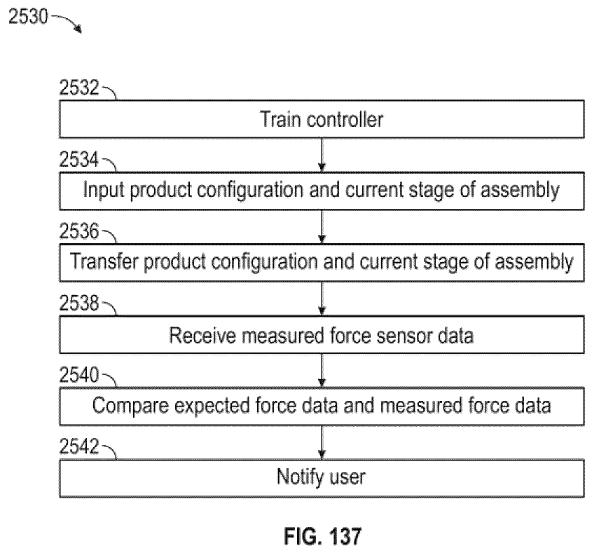

Referring to FIG. 137 a manufacturing method 2030 is shown according to exemplary embodiment. The manufacturing method 2530 is used for determining the status of the product 2502 build process at each station 160 of the production system 150 for each individual product configuration. By way of example, the production system 150 and individual stations 160 may be the production system 150 and stations 160 shown in FIG. 8.

Referring to FIG. 137, the manufacturing method 2530 includes a training step 2532. The training step 2532 includes simulating a production line 150 for each product configuration and storing expected force data. At each station of the production line 150, first sensor data indicating a first force on a first interface 2514 on a first vehicle 2504 and—if a second vehicle 2506 is also being used-second sensor data indicating a second force on a second interface 2516 may be collected and stored in the memory 106. The process of collecting first sensor data and second sensor data is repeated an n number (e.g., n=3, n=5, n=7, etc.) of times and the values are stored in the memory 106 as a range of values for a first expected force on the first interface 2514 and a second expected force on the second interface 2516. By way of example, the training step 2532 may include simulating the production system 150, shown in FIG. 8. In some embodiments, the expected weight of each component added to the product 2502 at each station 160 is stored in the memory 106 of the controller 102 and further used for predictive analysis (i.e. required components not installed, component installed in the wrong location, additional items accidentally left on vehicle 2500, etc.) of the status of production.

In some embodiments, step 2532 is optional and the controller 102 is provided (e.g., by the user, etc.) the expected weight, first expected force, and/or second expected force for one or more stations 160 prior to the start of manufacturing. For example, the expected weight can be based on measured values from prior operation of the production line 150. In some embodiments, the station 160 specific data provided to the first vehicle 2504 and/or the second vehicle 2506 may include an acceptable weight or weight range and acceptable center of gravity position ranges for each station 160 of a production line 150. If a weight is outside of the acceptable weight range, then the station 160 is either incomplete or a mistake has occurred. If a weight is within the acceptable range, the first vehicle 2504 and/or the second vehicle 2506 can proceed to the next stage. Similarly, if a center of gravity 2528 is outside the acceptable range of center of gravity positions, the station 160 may be incomplete or a mistake may have occurred. If the center of gravity 2528 is within the acceptable range, then the first vehicle 2504 and/or the second vehicle 2506 can proceed to the next station 160.

The manufacturing method 2530 includes an input step 2534. The input step 2534 may include the user inputting the desired product configuration and desired current stage of assembly of the product 2502 into the controller 102. By way of example, the controller 102 may be the controller 102 shown in FIG. 7. In some embodiments, the user may input the product configuration into a user device 132 of the controller 102 (e.g. smartphones, tablets, laptops, desktop computers, etc.). Additionally or alternatively, a user may input the product configuration into a user interface 114 of the controller 102 (i.e. input device that receives information and may include buttons, switches, knobs, touch screens, microphones, other input devices, etc.). Additionally or alternatively, the user may input the product configuration into a remote device 134 of the controller 102 (i.e. servers).

In some embodiments, one or more stations 160 of the production line 150 may include an indicator (e.g., visual indicator, aural indication, transmitter, etc.) which provides an indication of the current product configuration and/or current stage of the first vehicle 2504 and/or the second vehicle 2506. For example, each station 160 can include a Bluetooth emitter configured to emit, within a predetermined area of the production line 150, a first signal indicating that the area is identified as one of the stations 160. At another different station 160, a different Bluetooth emitter may emit a second signal, different than the first signal, indicating the identity of the other station 160. This emitter can be Bluetooth, WiFi, NFC, etc.

In some embodiments, the indicator is a visual indicator that is recognized by one sensor 112 (e.g., cameras) of the first vehicle 2504 and the second vehicle 2506. In some embodiments, the indicator is a specific sound or tone which can be sensed by the sensors 112 of the first vehicle 2504 and the second vehicle 2506. In some embodiments, the indicator is a magnetic indicator that can be sensed by magnetic sensors 112 such as a Hall-effect sensors, wherein the magnetic field of each magnetic indicator is unique and identifiable, to be associated with a station 160. In some embodiments, the vehicle 10 can identify the current product configuration and/or station 160 entirely based on image processing techniques.

The manufacturing method 2530 includes a transfer step 2536. The transfer step 2536 includes transferring to the controller 102, the product configuration and desired current stage of assembly of the product 2502. In other embodiments, step 2536 includes the vehicle 2500 itself determining the product configuration and the desired current state of assembly of the product 2502 as discussed above. When the controller 102 receives and/or determines the product configuration and the desired current stage of assembly of the product 2502, the controller 102 may determine or retrieve from memory 106 the corresponding first expected force, second expected force, expected weight of each component, and the expected force of gravity 2526 at the desired station 160. Each of the first expected force, second expected force, expected weight of each component, and the expected force of gravity 2526 at the desired station 160 may be a range of acceptable values.

In some embodiments, the user device 132, user interface 114, or remote device 134 may facilitate wireless communication (e.g. through Bluetooth, Wi-Fi, radio transmission, inductive transmission of energy, etc.) to the controller 102 to transfer the product configuration and the desired current stage of assembly of the product 2502. Additionally or alternatively, the user device 132, user interface 114, or remote device 134 may facilitate wired communication (e.g. through CAN, Ethernet, communication of power, etc.) to the controller 102 to transfer the product configuration and the desired current stage of assembly of the product 2502.

The manufacturing method 2530 includes a receiving sensor data information step 2538. The receiving sensor data information step 2538 includes providing by the first sensor 2518, first sensor 2518 data indicating a first measured force 2522 on the first interface 2514 (i.e. normal force on the first interface 2514) to the controller 102 and providing by the second sensor 2520, second sensor 2520 data indicating a second measured force 2524 on the second interface 2516 (i.e. normal force on the second interface 2516) to the controller 102. In some embodiments, the receiving sensor data information step 2538 includes providing, by the first sensor 2518 and the second sensor 2520, measured force data indicating the measured force of gravity 2526 on the product 2502 and the position of the center of gravity of the product 2502.

The manufacturing method 2530 includes a comparative step 2540. The comparative step 2540 includes comparing measured force data to expected force data (e.g., first measured force data to first expected force data, second measured force data to second expected force data) and determining if the measured force data, found in the receiving sensor data information step 2538, is within the range of expected sensor data, found in the training step 2532. In some embodiments, the processor 104 compares first expected force data to first measured force 2522 data and compares second expected force data to second measured force 2524 data to determine if the measured force data differs from expected force data. Additionally, in some embodiments, the processor 104 performs a center of gravity calculation to determine the measured center of gravity 2528 of the product 2502 and compares the expected center of gravity 2528 to the measured center of gravity 2528 to determine if measured center of gravity 2528 differs from expected center of gravity 2528.

The manufacturing method 2530 includes a notify user step 2542. The notify user step 2542 includes notifying the user when the measured force data differs from the expected force data described in the comparative step 2540. If the measured force data does not differ from the expected force data a positive notification (i.e. check mark, green screen, etc.) will be used to notify the user. If the measured force data differs from the expected force data a negative notification (e.g., an X, a red screen, etc.) will be used to notify the user. In some embodiments, following the transfer of the status of the product from the controller 102 to the user device 132, the controller will provide a notification to the user describing the status of the product 2502 (e.g., the measured sensor data is outside the range of the expected sensor data). Additionally or alternatively, the controller 102 can transfer the status of the product to the user interface 114, providing a notification to the user about the status of the product 2502. Additionally or alternatively, the controller 102 can transfer the status of the product to the remote device 134, providing a notification to the user about the status of the product 2502.

In some embodiments, the notification will include predictive analysis (i.e. required components not installed, component installed in the wrong location, additional items accidentally left on vehicle 2500, etc.). In some embodiments, the notification will provide a check list of required components at each station 160. In some embodiments, the controller 102 may also perform one or more other control actions such as controlling a state or position of the vehicle (e.g., vehicle 10, first vehicle 2504, second vehicle 2506) such as inhibiting further movement or automatically moving the vehicle out of the production line, controlling the state or position of vehicles in adjacent stations 160 of the production line 150, controlling the production line 150 itself (e.g., slowing the line, speeding up the line, etc.) or other control actions to facilitate the efficient operation of the production line 150.

### Reconfiguration of Vehicle Operation and Corresponding Autonomous Modes

Referring generally to the figures, one or more vehicles may be configured to operate in one of a plurality of different modes of operation, including different degrees of autonomous operation (e.g., manually controlled, partially autonomous, or fully autonomous). In some embodiments, a vehicle can be configured to switch between different modes of operation (e.g., between a mode of operation that is substantially user controlled to a mode of operation that is fully, or at least substantially, autonomous). Stated differently, in some embodiments, the vehicles may be configured to switch between different levels of autonomous operation (e.g., minimally autonomous to fully autonomous and vice versa) based a user input or information related to the operation of the one or more vehicles, including based on the feasibility of operating a vehicle autonomously in the presence of one or more different operational conditions (e.g., inclement weather, power outage, steep grades, spills, unexpected obstacles, etc.). For example, the vehicles may switch between a first mode of operation and a second mode of operation based on a match value determined from sensor data, which is indicative of one or more operational conditions and one or more operational criteria.

As described above, one or more of the vehicles 10 (e.g., one or more embodiments of the vehicle 10 shown in, and described with reference to, FIG. 1) may be configured to operate in a plurality of different modes of operation, including different degrees of autonomous operation (e.g., manually controlled, partially autonomous, or fully autonomous). In some embodiments, a vehicle 10 is configured to switch between different modes of operation (e.g., between a mode of operation that is substantially user controlled to a mode of operation that is fully, or at least substantially, autonomous). Stated, differently, in some embodiments, the vehicles 10 are configured to switch between different levels of autonomous operation (e.g., minimally autonomous to fully autonomous and vice versa) based on information related to the operation of the one or more vehicles 10 and/or the environment surrounding the vehicles 10, including based on the feasibility of operating a vehicle 10 autonomously in the presence of one or more different operational conditions (e.g., inclement weather, power outage, steep grades, spills, unexpected obstacles, etc.). For example, the vehicles may switch between a first mode of operation and a second mode of operation based on a match value determined from sensor data, which is indicative of one or more operational conditions, and one or more operational criteria. In some embodiments, the operator may also act as a supervisor over the autonomous operation of the vehicle 10. For example, the vehicle 10 may have plurality of goals or objectives to complete (e.g., tasks, waypoints, etc.) arranged in an order of completion. The vehicle may then proceed to accomplish those goals automatically in the semi-autonomous mode. The operator may then prioritize one goal over the others such that the prioritized goal is completed first before the remaining goals. In some embodiments, the user control is provided to an entire group of vehicles 10 to manually take control and prioritize certain goals (e.g., tasks) over others.

The vehicles 10 switch between a first mode of operation and a second mode of operation based on sensor data indicative of one or more operational conditions and one or more operational criteria. More specifically, the vehicle may determine a mode of operation based on sensor data relevant to the operation of the vehicle 10 and/or the environment surrounding the vehicle 10, including, for example, data collected by one or more sensors (e.g., sensors 112), light sensors, traction data (e.g., sensor data indicating a quality of the terrain on which the vehicle operates), load data (sensor data indicative of a load position, load orientation, the distribution of a load including between two or more vehicles, etc.), location data, network data, energy supply and state data (e.g., of batteries 110, etc.) such as a state of charge, and the like. The sensor data may be provided by sensors 112 of the vehicle 10, or based on sensor data provided by one or more remote device 134 or other vehicles 10 communicably coupled to the vehicle 10.

For example, a vehicle 10 may initially operate in a first mode or as an autonomous mobile robot and receive sensor data from one or more sensors 112 (e.g., cameras, LIDAR, etc.) indicative of a large unexpected obstacle in the vehicle's path. The vehicle 10 may initially remain in the first mode, and continue to operate as an autonomous mobile robot and upon unsuccessfully attempting to navigate around the unexpected obstacle, or due to sensor data indicating one or more additional operational conditions (e.g., low light/visibility, unexpected location, and/or an unstable load carried by the vehicle), the vehicle 10 may change operation to operate in a second mode (e.g., as an autonomous guided vehicle or a semi-autonomous guided vehicle, as described above). In some embodiments, the vehicle 10 may operate in one of a plurality of modes such as an autonomous mode, a semi-autonomous mode, or a manual mode and transition to a different mode of the plurality of modes based a command from at least one of a user device (e.g., user device 132), user interface 114, or remote device 134.

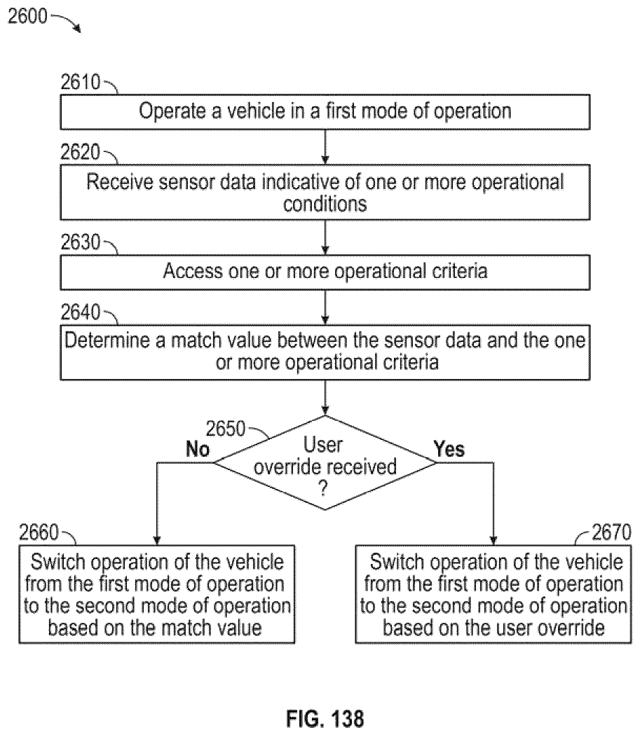

FIG. 138 depicts an example method for adjusting the mode of operation of a vehicle, according to one embodiment of the present disclosure. The method 2600 can be performed by at least the controller 102 and/or processor 104 of the system 100 depicted in FIG. 7, but is not limited thereto. In some implementations, one or more of the steps may be performed by a different processor, server, or any other computing device (e.g., user devices 132 and/or remote devices 134 of FIG. 7). For instance, one or more of the steps may be performed via a cloud-based service including any number of servers, which may be in communication with a processor of the vehicle 10 and/or an associated control system.

Although the steps are shown in FIG. 138 having a particular order, the steps may be performed in any order. In some instances, some of these steps may be optional. The method 2600 may be executed to improve the operation of one or more vehicles, including vehicles operating autonomously, and/or semi autonomously, within a manufacturing environment.

The method 2600 can, in some embodiments, include a method of operating a vehicle. In some embodiments, the method 2600 can include operating 2610 a vehicle in a first mode of operation. The vehicle 10 may include a plurality of modes of operation such as an autonomous mode, a semi-autonomous mode, and a user-guided or manual mode. In the autonomous mode, the vehicle 10 may be referred to as a self-guided vehicle or an autonomous mobile robot (AMR). In the semi-autonomous mode, the vehicle may be referred to as an automated guided vehicle (AGV). In the user-guided mode, the vehicle may be a remote-controlled vehicle. For example, in some embodiments, the method 2600 may include operating a vehicle in a first mode of operation that is fully autonomous or as an automated mobile robot, as described above, with reference to FIGS. 1 and 2. The autonomous mobile robot may be configured to operate within a manufacturing environment, including to move one or more components and/or products, without, or substantially without, user intervention or direct input from a user to control the operation of the vehicle 10.

Alternatively, or in addition, the vehicle 10 may operate in a first mode of operation that is substantially user controlled and/or that requires substantial input from a user to operate the vehicle 10, such as to steer the vehicle 10 while it is in a semi-automated guided vehicle configuration. For example, the vehicle 10 may operate in a semi-autonomous guided vehicle configuration based on the presence of one or more operating conditions.

The method 2600 can further include receiving 2620 sensor data indicative of one or more operational conditions. In some embodiments, operational conditions may include one or more conditions of the vehicles' environment that relate to the vehicle's operation. Operational conditions may include, for example, local weather, vehicle location, grade, traction, connectivity, proximity to one or more additional vehicles, tire pressure, battery levels, detected obstacles and/or obstructions, load data, light and/or visibility, sound, temperature, etc. The sensor data may be provided by the sensors 112 of the vehicle 10 or received from one or more other vehicles 10.

For example, in some embodiments, the method 2600 can receive sensor data indicative of an exceptionally steep grade based on or more orientation sensors of the vehicle 10 and may further receive sensor data indicative of a low traction environment (e.g., as traction data based on, or received from the operation of the vehicle's drivetrain).

The method 2600 can include accessing 2630 one or more operational criteria, wherein the one or more operational criteria correspond to one or more operational modes of the vehicle. The operational criteria may include one or more criteria specified for one or more different modes of operation of the vehicle, including, for example, one or more criteria that prohibit, or substantially conflict with, one or more modes of operation of the vehicle 10. For example, the operational criteria may include criteria that specify the vehicle 10 operate in a user controlled mode when a grade is above a given angle, when vehicle traction is inconsistent, or when the vehicle's load is precarious and/or difficult to maneuver safely.

Alternatively, or in addition, the one or more operational criteria may specify that a semi-autonomous and/or partially autonomous operation of the vehicle 10 may be used in the presence of certain operational conditions. For example, where the vehicle 10 has reliable connectivity to a vehicle network and/or guiding features, the vehicle may continue to operate autonomously even when a load is large, heavy, and/or costly, or the vehicle must maneuver between relatively small spaces and/or with little physical clearance.

In some embodiments, the method 2600 can include determining 2640 a match value between the sensor data (e.g., received at 2620) and the one or more operational criteria (e.g., accessed at 2630). For example, the method 2600 can include determining a match value via the controller 102 and/or the processor 104 of the vehicle. In some embodiments, determining the match value may include determining a degree of overlap and/or similarity between the operational conditions indicated by the sensor data and the one or more operational criteria accessed at 2630. For example, the method 2600 can include determining a match value for each operational condition for which sensor data has been received and for which an operational criteria may apply.

In some embodiments, the method 2600 can include determining if a user override is received at 2650. The user override can be a user input designating a mode of operation for the vehicle to operate in. For example, the user override can indicate the vehicle 10 should change from a manual mode to an autonomous mode.

In some embodiments, if a user override is not received, the method 2600 can include switching 2660 operation of the vehicle 10 from the first mode of operation to a second mode of operation based on the match value indicating a match between one or more operational criteria and the one or more operational conditions indicated by the sensor data. For example, the vehicle 10 controller 102 may change the operation of the vehicle from fully autonomous, or autonomous mobile robot operation, to a second mode of operation as a semi-autonomous guided vehicle for which steering must be controlled via user input. The vehicle may change to a SGV mode of operation based on the match value indicating the vehicle 10 lacks network connectivity and is located in an unexpected location (e.g., outside of an expected manufacturing environment and/or manufacturing station).

In some embodiments, if a user override is received at 2650, the method 2600 can include switching 2670 operation of the vehicle 10 from the first mode of operation to a second mode of operation based on the user override. For example, a user can override the vehicle and inhibit it from transitioning to an autonomous mode, and instead direct it to a manual mode. The user override otherwise direct the vehicle 10 to transition to any of the modes.

### Selective Manual Operation

Referring generally to the figures, one or more vehicles may be configured to operate in one of a plurality of different modes of operation, including different degrees of autonomous operation (e.g., manually controlled, partially autonomous, or fully autonomous). In some embodiments, a vehicle can be configured to switch between different modes of operation (e.g., between a mode of operation that is substantially user controlled to a mode of operation that is fully, or at least substantially, autonomous). Stated differently, in some embodiments, the vehicles may be configured to switch between different levels of autonomous operation (e.g., minimally autonomous to fully autonomous and vice versa) based a user input or information related to the operation of the one or more vehicles, including based on the feasibility of operating a vehicle autonomously in the presence of one or more different operational conditions (e.g., inclement weather, power outage, steep grades, spills, unexpected obstacles, etc.). For example, the vehicles may switch between a first mode of operation and a second mode of operation based on a match value determined from sensor data, which is indicative of one or more operational conditions and one or more operational criteria.

The different modes of operation may work together. A manually controlled mode of operation may be used to guide a vehicle along a path. The manually-guided vehicle may leave virtual waypoints to mark the path for future semi-autonomous or autonomous navigation along the same path. While being guided, an operator may also manually identify one or more milestones along the path. The vehicle may mark the location of the milestones relative to the path for future semi-autonomous or autonomous navigation. In a semi-autonomous or autonomous mode, the vehicle may move along the path and to one or more milestones indicated on the path in response to a command or automatically. An operator may also manually identify one or more zones the vehicle is to avoid moving through. The operator may use a user device (e.g., mobile phone, camera, laser pointer, IR emitter, motion/motion-sensing controller, etc.) to indicate the outer boundaries of a zone for the vehicle through operation of the user device. An operator may also manually identify the one or more zones by placing a plurality of indicators around an outer perimeter of the zone. The indicators may include visual indicators (e.g., flags, cones, markers, QR codes, NFC tags, radio-signal emitters, etc.) which may be detected by the vehicle. A vehicle may sense the zone a single time and remember the position of the zone relative to the surrounding work environment even after the indicators are removed.

During operation in a semi-autonomous or autonomous mode, a manual override may also be provided to force the vehicle to switch to a manual operation mode. The manual override can be generated from a controller onboard on the vehicle or from an external device (e.g., remote controller, mobile phone, laptop). The device can be onsite or offsite at a remote location. When taking manual control, an operator can control of a plurality of a vehicles or a single vehicle depending on the override provided.

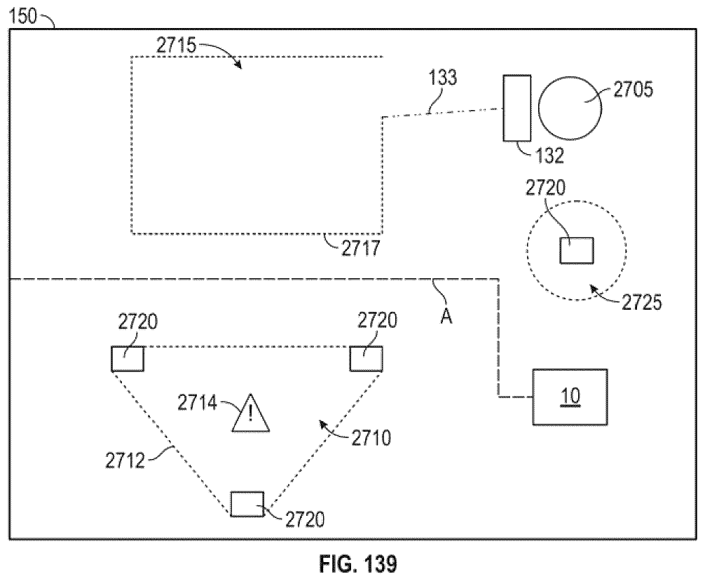

Referring now to FIG. 139 the vehicle 10 is shown in the manufacturing environment or production system 150, according to an exemplary embodiment. In the production system 150 is a plurality of zones, shown as a first zone 2710, a second zone 2715, and a third zone 2725. The plurality of zones such as the first zone 2710 and the second zone 2715 are areas of the production system 150 an operator such as operator 2705 may determine the vehicle 10 should not enter or should operate within in only certain circumstances or only under certain conditions (e.g., only in manual modes, only below a certain speed, only during certain hours, etc.). In some embodiments, a zone may surround a hazard. For example, first zone 2710 surrounds hazard 2714 in the production system 150. Still, one or more of the zones may simply be an area the vehicle 10 is not intended to enter. In some embodiments, the plurality of zones may be established manually by an operator, such as operator 2705, using the user device 132 to mark the boundaries of the zone. The plurality of zones may additionally and/or alternatively be established manually by an operator positioning one or more indicators (e.g., indicators 2720) in the production system 150. The vehicle 10 determines the location of the zones 2710, 2715 in the production system 150 by sensing one or more indicators (e.g., indicators 2720) identifying the zone, or receiving the location of the zone from another device (e.g., user device 132, another vehicle 10, etc.).

As shown in FIG. 139, the first zone 2710 surrounds a hazard 2714 and is established by a plurality of indicators 2720. The indicators 2720 are physical devices positioned in the production system 150 to delineate the boundaries of the first zone 2710 for the vehicle 10. In some embodiments, a user may place the indicators 2720 in the production system 150 to ensure a vehicle 10 does not enter the zone 2710. The indicators 2720 may include visual markers (e.g., flags, text, colors, shapes, symbols, QR codes, barcodes, etc.). For example, the indicators 2720 may be cones or flags simply placed by an operator in the production system 150. In some embodiments, when the indicators 2720 include visual markers, the vehicle 10 may sense the indicators 2720 using optical sensors in the sensors 112 (e.g., cameras, photodetectors, infrared sensors, etc.). The indicators 2720 may additionally and/or alternatively emit a signal (e.g., sound, electromagnetic wave, etc.). The signal may be a wireless signal such as Bluetooth, Wi-Fi, NFC, UWB, or other types of radio signals, a light with predetermined characteristics (e.g., color, brightness, etc.), or another type of signal. In some embodiments, when the indicators 2720 emit a signal, the vehicle 10 may include a corresponding receiver in the sensors 112 to receive the signal and determine a location of the respective indicator 2720. In some embodiments, there are a plurality of types of indicators 2720, wherein each type includes a unique visual marker and/or emits a unique signal which differentiates one type of indicator 2720 from another.

Upon sensing the indicators 2720, the controller 102 of the vehicle 10 performs one or more actions to determine the outer perimeter of the zone 2710. The actions may depend on the type of indicators 2720 that are sensed. The controller 102 of the vehicle 10 may reference a lookup table to determine a corresponding action or sequence of actions to take for each type of indicator 2720. For example, a first type of indicators 2720 may represent a corner of a zone, as shown in the first zone 2710. The vehicle 10 may then determine that indicators 2720 of the corner type the vehicle 10 determines an outer perimeter line, shown as perimeter 2712 which is defined by the indicators 2720. The perimeter 2712 may be a continuous line formed by connecting adjacent indicators 2720 (i.e., the vertices or corners of the first zone 2710) to each other until each indicator 2720 is connected to the rest of the indicators 2720. The types of indicators 2720 may indicate the indicator 2720 is a corner, a center, a side, a height of the zone to be established, a duration of the zone to be established, etc. For the height of the zone, the indicator 2720 may indicate that the zone, such as zone 2710 should not be entered by vehicle 10 with a height greater than the height indicated by the type of indicator. For example, the type of indicator may represent a zone which begins 2 feet above the ground of the production system 150, such that vehicles 10 shorter than 2 feet may freely enter the zone, but vehicles 10 at or greater than 2 feet may not. The duration of a zone may indicate how long vehicles 10 are to avoid the zone. In some embodiments, once a zone defined by indicators 2720 is sensed by a vehicle 10, the indicators 2720 may be removed by the vehicle may maintain the zone (e.g., in its memory 106). The duration the zone may be maintained and/or avoided may be a predetermined amount of time, such as 1 hour, 1 day, or 1 week, or a predetermined number of passes by a vehicle 10, such as after passing and identify the zone once, twice, three times, etc. After the duration has elapsed, the vehicle 10 may freely enter the zone. In such a manner, the features of the zones may be customized and/or determined by the type of indicator 2720 used.

Upon determining the boundary of the first zone 2710, the vehicle 10 may automatically adjust its path, shown as path A, to avoid the first zone 2710. In some embodiments, the vehicle 10 selects a path from a plurality of possible paths. In some embodiments, the selected path may be the path with the highest average distance from the plurality of zones along the path. In some embodiments, the selected path may be the path with the lowest average distance from the plurality of zones along the path. In some embodiments, selected path may be the path that is extends adjacent or next to the least number of zones. In some embodiments, the selected path may be the path with the largest minimum distance between the vehicle 10 and one of the plurality of zones. In some embodiments, the selected path may be the shortest path that maintains a predetermined minimum distance from each of the plurality of zones. In such embodiments, the vehicle 10 may be in a semi-autonomous or autonomous mode and automatically determine the appropriate path taking into account the senses first zone 2710.

In some embodiments with only two indicators 2720, the controller 102 determines a line connecting the indicators 2720 together and the vehicle 10 will treat the line as a boundary not to be crossed. In some instances a single indicator 2720 is used, such as the third zone 2725. In such cases, the vehicle 10 establishes a zone shown as the third zone 2725 with the indicator 2720 at its center. The diameter of the third zone 2725 may be a predetermined distance from the indicator 2720. In such cases, the predetermined distance may be based on the type of indicator 2720 used to indicate the third zone 2725. In other embodiments, the predetermined distance is configured by an operator or owner of the vehicle 10. Still, in other embodiments, the vehicle 10 may be configured to determine a maximum possible distance from the indicator 2720 based on the position of the indicator 2720 relative to surrounding objects, walls, or hazards in the production system 150.

The production system 150 also includes the second zone 2715. The second zone 2715 is shown in a partially completed state as it is being defined by an operator 2705. The second zone 2715 may be defined or established by an operator, shown as operator 2705, operating the user device 132. The user device 132 may be a motion/motion-sensing controller, smartphone, tablet, laptop, camera, laser pointer, IR emitter, etc. The user device 132 may facilitate a user mapping out the zone 2715 in virtual space. By way of example, the user devices 132 may be a motion/motion-sensing controller with an accelerometer, gyroscope, and/or a magnetometer that is capable of determining its own orientation in 3D space. The user device 132 can then act as a digital marker or a wand that can be wielded by an operator such as operator 2705 to delineate the boundaries of the second zone 2715. The operator 2705 may point the user device 132 at a point of the production system 150. The path 2717 traced by the virtual end 133 of the user device 132, may represent the outer boundary of a zone. Using the user device 132, an operator such as operator 2705 may trace a line or a boundary of zone. The user device 132 is communicably coupled to the vehicle 10 and may provide the path 2717 traced by the user device 132 to the vehicle 10 as zone data for the vehicle 10 to process and place the zone in the production system 150.

By way of another example, the user device 132 may include a touch interface, a display, and a camera. The camera may image the production system 150 and the operator 2705 may provide one or more user inputs to identify the path on the image of the production system 150 displayed. The user inputs may include tracing the boundary of the second zone 2715, and/or selecting multiple points in the image of the production system 150 to be connected to form the boundary of the second zone 2715. The data from the user device (e.g., the image, the user inputs, and/or the second zone 2715) may be provided to the vehicle 10.

In some embodiments, the operator 2705 may place the vehicle 10 in a manual operating mode and control the vehicle 10 to drive around the zone to define the boundary of the zone. The path traversed by the vehicle 10 may then be stored in memory as a boundary not to be crossed.

FIG. 11 depicts an example method 2800 for establishing and traversing a plurality of zones with a semi-autonomous or autonomous vehicle, according to an exemplary embodiment. The method 2800 can be performed by at least the controller 102 and/or processor 104 of the system 100 depicted in FIG. 7, but is not limited thereto. In some implementations, one or more of the steps may be performed by a different processor, server, or any other computing device (e.g., user devices 132 and/or remote devices 134 of FIG. 7). For instance, one or more of the steps may be performed via a cloud-based service including any number of servers, which may be in communication with a processor of the vehicle 10 and/or an associated control system.

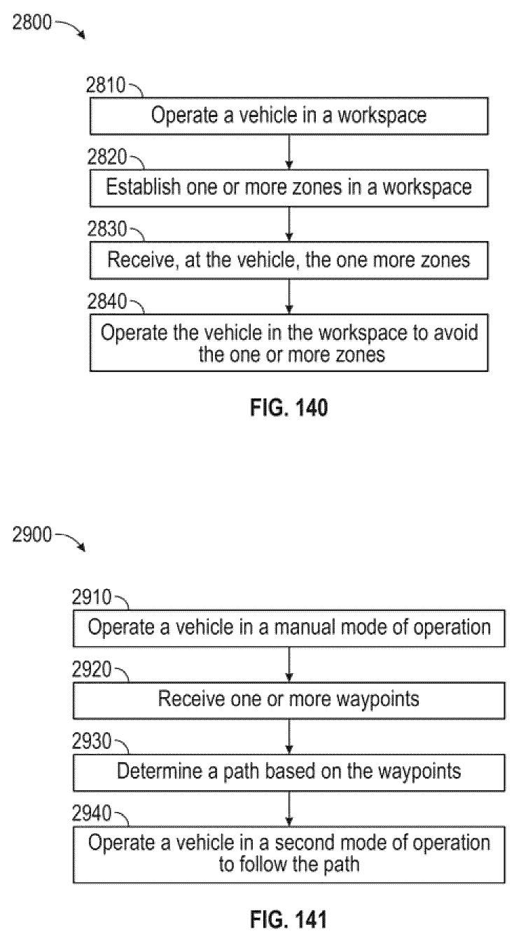

Although the steps are shown in FIG. 140 having a particular order, the steps may be performed in any order. In some instances, some of these steps may be optional. The method 2600 may be executed to improve the operation of one or more vehicles, including vehicles operating autonomously, and/or semi autonomously, within a manufacturing environment.

The method 2800, can, in some embodiments, include a method of operating a vehicle such as vehicle 10. The vehicle 10 may include a plurality of modes of operation such as an autonomous mode, a semi-autonomous mode, and a user-guided or manual mode. In the autonomous mode, the vehicle 10 may be referred to as a self-guided vehicle or an autonomous mobile robot (AMR). In the semi-autonomous mode, the vehicle may be referred to as an automated guided vehicle (AGV). In the user-guided mode, the vehicle may be a remote-controlled vehicle. For example, in some embodiments, the method 2800 may include at step 2810 operating a vehicle in a first mode of operation that is fully autonomous or as an automated mobile robot, as described above, with reference to FIGS. 1 and 2. The autonomous mobile robot may be configured to operate within a manufacturing environment, including to move one or more components and/or products, without, or substantially without, user intervention or direct input from a user to control the operation of the vehicle 10.

Alternatively, or in addition, at step 2810 the vehicle 10 may operate in a first mode of operation that is substantially user controlled and/or that requires substantial input from a user to operate the vehicle 10, such as to steer the vehicle 10 while it is in a semi-automated guided vehicle configuration. For example, the vehicle 10 may operate in a semi-autonomous guided vehicle configuration based on the presence of one or more operating conditions.

The method 2800 further includes at step 2820 establishing one or more zones in a workspace. The one or more zones (e.g., first zone 2710, second zone 2715, third zone 2725, etc.) may be established by an operator using a user device (e.g., user device 132) to virtually define the boundaries of the one or more zones in a workspace (e.g., production system 150) and/or by an operator placing one or more physical indicators in the zone (e.g., indicators 2720). The physical indicators may include visual markings and/or emit one or more sounds or signals to be sensed by the vehicle 10. In some embodiments, zones are established according to one or more rules based on the type of physical indicator used. There may be a plurality of types of indicators, with each type corresponding to a different function or feature of the zone. In some embodiments, rather than an operator placing the one or more physical indicators, a second vehicle 10 may place the one or more physical indicators in the workspace.

The method 2800 further includes at step 2830 receiving, at the vehicle the one or more zones. In some embodiments, where the zones are virtually defined by an operator using a user device, step 2830 includes receiving zone data from the user device 132. The zone data may include a position of the zone in the production system 150. In other embodiments, the zone data may include the user inputs, and the controller of the vehicle itself may determine the zone position in the production system 150 based on the user inputs. In some embodiments, where the zones are defined by physical indicators (e.g., indicators 2720) step 2830 includes using one or more sensors of the vehicle (e.g., sensors 112) to detect the physical indicators in the workspace. Upon detecting the physical indicators, the vehicle may then determine the boundary of the zone defined by the physical indicators, and thereby receive at the vehicle the one or more zones.

The method 2800 further includes at step 2840 operating the vehicle in the workspace to avoid the one or more zones. In step 2840 the vehicle may be operated in a manual mode, a semi-autonomous mode, or an autonomous mode. In a semi-autonomous or autonomous mode, the vehicle may determine a path to an endpoint that avoids each of the one or more zones in the work space. The path may be a selected path from a plurality of possible paths. The vehicle may determine the selected path based on one or more characteristics of the plurality of possible paths such as length, duration to traverse, minimum distance to a zone, maximum average distance to a zone, number of adjacent zones along the path, etc. The vehicle may then automatically traverse the production system 150 along a path that avoids the one or more zones. In some embodiments, in zones indicated by physical indicators (e.g., the indicators 2720) once the vehicle 10 has determined the zone defined by the physical indicators, even if the physical indicators are removed, the vehicle 10 can remember the zone and continue to avoid the zone. In some embodiments, any zones received or sensed by a first vehicle may be provided to a second vehicle, for the second vehicle to receive and avoid in a manner similar to the first vehicle. Thus, a zone sensed by a first vehicle may be provided to and avoided by a second vehicle. In some embodiments, each of a plurality of vehicles sense only a part of a zone, and in communicating each of the sensed parts to each other, the plurality of vehicles thereby sense the entire zone, and each vehicle can thereafter automatically avoid the sensed zone.

FIG. 12 depicts an example method 2900 for establishing and traversing a plurality of zones with a semi-autonomous or autonomous vehicle, according to an exemplary embodiment. The method 2900 can be performed by at least the controller 102 and/or processor 104 of the system 100 depicted in FIG. 7, but is not limited thereto. In some implementations, one or more of the steps may be performed by a different processor, server, or any other computing device (e.g., user devices 132 and/or remote devices 134 of FIG. 7). For instance, one or more of the steps may be performed via a cloud-based service including any number of servers, which may be in communication with a processor of the vehicle 10 and/or an associated control system.

Although the steps are shown in FIG. 141 having a particular order, the steps may be performed in any order. In some instances, some of these steps may be optional. The method 2600 may be executed to improve the operation of one or more vehicles, including vehicles operating autonomously, and/or semi autonomously, within a manufacturing environment.

The method 2900, can, in some embodiments, include at step 2910 a method of operating a vehicle such as vehicle 10 in a manual mode of operation. In the manual or user-guided mode, the vehicle may be a remote-controlled vehicle.

The method 2900 further includes at step 2920 receiving one or more waypoints. The vehicle 10 may receive a user input (e.g., via the user interface 114, the user device 132, the remote device 134, etc.) indicating the location of a waypoint. The location of the waypoint may be the location of the vehicle 10 at the time the user input is received. In some embodiments, the waypoint also includes a time series of the speed of the vehicle recorded since the last waypoint. In other embodiments, the vehicle 10 automatically determines waypoints based on a predetermined duration of time elapsing. For example, a vehicle may set waypoints of its current location every second, every 5 seconds, every minute, etc. In some embodiments, the vehicle determines a waypoint at each moment the vehicle changes its direction of travel. As the vehicle 10 is manually controlled in the workspace such as the production system 150, the vehicle may receive a plurality of waypoints.

The method 2900 further includes at step 2930 determining a path based on the plurality of waypoints. The plurality of waypoints may define a path of the vehicle 10 by connecting each adjacent (i.e., in time or in space) waypoint to the next consecutively. In some embodiments, the plurality of waypoints define only a portion of a path of the vehicle 10 as it has been under manual control. The portion of the total traversed path as indicated by the waypoints may be saved as a discrete path separate and apart from the total traversed path.

The method 2900 further includes at step 2940 operating the vehicle in a second mode of operation to follow the path. The vehicle 10 may be operable in plurality of modes of operation. While the vehicle 10 may learn the path and obtain the waypoints in a manual mode of operation (i.e., while controlled by an operator) when the vehicle 10 is in a semi-autonomous or autonomous mode, the vehicle 10 may traverse the path as indicated by the plurality of waypoints automatically. In some embodiments, the vehicle 10 may proceed along the path at the same speed as when in the manual mode. Still in other embodiments the vehicle 10 may follow the path at a predetermined speed which may be less than or greater than the speed the vehicle 10 traversed the path in the manual mode.

As utilized herein with respect to numerical ranges, the terms “approximately.” “about.” “substantially.” and similar terms generally mean+/−10°% of the disclosed values. When the terms “approximately.” “about.” “substantially.” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top.” “bottom.” “above.” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the production system as shown in the various exemplary embodiments is illustrative only. Additionally, any element disclosed in one embodiment may be incorporated or utilized with any other embodiment disclosed herein. For example, the first drive module 210 of the exemplary embodiment shown in at least FIGS. 11-15 may be incorporated in the second drive module 250 of the exemplary embodiment shown in at least FIGS. 9-10. Although only one example of an element from one embodiment that can be incorporated or utilized in another embodiment has been described above, it should be appreciated that other elements of the various embodiments may be incorporated or utilized with any of the other embodiments disclosed herein.

1. A system for transporting products throughout a manufacturing environment, comprising:
a mobile robot comprising:
a frame;
a tractive element coupled to the frame;
a motor coupled to the frame and configured to drive the tractive element to propel the mobile robot;
at least one sensor configured to collect sensor data regarding a surrounding environment of the mobile robot;
an interface configured to engage a product;
a lift assembly coupling the interface to the frame and configured to raise the interface relative to the frame; and
a controller operatively coupled to the motor, the at least one sensor, and the lift assembly and configured to control the motor and the lift assembly based on information from the at least one sensor to transport the product.

2. The system of claim 1, further comprising:
a subframe pivotably coupled to the frame;
a second tractive element coupled to the subframe,
wherein the motor and the tractive element are coupled to the frame via the subframe, and
wherein the subframe pivots relative to the frame to maintain contact of the tractive element and the second tractive element with a ground surface.

3. The system of claim 1, wherein the lift assembly is a scissor assembly and comprises a lift actuator coupled between the frame and the scissor assembly so that the lift actuator is configured to selectively raise the interface relative to the frame, wherein the lift actuator is a multi-stage telescoping actuator that includes a base stage, an intermediate stage, and an outer stage, and wherein the base stage is coupled to the frame, the outer stage is coupled to the scissor assembly, and the intermediate stage is arranged between the base stage and the outer stage.

4. The system of claim 1, wherein the lift assembly is a scissor assembly, and comprises:
a platform;
the scissor assembly coupled between the frame and the platform and including a prop pin;
a lift actuator coupled between the frame and the scissor assembly, wherein the lift actuator is configured to selectively raise the platform relative to the frame; and
a support prop including a plurality of notches, wherein the support prop is pivotably coupled to a side of the scissor assembly so that when the lift actuator raises the platform, the support prop is pivotably biased to bring one of the plurality of notches into engagement with the prop pin and prevent the platform from being lowered.

5. The system of claim 1, wherein the mobile robot further comprises:
a first channel and a second channel coupled to the frame, the first channel extending along a longitudinal axis and the second channel extending along a lateral axis, the first channel and the second channel each including:
a first guide and a second guide offset from one another and each including a first portion and a second portion, wherein the first portions extend substantially parallel to one another, and wherein the second portions extend away from one another as the second portions extend away from the first portions.

6. The system of claim 1, the mobile robot further comprising:
a cart interface for coupling a cart to the mobile robot, the cart interface comprising:
a mounting bracket configured to be coupled to the frame;
a cam plate pivotably coupled to the mounting bracket;
an actuator coupled to the mounting bracket and the cam plate and configured to rotate the cam plate relative to the mounting bracket; and
a pin coupled to the cam plate;
wherein rotation of the cam plate causes the pin to move upward to engage the cart.

7. The system of claim 1, further comprising:
a cart including a plurality of tractive elements and a platform configured to support the product;
the mobile robot further comprising:
a pin movably coupled to the frame and configured to engage the cart to couple the cart to the frame;
an actuator assembly including at least one actuator, wherein the actuator assembly is configured to raise the pin relative to the frame; and
wherein the controller is further configured to:
control the motor to propel the mobile robot to a position in which the pin is positioned beneath the cart; and
control the actuator assembly to raise the pin until the pin engages the cart to couple the cart to the frame.

8. The system of claim 1, the mobile robot further comprising:
a cart interface coupled to the frame and configured to couple the mobile robot to a cart extending above the cart interface, the cart interface including:
a first pin repositionable relative to the frame from a first lowered position to a first raised position to engage the cart;
a second pin repositionable from a second lowered position to a second raised position to engage the cart; and
an actuator coupled to the first pin and configured to move the first pin from the first lowered position to the first raised position,
wherein the first pin is repositionable without requiring movement of the second pin.

9. The system of claim 1, wherein the frame comprises a front surface, a rear surface opposite the front surface, and side surfaces extending between the front surface and the rear surface, and wherein the at least one sensor comprises a first sensor oriented parallel with at least one of the front surface, the rear surface, or the side surfaces and a second sensor oriented non-parallel with the front surface, the rear surface, and the side surfaces.

10. The system of claim 1, the mobile robot further comprising:
a first implement including:
a first implement interface configured to be coupled to a first type of product; and
a first base frame configured to be removably coupled to a mounting interface of the frame; and
a second implement including:
a second implement interface configured to be coupled to a second type of product; and
a second base frame configured to be removably coupled to the mounting interface of the frame.

11. The system of claim 1, further comprising a tow bar coupled to the mobile robot at a first end of the tow bar and coupled to a second mobile robot at a second end of the tow bar opposite the first end,
wherein, responsive to the motor propelling the mobile robot, the tow bar exerts a force on the second mobile robot to maintain a space between the second mobile robot and the mobile robot.

12. The system of claim 1, further comprising:
a second mobile robot;
wherein the interface comprises a platform defining a platform aperture and a cradle configured to support an end of the product for movement, the cradle rotatably coupled to the frame, the mobile robot further comprising:
a bracket coupled with the cradle and defining a bracket aperture; and
a pin configured to be received in a platform aperture and the bracket aperture to inhibit rotation of the cradle relative to the platform,
wherein the controller is further configured to:
monitor a position of the pin; and
control the motor of at least one of the mobile robot or the second mobile robot based on the position of the pin;
wherein the mobile robot and the second mobile robot are configured to transition between a first configuration and a second configuration by moving the pin out of the platform aperture and the bracket aperture of one of the mobile robot and the second mobile robot and into the platform aperture and the bracket aperture of the other of the mobile robot and the second mobile robot.

13. The system of claim 1, wherein the at least one sensor is moveable coupled to the frame, the mobile robot further comprising:
an actuator configured to move the at least one sensor to reposition the at least one sensor relative to the frame,
wherein the controller is further configured to detect an obstruction of the at least one sensor and operate the actuator to reposition the at least one sensor.

14. The system of claim 1, wherein the controller is further configured to:
obtain a floorplan of a production system and a current position of the mobile robot;
receive one or more inputs comprising a plurality of locations and an order of the plurality of locations;
generate, based on the floorplan of the production system and a footprint of the mobile robot, a route for the mobile robot from the current position of the mobile robot to the plurality of locations in the order.

15. The system of claim 1, further comprising:
a second mobile robot coupled with the mobile robot, the mobile robot and the second mobile robot configured to support the product;
wherein at least one of the controller is configured to, or one or more memory devices storing instructions thereon, that, when executed by one or more processors, cause the one or more processors to:
obtain one or more locations in a floorplan of a production system;
obtain a route for the mobile robot and the second mobile robot, from a first current position of the mobile robot and a second current position of the second mobile robot to the one or more locations; and
generate a series of coordinated motions between the mobile robot and the second mobile robot based on the route.

16. The system of claim 1, the mobile robot further comprising:
at least one of an audio output device or a visual output device,
wherein the controller is further configured to:
determine a condition of the mobile robot; and
provide an alert, via the at least one audio output device or visual output device based on the determined condition, wherein the determined condition is at least one of a plurality of conditions, and wherein each condition of the plurality of conditions is associated with a unique alert, the unique alert comprising at least one unique aspect specific to the condition relative to the other conditions of the plurality of conditions.

17. The system of claim 1, the mobile robot further comprising:
a sensor coupled to the interface and configured to provide sensor data indicating a measured force on the interface,
wherein the controller is further configured to:
receive an indication of a current stage of assembly of the product;
determine an expected force on the interface based on the current stage of assembly of the product;
compare the measured force with the expected force; and
in response to a determination that the measured force differs from the expected force, provide a notification to a user.

18. The system of claim 1, wherein the controller is further configured to:
operate the mobile robot in a first mode of a plurality of modes, wherein the plurality of modes comprises a manual mode, a guided mobile robot mode, and an autonomous mode;
determine a match value between the sensor data and at least one operational criteria of a plurality of operational criteria; and
operate the mobile robot in a second mode of the plurality of modes based on the match value, wherein the second mode is different than the first mode.

19. The system of claim 1, wherein the controller is further configured to:
operate the mobile robot along a first path;
sense, via the at least one sensor, at least one indicator in the environment;
determine, based on the at least one indicator, a boundary of a first predefined zone;
determine the first path extends into the first predefined zone in the environment surrounding the mobile robot;
generate a second path based on the sensor data that avoids the first predefined zone; and
operate the mobile robot along the second path.

20. A system for transporting products throughout a manufacturing environment, comprising:
(1) a mobile robot comprising:
a frame;
a tractive element coupled to the frame;
a motor coupled to the frame and configured to drive the tractive element to propel the mobile robot;
at least one sensor configured to collect sensor data regarding a surrounding environment of the mobile robot;
an interface configured to engage a product;
a lift assembly coupling the interface to the frame and configured to raise the interface relative to the frame; and
a controller operatively coupled to the motor, the at least one sensor, and the lift assembly and configured to control the motor and the lift assembly based on information from the at least one sensor to transport the product,
(2) the mobile robot further comprising:
a subframe pivotably coupled to the frame;
a second tractive element coupled to the subframe,
wherein the motor and the tractive element are coupled to the frame via the subframe, and
wherein the subframe pivots relative to the frame to maintain contact of the tractive element and the second tractive element with a ground surface; and
(3) wherein the lift assembly is a scissor assembly and comprises a lift actuator coupled between the frame and the scissor assembly so that the lift actuator is configured to selectively raise the interface relative to the frame, wherein the lift actuator is a multi-stage telescoping actuator that includes a base stage, an intermediate stage, and an outer stage, and wherein the base stage is coupled to the frame, the outer stage is coupled to the scissor assembly, and the intermediate stage is arranged between the base stage and the outer stage; and
(4) wherein the lift assembly further comprises:
a platform;
the scissor assembly coupled between the frame and the platform and including a prop pin;
the lift actuator coupled between the frame and the scissor assembly, wherein the lift actuator is configured to selectively raise the platform relative to the frame; and
a support prop including a plurality of notches, wherein the support prop is pivotably coupled to a side of the scissor assembly so that when the lift actuator raises the platform, the support prop is pivotably biased to bring one of the plurality of notches into engagement with the prop pin and prevent the platform from being lowered; and
(5) the mobile robot further comprising:
a first channel and a second channel coupled to the frame, the first channel extending along a longitudinal axis and the second channel extending along a lateral axis, the first channel and the second channel each including:
a first guide and a second guide offset from one another and each including a first portion and a second portion, wherein the first portions extend substantially parallel to one another, and wherein the second portions extend away from one another as the second portions extend away from the first portions; and
(6) the mobile robot further comprising:
a cart interface for coupling a cart to the mobile robot, the cart interface comprising:
a mounting bracket configured to be coupled to the frame;
a cam plate pivotably coupled to the mounting bracket;
a cart interface actuator coupled to the mounting bracket and the cam plate and configured to rotate the cam plate relative to the mounting bracket; and
a first pin coupled to the cam plate;
wherein rotation of the cam plate causes the first pin to move upward to engage the cart; and
(7) wherein the cart includes a plurality of tractive elements and a platform configured to support the product, and the mobile robot further comprises:
the first pin movably coupled to the frame and configured to engage the cart to couple the cart to the frame;
an actuator assembly including at least one actuator, wherein the actuator assembly is configured to raise the first pin relative to the frame; and
wherein the controller is further configured to:
control the motor to propel the mobile robot to a position in which the pin is positioned beneath the cart; and
control the actuator assembly to raise the first pin until the first pin engages the cart to couple the cart to the frame; and
(8) the mobile robot further comprising:
a cart interface coupled to the frame and configured to couple the mobile robot to a cart extending above the cart interface, the cart interface including:
a second pin repositionable relative to the frame from a first lowered position to a first raised position to engage the cart;
a third pin repositionable from a second lowered position to a second raised position to engage the cart; and
a second cart interface actuator coupled to the second pin and configured to move the second pin from the first lowered position to the first raised position,
wherein the second pin is repositionable without requiring movement of the third pin; and
(9) wherein the frame comprises a front surface, a rear surface opposite the front surface, and side surfaces extending between the front surface and the rear surface, and wherein the at least one sensor comprises a first sensor oriented parallel with at least one of the front surface, the rear surface, or the side surfaces and a second sensor oriented non-parallel with the front surface, the rear surface, and the side surfaces; and
(10) the mobile robot further comprises:
a first implement including:
a first implement interface configured to be coupled to a first type of product; and
a first base frame configured to be removably coupled to a mounting interface of the frame; and
a second implement including:
a second implement interface configured to be coupled to a second type of product; and
a second base frame configured to be removably coupled to the mounting interface of the frame; and
(11) a tow bar coupled to the mobile robot at a first end of the tow bar and coupled to a second mobile robot at a second end of the tow bar opposite the first end,
wherein, responsive to the motor propelling the mobile robot, the tow bar exerts a force on the second mobile robot to maintain a space between the second mobile robot and the first mobile robot; and
(12) wherein the interface comprises a platform defining a platform aperture and a cradle configured to support an end of the product for movement, the cradle rotatably coupled to the frame, the mobile robot further comprising:
a bracket coupled with the cradle and defining a bracket aperture; and
a pin configured to be received in a platform aperture and the bracket aperture to inhibit rotation of the cradle relative to the platform,
wherein the controller is further configured to:
monitor a position of the pin; and
control the motor of at least one of the mobile robot or the second mobile robot based on the position of the pin;
wherein the mobile robot and the second mobile robot are configured to transition between a first configuration and a second configuration by moving the pin out of the platform aperture and the bracket aperture of one of the mobile robot and the second mobile robot and into the platform aperture and the bracket aperture of the other of the mobile robot and the second mobile robot; and
(13) wherein the at least one sensor is moveable coupled to the frame, the mobile robot further comprising:
a sensor actuator configured to move the at least one sensor to reposition the at least one sensor relative to the frame,
wherein the controller is further configured to detect an obstruction of the at least one sensor and operate the sensor actuator to reposition the at least one sensor; and
(14) wherein the controller is further configured to:
obtain a floorplan of a production system and a current position of the mobile robot;
receive one or more inputs comprising a plurality of locations and an order of the plurality of locations;
generate, based on the floorplan of the production system and a footprint of the mobile robot, a route for the vehicle from the current position of the vehicle to the plurality of locations in the order; and
(15) the second mobile robot coupled with the mobile robot, the mobile robot and the second mobile robot configured to support the product;
wherein at least one of the controller is configured to, or one or more memory devices storing instructions thereon, that, when executed by one or more processors, cause the one or more processors to:
obtain one or more locations in a floorplan of a production system;
obtain a route for the first vehicle and the second vehicle, from a first current position of the first vehicle and a second current position of the second vehicle to the one or more locations; and
generate a series of coordinated motions between the first vehicle and the second vehicle based on the route; and
(16) the mobile robot further comprising:
at least one of an audio output device or a visual output device,
wherein the controller is further configured to:
determine a condition of the mobile robot; and
provide an alert, via the at least one audio output device or visual output device based on the determined condition, wherein the determined condition is at least one of a plurality of conditions, and wherein each condition of the plurality of conditions is associated with a unique alert, the unique alert comprising at least one unique aspect specific to the condition relative to the other conditions of the plurality of conditions; and
(17) the mobile robot further comprising:
a sensor coupled to the interface and configured to provide sensor data indicating a measured force on the interface,
wherein the controller is further configured to:
receive an indication of a current stage of assembly of the product;
determine an expected force on the interface based on the current stage of assembly of the product;
compare the measured force with the expected force; and
in response to a determination that the measured force differs from the expected force, provide a notification to a user; and
(18) wherein the controller is further configured to:
operate the mobile robot in a first mode of a plurality of modes, wherein the plurality of modes comprises a manual mode, a guided mobile robot mode, and an autonomous mode;
determine a match value between the sensor data and at least one operational criteria of a plurality of operational criteria; and
operate the mobile robot in a second mode of the plurality of modes based on the match value, wherein the second mode is different than the first mode; and
(19) wherein the controller is further configured to:
operate the mobile robot along a first path;
sense, via the at least one sensor, at least one indicator in the environment;
determine, based on the at least one indicator, a boundary of a first predefined zone;
determine the first path extends into the first predefined zone in the environment surrounding the mobile robot;
generate a second path based on the sensor data that avoids the first predefined zone; and
operate the mobile robot along the second path.

21-380. (canceled)
